(19) United States
(12) Patent Application Publication
(10) Pub. No.: US 2019/0389723 A1
(43) Pub. Date: Dec. 26, 2019

(54) HYDROGEN-CATALYST REACTOR

(71) Applicant: Brilliant Light Power, Inc., Cranbury, NJ (US)

(72) Inventor: Randell L. Mills, Cranbury, NJ (US)

(73) Assignee: Brilliant Light Power, Inc., Cranbury, NJ (US)

(21) Appl. No.: 16/426,687

(22) Filed: May 30, 2019

Related U.S. Application Data
(63) Continuation of application No. 12/108,700, filed on Apr. 24, 2008, now abandoned.
(60) Provisional application No. 60/913,556, filed on Apr. 24, 2007.
(60) Provisional application No. 60/952,305, filed on Jul. 27, 2007.
(60) Provisional application No. 60/954,426, filed on Aug. 7, 2007.
(60) Provisional application No. 60/935,373, filed on Aug. 9, 2007.
(60) Provisional application No. 60/955,465, filed on Aug. 13, 2007.
(60) Provisional application No. 60/956,821, filed on Aug. 20, 2007.
(60) Provisional application No. 60/957,540, filed on Aug. 23, 2007.
(60) Provisional application No. 60/972,342, filed on Sep. 14, 2007.
(60) Provisional application No. 60/974,191, filed on Sep. 21, 2007.
(60) Provisional application No. 60/975,330, filed on Sep. 26, 2007.
(60) Provisional application No. 60/976,004, filed on Sep. 28, 2007.
(60) Provisional application No. 60/978,435, filed on Oct. 9, 2007.
(60) Provisional application No. 60/987,552, filed on Nov. 13, 2007.
(60) Provisional application No. 60/987,946, filed on Nov. 14, 2007.
(60) Provisional application No. 60/989,677, filed on Nov. 21, 2007.
(60) Provisional application No. 60/991,434, filed on Nov. 30, 2007.
(60) Provisional application No. 60/991,974, filed on Dec. 3, 2007.
(60) Provisional application No. 60/992,601, filed on Dec. 5, 2007.
(60) Provisional application No. 61/012,717, filed on Dec. 10, 2007.
(60) Provisional application No. 61/014,860, filed on Dec. 19, 2007.
(60) Provisional application No. 61/016,790, filed on Dec. 26, 2007.
(60) Provisional application No. 61/020,023, filed on Jan. 9, 2008.
(60) Provisional application No. 61/021,205, filed on Jan. 15, 2008.
(60) Provisional application No. 61/021,808, filed on Jan. 17, 2008.
(60) Provisional application No. 61/022,112, filed on Jan. 18, 2008.
(60) Provisional application No. 61/022,949, filed on Jan. 23, 2008.
(60) Provisional application No. 61/023,297, filed on Jan. 24, 2008.
(60) Provisional application No. 61/023,687, filed on Jan. 25, 2008.
(60) Provisional application No. 61/024,730, filed on Jan. 30, 2008.
(60) Provisional application No. 61/025,520, filed on Feb. 1, 2008.
(60) Provisional application No. 61/028,605, filed on Feb. 14, 2008.
(60) Provisional application No. 61/030,468, filed on Feb. 21, 2008.
(60) Provisional application No. 61/064,453, filed on Mar. 6, 2008.
(60) Provisional application No. 61/064,723, filed on Mar. 21, 2008.
(60) Provisional application No. 61/071,191, filed on Apr. 17, 2008.

(51) Int. Cl. C01B 3/02

(52) U.S. Cl. CPC C01B 3/02

(57) ABSTRACT

A power source and hydride reactor is provided comprising a reaction cell for the catalysis of atomic hydrogen to form novel hydrogen species and compositions of matter comprising new forms of hydrogen, a source of atomic hydrogen, a source of a hydrogen catalyst comprising a reaction mixture of at least one reactant comprising the element or elements that form the catalyst and at least one other element, whereby the catalyst is formed from the source and the catalysis of atomic hydrogen releases energy in an amount greater than about 300 kJ per mole of hydrogen during the catalysis of the hydrogen atom. Further provided is a reactor wherein the reaction mixture comprises a catalyst or a source of catalyst and atomic hydrogen or a source of atomic hydrogen (H) wherein at least one of the catalyst and atomic hydrogen is released by a chemical reaction of at least one species of the reaction mixture or between two or more reaction-mixture species. In an embodiment, the species may be at least one of an element, complex, alloy, or a compound such as a molecular or inorganic compound wherein each may be at least one of a reagent or product in the reactor. Alternatively, the species may form a complex, alloy, or compound with at least one of hydrogen and the catalyst. Preferably, the reaction to generate at least one of atomic H and catalyst is reversible.

### CROSS-REFERENCES TO RELATED APPLICATIONS

This application is a Continuation of application Ser. No. 12/108,700 filed Apr. 24, 2008 which claims the benefit of (1) Application No. 60/913,556 filed on Apr. 24, 2007; (2) Application No. 60/952,305 filed on Jul. 27, 2007; (3) Application No. 60/954,426 filed on Aug. 7, 2007; (4) Application No. 60/935,373 filed on Aug. 9, 2007; (5) Application No. 60/955,465 filed on Aug. 13, 2007; (6) Application No. 60/956,821 filed on Aug. 20, 2007; (7) Application No. 60/957,540 filed on Aug. 23, 2007; (8) Application No. 60/972,342 filed on Sep. 14, 2007; (9) Application No. 60/974,191 filed on Sep. 21, 2007; (10) Application No. 60/975,330 filed on Sep. 26, 2007; (11) Application No. 60/976,004 filed on Sep. 28, 2007; (12) Application No. 60/978,435 filed on Oct. 9, 2007; (13) Application No. 60/987,552 filed on Nov. 13, 2007; (14) Application No. 60/987,946 filed on Nov. 14, 2007; (15) Application No. 60/989,677 filed on Nov. 21, 2007; (16) Application No. 60/991,434 filed on Nov. 30, 2007; (17) Application No. 60/991,974 filed on Dec. 3, 2007; (18) Application No. 60/992,601 filed on Dec. 5, 2007; (19) Application No. 61/012,717 filed on Dec. 10, 2007; (20) Application No. 61/014,860 filed on Dec. 19, 2007; (21) Application No. 61/016,790 filed on Dec. 26, 2007; (22) Application No. 61/020,023 filed on Jan. 9, 2008; (23) Application No. 61/021,205 filed on Jan. 15, 2008; (24) Application No. 61/021,808 filed on Jan. 17, 2008; (25) Application No. 61/022,112 filed on Jan. 18, 2008; (26) Application No. 61/022,949 filed on Jan. 23, 2008; (27) Application No. 61/023,297 filed on Jan. 24, 2008; (28) Application No. 61/023,687 filed on Jan. 25, 2008; (29) Application No. 61/024,730 filed on Jan. 30, 2008; (30) Application No. 61/025,520 filed on Feb. 1, 2008; (31) Application No. 61/028,605 filed on Feb. 14, 2008; (32) Application No. 61/030,468 filed on Feb. 21, 2008; (33) Application No. 61/064,453 filed on Mar. 6, 2008; (34) Application No. 61/______ filed on Mar. 21, 2008, and (35) Application No. 61/______ filed on Apr. 17, 2008, all of which are herein incorporated by reference in their entirety.

### DESCRIPTION OF THE INVENTION

### Field of the Invention

As disclosed in the paper R. Mills, J. He, Z. Chang, W. Good, Y. Lu, B. Dhandapani, “Catalysis of Atomic Hydrogen to Novel Hydrogen Species H⁻(1/4) and H₂(1/4) as a New Power Source”, Int. J. Hydrogen Energy, Vol. 32, No. 12, (2007), pp. 2573-2584 which is herein incorporated by reference, the data from a broad spectrum of investigational techniques strongly and consistently indicates that hydrogen can exist in lower-energy states then previously thought possible. The predicted reaction involves a resonant, nonradiative energy transfer from otherwise stable atomic hydrogen to a catalyst capable of accepting the energy. The product is H(1/p), fractional Rydberg states of atomic hydrogen wherein

$$n = \frac{1}{2} , \frac{1}{3} , \frac{1}{4} , … , \frac{1}{p} ;$$

(p≤137 is an integer) replaces the well known parameter n=integer in the Rydberg equation for hydrogen excited states. He⁺, Ar⁺, and K are predicted to serve as catalysts since they meet the catalyst criterion—a chemical or physical process with an enthalpy change equal to an integer multiple of the potential energy of atomic hydrogen, 27.2 eV. Specific predictions based on closed-form equations for energy levels were tested. For example, two H(1/p) may react to form H₂(1/p) that have vibrational and rotational energies that are p² times those of H₂ comprising uncatalyzed atomic hydrogen. Rotational lines were observed in the 145-300 nm region from atmospheric pressure electron-beam excited argon-hydrogen plasmas. The unprecedented energy spacing of 4² times that of hydrogen established the internuclear distance as 1/4 that of H, and identified H₂(1/4).

The predicted products of alkali catalyst K are H⁻(1/4) which form KH*X, a novel alkali halido (X) hydride compound, and H₂(1/4) which may be trapped in the crystal. The ¹H MAS NMR spectrum of novel compound KH*Cl relative to external tetramethylsilane (TMS) showed a large distinct upfield resonance at −4.4 ppm corresponding to an absolute resonance shift of −35.9 ppm that matched the theoretical prediction of H⁻(1/p) with p=4. The predicted frequencies of ortho and para-H₂(1/4) were observed at 1943 cm⁻¹ and 2012 cm⁻¹ in the high resolution FTIR spectrum of KH*I having a −4.6 ppm NMR peak assigned to H⁻(1/4). The 1943/2012 cm⁻¹-intensity ratio matched the characteristic ortho-to-para-peak-intensity ratio of 3:1, and the ortho-para splitting of 69 cm⁻¹ matched that predicted. KH*Cl having H⁻(1/4) by NMR was incident to the 12.5 keV electron-beam which excited similar emission of interstitial H₂(1/4) as observed in the argon-hydrogen plasma. KNO₃ and Raney nickel were used as a source of K catalyst and atomic hydrogen, respectively, to produce the corresponding exothermic reaction. The energy balance was ΔH=−17,925 kcal/mole KNO₃, about 300 times that expected for the most energetic known chemistry of KNO₃, and −3585 kcal/mole H₂, over 60 times the hypothetical maximum enthalpy of −57.8 kcal mole H₂ due to combustion of hydrogen with atmospheric oxygen, assuming the maximum possible H₂ inventory. The reduction of KNO₃ to water, potassium metal, and NH₃ calculated from the heats of formation only releases −14.2 kcal/mole H₂ which cannot account for the observed heat; nor can hydrogen combustion. But, the results are consistent with the formation of H⁻(1/4) and H₂(1/4) having enthalpies of formation of over 100 times that of combustion.

In embodiments, the invention comprises a power source and a reactor to form lower-energy-hydrogen species and compounds. The invention further comprises catalyst reaction mixtures to provide catalyst and atomic hydrogen.

Preferred atomic catalysts are lithium, potassium, and cesium atoms. A preferred molecular catalyst is NaH.

### Hydrinos

A hydrogen atom having a binding energy given by

$$Binding Energy = \frac{13.6 eV}{{( 1 / p )}^{2}} \qquad ( 1 )$$

where p is an integer greater than 1, preferably from 2 to 137, is disclosed in R. L. Mills, “The Grand Unified Theory of Classical Quantum Mechanics”, October 2007 Edition, (posted at http://www.blacklightpowercom/theory/book.shtml); R. Mills, The Grand Unified Theory of Classical Quantum Mechanics, May 2006 Edition, BlackLight Power, Inc., Cranbury, N.J., (“'06 Mills GUT”), provided by BlackLight Power, Inc., 493 Old Trenton Road, Cranbury, N.J., 08512 (posted at www.blacklightpower.com); R. Mills, The Grand Unified Theory of Classical Quantum Mechanics, January 2004 Edition, BlackLight Power, Inc., Cranbury, N.J., (“'04 Mills GUT”), provided by BlackLight Power, Inc., 493 Old Trenton Road, Cranbury, N.J., 08512; R. Mills, The Grand Unified Theory of Classical Quantum Mechanics, September 2003 Edition, BlackLight Power, Inc., Cranbury, N.J., (“'03 Mills GUT”), provided by BlackLight Power, Inc., 493 Old Trenton Road, Cranbury, N.J., 08512; R. Mills, The Grand Unified Theory of Classical Quantum Mechanics, September 2002 Edition, BlackLight Power, Inc., Cranbury, N.J., (“'02 Mills GUT”), provided by BlackLight Power, Inc., 493 Old Trenton Road, Cranbury, N.J., 08512; R. Mills, The Grand Unified Theory of Classical Quantum Mechanics, September 2001 Edition, BlackLight Power, Inc., Cranbury, N.J., Distributed by Amazon.com (“'01 Mills GUT”), provided by BlackLight Power, Inc., 493 Old Trenton Road, Cranbury, N.J., 08512; R. Mills, The Grand Unified Theory of Classical Quantum Mechanics, January 2000 Edition, BlackLight Power, Inc., Cranbury, N.J., Distributed by Amazon.com (“'00 Mills GUT”), provided by BlackLight Power, Inc., 493 Old Trenton Road, Cranbury, N.J., 08512; R. L. Mills, “Physical Solutions of the Nature of the Atom, Photon, and Their Interactions to Form Excited and Predicted Hydrino States,” Physics Essay, in press; R. L. Mills, “Exact Classical Quantum Mechanical Solution for Atomic Helium which Predicts Conjugate Parameters from a Unique Solution for the First Time,” Physics Essays, in press; R. L. Mills, P. Ray, B. Dhandapani, “Excessive Balmer α Line Broadening of Water-Vapor Capacitively-Coupled RF Discharge Plasmas,” International Journal of Hydrogen Energy, Vol. 33, (2008), 802-815; R. L. Mills, J. He, M. Nansteel, B. Dhandapani, “Catalysis of Atomic Hydrogen to New Hydrides as a New Power Source,” International Journal of Global Energy Issues (IJGEI). Special Edition in Energy Systems, Vol. 28, issue 2-3, (2007), 304-324; R. L. Mills, H. Zea, J. He, B. Dhandapani, “Water Bath calorimetry on a Catalytic Reaction of Atomic Hydrogen,” Int. J. Hydrogen Energy, Vol. 32, (2007), 4258-4266; J. Phillips, C. K. Chen, R. L. Mills, “Evidence of Catalytic Production of Hot Hydrogen in RE-Generated Hydrogen/Argon Plasmas,” Int. J. Hydrogen Energy, Vol. 32(14), (2007), 3010-3025; R. L. Mills, J. He, Y. Lu, M. Nansteel, Z. Chang, B. Dhandapani, “Comprehensive Identification and Potential Applications of New States of Hydrogen,” Int. J. Hydrogen Energy, Vol. 32(14), (2007), 2988-3009; R. L. Mills, J. He, Z. Chang, W. Good, Y. Lu, B. Dhandapani, “Catalysis of Atomic Hydrogen to Novel Hydrogen Species H⁻(1/4) and H₂(1/4) as a New Power Source,” Int. J. Hydrogen Energy, Vol. 32(13), (2007), pp. 2573-2584; R. L. Mills, “Maxwell's Equations and QED: Which is Fact and Which is Fiction,” Physics Essays, Vol. 19, (2006), 225-262; R. L. Mills, P. Ray, B. Dhandapani, Evidence of an energy transfer reaction between atomic hydrogen and argon II or helium II as the source of excessively hot H atoms in radio-frequency plasmas, J. Plasma Physics, Vol. 72, No. 4, (2006), 469-484; R. L. Mills, “Exact Classical Quantum Mechanical Solutions for One- through Twenty-Electron Atoms,” Physics Essays, Vol. 18, (2005), 321-361; R. L. Mills, P. C. Ray, R. M. Mayo, M. Nansteel, B. Dhandapani, J. Phillips, “Spectroscopic Study of Unique Line Broadening and Inversion in Low Pressure Microwave Generated Water Plasmas,” J. Plasma Physics, Vol. 71, No 6, (2005), 877-888; R. L. Mills, “The Fallacy of Feynman's Argument on the Stability of the Hydrogen Atom According to Quantum Mechanics,” Ann. Fund. Louis de Broglie, Vol. 30, No. 2, (2005), pp. 129-151; R. L. Mills, B. Dhandapani, J. He, “Highly Stable Amorphous Silicon Hydride from a Helium Plasma Reaction,” Materials Chemistry and Physics, 94/2-3, (2005), 298-307; R. L. Mills, J. He, Z, Chang, W. Good, Y. Lu, B. Dhandapani, “Catalysis of Atomic Hydrogen to Novel Hydrides as a New Power Source,” Prepr. Pap.—Am. Chem. Soc. Conf., Div. Fuel Chem., Vol. 50, No. 2, (2005); R. L. Mills, J. Sankar, A. Voigt, J. He, P. Ray, B. Dhandapani, “Role of Atomic Hydrogen Density and Energy in Low Power CVD Synthesis of Diamond Films,” Thin Solid Films, 478, (2005) 77-90; R. L. Mills, “The Nature of the Chemical Bond Revisited and an Alternative Maxwellian Approach,” Physics Essays, Vol. 17, (2004), 342-389; R. L. Mills, P. Ray, “Stationary Inverted Lyman Population and a Very Stable Novel Hydride Formed by a Catalytic Reaction of Atomic Hydrogen and Certain Catalysts,” J. Opt. Mat., 27, (2004), 181-186; W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts,” European Physical Journal: Applied Physics, 28, (2004), 83-104; J. Phillips, R. L. Mills, X. Chen, “Water Bath calorimetric Study of Excess Heat in ‘Resonance Transfer’ Plasmas,” J. Appl. Phys., Vol. 96, No. 6, (2004) 3095-3102; R. L. Mills, Y. Lu, M. Nansteel, J. He, A. Voigt, W. Good, B. Dhandapani, “Energetic Catalyst-Hydrogen Plasma Reaction as a Potential New Energy Source,” Division of Fuel Chemistry, Session: Advances in Hydrogen Energy, Prepr. Pap.—Am. Chem. Soc. Conf., Vol. 49, No. 2, (2004); R. L. Mills, J. Sankar, A. Voigt, J. He, B. Dhandapani, “Synthesis of HDLC Films from Solid Carbon,” J. Materials Science, J. Mater. Sci. 39 (2004) 3309-3318; R. L. Mills, Y. Lu, M. Nansteel, J. He, A. Voigt, B. Dhandapani, “Energetic Catalyst-Hydrogen Plasma Reaction as a Potential New Energy Source,” Division of Fuel Chemistry, Session: Chemistry of Solid, Liquid, and Gaseous Fuels, Prepr. Pap.—Am. Chem. Soc. Conf., Vol. 49, No. 1, (2004); R. L. Mills, “Classical Quantum Mechanics,” Physics Essays, Vol. 16, (2003), 433-498; R. L. Mills, P. Ray, M. Nansteel, J. He, X. Chen, A. Voigt, B. Dhandapani, “Characterization of an Energetic Catalyst-Hydrogen Plasma Reaction as a Potential New Energy Source,” Am. Chem. Soc. Div. Fuel Chem. Prepr., Vol. 48, No. 2, (2003); R. L. Mills, J. Sankar, A. Voigt, J. He, B. Dhandapani, “Spectroscopic Characterization of the Atomic Hydrogen Energies and Densities and Carbon Species During Helium-Hydrogen-Methane Plasma CVD Synthesis of Diamond Films,” Chemistry of Materials, Vol. 15, (2003), pp. 1313-1321; R. L. Mills, P. Ray, “Extreme Ultraviolet Spectroscopy of Helium-Hydrogen Plasma,” J. Phys. D, Applied Physics, Vol. 36, (2003), pp. 1535-1542; R. L. Mills, X. Chen, P. Ray, J. He, B. Dhandapani, “Plasma Power Source Based on a Catalytic Reaction of Atomic Hydrogen Measured by Water Bath calorimetry,” Thermochimica Acta, Vol. 406/1-2, (2003), pp. 35-53; R. L. Mills, B. Dhandapani, J. He, “Highly Stable Amorphous Silicon Hydride,” Solar Energy Materials & Solar Cells, Vol. 80, No. 1, (2003), pp. 1-20; R. L. Mills, P. Ray, R. M. Mayo, “The Potential for a Hydrogen Water-Plasma Laser,” Applied Physics Letters, Vol. 82, No. 11, (2003), pp. 1679-1681; R. L. Mills, P. Ray, “Stationary Inverted Lyman Population Formed from Incandescently Heated Hydrogen Gas with Certain Catalysts,” J. Phys. D, Applied Physics, Vol. 36, (2003), pp. 1504-1509; R. L. Mills, P. Ray, B. Dhandapani, J. He, “Comparison of Excessive Balmer α Line Broadening of Inductively and Capacitively Coupled RF, Microwave, and Glow Discharge Hydrogen Plasmas with Certain Catalysts,” IEEE Transactions on Plasma Science, Vol. 31, No. (2003), pp. 338-355; R. L. Mills, P. Ray, R. M. Mayo, “CW HI Laser Based on a Stationary Inverted Lyman Population Formed from Incandescently Heated Hydrogen Gas with Certain Group I Catalysts,” IEEE Transactions on Plasma Science, Vol. 31, No. 2, (2003), pp. 236-247; R. L. Mills, P. Ray, J. Dong, M. Nansteel, B. Dhandapani, J. He, “Spectral Emission of Fractional-Principal-Quantum-Energy-Level Atomic and Molecular Hydrogen,” Vibrational Spectroscopy, Vol. 31, No. 2, (2003), pp. 195-213; H. Conrads, R. L. Mills, Th. Wrubel, “Emission in the Deep Vacuum Ultraviolet from a Plasma Formed by Incandescently Heating Hydrogen Gas with Trace Amounts of Potassium Carbonate,” Plasma Sources Science and Technology, Vol. 12, (2003), pp. 389-395; R. L. Mills, J. He, P. Ray, B. Dhandapani, X. Chen, “Synthesis and Characterization of a Highly Stable Amorphous Silicon Hydride as the Product of a Catalytic Helium-Hydrogen Plasma Reaction,” Int. J. Hydrogen Energy, Vol. 28, No. 12, (2003), pp. 1401-1424; R. L. Mills, P. Ray, “A Comprehensive Study of Spectra of the Bound-Free Hyperfine Levels of Novel Hydride Ion H⁻(1/2), Hydrogen, Nitrogen, and Air,” Int. J. Hydrogen Energy, Vol. 28, No. 8, (2003), pp. 825-871; R. L. Mills, M. Nansteel, and P. Ray, “Excessively Bright Hydrogen-Strontium Plasma Light Source Due to Energy Resonance of Strontium with Hydrogen,” J. Plasma Physics, Vol. 69, (2003), pp. 131-158; R. L. Mills, “Highly Stable Novel Inorganic Hydrides,” J. New Materials for Electrochemical Systems, Vol. 6, (2003), pp. 45-54; R. L. Mills, P. Ray, “Substantial Changes in the Characteristics of a Microwave Plasma Due to Combining Argon and Hydrogen,” New Journal of Physics, www.njp.org, Vol. 4, (2002), pp. 22.1-22.17; R. M. Mayo, R. L. Mills, M. Nansteel, “Direct Plasmadynamic Conversion of Plasma Thermal Power to Electricity,” IEEE Transactions on Plasma Science, October, (2002), Vol. 30, No. 5, pp. 2066-2073; R. L. Mills, M. Nansteel, P. Ray, “Bright Hydrogen-Light Source due to a Resonant Energy Transfer with Strontium and Argon Ions,” New Journal of Physics, Vol. 4, (2002), pp. 70.1-70.28; R. M. Mayo, R. L. Mills, M. Nansteel, “On the Potential of Direct and MHD Conversion of Power from a Novel Plasma Source to Electricity for Microdistributed Power Applications,” IEEE Transactions on Plasma Science, August, (2002), Vol. 30, No. 4, pp. 1568-1578; R. M. Mayo, R. L. Mills, “Direct Plasmadynamic Conversion of Plasma Thermal Power to Electricity for Microdistributed Power Applications,” 40th Annual Power Sources Conference, Cherry Hill, N.J., Jun. 10-13, (2002), pp. 1-4; R. L. Mills, E. Dayalan, P. Ray, B. Dhandapani, J. He, “Highly Stable Novel Inorganic Hydrides from Aqueous Electrolysis and Plasma Electrolysis,” Electrochimica Acta, Vol. 47, No. 24, (2002), pp. 3909-3926; R. L. Mills, P. Ray, B. Dhandapani, R. M. Mayo, J. He, “Comparison of Excessive Balmer α Line Broadening of Glow Discharge and Microwave Hydrogen Plasmas with Certain Catalysts,” J. of Applied Physics, Vol. 92, No. 12, (2002), pp. 7008-7022; R. L. Mills, P. Ray, B. Dhandapani, M. Nansteel, X. Chen, J. He, “New Power Source from Fractional Quantum Energy Levels of Atomic Hydrogen that Surpasses Internal Combustion,” J. Mol. Struct., Vol. 643, No. 1-3, (2002), pp. 43-54; R. L. Mills, J. Dong, W. Good, P. Ray, J. He, B. Dhandapani, “Measurement of Energy Balances of Noble Gas-Hydrogen Discharge Plasmas Using Calvet calorimetry,” Int. J. Hydrogen Energy, Vol. 27, No. 9, (2002), pp. 967-978; R. L. Mills, P. Ray, “Spectroscopic Identification of a Novel Catalytic Reaction of Rubidium Ion with Atomic Hydrogen and the Hydride Ion Product,” Int. J. Hydrogen Energy, Vol. 27, No. 9, (2002), pp. 927-935; R. L. Mills, A. Voigt, P. Ray, M. Nansteel, B. Dhandapani, “Measurement of Hydrogen Balmer Line Broadening and Thermal Power Balances of Noble Gas-Hydrogen Discharge Plasmas,” Int. J. Hydrogen Energy, Vol. 27, No. 6, (2002), pp. 671-685; R. L. Mills, N. Greenig, S. Hicks, “Optically Measured Power Balances of Glow Discharges of Mixtures of Argon, Hydrogen, and Potassium, Rubidium, Cesium, or Strontium Vapor,” Int. J. Hydrogen Energy, Vol. 27, No. 6, (2002), pp. 651-670; R. L. Mills, “The Grand Unified Theory of Classical Quantum Mechanics,” Int. J. Hydrogen Energy, Vol. 27, No. 5, (2002), pp. 565-590; R. L. Mills, P. Ray, “Vibrational Spectral Emission of Fractional-Principal-Quantum-Energy-Level Hydrogen Molecular Ion,” Int. J. Hydrogen Energy, Vol. 27, No. 5, (2002), pp. 533-564; R. L. Mills and M. Nansteel, P. Ray, “Argon-Hydrogen-Strontium Discharge Light Source,” IEEE Transactions on Plasma Science, Vol. 30, No. 2, (2002), pp. 639-653; R. L. Mills, P. Ray, “Spectral Emission of Fractional Quantum Energy Levels of Atomic Hydrogen from a Helium-Hydrogen Plasma and the Implications for Dark Matter,” Int. J. Hydrogen Energy, (2002), Vol. 27, No. 3, pp. 301-322; R. L. Mills, P. Ray, “Spectroscopic Identification of a Novel Catalytic Reaction of Potassium and Atomic Hydrogen and the Hydride Ion Product,” Int. J. Hydrogen Energy, Vol. 27, No. 2, (2002), pp. 183-192; R. L. Mills, E. Dayalan, “Novel Alkali and Alkaline Earth Hydrides for High Voltage and High Energy Density Batteries,” Proceedings of the 17th Annual Battery Conference on Applications and Advances, California State University, Long Beach, Calif., (Jan. 15-18, 2002), pp. 1-6; R. L. Mills, W. Good, A. Voigt, Jinquan Dong, “Minimum Heat of Formation of Potassium Iodo Hydride,” Int. J. Hydrogen Energy, Vol. 26, No. 11, (2001), pp. 1199-1208; R. L. Mills, “The Nature of Free Electrons in Superfluid Helium—a Test of Quantum Mechanics and a Basis to Review its Foundations and Make a Comparison to Classical Theory,” Int. J. Hydrogen Energy, Vol. 26, No. 10, (2001), pp. 1059-1096; R. L. Mills, “Spectroscopic Identification of a Novel Catalytic Reaction of Atomic Hydrogen and the Hydride Ion Product,” Int. J. Hydrogen Energy, Vol. 26, No. 10, (2001), pp. 1041-1058; R. L. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979; R. L. Mills, T. Onuma, and Y. Lu, “Formation of a Hydrogen Plasma from an Incandescently Heated Hydrogen-Catalyst Gas Mixture with an Anomalous Afterglow Duration,” Int. J. Hydrogen Energy, Vol. 26, No. 7, July, (2001), pp. 749-762; R. L. Mills, “Observation of Extreme Ultraviolet Emission from Hydrogen-KI Plasmas Produced by a Hollow Cathode Discharge,” Int. J. Hydrogen Energy, Vol. 26, No. 6, (2001), pp. 579-592; R. L. Mills, B. Dhandapani, M. Nansteel, J. He, T. Shannon, A. Echezuria, “Synthesis and Characterization of Novel Hydride Compounds,” Int. J. of Hydrogen Energy, Vol. 26, No. 4, (2001), pp. 339-367; R. L. Mills, “Temporal Behavior of Light-Emission in the Visible Spectral Range from a Ti-K2CO3-H-Cell,” Int. J. Hydrogen Energy, Vol. 26, No. 4, (2001), pp. 327-332; R. L. Mills, M. Nansteel, and Y. Lu, “Observation of Extreme Ultraviolet Hydrogen Emission from Incandescently Heated Hydrogen Gas with Strontium that Produced an Anomalous Optically Measured Power Balance,” Int. J. Hydrogen Energy, Vol. 26, No. 4, (2001), pp. 309-326; R. L. Mills, “BlackLight Power Technology—A New Clean Hydrogen Energy Source with the Potential for Direct Conversion to Electricity,” Proceedings of the National Hydrogen Association, 12th Annual U.S. Hydrogen Meeting and Exposition, Hydrogen: The Common Thread, The Washington Hilton and Towers, Washington D.C., (Mar. 6-8, 2001), pp. 671-697; R. L. Mills, “The Grand Unified Theory of Classical Quantum Mechanics,” Global Foundation, Inc. Orbis Scientiae entitled The Role of Attractive and Repulsive Gravitational Forces in Cosmic Acceleration of Particles The Origin of the Cosmic Gamma Ray Bursts, (29th Conference on High Energy Physics and Cosmology Since 1964) Dr. Behram N. Kursunoglu, Chairman, Dec. 14-17, 2000, Lago Mar Resort, Fort Lauderdale, Fla., Kluwer Academic/Plenum Publishers, New York, pp. 243-258; R. L. Mills, B. Dhandapani, N. Greenig, J. He, “Synthesis and Characterization of Potassium Iodo Hydride,” Int. J. of Hydrogen Energy, Vol. 25, Issue 12, December, (2000), pp. 1185-1203; R. L. Mills, “The Hydrogen Atom Revisited,” Int. J. of Hydrogen Energy, Vol. 25, Issue 12, December, (2000), pp. 1171-1183; R. L. Mills, “BlackLight Power Technology—A New Clean Energy Source with the Potential for Direct Conversion to Electricity,” Global Foundation International Conference on “Global Warming and Energy Policy,” Dr. Behram N. Kursunoglu, Chairman, Fort Lauderdale, Fla., Nov. 26-28, 2000, Kluwer Academic/Plenum Publishers, New York, pp. 187-202; R. L. Mills, J. Dong, Y. Lu, “Observation of Extreme Ultraviolet Hydrogen Emission from Incandescently Heated Hydrogen Gas with Certain Catalysts,” Int. J. Hydrogen Energy, Vol. 25, (2000), pp. 919-943; R. L. Mills, “Novel Inorganic Hydride,” Int. J. of Hydrogen Energy, Vol. 25, (2000), pp. 669-683; R. L. Mills, “Novel Hydrogen Compounds from a Potassium Carbonate Electrolytic Cell,” Fusion Technol., Vol. 37, No. 2, March, (2000), pp. 157-182; R. L. Mills, W. Good, “Fractional Quantum Energy Levels of Hydrogen,” Fusion Technology, Vol. 28, No. 4, November, (1995), pp. 1697-1719; R. L. Mills, W. Good, R. Shaubach, “Dihydrino Molecule Identification,” Fusion Technol., Vol. 25, (1994), 103; R. L. Mills and S. Kneizys, Fusion Technol. Vol. 20, (1991), 65; and in prior published PCT application Nos. WO90/13126; WO92/10838; WO94/29873; WO96/42085; WO99/05735; WO99/26078; WO99/34322; WO99/35698; WO00/07931; WO00/07932; WO01/095944; WO01/18948; WO01/21300; WO01/22472; WO01/70627; WO02/087291; WO02/088020; WO02/16956; WO03/093173; WO03/066516; WO04/092058; WO05/041368; WO05/067678; WO2005/116630; WO2007/051078; and WO2007/053486; and prior U.S. Pat. Nos. 6,024,935 and 7,188,033, the entire disclosures of which are all incorporated herein by reference (hereinafter “Mills Prior Publications”).

The binding energy of an atom, ion, or molecule, also known as the ionization energy, is the energy required to remove one electron from the atom, ion or molecule. A hydrogen atom having the binding energy given in Eq. (1) is hereafter referred to as a hydrino atom or hydrino. The designation for a hydrino of radius a_{H}/p, where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.2 eV (2)

where m is an integer. This catalyst has also been referred to as an energy hole or source of energy hole in Mills earlier filed patent applications. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

This catalysis releases energy from the hydrogen atom with a commensurate decrease in size of the hydrogen atom, rₙ=na_{H}. For example, the catalysis of H(n=1) to H(n=1/2) releases 40.8 eV, and the hydrogen radius decreases from a_{H} to 1/2a_{H}. A catalytic system is provided by the ionization oft electrons from an atom each to a continuum energy level such that the sum of the ionization energies of the t electrons is approximately m·27.2 eV where in is an integer.

One such catalytic system involves lithium metal. The first and second ionization energies of lithium are 5.39172 eV and 75.64018 eV, respectively [1]. The double ionization (t=2) reaction of Li to Li²⁺, then, has a net enthalpy of reaction of 81.0319 eV, which is equivalent to m=3 in Eq. (2).

$$\begin{matrix}81.0319 eV + Li ( m ) + H [ \frac{{a}_{H}}{p} ] -> {Li}^{2 +} + 2 {e}^{-} + H [ \frac{{a}_{H}}{( p + 3 )} ] + [ {( p + 3 )}^{2} - {p}^{2} ] \cdot 13.6 eV & ( 3 ) \\ {Li}^{2 +} + 2 {e}^{-} -> Li ( m ) + 81.0319 eV & ( 4 )\end{matrix}$$

And, the overall reaction is

$$H [ \frac{{a}_{H}}{p} ] -> H [ \frac{{a}_{H}}{( p + 3 )} ] + [ {( p + 3 )}^{2} - {p}^{2} ] \cdot 13.6 eV \qquad ( 5 )$$

In another embodiment, the catalytic system involves cesium. The first and second ionization energies of cesium are 3.89390 eV and 23.15745 eV, respectively. The double ionization (t=2) reaction of Cs to Cs²⁺, then, has a net enthalpy of reaction of 27.05135 eV, which is equivalent to m=1 in Eq. (2).

$$\begin{matrix}27.05135 eV + Cs ( m ) + H [ \frac{{a}_{H}}{p} ] -> {Cs}^{2 +} + 2 {e}^{-} + H [ \frac{{a}_{H}}{( p + 1 )} ] + [ {( p + 1 )}^{2} - {p}^{2} ] \cdot 13.6 eV & ( 6 ) \\ {Cs}^{2 +} + 2 {e}^{-} -> Cs ( m ) + 27.05135 eV & ( 7 )\end{matrix}$$

And the overall reaction is

$$H [ \frac{{a}_{H}}{p} ] -> H [ \frac{{a}_{H}}{( p + 1 )} ] + [ {( p + 1 )}^{2} - {p}^{2} ] \cdot 13.6 eV \qquad ( 8 )$$

An additional catalytic system involves potassium metal. The first, second, and third ionization energies of potassium are 4.34066 eV, 31.63 eV, 45.806 eV, respectively [1]. The triple ionization (t=3) reaction of K to K³⁺, then, has a net enthalpy of reaction of 81.7767 eV, which is equivalent to m=3 in Eq. (2).

$$\begin{matrix}81.7767 eV + K ( m ) + H [ \frac{{a}_{H}}{p} ] -> {K}^{3 +} + 3 {e}^{-} + H [ \frac{{a}_{H}}{( p + 3 )} ] + [ {( p + 3 )}^{2} - {p}^{2} ] \cdot 13.6 eV & ( 9 ) \\ {K}^{3 +} + 3 {e}^{-} -> K ( m ) + 81.7426 eV & ( 10 )\end{matrix}$$

And, the overall reaction is

$$H [ \frac{{a}_{H}}{p} ] -> H [ \frac{{a}_{H}}{( p + 3 )} ] + [ {( p + 3 )}^{2} - {p}^{2} ] \cdot 13.6 eV \qquad ( 11 )$$

As a power source, the energy given off during catalysis is much greater than the energy lost to the catalyst. The energy released is large as compared to conventional chemical reactions. For example, when hydrogen and oxygen gases undergo combustion to form water

H₂(g)+1/2O₂(g)→H₂O(l) (12)

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} \to \frac{1}{3} , \frac{1}{3} \to \frac{1}{4} , \frac{1}{4} \to \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

### Further Catalysis Products of the Present Invention

The hydrino hydride ion of the present invention can be formed by the reaction of an electron source with a hydrino, that is, a hydrogen atom having a binding energy of about

$$\frac{13.6 eV}{{n}^{2}} ,$$

where

$$n = \frac{1}{p}$$

and p is an integer greater than 1. The hydrino hydride ion is represented by H⁻(n=1/p) or H⁻(1/p):

$$\begin{matrix}H [ \frac{{a}_{H}}{p} ] + {e}^{-} -> {H}^{-} ( n = 1 / p ) & ( 13 ) \\ H [ \frac{{a}_{H}}{p} ] + {e}^{-} -> {H}^{-} ( 1 / p ) & ( 14 )\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eq. (15).

The binding energy of a novel hydrino hydride ion can be represented by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 15 )$$

where p is an integer greater than one, s=1/2, π is pi, ℏ is Planck's constant bar, μₒ is the permeability of vacuum, mₑ, is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, a_{H} is the radius of the hydrogen atom, aₒ is the Bohr radius, and e is the elementary charge. The radii are given by

r₂=r₁=a₀(1+\sqrt{s(s+1)}); s=1/2 (16)

The binding energies of the hydrino hydride ion, H⁻(n=1/p) as a function of p, where p is an integer, are shown in TABLE 1.

TABLE 1
The representative binding energy of the hydrino hydride ion
H⁻ (n = 1/p) as a function of p, Eq. (15).

| | r₁ | Binding | Wavelength |
|---|---|---|---|
| Hydride Ion | (a₀)^{a} | Energy (eV)^{b} | (nm) |
| H⁻ (n = 1) | 1.8660 | 0.7542 | 1644 |
| H⁻ (n = ½) | 0.9330 | 3.047 | 406.9 |
| H⁻ (n = ⅓) | 0.6220 | 6.610 | 187.6 |
| H⁻ (n = ¼) | 0.4665 | 11.23 | 110.4 |
| H⁻ (n = ⅕) | 0.3732 | 16.70 | 74.23 |
| H⁻ (n = ⅙) | 0.3110 | 22.81 | 54.35 |
| H⁻ (n = 1/7) | 0.2666 | 29.34 | 42.25 |
| H⁻ (n = ⅛) | 0.2333 | 36.09 | 34.46 |
| H⁻ (n = 1/9) | 0.2073 | 42.84 | 28.94 |
| H⁻ (n = 1/10) | 0.1866 | 49.38 | 25.11 |
| H⁻ (n = 1/11) | 0.1696 | 55.50 | 22.34 |
| H⁻ (n = 1/12) | 0.1555 | 60.98 | 20.33 |
| H⁻ (n = 1/13) | 0.1435 | 65.63 | 18.89 |
| H⁻ (n = 1/14) | 0.1333 | 69.22 | 17.91 |
| H⁻ (n = 1/15) | 0.1244 | 71.55 | 17.33 |
| H⁻ (n = 1/16) | 0.1166 | 72.40 | 17.12 |
| H⁻ (n = 1/17) | 0.1098 | 71.56 | 17.33 |
| H⁻ (n = 1/18) | 0.1037 | 68.83 | 18.01 |
| H⁻ (n = 1/19) | 0.0982 | 63.98 | 19.38 |
| H⁻ (n = 1/20) | 0.0933 | 56.81 | 21.82 |
| H⁻ (n = 1/21) | 0.0889 | 47.11 | 26.32 |
| H⁻ (n = 1/22) | 0.0848 | 34.66 | 35.76 |
| H⁻ (n = 1/23) | 0.0811 | 19.26 | 64.36 |
| H⁻ (n = 1/24) | 0.0778 | 0.6945 | 1785 |

^{a}Eq. (16)
^{b}Eq. (15)

According to the present invention, a hydrino hydride ion (H⁻) having a binding energy according to Eqs. (15-16) that is greater than the binding of ordinary hydride ion (about 0.8 eV) for p=2 up to 23, and less for p=24 (H⁻) is provided. For p=2 to p=24 of Eqs. (15-16), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Compositions comprising the novel hydride ion are also provided.

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eqs. (15-16).

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further embodiment of the invention, a compound is provided comprising at least one increased binding energy hydrogen species such as (a) a hydrogen atom having a binding energy of about

$$\frac{13.6 eV}{{( \frac{1}{p} )}^{2}} ,$$

preferably within ±10%, more preferably ±5%, where p is an integer, preferably an integer from 2 to 137; (b) a hydride ion (H⁻) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

preferably within ±10%, more preferably +5%, where p is an integer, preferably an integer from 2 to 24; (c) H₄⁺(1/p); (d) a trihydrino molecular ion, H₃⁺(1/p), having a binding energy of about

$$\frac{22.6}{{( \frac{1}{p} )}^{2}} eV$$

preferably within ±10%, more preferably ±5%, where p is an integer, preferably an integer from 2 to 137; (e) a dihydrino having a binding energy of about

$$\frac{15.3}{{( \frac{1}{p} )}^{2}} eV$$

preferably within ±10%©, more preferably ±5%, where p is an integer, preferably and integer from 2 to 137; (f) a dihydrino molecular ion with a binding energy of about

$$\frac{16.3}{{( \frac{1}{p} )}^{2}} e V$$

preferably within ±10%, more preferably ±5%, where p is an integer, preferably an integer from 2 to 137.

According to a further preferred embodiment of the invention, a compound is provided comprising at least one increased binding energy hydrogen species such as (a) a dihydrino molecular ion having a total energy of

$${E}_{T} = - {p}^{2} \{ \frac{{e}^{2}}{8 {πɛ}_{o} {a}_{H}} ( 4 ln 3 - 1 - 2 ln 3 ) [ 1 + p \sqrt{\frac{2 ℏ \sqrt{\frac{2 {e}^{2}}{\frac{4 {{πɛ}_{o} ( 2 {a}_{H} )}^{3}}{{m}_{e}}}}}{{m}_{e} {c}^{2}}} ] - \frac{1}{2} ℏ \sqrt{\frac{k}{μ}} \} = - {p}^{2} 16.13392 e V - {p}^{3} 0.118755 e V \qquad ( 17 )$$

preferably within ±10%, more preferably ±5%, where p is an integer, ℏ is Planck's constant bar, mₑ is the mass of the electron, c is the speed of light in vacuum, μ is the reduced nuclear mass, and k is the harmonic force constant solved previously [2] and (b) a dihydrino molecule having a total energy of

$${E}_{T} = - {p}^{2} \{ \frac{{e}^{2}}{8 {πɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{2 {e}^{2}}{\frac{4 {{πɛ}_{o} ( 2 {a}_{H} )}^{3}}{{m}_{e}}}}}{{m}_{e} {c}^{2}}} ] - \frac{1}{2} ℏ \sqrt{\frac{k}{μ}} \} = - {p}^{2} 31.351 e V - {p}^{3} 0.326469 e V \qquad ( 18 )$$

preferably within ±10%, more preferably ±5%, where p is an integer and aₒ is the Bohr radius.

According to one embodiment of the invention wherein the compound comprises a negatively charged increased binding energy hydrogen species, the compound further comprises one or more cations, such as a proton, ordinary H₂⁺, or ordinary H₃⁺.

A method is provided for preparing compounds comprising at least one increased binding energy hydride ion. Such compounds are hereinafter referred to as “hydrino hydride compounds”. The method comprises reacting atomic hydrogen with a catalyst having a net enthalpy of reaction of about

$$\frac{m}{2} \cdot 27 e V ,$$

where m is an integer greater than 1, preferably an integer less than 400, to produce an increased binding energy hydrogen atom having a binding energy of about

$$\frac{13.6 e V}{{( \frac{1}{p} )}^{2}}$$

where p is an integer, preferably an integer from 2 to 137. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

Novel hydrogen species and compositions of matter comprising new forms of hydrogen formed by the catalysis of atomic hydrogen are disclosed in “Mills Prior Publications”. The novel hydrogen compositions of matter comprise:

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present invention has a total energy greater than the total energy of the corresponding ordinary hydrogen species. The hydrogen species having an increased total energy according to the present invention is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eqs. (15-16) for p=24 has a first binding energy that is less than the first binding energy of ordinary hydride ion, while the total energy of the hydride ion of Eqs. (15-16) for p=24 is much greater than the total energy of the corresponding ordinary hydride ion.

Also provided are novel compounds and molecular ions comprising

(a) a plurality of neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the invention are hereinafter referred to as “increased binding energy hydrogen compounds”.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the invention are hereinafter referred to as “increased binding energy hydrogen compounds”.

In an embodiment, a compound is provided, comprising at least one increased binding energy hydrogen species selected from the group consisting of (a) hydride ion having a binding energy according to Eqs. (15-16) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV “increased binding energy molecular hydrogen ion” or “dihydrino molecular ion”).

### Characteristics and Identification of Increased Binding Energy Species

A new chemically generated or assisted plasma source based on a resonant energy transfer mechanism (rt-plasma) between atomic hydrogen and certain catalysts has been developed that may be a new power source. The products are more stable hydride and molecular hydrogen species such as H⁻(1/4) and H₂(1/4). One such source operates by incandescently heating a hydrogen dissociator and a catalyst to provide atomic hydrogen and gaseous catalyst, respectively, such that the catalyst reacts with the atomic hydrogen to produce a plasma. It was extraordinary that intense extreme ultraviolet (EUV) emission was observed by Mills et al. [3-10] at low temperatures (e.g. ≈10³ K) and an extraordinary low field strength of about 1-2 V/cm from atomic hydrogen and certain atomized elements or certain gaseous ions which singly or multiply ionize at integer multiples of the potential energy of atomic hydrogen, 27.2 eV. A number of independent experimental observations confirm that the rt-plasma is due to a novel reaction of atomic hydrogen which produces as chemical intermediates, hydrogen in fractional quantum states that are at lower energies than the traditional “ground” (n=1) state. Power is released [3, 9, 11-13], and the final reaction products are novel hydride compounds [3, 14-16] or lower-energy molecular hydrogen [17]. The supporting data include EUV spectroscopy [3-10, 13, 17-22, 25, 27-28], characteristic emission from catalysts and the hydride ion products [3, 5, 7, 21-22, 27-28], lower-energy hydrogen emission [12-13, 18-20], chemically formed plasmas [3-10, 21-22, 27-28], extraordinary (>100 eV) Balmer α line broadening [3-5, 7, 9-10, 12, 18-19, 21, 23-28], population inversion of H lines [3, 21, 27-29], elevated electron temperature [19, 23-25], anomalous plasma afterglow duration [3, 8], power generation [3, 9, 11-13], and analysis of novel chemical compounds [3, 14-16].

The theory given previously [6, 18-20, 30] is based on Maxwell's equations to solving the structure of the electron. The familiar Rydberg equation (Eq. (19)) arises for the hydrogen excited states for n>1 of Eq. (20).

$$\begin{matrix}{E}_{n} = - \frac{{e}^{2}}{{n}^{2} 8 {πɛ}_{o} {a}_{0}} = - \frac{13.598 e V}{{n}^{2}} & ( 19 ) \\ n = 1 , 2 , 3 , … & ( 20 )\end{matrix}$$

An additional result is that atomic hydrogen may undergo a catalytic reaction with certain atoms, excimers, and ions which provide a reaction with a net enthalpy of an integer multiple of the potential energy of atomic hydrogen, m·27.2 eV wherein m is an integer. The reaction involves a nonradiative energy transfer to form a hydrogen atom called a hydrino atom that is lower in energy than unreacted atomic hydrogen that corresponds to a fractional principal quantum number. That is

$$n = \frac{1}{2} , \frac{1}{3} , \frac{1}{4} , … , \frac{1}{p} ; p is an integer \qquad ( 21 )$$

replaces the well known parameter n=integer in the Rydberg equation for hydrogen excited states. The n=1 state of hydrogen and the

$$n = \frac{1}{integer}$$

states of hydrogen are nonradiative, but a transition between two nonradiative states, say n=1 to n=1/2, is possible via a nonradiative energy transfer. Thus, a catalyst provides a net positive enthalpy of reaction of m·27.2 eV (i.e. it resonantly accepts the nonradiative energy transfer from hydrogen atoms and releases the energy to the surroundings to affect electronic transitions to fractional quantum energy levels). As a consequence of the nonradiative energy transfer, the hydrogen atom becomes unstable and emits further energy until it achieves a lower-energy nonradiative state having a principal energy level given by Eqs. (19) and (21). Processes such as hydrogen molecular bond formation that occur without photons and that require collisions are common [31]. Also, some commercial phosphors are based on resonant nonradiative energy transfer involving multipole coupling [32].

Two H(1/p) may react to form H₂(1/p). The hydrogen molecular ion and molecular charge and current density functions, bond distances, and energies were exactly solved previously with remarkable accuracy [30, 33]. Using the Laplacian in ellipsoidal coordinates with the constraint of nonradiation, the total energy of the hydrogen molecule having a central field of +pe at each focus of the prolate spheroid molecular orbital is

$${E}_{T} = - {p}^{2} \{ \frac{{e}^{2}}{8 {πɛ}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{2 {e}^{2}}{\frac{4 {πɛ}_{o} {{a}_{0}}^{3}}{{m}_{e}}}}}{{m}_{e} {c}^{2}}} ] - \frac{1}{2} ℏ \sqrt{\frac{k}{μ}} \} = - {p}^{2} 31.351 e V - {p}^{3} 0.326469 e V \qquad ( 22 )$$

where p is an integer, ℏ is Planck's constant bar, mₑ is the mass of the electron, c is the speed of light in vacuum, μ is the reduced nuclear mass, k is the harmonic force constant solved previously in a closed-form equation with fundamental constants only [30, 33] and aₒ is the Bohr radius. The vibrational and rotational energies of fractional-Rydberg-state molecular hydrogen H₂(1/p) are p² those of H₂. Thus, the vibrational energies, E_{vib}, for the υ=0 to υ=1 transition of hydrogen-type molecules H₂(1/p) are [30, 33]

E_{vib}=p²0.515902 eV (23)

where the experimental vibrational energy for the υ=0 to υ=1 transition of H₂, E_{H}_{₂}_{(υ=0→υ=1)}, is given by Beutler [34] and Herzberg [35]. The rotational energies, Eᵣₒₜ, for the J to J+1 transition of hydrogen-type molecules H₂(1/p) are [30, 33]

$${E}_{rot} = {E}_{J + 1} - {E}_{J} = \frac{{ℏ}^{2}}{I} [ J + 1 ] = {p}^{2} ( J + 1 ) 0.01509 e V \qquad ( 24 )$$

where I is the moment of inertia, and the experimental rotational energy for the J=0 to J=1 transition of H₂ is given by Atkins [36]. The p² dependence of the rotational energies results from an inverse p dependence of the internuclear distance and the corresponding impact on I. The predicted internuclear distance 2c′ for H₂(1/p) is

$$2 {c}^{′} = \frac{{a}_{o} \sqrt{2}}{p} \qquad ( 25 )$$

The rotational energies provide a very precise measure of I and the internuclear distance using well established theory [37].

Ar⁺ may serve as a catalyst since its ionization energy is about 27.2 eV. The catalyst reaction of Ar⁺ to Ar²⁺ forms H(1/2) which may further serve as both a catalyst and a reactant to form H(1/4) [19-20, 30]. Thus, the observation of H(1/4) is predicted to be flow dependent since the formation of H₂(1/4) requires the buildup of intermediates. The mechanism was tested by experiments with flowing plasma gases. Neutral molecular emission was anticipated for high pressure argon-hydrogen plasmas excited by a 12.5 keV electron beam. Rotational lines for H₂(1/4) were anticipated and sought in the 150-250 nm region. The spectral lines were compared to those predicted by Eqs. (23-24) corresponding to the internuclear distance of 1/4 that of H₂ given by Eq. (25). For p=4 in Eqs. (23-24), the predicted energies for the υ=1→υ=0 vibration-rotational series of H₂(1/4) are

$$\begin{matrix}{E}_{vib - rot} = {p}^{2} {E}_{{vibH}_{2} ( v = 0 \to v = 1 )} \pm {p}^{2} ( J + 1 ) {E}_{{rotH}_{2}} \\ = 8.254432 e V \pm ( J + 1 ) 0.24144 e V ,\end{matrix} \\ J = 0 , 1 , 2 , 3 … \qquad ( 26 )$$

He⁺ also fulfills the catalyst criterion—a chemical or physical process with an enthalpy change equal to an integer multiple of 27.2 eV since it ionizes at 54.417 eV which is 2·27.2 eV. The product of the catalysis reaction of He⁺, H(1/3), may further serve as a catalyst to form H(1/4) and H(1/2) [19-20, 30] which can lead to transitions to other states H(1/p). Novel emission lines with energies of q·13.6 eV where q=1.2, 3, 4, 6, 7, 8, 9, or 11 were previously observed by extreme ultraviolet (EUV) spectroscopy recorded on microwave discharges of helium with 2% hydrogen [18-20]. These lines matched H(1/p), fractional Rydberg states of atomic hydrogen given by Eqs. (19) and (21).

Rotational lines were observed in the 145-300 nm region from atmospheric pressure electron-beam excited argon-hydrogen plasmas. The unprecedented energy spacing of 4² times that of hydrogen established the internuclear distance as 1/4 that of H₂ and identified H₂(1/4) (Eqs. (23-26)). H₂(1/p) gas was isolated by liquefaction of helium-hydrogen plasma gas using an high-vacuum (10⁻⁶ Torr) capable, liquid nitrogen cryotrap and was characterized by mass spectroscopy (MS). The condensable gas had a higher ionization energy than H₂ by MS [17]. H₂(1/4) gas from chemical decomposition of hydrides containing the corresponding hydride ion H⁻(1/4) as well from liquefaction of the catalysis-plasma gas was also identified by ¹H NMR as an upfield-shifted singlet peak at 2.18 ppm relative to H₂ at 4.63 that matched theoretical predictions [13, 17]. H₂(1/4) was further characterized by studies on the vibration-rotational emission from electron-beam maintained argon-hydrogen plasmas and from Fourier-transform infrared (FTIR) spectroscopy of solid samples containing H⁻(1/4) with interstitial H₂(1/4).

Water bath calorimetry was used to determine that measurable power was developed in rt-plasmas due to the reaction to form states given by Eqs. (19) and (21). Specifically, He/H₂(10%) (500 mTorr), Ar/H₂(10%) (500 mTorr), and H₂O(g) (500 and 200 mTorr) plasmas generated with an Evenson microwave cavity consistently yielded on the order of 50% more heat than non rt-plasma (controls) such as He, Kr, Kr/H₂(10%), under identical conditions of gas flow, pressure, and microwave operating conditions. The excess power density of rt-plasmas was of the order 10 W·cm⁻³. In addition to unique vacuum ultraviolet (VUV) lines, earlier studies with these same rt-plasmas demonstrated that other unusual features were present including dramatic broadening of the hydrogen Balmer series lines [3-5, 7, 9-10, 12, 18-19, 21, 23-28], and in the case of water plasmas, population inversion of the hydrogen excited states [3, 21, 27-29]. Both the current results and the earlier results are completely consistent with the existence of a hitherto unknown predicted exothermic chemical reaction occurring in rt-plasmas.

Since the ionization energy of Sr⁺ to Sr³⁺ has a net enthalpy of reaction of 2·27.2 eV, Sr⁺ may serve as catalyst alone or with Ar⁺ catalyst. It was reported previously that an rt-plasma formed with a low field (1V/cm), at low temperatures (e.g. −10³ K), from atomic hydrogen generated at a tungsten filament and strontium which was vaporized by heating the metal [4-5, 7, 9-10]. Strong VUV emission was observed that increased with the addition of argon, but not when sodium, magnesium, or barium replaced strontium or with hydrogen, argon, or strontium alone. Characteristic emission was observed from a continuum state of Ar²⁺ at 45.6 nm without the typical Rydberg series of Ar I and Ar II lines which confirmed the resonant nonradiative energy transfer of 27.2 eV from atomic hydrogen to Ar⁺[5, 7, 22]. Predicted Sr³⁺ emission lines were also observed from strontium-hydrogen plasmas [5, 7] that supported the rt-plasma mechanism. Time-dependent line broadening of the H Balmer α line was observed corresponding to extraordinarily fast H(25 eV). An excess power of 20 mW·cm⁻³ was measured calorimetrically on rt-plasmas formed when Ar⁺ was added to Sr⁺ as an additional catalyst.

Significant Balmer α line broadening corresponding to an average hydrogen atom temperature of 14, 24 eV, and 23-45 eV was observed for strontium and argon-strontium rt-plasmas and discharges of strontium-hydrogen, helium-hydrogen, argon-hydrogen, strontium-helium-hydrogen, and strontium-argon-hydrogen, respectively, compared to ≈3 eV for pure hydrogen, xenon-hydrogen, and magnesium-hydrogen. To achieve that same optically measured light output power, hydrogen-sodium, hydrogen-magnesium, and hydrogen-barium mixtures required 4000, 7000, and 6500 times the power of the hydrogen-strontium mixture, respectively, and the addition of argon increased these ratios by a factor of about two. A glow discharge plasma formed for hydrogen-strontium mixtures at an extremely low voltage of about 2 V compared to 250 V for hydrogen alone and sodium-hydrogen mixtures, and 140-150 V for hydrogen-magnesium and hydrogen-barium mixtures [4-5, 7]. These voltages are too low to be explicable by conventional mechanisms involving accelerated ions with a high applied field. A low-voltage EUV and visible light source is feasible [10].

In general, the energy transfer of m·27.2 eV from the hydrogen atom to the catalyst causes the central-field interaction of the H atom to increase by m and its electron to drop m levels lower from the radius of the hydrogen atom, a_{H}, to a radius of

$$\frac{{a}_{H}}{1 + m} [ 19 - 20 ] .$$

Since K to K³⁺ provides a reaction with a net enthalpy equal to three times the potential energy of atomic hydrogen, 3·27.2 eV, it may serve as a catalyst such that each ordinary hydrogen atom undergoing catalysis releases a net of 204 eV [3]. K may then react with the product H(1/4) to form a yet lower-state H(1/7) or further catalytic transitions may occur:

$$\frac{1}{4} \to \frac{1}{5} , \frac{1}{5} \to \frac{1}{6} , \frac{1}{6} \to \frac{1}{7} ,$$

and so, involving only hydrinos in a process called disproportionation. Since the ionization energies and metastable resonant states of hydrinos due corresponding to the multipole expansion of the potential energy are m·27.2 eV (Eqs. (19) and (21)) as given previously [19-20, 30] once catalysis begins, hydrinos autocatalyze further transitions to lower states. This mechanism is similar to that of an inorganic ion catalysis. An energy transfer of m·27.2 eV from a first hydrino atom to the second hydrino atom causes the central field of the first atom to increase by m and its electron to drop M levels lower from a radius of

$$\frac{{a}_{H}}{p}$$

to a radius of

$$\frac{{a}_{H}}{p + m} .$$

The catalyst product, H(1/p), may also react with an electron to form a novel hydride ion H⁻(1/p) with a binding energy E_{B} [3, 14, 16, 21, 30]:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{a}_{0}^{3} [ \frac{1 + \sqrt{s ( s + 1 )}}{p} ]} ) \qquad ( 27 )$$

where p is an integer greater than one, s=1/2, ℏ is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, a_{H} is the radius of the hydrogen atom, aₒ is the Bohr radius, and e is the elementary charge. The ionic radius is

$${r}_{1} = \frac{{a}_{0}}{p} ( 1 + \sqrt{s ( s + 1 )} ) ; s = \frac{1}{2} .$$

From Eq. (27), the calculated ionization energy of the hydride ion is 0.75418 eV, and the experimental value given by Lykke [38] is 6082.99±0.15 cm⁻¹ (0.75418 eV).

Substantial evidence of an energetic catalytic reaction was previously reported [3] involving a resonant energy transfer between hydrogen atoms and K to form very stable novel hydride ions H⁻(1/p) called hydrino hydrides having a predicted fractional principal quantum number p=4. Characteristic emission was observed from K³⁺ that confirmed the resonant nonradiative energy transfer of 3·27.2 eV from atomic hydrogen to K. From Eq. (27), the binding energy E_{B} of H⁻(1/4) is

E_{B}=11.232 eV (λ_{vac}=1103.8Å) (28)

The product hydride ion H⁻(1/4) was observed spectroscopically at 110 nm corresponding to its predicted binding energy of 11.2 eV [3, 21].

Upfield-shifted NMR peaks are direct evidence of the existence of lower-energy state hydrogen with a reduced radius relative to ordinary hydride ion and having an increase in diamagnetic shielding of the proton. The total theoretical shift

$$\frac{Δ {B}_{T}}{B}$$

for H⁻(1/p) is given by the sum of the shift of H⁻(1/1) plus the contribution due to the lower-electronic energy state:

$$\begin{matrix}\frac{Δ {B}_{T}}{B} = - {μ}_{0} \frac{{e}^{2}}{12 {m}_{e} {a}_{0} ( 1 + \sqrt{s ( s + 1 )} )} ( 1 + α2π p ) \\ = - ( 29.9 + 1.37 p ) ppm\end{matrix} \qquad ( 29 )$$

where p=integer >1. Corresponding alkali hydrides and alkali hydrino hydrides (containing H⁻(1/p)) were characterized by ¹H MAS NMR and compared to the theoretical values. A match of the predicted and observed peaks with no alternative represents a definite test.

The ¹H MAS NMR spectrum of novel compound KH*Cl relative to external tetramethylsilane (TMS) showed a large distinct upfield resonance at −4.4 ppm corresponding to an absolute resonance shift of −35.9 ppm that matched the theoretical prediction of p=4 [3, 14-16]. This result confirmed the previous observations from the rt-plasmas of intense hydrogen Lyman emission, a stationary inverted Lyman population, excessive afterglow duration, highly energetic hydrogen atoms, characteristic alkali-ion emission due to catalysis, predicted novel spectral lines, and the measurement of a power beyond any conventional chemistry [3] that matched predictions for a catalytic reaction of atomic hydrogen to form more stable hydride ions designated H⁻(1/p). Since the comparison of theory and experimental shifts of KH*Cl is direct evidence of lower-energy hydrogen with an implicit large exotherm during its formation, the NMR results were repeated with the further analysis by infrared (FTIR) spectroscopy to eliminate any known explanation [39].

Elemental analysis identified [14, 16] these compounds as only containing the alkaline metal, halogen, and hydrogen, and no known hydride compound of this composition could be found in the literature which has an upfield-shifted hydride NMR peak. Ordinary alkali hydrides alone or mixed with alkali halides show down-field shifted peaks [3, 14-16]. From the literature, the list of alternatives to H⁻(1/p) as a possible source of the upfield NMR peaks was limited to U centered H. The intense and characteristic infrared vibration band at 503 cm⁻¹ due to the substitution of H⁻ for Cl⁻ in KCl enabled the elimination of U centered H as the source of the upfield-shifted NMR peaks [39].

As further characterizations, the X-ray photoelectron spectrum (XPS) of the hydrino hydride KH*I was performed to determine if the predicted H⁻(1/4) binding energy given by Eq. (28) was observed, and FTIR analysis of these crystals with H⁻(1/4) was performed before and after storage in argon for 90 days to search for interstitial H₂(1/4) having a predicted rotational energy given by Eq. (24). The identification of single rotational peaks at this energy with ortho-para splitting due to free rotation of a very small hydrogen molecule would represent definite proof of its existence since there is no other possible assignment [39].

Since the rotational emission of H₂(1/4) was observed in crystals of KH*I having a peak assigned to H⁻(1/4) and the vibration-rotational emission of H₂(1/4) was observed from 12.5 keV-electron-beam-maintained plasmas of argon with 1% hydrogen due to collisional excitation of H₂(1/4), H₂(1/4) trapped in the lattice of KH*Cl, or H₂(1/4) formed from H⁻(1/4) or formed insitu from K catalysis of H via electron bombardment was investigated by windowless EUV spectroscopy on electron-beam excitation of the crystals using the 12.5 keV electron gun at pressures below which any gas could produce detectable emission (<10⁻⁵ Torr) [39]. The rotational energy of H₂(1/4) was confirmed by this technique as well. Consistent results from the broad spectrum of investigational techniques provide definitive evidence that hydrogen can exist in lower-energy states then previously thought possible in the form of H⁻(1/4) and H₂(1/4). In an embodiment, the products of the Li catalyst reaction and NaH catalyst reaction are both H⁻(1/4) and H₂(1/4) and additionally H⁻(1/3) and H₂(1/3) for NaH. The present invention provides for their identification and the corresponding energetic exothermic reaction by EUV spectroscopy, characteristic emission from catalysts and the hydride ion products, lower-energy hydrogen emission, chemically formed plasmas, extraordinary Balmer α line broadening, population inversion of H lines, elevated electron temperature, anomalous plasma afterglow duration, power generation, and analysis of novel chemical compounds. Preferred identification techniques for the species H⁻(1/p) and H₂(1p) are NMR of H⁻(1/p) and H₂(1/p), FTIR of H₂(1/p) trapped in a crystal, XPS of H⁻(1/p), ToF-SIMs of H⁻(1/p), electron-beam excitation emission spectroscopy of H₂ (1/p), electron beam emission spectroscopy of H₂(1/p) trapped in a crystalline lattice, and TOF-SIMS identification of novel compounds comprising H⁻(1/p). Preferred characterization techniques for the energetic catalysis reaction and the power balance are line broadening, plasma formation, and calorimetry. Preferably, H⁻(1/p) and H₂ (1/p) are H⁻(1/4) and H₂ (1/4), respectively.

### BRIEF DESCRIPTION OF THE DRAWINGS

FIG. 1A is a schematic drawing of an energy reactor and power plant in accordance with the present invention.

FIG. 1B is a schematic drawing of an energy reactor and power plant for recycling or regenerating the fuel in accordance with the present invention.

FIG. 1C is a schematic drawing of a power reactor in accordance with the present invention.

FIG. 1D is a schematic drawing of a discharge power and plasma cell and reactor in accordance with the present invention.

FIG. 2A is the experimental set up comprising a filament gas cell to form lithium-argon-hydrogen and lithium-hydrogen rt-plasmas.

FIG. 2B is a schematic of the reaction cell and the cross sectional view of the water flow calorimeter used to measure the energy balance of the NaH catalyst reaction to form hydrinos. The components were: 1—inlet and outlet thermistors; 2—high-temperature valve; 3—ceramic fiber heater; 4—copper water-coolant coil; 5—reactor; 6—insulation; 7—cell thermocouple, and 8—water flow chamber.

FIG. 3 is a schematic of the water flow calorimeter used to measure the energy balance of the NaH catalyst reaction to form hydrinos.

FIG. 4 is a schematic of the stainless steel gas cell to synthesize LiH*Br, LiH*I, NaH*Cl and NaH*Br comprising the reaction mixture (i) R-Ni, Li, LiNH₂, and LiBr or LiI or (ii) Pt/Ti dissociator, Na, NaH, and NaCl or NaBr as the reactants. The components were: 101—stainless steel cell; 117—internal cavity of cell; 118—high vacuum conflat flange; 119—mating blank conflat flange; 102—stainless steel tube vacuum line and gas supply line; 103—lid to the kiln or top insulation, 104—surrounding heaters coverer by high temperature insulation; 108—Pt/Ti dissociator; 109—reactants; 110—high vacuum turbo pump; 112—pressure gauge; 111—vacuum pump valve; 113—valve; 114—valve; 115—regulator, and 116—hydrogen tank.

FIG. 5 shows the 656.3 nm Balmer α line width recorded with a high-resolution visible spectrometer on (A) the initial emission of a lithium-argon-hydrogen rt-plasma and (B) the emission at 70 hours of operation. Lithium lines and significant broadening of only the H lines was observed over time corresponding to an average hydrogen atom temperature of >40 eV and fractional population over 90%.

FIG. 6 shows the 656.3 nm Balmer α line width recorded with a high-resolution (±0.006 nm) visible spectrometer on (A) the initial emission of a lithium-hydrogen rt-plasma and (B) the emission at 70 hours of operation. Lithium lines and broadening of only the H lines was observed over time, but diminished relative to the case having the argon-hydrogen gas (95/5%). The Balmer width corresponded to an average hydrogen atom temperature of 6 eV and a 27% fractional population.

FIG. 7 shows the results of the DSC (100-750° C.) of NaH at a scan rate of 0.1 degree/minute. A broad endothermic peak was observed at 350° C. to 420° C. which corresponds to 47 kJ/mole and matches sodium hydride decomposition in this temperature range with a corresponding enthalpy of 57 kJ/mole. A large exotherm was observed under conditions that form NaH catalyst in the region 640° C. to 825° C. which corresponds to at least −354 kJ/mole H₂, greater than that of the most exothermic reaction possible for H, the −241.8 kJ/mole H₂ enthalpy of combustion of hydrogen.

FIG. 8 shows the results of the DSC (100-750° C.) of MgH₂ at a scan rate of 0.1 degree/minute. Two sharp endothermic peaks were observed. A first peak centered at 351.75° C. corresponding to 68.61 kJ/mole MgH₂ matches the 74.4 kJ mole MgH₂ decomposition energy. The second peak at 647.66° C. corresponding to 6.65 kJ/mole MgH₂ matches the known melting point of Mg(m) is 650° C. and enthalpy of fusion of 8.48 kJ/mole Mg(m). Thus, the expected behavior was observed for the decomposition of a control, noncatalyst hydride.

FIG. 9 shows the temperature versus time for the calibration run with an evacuated test cell and resistive heating only.

FIG. 10 shows the power versus time for the calibration run with an evacuated test cell and resistive heating only. The numerical integration of the input and output power curves yielded an output energy of 292.2 kJ and an input energy of 303.1 kJ corresponding to a coupling of flow of 96.4% of the resistive input to the output coolant.

FIG. 11 shows the cell temperature with time for the hydrino reaction with the cell containing the reagents comprising the catalyst material, 1 g Li, 0.5 g LiNH₂, 10 g LiBr, and 15 g Pd/Al₂O₃. The reaction liberated 19.1 kJ of energy in less than 120 s to develop a system-response-corrected peak power in excess of 160 W.

FIG. 12 shows the coolant power with time for the hydrino reaction with the cell containing the reagents comprising the catalyst material, 1 g Li, 0.5 g LiNH₂, 10 g LiBr, and 15 g Pd/Al₂O₃. The numerical integration of the input and output power curves with the calibration correction applied yielded an output energy of 227.2 kJ and an input energy of 208.1 kJ corresponding to an excess energy of 19.1 kJ.

FIG. 13 shows the cell temperature with time for the R-Ni control power test with the cell containing the reagents comprising the starting material for R-Ni, 15 g R-Ni/Al alloy powder, and 3.28 g of Na.

FIG. 14 shows the coolant power with time for the control power test with the cell containing the reagents comprising the starting material for R-Ni, 15 g R-Ni/Al alloy powder and 3.28 g of Na. Energy balance was obtained with the calibration-corrected numerical integration of the input and output power curves yielding an output energy of 384 kJ and an input energy of 385 kJ.

FIG. 15 shows the cell temperature with time for the hydrino reaction with the cell containing the reagents comprising the catalyst material, 15 g NaOH-doped R-Ni 2800, and 3.28 g of Na. The reaction liberated 36 kJ of energy in less than 90 s to develop a system-response-corrected peak power in excess of 0.5 kW.

FIG. 16 shows the coolant power with time for the hydrino reaction with the cell containing the reagents comprising the catalyst material, 15 g NaOH-doped R-Ni 2800, and 3.28 g of Na. The numerical integration of the input and output power curves with the calibration correction applied yielded an output energy of 185.1 kJ and an input energy of 149.1 kJ corresponding to an excess energy of 36 kJ.

FIG. 17 shows the cell temperature with time for the hydrino reaction with the cell containing the reagents comprising the catalyst material, 15 g NaOH-doped R-Ni 2400. The cell temperature jumped from 60° C. to 205° C. in 60 s wherein the reaction liberated 11.7 kJ of energy in less time to develop a system-response-corrected peak power in excess of 0.25 kW.

FIG. 18 shows the coolant power with time for the hydrino reaction with the cell containing the reagents comprising the catalyst material, 15 g NaOH-doped R-Ni 2400. The numerical integration of the input and output power curves with the calibration correction applied yielded an output energy of 195.7 kJ and an input energy of 184.0 kJ corresponding to an excess energy of 11.7 kJ.

FIG. 19 shows the positive ToF-SIMS spectrum (m/e=0-100) of LiBr.

FIG. 20 shows the positive ToF-SIMS spectrum (m/e=0-10 of the LiH*Br crystals.

FIG. 21 shows the negative ToF-SIMS spectrum (m/e=0-100) of LiBr.

FIG. 22 shows the negative ToF-SIMS spectrum (m/e=0-100) of the LiH*Br crystals. A dominant hydride, LiHBr⁻, and Li₂H₂Br⁻ peaks were uniquely observed.

FIG. 23 shows the positive ToF-SIMS spectrum (m/e=0-200) of LiI.

FIG. 24 shows the positive ToF-SIMS spectrum (m/e=0-200) of the LiH*I crystals. LiHI⁺, Li₂H₂I⁺, Li₄H₂I⁺, and Li₆H₂I⁺ were only observed in the positive ion spectrum of the LiH*I crystals.

FIG. 25 shows the negative ToF-SIMS spectrum (m/e=0-180) of LiI.

FIG. 26 shows the negative ToF-SIMS spectrum (m/e=0-180) of the LiH*I crystals. A dominant hydride, LiHI⁻, Li₂H₂I⁻, and NaHI⁻ peaks were uniquely observed.

FIG. 27 shows the negative ToF-SIMS spectrum (m/e=20-30) of NaH*-coated Pt/Ti following the production of 15 kJ of excess heat. Hydrino hydride compounds NaH; were observed.

FIG. 28 shows the positive ToF-SIMS spectrum (m/e=0-100) of R-Ni reacted over a 48 hour period at 50° C. The dominant ion on the surface was Na⁺ consistent with NaOH doping of the surface. The ions of the other major elements of R-Ni 2400 such as Al⁺, Ni⁺, Cr⁺, and Fe⁺ were also observed.

FIG. 29 shows the negative ToF-SIMS spectrum (m/e=0-180) of R-Ni reacted over a 48 hour period at 50° C. A dominant hydride, NaH₃⁻ and NaH₃NaOH⁻ assigned to sodium hydrino hydride and this ion in combination with NaOH, as well as other unique ions assignable to sodium hydrino hydrides NaHₓ—; in combinations with NaOH, NaO, OH— and O⁻ were observed.

FIG. 30 show ′H MAS NMR spectra relative to external TMS. (A) LiH*Br showing a broad −2.5 ppm upfield-shifted peak and a peak at 1.13 ppm assigned to H−(1/4) and H₂(1/4), respectively. (B) LiH*I showing a broad −2.09 ppm upfield-shifted peak assigned to H⁻(1/4) and peaks at 1.06 ppm and 4.38 ppm assigned to H₂(1/4) and H₂, respectively.

FIG. 31 shows ′H MAS NMR spectra relative to external TMS. (A) KH*Cl showing a very sharp −4.46 ppm upfield-shifted peak corresponding to an environment that is essentially that of a free ion. (B) KH*I showing a broad −2.31 ppm upfield-shifted peak similar to the case of LiH*Br and LiH*I. Both spectra also had a 1.13 ppm peak assigned to H₂(1/4).

FIG. 32 shows ¹H MAS NMR spectra relative to external TMS showing an H-content selectivity of LiH*X for molecular species alone based on the nonpolarizability of the halide and the corresponding nonreactivity towards H− (1/4). (A) LiH*F comprising a nonpolarizable fluorine showing peaks at 4.31 ppm assigned to H₂ and 1.16 ppm assigned to H₂(1/4) and the absence of the H⁻(1/4) ion peak. (B) LiH*Cl comprising a nonpolarizable chlorine showing peaks at 4.28 ppm assigned to H₂ and 1.2 ppm assigned to H₂(1/4) and the absence of the H⁻(1/4) ion peak

FIG. 33 shows the ¹H MAS NMR spectra of NaH Br relative to external TMS showing a −3.58 ppm upfield-shifted peak, a peak at 1.13 ppm, and a peak at 4.3 ppm assigned to H⁻(1/4), H₂(1/4), and H₂, respectively.

FIG. 34 shows the NaH*Cl ¹H MAS NMR spectra relative to external TMS showing the effect of hydrogen addition on the relative intensities of H₂, H₂(1/4), and H⁻(1/4). The addition of hydrogen increased the H⁻(1/4) peak and decreased the H₂(1/4) while the H₂ increased. (A) NaH*Cl synthesized with hydrogen addition showing a −4 ppm upfield-shifted peak assigned to H⁻(1/4), a 1.1 ppm peak assigned to H₂(1/4), and a dominant 4 ppm peak assigned to H (B)*Cl synthesized without hydrogen addition showing a −4 ppm upfield-shifted peak assigned to H−(1/4), a dominant 1.0 ppm peak assigned to H₂(1/4), and a small 4.1 ppm assigned to H₂.

FIG. 35 shows the ¹H MAS NMR spectrum relative to external TMS of NaH*Cl from reaction of NaCl and the solid acid KHSO₄ as the only source of hydrogen showing both the H−(1/4) peak at −3.97 ppm and an upfield-shifted peak at −3.15 ppm assigned to H⁻(1/3). The corresponding H₂(1/4) and H₂(113) peaks are shown at 1.15 ppm and 1.7 ppm, respectively. Both fractional hydrogen states were present and the H₂ peak was absent at 4.3 ppm due to the synthesis of NaH*Cl using a solid acid as the H source rather that addition of hydrogen gas and a dissociator. (SB=side band).

FIG. 36 shows XPS survey spectra (E_{b}=0 e V to 1200 eV) for (A) LiBr. and (B) LiH*Br.

FIG. 37 shows the 0-85 eV binding energy region of a high resolution XPS spectrum of LiH*Br and the control LiBr (dashed). The XPS spectrum of LiH*Br differs from that of LiBr by having additional peaks at 9.5 eV and 12.3 eV that could not be assigned to known elements and do not correspond to any other primary element peak. The peaks match H⁻(1/4) in two different chemical environments.

FIG. 38 shows the XPS survey spectra (E_{b}=0 eV to 1200 eV) for (A) NaBr and (B) NaH*Br.

FIG. 39 shows the 0-40 eV binding energy region of a high resolution XPS spectrum of NaH*Br and the control NaBr (dashed). The XPS spectrum of NaH*Br differs from that of NaBr by having additional peaks at 9.5 eV and 12.3 eV that could not be assigned to known elements and do not correspond to any other primary element peak. The peaks match H⁻(1/4) in two different chemical environments.

FIG. 40 shows XPS survey spectra (E_{b}=0 eV to 1200 eV) for (A) PtITi and (B) NaH*-coated Pt/Ti following the production of 15 kJ of excess heat.

FIG. 41 shows high resolution XPS spectra (E_{b}=0 eV to 100 eV) for (A) PtI Ti and (B) NaH*-coated PtITi following the production of 15 kJ of excess heat. The Pt 4f_{7/2}, Pt 4f_{5/2}, and O 2s peaks were observed at 70.7 eV, 74 eV, and 23 eV, respectively. The Na 2p and Na 2s peaks were observed at 31 eV and 64 eV on NaH*-coated Pt/Ti, and a valance band was only observed for Pt/Ti.

FIG. 42 shows high resolution XPS spectra (E_{b}=0 eV to 50 eV) for (A) Pt/Ti and (B) NaH*-coated Pt/Ti following the production of 15 kJ of excess heat. The XPS spectrum of NaH*-coated Pt/Ti differs from that of Pt/Ti by having additional peaks at 6 eV, 10.8 eV, and 12.8 eV that could not be assigned to known elements and do not correspond to any other primary element peak. The 10.8 eV, and 12.8 eV peaks match H⁻(1/4) in two different chemical environments, and the 6 eV peak matched and was assigned to H−(1/3). Thus, both fractional hydrogen states, 1/3 and 1/4, were present as predicted by Eq. (27).

FIG. 43 shows XPS survey spectrum (E_{b}=0 eV to 120 eV) of NaH*-coated Si with the primary-element peaks identified.

FIG. 44 shows high resolution XPS spectrum (E_{b}=0 eV to 120 eV) of NaH*-coated Si having peaks at 6 eV, 10.8 eV, and 12.8 eV that could not be assigned to known elements and do not correspond to any other primary element peak. The 10.8 eV, and 12.8 eV peaks match H−(1/4) in two different chemical environments, and the 6 eV peak matched and was assigned to H−(1/3). Thus, both fractional hydrogen states, 1/3 and 1/4, were present as predicted by Eq. (27) matching the results of NaH*-coated Pt/shown in FIG. 42 marked B.

FIG. 45 shows high resolution (0.5 cm⁻¹) FTIR spectra (490-4000 cm⁻¹) for (A) LiBr and (B) LiH*Br sample having a NMR peak assigned to H⁻(1/4) that was heated to >600° C. under dynamic vacuum that retained the −2.5 ppm NMR peak. The amide peaks at 3314, 3259, 2079 (broad), 1567, and 1541 cm⁻¹ and the imide peaks at 3172 (broad), 1953, and 1578 cm⁻¹ were eliminated; thus, they were not the source of the −2.5 ppm NMR peak that remained. The −2.5 ppm peak in NMR spectrum was assigned to the H⁻(1/4) ion. In addition, the 1989 cm⁻¹ FTIR peak could not be assigned to any know compound, but matched the predicted frequency of para H₂ (1/4).

FIG. 46 shows the 150-350 nm spectrum of electron-beam excited CsCl crystals having trapped H₂(1/4). A series of evenly spaced lines was observed in the 220-300 nm region that matched the spacing and intensity profile of the P branch of H₂(1/4).

FIG. 47 shows the 100-550 nm spectrum of an electron-beam excited silicon wafer coated with NaH*Cl having trapped H₂(1/4). A series of evenly spaced lines was observed in the 220-300 nm region that matched the spacing and intensity profile of the P branch of H₂(1/4)

### DETAILED DESCRIPTION OF THE PREFERRED EMBODIMENTS

### Hydrogen Catalyst Reactor

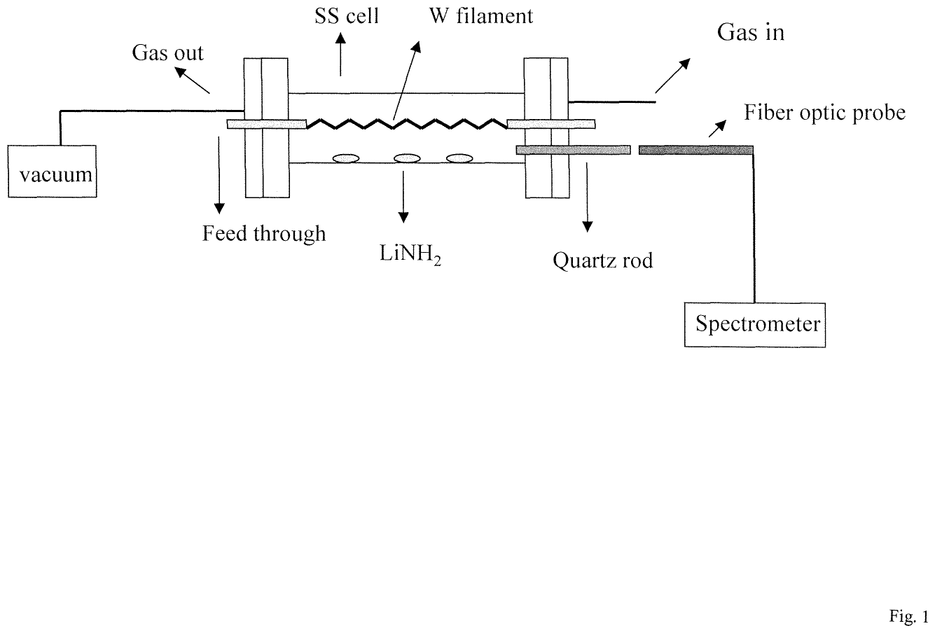

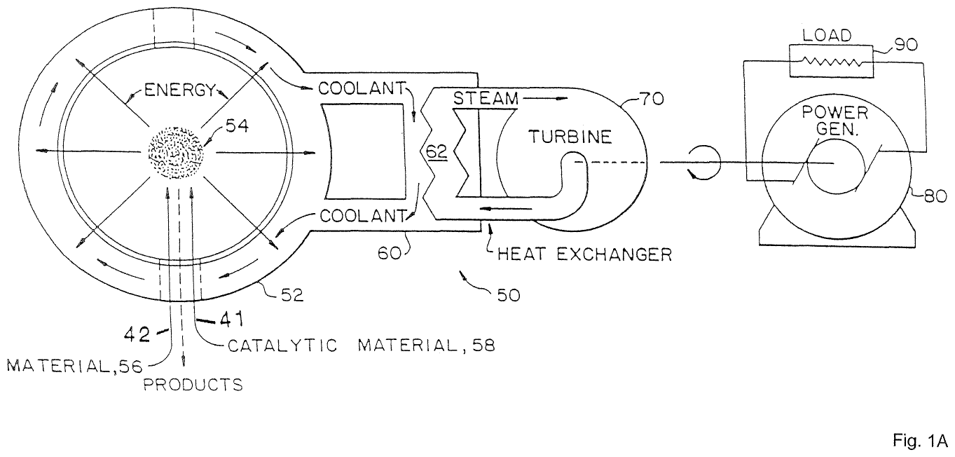

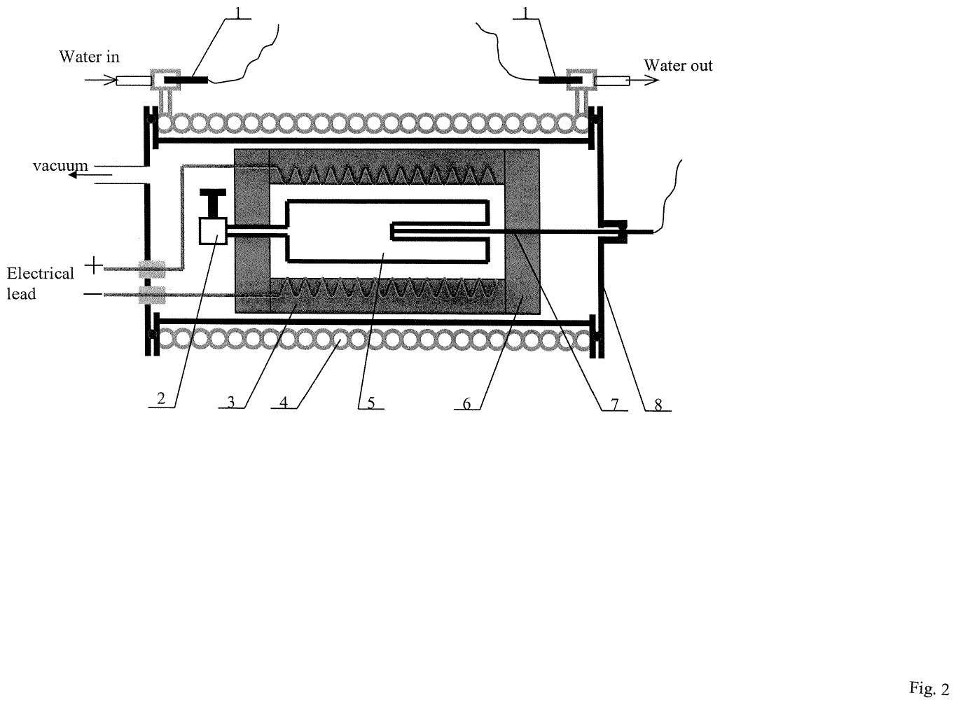

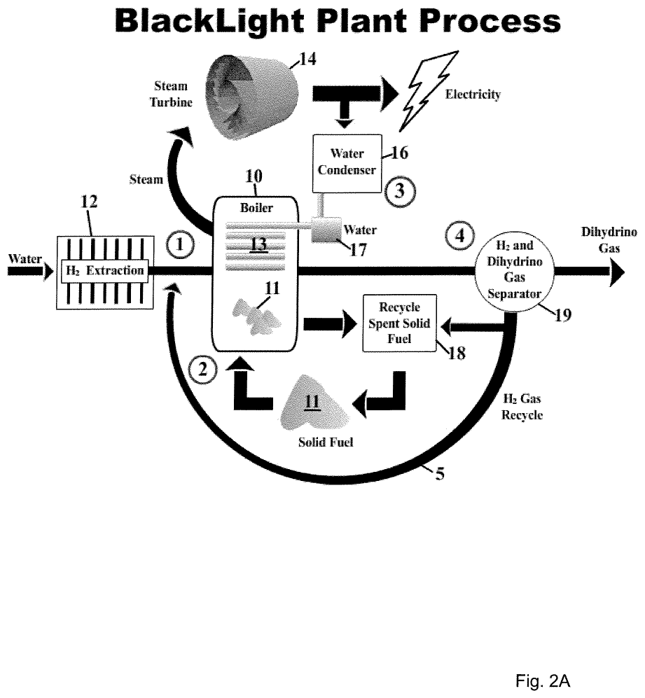

A hydrogen catalyst reactor 50 for producing energy and lower-energy hydrogen species, in accordance with the invention, is shown in FIG. 1A and comprises a vessel 52 which contains an energy reaction mixture 54, a heat exchanger 60, and a power converter such as a steam generator 62 and turbine 70. In an embodiment, the catalysis involves reacting atomic hydrogen from the source 56 with the catalyst 58 to form lower-energy hydrogen “hydrinos” and produce power. The heat exchanger 60 absorbs heat released by the catalysis reaction, when the reaction mixture, comprised of hydrogen and a catalyst, reacts to form lower-energy hydrogen. The heat exchanger exchanges heat with the steam generator 62 which absorbs heat from the exchanger 60 and produces steam. The energy reactor 50 further comprises a turbine 70 which receives steam from the steam generator 62 and supplies mechanical power to a power generator 80 which converts the steam energy into electrical energy, which can be received by a load 90 to produce work or for dissipation.

In an embodiment, the energy reaction mixture 54 comprises an energy releasing material 56 such as a solid fuel supplied through supply passage 42. The reaction mixture may comprise a source of hydrogen isotope atoms or a source of molecular hydrogen isotope, and a source of catalyst 58 which resonantly remove approximately m·27.2 eV to form lower-energy atomic hydrogen where m is an integer, preferably an integer less than 400 wherein the reaction to lower energy states of hydrogen occurs by contact of the hydrogen with the catalyst. The catalyst may be in the molten, liquid, gaseous, or solid state. The catalysis releases energy in a form such as heat and forms at least one of lower-energy hydrogen isotope atoms, molecules, hydride ions, and lower-energy hydrogen compounds. Thus, the power cell also comprises a lower-energy hydrogen chemical reactor.

The source of hydrogen can be hydrogen gas, dissociation of water including thermal dissociation, electrolysis of water, hydrogen from hydrides, or hydrogen from metal-hydrogen solutions. In another embodiment, molecular hydrogen of the energy releasing material 56 is dissociated into atomic hydrogen by a molecular hydrogen dissociating catalyst of the mixture 54. Such dissociating catalysts may also absorb hydrogen, deuterium, or tritium atoms and/or molecules and include, for example, an element, compound, alloy, or mixture of noble metals such as palladium and platinum, refractory metals such as molybdenum and tungsten, transition metals such as nickel and titanium, inner transition metals such as niobium and zirconium, and other such materials listed in the Prior Mills Publications. Preferably, the dissociator has a high surface area such as a noble metal such as Pt, Pd, Ru, Ir, Re, or Rh, or Ni on Al₂O₃, SiO₂, or combinations thereof.

In an embodiment, a catalyst is provided by the ionization of t electrons from an atom or ion to a continuum energy level such that the sum of the ionization energies of the t electrons is approximately m·27.2 eV where t and in are each an integer. A catalyst may also be provided by the transfer of t electrons between participating ions. The transfer of t electrons from one ion to another ion provides a net enthalpy of reaction whereby the sum of the t ionization energies of the electron-donating ion minus the ionization energies of t electrons of the electron-accepting ion equals approximately m·27.2 eV where r and m are each an integer. In another preferred embodiment, the catalyst comprises MH such as NaH having an atom M bound to hydrogen, and the enthalpy of m·27.2 eV is provided by the sum of the M—H bond energy and the ionization energies of the t electrons.

In a preferred embodiment, a source of catalyst comprises a catalytic material 58 supplied through catalyst supply passage 41, that typically provides a net enthalpy of approximately

$$\frac{m}{2} \cdot 27.2 eV$$

plus or minus 1 eV. The catalysts include those given herein and the atoms, ions, molecules, and hydrinos described in Mills Prior Publications (e.g. TABLE 4 of PCT/US90/01998 and pages 25-46, 80-108 of PCT/US94/02219) which are incorporated herein by reference. In embodiments, the catalyst may comprise at least one species selected from the group of molecules of AlH, BiH, ClH, CoH, GeH, InH, NaH, RuH, SbH, SeH, SiH, SnH, C₂, N₂, O₂, CO₂, NO₂, and NO₃ and atoms or ions of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, Kr, 2K⁺, He⁺, Na⁺, Rb⁺, Sr⁺, Fe³⁺, Mo²⁺, Mo⁴⁺, In³⁺, He⁺, Ar⁺, Xe⁺, Ar²⁺ and H⁺, and Ne⁺ and H⁺.

### Hydrogen Catalyst Reactor and Electrical Power System

In an embodiment of a power system, the heat is removed by a heat exchanger having a heat exchange medium. The heat exchanger may be a water wall and the medium may be water. The heat may be transferred directly for space and process heating. Alternatively, the heat exchanger medium such as water undergoes a phase change such as conversion to steam. This conversion may occur in a steam generator. The steam may be used to generate electricity in a heat engine such as a steam turbine and a generator.

An embodiment of a hydrogen catalyst energy and lower-energy-hydrogen species-producing reactor 5, for recycling or regenerating the fuel in accordance with the Invention, is shown in FIG. 1B and comprises a boiler 10 which contains a solid fuel reaction mixture 11, a hydrogen source 12, steam pipes and steam generator 13, a power converter such as a turbine 14, a water condenser 16, a water-make-up source 17, a solid-fuel recycler 18, and a hydrogen-dihydrino gas separator 19. At Step 1, the solid fuel comprising a source of catalyst and a source of hydrogen reacts to form hydrinos and lower-energy hydrogen products. At Step 2, the spent fuel is reprocessed to re-supply the boiler 10 to maintain thermal power generation. The heat generated in the boiler 10 forms steam in the pipes and steam generator 13 that is delivered to the turbine 14 that in turn generates electricity by powering a generator. At Step 3, the water is condensed by the water condenser 16. Any water loss may be made up by the water source 17 to complete the cycle to maintain thermal to electric power conversion. At Step 4, lower-energy hydrogen products such as hydrino hydride compounds and dihydrino gas may be removed, and unreacted hydrogen may be returned to the fuel recycler 18 or hydrogen source 12 to be added back to spent fuel to make-up recycled fuel. The gas products and unreacted hydrogen may be separated by hydrogen-dihydrino gas separator 19. Any product hydrino hydride compounds may be separated and removed using solid-fuel recycler 18. The processing may be performed in the boiler or externally to the boiler with the solid fuel returned. Thus, the system may further comprise at least one of gas and mass transporters to move the reactants and products to achieve the spent fuel removal, regeneration, and re-supply. Hydrogen make-up for that spent in the formation of hydrinos is added from the source 12 during fuel reprocessing and may involve recycled, unconsumed hydrogen. The recycled fuel maintains the production of thermal power to drive the power plant to generate electricity.

In a preferred embodiment, the reaction mixture comprises species that can generate the reactants of atomic or molecular catalyst and atomic hydrogen that further react to form hydrinos, and the product species formed by the generation of catalyst and atomic hydrogen can be regenerated by at least the step of reacting the products with hydrogen. In an embodiment, the reactor comprises a moving bed reactor that may further comprise a fluidized-reactor section wherein the reactants are continuously supplied and side products are removed and regenerated and returned to the reactor. In an embodiment, the lower-energy hydrogen products such as hydrino hydride compounds or dihydrino molecules are collected as the reactants are regenerated. Furthermore, the hydrino hydride ions may be formed into other compounds or converted into dihydrino molecules during the regeneration of the reactants.

The power system may further comprise a catalyst condensor means to maintain the catalyst vapor pressure by a temperature control means which controls the temperature of a surface at a lower value than that of the reaction cell. The surface temperature is maintained at a desired value which provides the desired vapor pressure of the catalyst. In an embodiment, the catalyst condensor means is a tube grid in the cell. In an embodiment with a heat exchanger, the flow rate of the heat transfer medium may be controlled at a rate that maintains the condensor at the desired lower temperature than the main heat exchanger. In an embodiment, the working medium is water, and the flow rate is higher at the condensor than the water wall such that the condensor is the lower, desired temperature. The separate streams of working media may be recombined to be transferred for space and process heating or for conversion to steam.

The present energy invention is further described in Mills Prior Publications which are incorporated herein by reference. The cells of the present invention include those described previously and further comprise the catalysts, reaction mixtures, methods, and systems disclosed herein. The electrolytic cell energy reactor, plasma electrolysis reactor, barrier electrode reactor, RF plasma reactor, pressurized gas energy reactor, gas discharge energy reactor, microwave cell energy reactor, and a combination of a glow discharge cell and a microwave and or RF plasma reactor of the present invention comprises: a source of hydrogen; one of a solid, molten, liquid, and gaseous source of catalyst; a vessel containing hydrogen and the catalyst wherein the reaction to form lower-energy hydrogen occurs by contact of the hydrogen with the catalyst or by reaction of MH catalyst; and a means for removing the lower-energy hydrogen product. For power conversion, each cell type may be interfaced with any of the converters of thermal energy or plasma to mechanical or electrical power described in Mills Prior Publications as well as converters known to those skilled in the Art such as a heat engine, steam or gas turbine system, Sterling engine, or thermionic or thermoelectric converter. Further plasma converters comprise the magnetic mirror magnetohydrodynamic power converter, plasmadynamic power converter, gyrotron, photon bunching microwave power converter, charge drift power, or photoelectric converter disclosed in Mills Prior Publications. In an embodiment, the cell comprises at least one cylinder of an internal combustion engine as given in Mills Prior Publications.

### Hydrogen Gas Cell and Solid Fuel Reactor

According to an embodiment of the invention, a reactor for producing hydrinos and power may take the form of a hydrogen gas cell. A gas cell hydrogen reactor of the present invention is shown in FIG. 1C. Reactant hydrinos are provided by a catalytic reaction with catalyst. Catalysis may occur in the gas phase or in solid or liquid state.

The reactor of FIG. 1C comprises a reaction vessel 207 having a chamber 200 capable of containing a vacuum or pressures greater than atmospheric. A source of hydrogen 221 communicating with chamber 200 delivers hydrogen to the chamber through hydrogen supply passage 242. A controller 222 is positioned to control the pressure and flow of hydrogen into the vessel through hydrogen supply passage 242. A pressure sensor 223 monitors pressure in the vessel. A vacuum pump 256 is used to evacuate the chamber through a vacuum line 257.

In an embodiment, the catalysis occurs in the gas phase. The catalyst may be made gaseous by maintaining the cell temperature at an elevated temperature that, in turn, determines the vapor pressure of the catalyst. The atomic and/or molecular hydrogen reactant is also maintained at a desired pressure that may be in any pressure range. In an embodiment, the pressure is less than atmospheric, preferably in the range about 10 millitorr to about 100 Torr. In another embodiment, the pressure is determined by maintaining a mixture of source of catalyst such as a metal source and the corresponding hydride such as a metal hydride in the cell maintained at the desired operating temperature.

A source of catalyst 250 for generating hydrino atoms can be placed in a catalyst reservoir 295, and gaseous catalyst can be formed by heating. The reaction vessel 207 has a catalyst supply passage 241 for the passage of gaseous catalyst from the catalyst reservoir 295 to the reaction chamber 200. Alternatively, the catalyst may be placed in a chemically resistant open container, such as a boat, inside the reaction vessel.

The source of hydrogen can be hydrogen gas and the molecular hydrogen. Hydrogen may be dissociated into atomic hydrogen by a molecular hydrogen dissociating catalyst. Such dissociating catalysts or dissociators include, for example, Raney nickel (R-Ni), precious or noble metals, and a precious or noble metal on a support. The precious or noble metal may be Pt, Pd, Ru, Ir, and Rh, and the support may be at least one of Ti, Nb, Al₂O₃, SiO₂ and combinations thereof. Further dissociators are Pt or Pd on carbon that may comprise a hydrogen spillover catalyst, nickel fiber mat, Pd sheet, Ti sponge, Pt or Pd electroplated on Ti or Ni sponge or mat, TiH, Pt black, and Pd black, refractory metals such as molybdenum and tungsten, transition metals such as nickel and titanium, inner transition metals such as niobium and zirconium, and other such materials listed in the Prior Mills Publications In a preferred embodiment, hydrogen is dissociated on Pt or Pd. The Pt or Pd may be coated on a support material such as titanium or Al₂O₃. In another embodiment, the dissociator is a refractory metal such as tungsten or molybdenum, and the dissociating material may be maintained at elevated temperature by temperature control means 230, which may take the form of a heating coil as shown in cross section in FIG. 1C. The heating coil is powered by a power supply 225. Preferably, the dissociating material is maintained at the operating temperature of the cell. The dissociator may further be operated at a temperature above the cell temperature to more effectively dissociate, and the elevated temperature may prevent the catalyst from condensing on the dissociator. Hydrogen dissociator can also be provided by a hot filament such as 280 powered by supply 285.

In an embodiment, the hydrogen dissociation occurs such that the dissociated hydrogen atoms contact gaseous catalyst to produce hydrino atoms. The catalyst vapor pressure is maintained at the desired pressure by controlling the temperature of the catalyst reservoir 295 with a catalyst reservoir heater 298 powered by a power supply 272. When the catalyst is contained in a boat inside the reactor, the catalyst vapor pressure is maintained at the desired value by controlling the temperature of the catalyst boat, by adjusting the boat's power supply. The cell temperature can be controlled at the desired operating temperature by the heating coil 230 that is powered by power supply 225. The cell (called a permeation cell) may further comprise an inner reaction chamber 200 and an outer hydrogen reservoir 290 such that hydrogen may be supplied to the cell by diffusion of hydrogen through the wall 291 separating the two chambers. The temperature of the wall may be controlled with a heater to control the rate of diffusion. The rate of diffusion may be further controlled by controlling the hydrogen pressure in the hydrogen reservoir.

To maintain the catalyst pressure at the desire level, the cell having permeation as the hydrogen source may be sealed. Alternatively, the cell further comprises high temperature valves at each inlet or outlet such that the valve contacting the reaction gas mixture is maintained at the desired temperature. The cell may further comprise a getter or trap 255 to selectively collect the lower-energy-hydrogen species and/or the increased-binding-energy hydrogen compounds and may further comprise a selective valve 206 for releasing dihydrino gas product.

The catalyst may be at least one of the group of atomic lithium, potassium, or cesium, NaH molecule and hydrino atoms wherein catalysis comprises a disproportionation reaction. Lithium catalyst may be made gaseous by maintaining the cell temperature in the 500-1000° C. range. Preferably, the cell is maintained in the 500-750° C. range. The cell pressure may be maintained at less than atmospheric, preferably in the range about 10 m II torr to about 100 Torr. Most preferably, at least one of the catalyst and hydrogen pressure is determined by maintaining a mixture of catalyst metal and the corresponding hydride such as lithium and lithium hydride, potassium and potassium hydride, sodium and sodium hydride, and cesium and cesium hydride in the cell maintained at the desired operating temperature. The catalyst in the gas phase may comprise lithium atoms from the metal or a source of lithium metal. Preferably, the lithium catalyst is maintained at the pressure determined by a mixture of lithium metal and lithium hydride at the operating temperature range of 500-1000° C. and most preferably, the pressure with the cell at the operating temperature range of 500-750° C. In other embodiments, K, Cs, and Na replace Li wherein the catalyst is atomic K, atomic Cs, and molecular NaH.

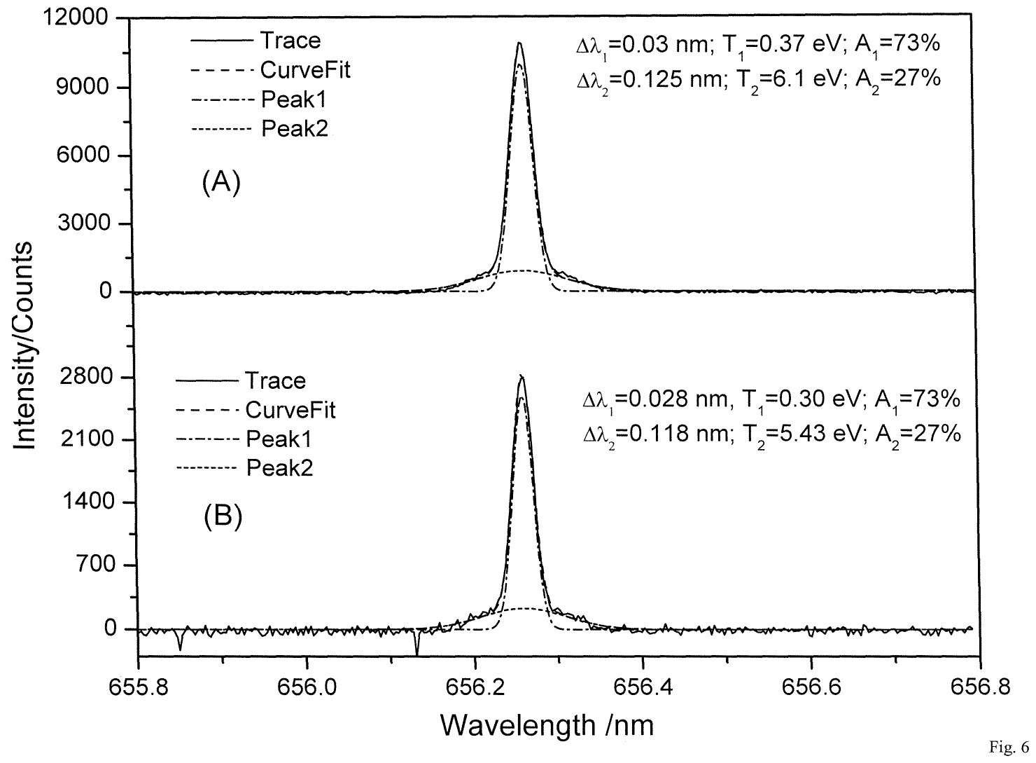

In an embodiment of the gas cell reactor comprising a catalyst reservoir or boat, gaseous Na, NaH catalyst, or the gaseous catalyst such as Li, K, and Cs vapor is maintained in a super-heated condition in the cell relative to the vapor in the reservoir or boat which is the source of the cell vapor. In one embodiment, the superheated vapor reduces the condensation of catalyst on the hydrogen dissociator or the dissociator of at least one of metal and metal hydride molecules disclosed infra. In an embodiment comprising Li as the catalyst from a reservoir or boat, the reservoir or boat is maintained at a temperature at which Li vaporizes. H₂ may be maintained at a pressure that is lower than that which forms a significant mole fraction of LiH at the reservoir temperature. The pressures and temperatures that achieve this condition can be determined from the data plots of Mueller et al. such as FIG. 6.1 [40] of H₂ pressure versus LiH mole fraction at given isotherms. In an embodiment, the cell reaction chamber containing a dissociator is operated at a higher temperature such that the Li does not condense on the walls or the dissociator. The H₂ may flow from the reservoir to the cell to increase the catalyst transport rate. Flow such as from the catalyst reservoir to the cell and then out of the cell is a means to remove hydrino product to prevent hydrino product inhibition of the reaction. In other embodiments, K, Cs, and Na replace Li wherein the catalyst is atomic K, atomic Cs, and molecular NaH.

Hydrogen is supplied to the reaction from a source of hydrogen. Preferably the hydrogen is supplied by permeation from a hydrogen reservoir. The pressure of the hydrogen reservoir may be in the range of 10 Torr to 10,000 Torr, preferably 100 Torr to 1000 Torr, and most preferably about atmospheric pressure. The cell may be operated in the temperature of about 100° C. to 3000° C., preferably in the temperature of about 100° C. to 1500° C., and most preferably in the temperature of about 500° C. to 800° C.

The source of hydrogen may be from decomposition of an added hydride. A cell design that supplies H₂ by permeation is one comprising an internal metal hydride placed in a sealed vessel wherein atomic H permeates out at high temperature. The vessel may comprise Pd, Ni, Ti, or Nb. In an embodiment, the hydride is placed in a sealed tube such as a Nb tube containing a hydride and sealed at both ends with seals such as Swagelocks. In the sealed case, the hydride could be an alkaline or alkaline earth hydride. Or, in this as well as the internal-hydride-reagent case, the hydride could be at least one of the group of saline hydrides, titanium hydride, vanadium, niobium, and tantalum hydrides, zirconium and hafnium hydrides, rare earth hydrides, yttrium and scandium hydrides, transition element hydrides, intermetallic hydrides, and their alloys given by W. M. Mueller et al. [40].

In an embodiment the hydride and operating temperature ±200° C., based on each hydride decomposition temperature is at least one of the list of:

a rare earth hydride with an operating temperature of about 800° C.; lanthanum hydride with an operating temperature of about 700° C.; gadolinium hydride with an operating temperature of about 750° C.; neodymium hydride with an operating temperature of about 750° C.; yttrium hydride with an operating temperature of about 800° C.; scandium hydride with an operating temperature of about 800° C.; ytterbium hydride with an operating temperature of about 850-900° C.; titanium hydride with an operating temperature of about 450° C.; cerium hydride with an operating temperature of about 950° C.; praseodymium hydride with an operating temperature of about 700° C.; zirconium-titanium (50%/50%) hydride with an operating temperature of about 600° C.; an alkali metal/alkali metal hydride mixture such as Rb/RbH or K/KH with an operating temperature of about 450° C., and an alkaline earth metal/alkaline earth hydride mixture such as Ba/BaH₂ with an operating temperature of about 900-1000° C.

Metals in the gas state comprise diatomic covalent molecules. An objective of the present Invention is to provide atomic catalyst such as Li as well as K and Cs. Thus, the reactor may further comprise a dissociator of at least one of metal molecules (“MM”) and metal hydride molecules (“MH”). Preferably, the source of catalyst, the source of H₂, and the dissociator of MM, MH, and HH, wherein M is the atomic catalyst are matched to operate at the desired cell conditions of temperature and reactant concentrations for example. In the case that a hydride source of H₂ is used, in an embodiment, its decomposition temperature is in the range of the temperature that produces the desired vapor pressure of the catalyst. In the case of that the source of hydrogen is permeation from a hydrogen reservoir to the reaction chamber, preferable sources of catalysts for continuous operation are Sr and Li metals since each of their vapor pressures may be in the desired range of 0.01 to 100 Torr at the temperatures for which permeation occurs. In other embodiments of the permeation cell, the cell is operated at a high temperature permissive of permeation, then the cell temperature is lowered to a temperature which maintains the vapor pressure of the volatile catalyst at the desired pressure.

In an embodiment of a gas cell, a dissociator comprises a means to generate catalyst and H from sources. Surface catalysts such as Pt on Ti or Pd, iridium, or rhodium alone or on a substrate such as Ti may also serve the role as a dissociator of molecules of combinations of catalyst and hydrogen atoms. Preferably, the dissociator has a high surface area such as Pt/Al₂O₃ or Pd/Al₂O₃.

The H₂ source can also be H₂ gas. In this case, the pressure can be monitored and controlled. This is possible with catalyst and catalyst sources such as K or Cs metal and LiNH₂, respectively, since they are volatile at low temperature which is permissive of using a high-temperature valve. LiNH₂ also lowers the necessary operating temperature of the Li cell and is less corrosive which is permissive of long-duration operation using a feed through in the case of plasma and filament cells wherein a filament serves as a hydrogen dissociator.

Further embodiments of the gas cell hydrogen reactor having NaH as the catalyst comprise a filament with a dissociator in the reactor cell and Na in the reservoir. H₂ may be flowed through the reservoir to main chamber. The power may be controlled by controlling the gas flow rate, H₂ pressure, and Na vapor pressure. The latter may be controlled by controlling the reservoir temperature. In another embodiment, the hydrino reaction is initiated by heating with the external heater and an atomic H is provided by a dissociator.

The invention is also directed to other reactors for producing increased binding energy hydrogen compounds of the invention, such as dihydrino molecules and hydrino hydride compounds. A further products of the catalysis is plasma, light, and power. Such a reactor is hereinafter referred to as a “hydrogen reactor” or “hydrogen cell”. The hydrogen reactor comprises a cell for making hydrinos. The cell for making hydrinos may take the form of a gas cell, a gas discharge cell, a plasma torch cell, or microwave power cell, for example. These exemplary cells which are not meant to be exhaustive are disclosed in Mills Prior Publications and are incorporated by reference. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only proteum (¹H), but also deuterium (²H) and tritium (³H).

### Hydrogen Gas Discharge Power and Plasma Cell and Reactor

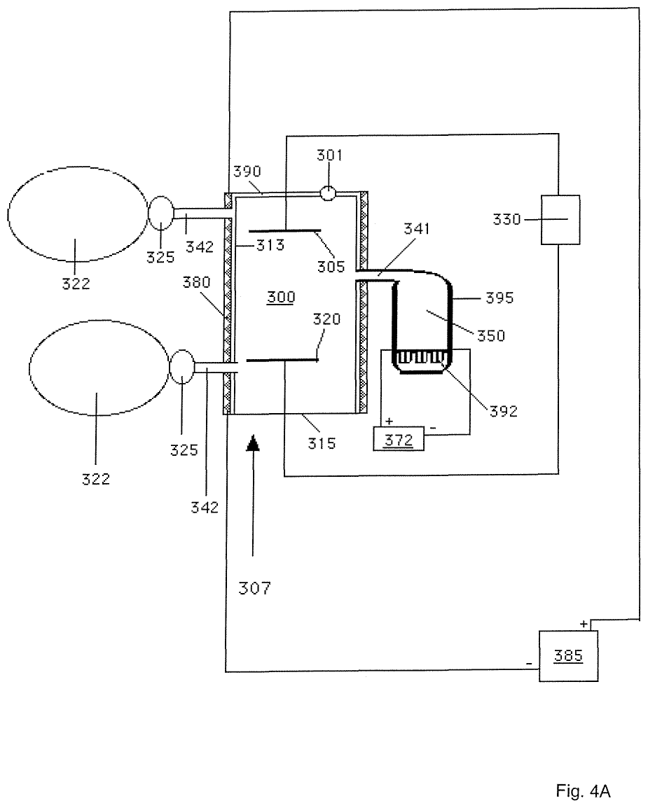

A hydrogen gas discharge power and plasma cell and reactor of the present invention is shown in FIG. 4A. The hydrogen gas discharge power and plasma cell and reactor of FIG. 4A, includes a gas discharge cell 307 comprising a hydrogen gas-filled glow discharge vacuum vessel 315 having a chamber 300. A hydrogen source 322 supplies hydrogen to the chamber 300 through control valve 325 via a hydrogen supply passage 342. A catalyst is contained in the cell chamber 300. A voltage and current source 330 causes current to pass between a cathode 305 and an anode 320. The current may be reversible.

In an embodiment, the material of cathode 305 may be a source of catalyst such as Fe, Dy, Be, or Pd. In another embodiment of the hydrogen gas discharge power and plasma cell and reactor, the wall of vessel 313 is conducting and serves as the cathode which replaces electrode 305, and the anode 320 may be hollow such as a stainless steel hollow anode. The discharge may vaporize the catalyst source to catalyst. Molecular hydrogen may be dissociated by the discharge to form hydrogen atoms for generation of hydrinos and energy. Additional dissociation may be provided by a hydrogen dissociator in the chamber.

Another embodiment of the hydrogen gas discharge power and plasma cell and reactor where catalysis occurs in the gas phase utilizes a controllable gaseous catalyst. The gaseous hydrogen atoms for conversion to hydrinos are provided by a discharge of molecular hydrogen gas. The gas discharge cell 307 has a catalyst supply passage 341 for the passage of the gaseous catalyst 350 from catalyst reservoir 395 to the reaction chamber 300. The catalyst reservoir 395 is heated by a catalyst reservoir heater 392 having a power supply 372 to provide the gaseous catalyst to the reaction chamber 300. The catalyst vapor pressure is controlled by controlling the temperature of the catalyst reservoir 395, by adjusting the heater 392 by means of its power supply 372. The reactor further comprises a selective venting valve 301. A chemically resistant open container, such as a stainless steel, tungsten or ceramic boat, positioned inside the gas discharge cell may contain the catalyst. The catalyst in the catalyst boat may be heated with a boat heater using an associated power supply to provide the gaseous catalyst to the reaction chamber. Alternatively, the glow gas discharge cell is operated at an elevated temperature such that the catalyst in the boat is sublimed, boiled, or volatilized into the gas phase. The catalyst vapor pressure is controlled by controlling the temperature of the boat or the discharge cell by adjusting the heater with its power supply. To prevent the catalyst from condensing in the cell, the temperature is maintained above the temperature of the catalyst source, catalyst reservoir 395 or catalyst boat.

In a preferred embodiment, the catalysis occurs in the gas phase, lithium is the catalyst, and a source of atomic lithium such as lithium metal or a lithium compound such as LiNH₂ is made gaseous by maintaining the cell temperature in the range of about 300-1000° C. Most preferably, the cell is maintained in the range of about 500-750° C. The atomic and/or molecular hydrogen reactant may be maintained at a pressure less than atmospheric, preferably in the range of about 10 millitorr to about 100 Torr. Most preferably, the pressure is determined by maintaining a mixture of lithium metal and lithium hydride in the cell maintained at the desired operating temperature. The operating temperature range is preferably in the range of about 300-1000° C. and most preferably, the pressure is that achieved with the cell at the operating temperature range of about 300-750° C. The cell can be controlled at the desired operating temperature by the heating coil such as 380 of FIG. 4A that is powered by power supply 385. The cell may further comprise an inner reaction chamber 300 and an outer hydrogen reservoir 390 such that hydrogen may be supplied to the cell by diffusion of hydrogen through the wall 313 separating the two chambers. The temperature of the wall may be controlled with a heater to control the rate of diffusion. The rate of diffusion may be further controlled by controlling the hydrogen pressure in the hydrogen reservoir.

An embodiment of the plasma cell of the present invention regenerates the reactants such as Li and LiNH₂. In an embodiment, the reaction given by Eqs. (32) and (37) occurs to generate the hydrino reactants Li and H with a large excess of energy released due to hydrino production. The products are then hydrogenated by a hydrogen source. In the case that LiH is formed, one reaction to regenerate the lower-energy-hydrogen-catalysis reactants is given by Eq. (66). This may be achieved with the reactants placed in a reactive region in the plasma cell such as at the cathode region in a hydrogen plasma cell. The reaction may be

LiH+e− to Li and H− (30)

and then the reaction

Li₂NH+H− to Li+LiNH₂ (31)

may occur to some extent to maintain a steady-state level of Li+LiNH₂. The H₂ pressure, electron density, and energy may be controlled to achieve the maximum or desired extent of the reaction to regenerate hydrino reactants Li+LiNH₂.

In an embodiment, the mixture is stirred or mixed during the plasma reaction. In a further embodiment of the plasma regeneration system and method of the present invention, the cell comprises a heated flat-bottom stainless steel plasma chamber. LiH and Li₂NH comprise a mixture in molten Li. Since stainless steel is not magnetic, the liquid mixture may be stirred with a stainless-steel-coated stirring bar driven by a stirring motor upon which the flat-bottom plasma reactor sits. The Li-metal mixture may serve as a cathode. The reduction of LiH to Li and H⁻ and the further reaction of H⁻+Li₂NH to Li and LiNH₂ can be monitored by XRD and FTIR of the product.

In another embodiment of a system having a reaction mixture comprising species of the group of Li, LiNH₂, Li₂NH, Li₃N, LiNO₃, LiX, NH₄X (X is a halide), NH₃, and H₂, at least one of the reactants is regenerated by adding one or more of the reagents and by a plasma regeneration. The plasma may be one of the gases such as NH₃ and H₂. The plasma may be maintained in situ (in the reaction cell) or in an external cell in communication with the reaction cell. In other embodiments, K, Cs, and Na replace Li wherein the catalyst is atomic K, atomic Cs, and molecular NaH.

To maintain the catalyst pressure at the desire level, the cell having permeation as the hydrogen source may be sealed. Alternatively, the cell further comprises high temperature valves at each inlet or outlet such that the valve contacting the reaction gas mixture is maintained at the desired temperature.

The plasma cell temperature can be controlled independently over a broad range by insulating the cell and by applying supplemental heater power with heater 380. Thus, the catalyst vapor pressure can be controlled independently of the plasma power.

The discharge voltage may be in the range of about 100 to 10,000 volts. The current may be in any desired range at the desired voltage. Furthermore, the plasma may be pulsed as disclosed in Mills Prior Publications such as PCT/US04/10608 entitled “Pulsed Plasma Power Cell and Novel Spectral Lines” which is herein incorporated by reference in its entirety.

Boron nitride may comprise the feed-throughs of the plasma cell since this material is stable to Li vapor. Crystalline or transparent alumina are other stable feed-through materials of the present invention.

### Solid Fuels and Hydrogen Catalyst Reactor

Metals in the gas state comprise diatomic covalent molecules. An objective of the present Invention is to provide atomic catalyst such as Li as well as K and Cs and molecular catalyst NaH. Thus, in a solid-fuels embodiment, the reactants comprise alloys, complexes, or sources of complexes that reversibly form with a metal catalyst M and decompose or react to provide gaseous catalyst such as Li. In another embodiment, at least one of the catalyst source and atomic hydrogen source further comprises at least one reactant which reacts to form at least one of the catalyst and atomic hydrogen. In an embodiment, the source or sources comprise at least one of amides such as LiNH₂, imides such as Li₂NH, nitrides such as Li₃N, and catalyst metal with NH₃. Reactions of these species provide both Li atoms and atomic hydrogen. These and other embodiments are given infra., wherein, additionally, K, Cs, and Na may replace Li and the catalyst is atomic K, atomic Cs, and molecular NaH.

The present invention comprises an energy reactor comprising a reaction vessel constructed and arranged to contain pressures lower, equal to, and higher than atmospheric pressure, a source of atomic hydrogen for chemically producing atomic hydrogen in communication with the vessel, a source of catalyst comprising at least one of atomic lithium, atomic cesium, atomic potassium, and molecular NaH in communication with the vessel, and may further comprise a getter such as source of an ionic compound for binding or reacting with a lower-energy hydride. The source of catalyst and reactant atomic hydrogen may comprise a solid fuel that may be continuously or batch-wise regenerated inside or outside of the cell wherein a physical process or chemical reaction generates the catalyst and H from a source such that H catalysis occurs and hydrinos are formed. Thus, embodiments of the present invention of hydrino reactants comprise solid fuels, and preferable embodiments comprise those solid fuels that can be regenerated. Solid fuels can used in many applications ranging from space and process heating, electricity generation, motive applications, propellants, and others applicants well known to those skilled in the Art.

A gas cell or plasma cell of the present invention such as those shown in FIGS. 1C and 4D comprises a means for the formation of catalyst and H atoms from sources. In solid-fuels embodiments, the cell further comprises reactants to provide catalyst and H upon initiation of a chemical or physical process. The initiation may be by means such as heating or plasma reaction. Preferably the external power requirement to maintain the production of hydrinos is low or zero based on the large power of the H catalysis reaction to form hydrinos. With a large energy gain, the reactants can be regenerated with a net release of energy for each cycle of reaction and regeneration.

In other embodiments, the reactor shown in FIG. 1C comprises a solid-fuels reactor wherein a reaction mixture comprises a source of catalyst and a source of hydrogen. The reaction mixture can be regenerated by supplying a flow of reactants and by removing products from the corresponding product mixture. In an embodiment, the reaction vessel 207 has a chamber 200 capable of containing a vacuum or pressures equal to or greater than atmospheric. At least one source of reagent such a gaseous reagent 221 is in communication with chamber 200 and delivers reagent to the chamber through at least one reagent supply passage 242. A controller 222 is positioned to control the pressure and flow of reagent into the vessel through reagent supply passage 242. A pressure sensor 223 monitors pressure in the vessel. A vacuum pump 256 is used to evacuate the chamber through a vacuum line 257. Alternatively, line 257 represents at least one output path such as a product passage line to remove material from the reactor. The reactor further comprises a source of heat such as a heater 230 to bring the reactants up to a desired temperature that initiates the solids fuel chemistry and the hydrino-forming catalysis reaction. In an embodiment, the temperature is in the range of about 50 to 1000° C.; preferably it is in the range of about 100-600° C., and for reactants comprising at least the Li/N-alloy system, the desired temperature is in the range of about 100-500° C.

The cell may further comprise a source of hydrogen gas and dissociator to form atomic hydrogen. The vessel may further comprise a source of hydrogen 221 in communication with the vessel for regenerating at least one of the source of atomic catalyst such as atomic lithium and the source of atomic hydrogen. The hydrogen source may be hydrogen gas. The H₂ gas may be supplied by a hydrogen line 242 or by permeation from a hydrogen reservoir 290. In exemplary regeneration reactions, the source of atomic lithium and atomic hydrogen may be generated by hydrogen addition according to Eqs. (66-71). The first step of an alternative regeneration reaction may given by Eq. (69).

In an embodiment, the cell size and materials are such that a high operating temperature is archived. The cell may be appropriately sized to the power output to achieve the desired operating temperature. High-temperature materials for the cell construction are niobium and a high-temperature stainless steel such as Hastalloy. The source of H₂ may be an internal metal hydride that does not react with LiNH₂, but releases H only at very high temperature. Also, even in the cases that the hydride does react with LiNH₂, it can be separated from the reagents such as Li and LiNH₂ by placing it in an open or closed vessel in the cell. A cell design that supplies H₂ by permeation is one comprising an internal metal hydride placed in a sealed vessel wherein atomic H permeates out at high temperature.

The reactor may further comprise means to separate components of a product mixture such as sieves for mechanically separating by differences in physical properties such as size. The reactor may further comprise means to separate one or more components based on a differential phase change or reaction. In an embodiment, the phase change comprises melting using a heater, and the liquid is separated from the solid by means known in the Art such as gravity filtration, filtration using a pressurized gas assist, and centrifugation. The reaction may comprise decomposition such as hydride decomposition or reaction to from a hydride, and the separations may be achieved by melting the corresponding metal followed by its separation and by mechanically separating the hydride, respectively. The latter may be achieved by sieving. In an embodiment, the phase change or reaction may produce a desired reactant or intermediate. In embodiments, the regeneration including any desired separation steps may occur inside or outside of the reactor.

### Chemical Reactor

A chemical reactor of the present invention further comprises a source of inorganic compound such as MX wherein M is an alkali metal and X is a halide. Additionally to halides, the inorganic compound may be an alkali or alkaline earth salt such a hydroxide, oxide, carbonate, sulfate, phosphate, borate, and silicate (other suitable inorganic compounds are given in D. R. Lide, CRC Handbook of Chemistry and Physics, 86th Edition, CRC Press, Taylor & Francis, Boca Raton, (2005 June), pp. 4-45 to 4-97 which is herein incorporated by reference). The inorganic compound may further serve as a getter in the generation of power by preventing product accumulation and a consequent back reaction or other product inhibition. A preferred Li chemical-type power cell comprises Li, LiNH₂, LiBr or LiI, and R-Ni in a hydrogen cell run at about 760 Torr H₂ and about 700+° C. A preferred NaH chemical-type power cell comprises Na, NaX (X is a halide, preferably Br or I) and R-Ni in a hydrogen cell run at about 760 Torr H₂ and about 700+° C. The cell may further comprise at least one of NaH and NaNH₂. A preferred K chemical-type power cell comprises K, KI, and Ni screen or R-Ni dissociator in a hydrogen cell run at about 760 Torr H₂ and about 700+° C. In an embodiment, the H₂ pressure range is about 1 Torr to 10⁵ Torr. Preferably, the H pressure is maintained in the range of about 760-1000 Torr. LiHX such as LiHBr and LiHI is typically synthesized in the temperature range of about 450-550° C., but can be run at lower temp (˜350° C.) with LiH present. NaHX such as NaHBr and NaHI is typically synthesized in the temperature range of about 450-550° C. KHX such as KHI is preferably synthesized in the temperature range of about 450-550° C. In embodiments of the NaHX and KHX reactors, NaH and K are supplied from a source such as catalyst reservoir wherein the cell temperature is maintained at a higher level than that of the catalyst reservoir. Preferably, the cell is maintained at the temperature range of about 300-550° C. and the reservoir is maintained in a temperature range of about 50 to 200° C. lower.

Another embodiment of the hydrogen reactor having NaH as the catalyst comprises a plasma torch for the production of power and increased-binding-energy hydrogen compounds such as NaHX wherein H is increased-binding-energy hydrogen and X is a halide. At least one of NaF, NaCl, NaBr, NaI may be aerosolized in the plasma gas such as H₂ or a noble gas/hydrogen mixture such as He/H₂ or Ar/H₂.

### General Solid Fuels Chemistry

A reaction mixture of the present invention comprises a catalyst or a source of catalyst and atomic hydrogen or a source of atomic hydrogen (H) wherein at least one of the catalyst and atomic hydrogen is released by a chemical reaction of at least one species of the reaction mixture or between two or more reaction-mixture species. Preferably, the reaction is reversible. Preferably, the energy released is greater than the enthalpy of reaction of the formation of catalyst and reactant hydrogen, and in the case that the reactants of the reaction mixture are regenerated and recycled, preferably, net energy is given off over the cycle of reaction and regeneration due to the large energy of formation of product H states given by Eq. (1). The species may be at least one of an element, alloy, or a compound such as a molecular or inorganic compound wherein each may be at least one of a reagent or product in the reactor. In an embodiment, the species may form an alloy or compound such as a molecular or inorganic compound with at least one of hydrogen and the catalyst. One or more of the reaction-mixture species may form one or more reaction product species such that the energy to release H or free catalyst is lowered relative to the case in the absence of the formation of the reaction product species. In embodiments of the reactants to provide a catalyst and atomic hydrogen to form states with energy levels given by Eq. (1), the reactants comprise at least one of solid, liquid (including molten), and gaseous reactants. The reactions to form the catalyst and atomic hydrogen to form states with energy levels given by Eq. (1) occurs in one or more of the solid, liquid (including molten), and gaseous phase. Exemplary solid-fuels reactions are given herein that are certainly not meant to be limiting in that other reactions comprising additional reagents are within the scope of the Invention.

In an embodiment, the reaction product species is an alloy or compound of at least one of the catalyst and hydrogen or sources thereof. In an embodiment, the reaction-mixture species is a catalyst hydride and the reaction product species is a catalyst alloy or compound that has a lower hydrogen content. The energy to release H from a hydride of the catalyst may be lowered by the formation of an alloy or second compound with the at least one another species such as an element or first compound. In an embodiment, the catalyst is one of Li, K, Cs, and NaH molecule and the hydride is one of LiH, KH, CsH, NaH(s) and the at least one other element is selected from the group of M (catalyst), Al, B, Si, C, N, Sn, Te, P, S, Ni, Ta, Pt, and Pd. The first and the second compound may be one of the group of H₂, H₂O, NH₃, NH₄X, (X is a couterion such as halide (other anions are given in D. R. Lide, CRC Handbook of Chemistry and Physics, 86th Edition, CRC Press, Taylor & Francis, Boca Raton, (2005 Jun.), pp. 4-45 to 4-97 which is herein incorporated by reference) MX, MNO₃, MAlH₄, M₃AlH₆, MBH₄, M₃N, M₂NH, and MNH₂ wherein M is an alkali metal that may be the catalyst. In another embodiment, a hydride comprising at least one other element than the catalyst element releases H by reversible decomposition.

One or more of the reaction-mixture species may form one or more reaction product species such that the energy to release free catalyst is lowered relative to the case in the absence of the formation of the reaction product species. A reaction species such as an alloy or compound may release free catalyst by a reversible reaction or decomposition. Also, the free catalyst may be formed by a reversible reaction of a source of catalyst with at least one other species such as an element or first compound to form a species such as an alloy or second compound. The element or alloy may comprise at least one of M (catalyst atom), H, Al, B, Si, C, N, Sn, Te, P, S, Ni, Ta, Pt, and Pd. The first and the second compound may be one of the group of H₂, NH₃, NH₄X where X is a couterion such as halide, MMX, MNO₃, MAlH₄, M₃AlH₆, MBH₄, M₃N, M₂NH, and MNH₂, wherein M is an alkali metal that may be the catalyst. The catalyst may be one of Li, K, and Cs, and NaH molecule. The source of catalyst may be M-M such as LiLi, KK, CsCs, and NaNa. The source of H may be MH such as LiH, KH, CsH, or NaH(s).

Li catalyst may be alloyed or react to form a compound with at least one other element or compound such that the energy barrier for the release of H from LiH or Li from LiH and LiLi molecules is lowered. The alloy or compound may also release H or Li by decomposition or reaction with further reaction species. The alloy or compound may be one or more of LiAlH₄, Li₃AlH₆, LiBH₄, Li₃N, Li₂NH, LiNH₂, LiX, and LiNO₃. The alloy or a compound may be one or more of Li/Ni, Li/Ta, Li/Pd, Li/Te, Li/C, Li/Si, and Li/Sn wherein the stoichiometry of Li and any other element of the alloy or compound is varied to achieve the optimal release of Li and H which subsequently react during the catalysis reaction to form lower energy states of hydrogen. In other embodiments, K, Cs, and Na replace Li wherein the catalyst is atomic K, atomic Cs, and molecular NaH.

In an embodiment, the alloy or compound has the formula MₓE_{y} wherein M is the catalyst such as Li, K, or Cs, or it is Na, E is the other element, and x and y designate the stoichiometry. M and E_{y} may be in ant desired molar ratio. In an embodiment x is in the range of 1 to 50 and y is in the range of 1 to 50, and preferably x is in the range of 1 to 10 and y is in the range of 1 to 10. In another embodiment, the alloy or compound has the formula M_{X}E_{Y}E_{Z} wherein M is the catalyst such as Li, K, or Cs, or it is Na, E_{y} is a first other element, E_{z} is a second other element, and x, y, and z designate the stoichiometry. M, E_{y}, and E_{y} may be in any desired molar ratio. In an embodiment, x is in the range of 1 to 50, y is in the range of 1 to 50, and z is in the range of 1 to 50, and preferably x is in the range of 1 to 10, y is in the range of 1 to 10, and z is in the range of 1 to 10. In preferred embodiments, E_{y} and E_{z} are selected from the group of H, N, C, Si, and Sn. The alloy or compound may be at least one of LiₓC_{y}Si_{z}, LiₓSn_{y}Si_{z}, LiₓN_{y}Si_{z}, LiₓSn_{y}C_{z}, LiₓN_{y}Sn_{z}, LiₓC_{y}N_{z}, LiₓC_{y}H_{z}, LiₓSn_{y}H_{z}, LiₓN_{y}H_{z}, and LiₓSi_{y}H_{z}. In other embodiments, K, Cs, and Na replace Li wherein the catalyst is atomic K, atomic Cs, and molecular NaH.

In another embodiment, the alloy or compound has the formula MₓE_{w}E_{y}E_{z} wherein M is the catalyst such as Li, K, or Cs, or it is Na, E_{w} is a first other element, E_{y} is a second other element, E_{z} is a third other element, and x, w, y, and z designate the stoichiometry. M, E_{y}, E_{y}, and E_{z} may be in any desired molar ratio. In an embodiment, x is in the range of 1 to 50, w is in the range of 1 to 50, y is in the range of 1 to 50, and z is in the range of 1 to 50, and preferably x is in the range of 1 to 10, w is in the range of 1 to 10, y is in the range of 1 to 10, and z is in the range of 1 to 10. In preferred embodiments, E_{w}, E_{y}, and E_{z} are selected from the group of H, N, C, Si, and Sn. The alloy or compound may be at least one of LiₓH_{w}C_{y}Si_{z}, LiₓH_{w}Sn_{y}Si_{z}, LiₓH_{w}N_{y}Si_{z}, LiₓH_{w}Sn_{y}C_{z}, LiₓH_{w}N_{y}Sn_{z}, and LiₓH_{w}C_{y}N_{z}. In other embodiments, K, Cs, and Na replace Li wherein the catalyst is atomic K, atomic Cs, and molecular NaH. Species such as MₓE_{w}E_{y}E_{z} are exemplary and are certainly not meant to be limiting in that other species comprising additional elements are within the scope of the Invention.

In an embodiment, the reaction contains a source of atomic hydrogen and a source of Li catalyst. The reaction contains one or more species from the group of a hydrogen dissociator, H₂, a source of atomic hydrogen, Li, LiH, LiNO₃, LiNH₂, Li₂NH, Li₃N, LiX, NH₃, LiBH₄, LiAlH₄, Li₃AlH₆, NH₃, and NH₄X wherein X is a counterion such halide and those given in the CRC [41]. The weight % of the reactants may be in any desired molar range. The reagents may be well mixed using a ball mill.

In an embodiment, the reaction mixture comprises a source of catalyst and a source of H. In an embodiment, the reaction mixture further comprises reactants which undergo reaction to form Li catalyst and atomic hydrogen. The reactants may comprise one or more of the group of H₂, hydrino catalyst, MNH₂, M₂NH, M₃N, NH₃, LiX, NH₄X (X is a couterion such as a halide), MNO₃, MAlH₄, M₃AlH₆, and MBH₄, wherein M is an alkali metal that may be the catalyst. The reaction mixture may comprise reagents selected from the group of Li, LiH, LiNO₃, LiNO, LiNO₂, Li₃N, Li₂NH, LiNH₂, LiX, NH₃, LiBH₄, LiAlH₄, Li₃AlH₆, LiOH, Li₂S, LiHS, LiFeSi, Li₂CO₃, LiHCO₃, Li₂SO₄, LiHSO₄, Li₃PO₄, Li₂HPO₄, LiH₂PO₄, Li₂MoO₄, LiNbO₃, Li₂B₄O₇ (lithium tetraborate), LiBO₂, Li₂WO₄, LiAlCl₄, LiGaCl₄, Li₂CrO₄, Li₂Cr₂O₇, Li₂TiO₃, LiZrO₃, LiAlO₂, LiCoO₂, LiGaO₂, Li₂GeO₃, LiMn₂O₄, Li₄SiO₄, Li₂SiO₃, LiTaO₃, LiCuCl₄, LiPdCl₄, LiVO₃, LiIO₃, LiFeO₂, LiIO₄, LiClO₄, LiScOₙ, LiTiOₙ, LiVOₙ, LiCrOₙ, LiCr₂Oₙ, LiMn₂Oₙ, LiFeOₙ, LiCoOₙ, LiNiOₙ, LiNi₂On, LiCuOₙ, and LiZnOₙ, where n=1, 2, 3, or 4, an oxyanion, an oxyanion of a strong acid, an oxidant, a molecular oxidant such as V₂O₃, I₂O₅, MnO₂, Re₂O₇, CrO₃, RuO₂, AgO, PdO, PdO₂, PtO, PtO₂, and NH₄X wherein X is a nitrate or other suitable anion given in the CRC [41], and a reductant. In each case, the mixture further comprises hydrogen or a source of hydrogen. In other embodiments, other dissociators are used or one may not be used wherein atomic hydrogen, and, optionally, atomic catalyst, are generated chemically by reaction of the species of the mixture. In a further embodiment, the reactant catalyst may be added to the reaction mixture.

The reaction mixture may further comprise an acid such as H₂SO₃, H₂SO₄, H₂CO₃, HNO₂, HNO₃, HClO₄, H₃PO₃, and H₃PO₄ or a source of an acid such as an anhydrous acid. The latter may comprise at least one of the list of SO₂, SO₃, CO₂, NO₂, N₂O₃, N₂O₅, Cl₂O₇, PO₂, P₂O₃, and P₂O₅.

In an embodiment, the reaction mixture further comprises a reactant catalyst to generate the reactants that serve as a lower-energy-hydrogen catalyst or a source of lower-energy-hydrogen catalyst and atomic hydrogen or a source of atomic hydrogen. Suitable reactant catalysts comprise at one of the group of acids, bases, halide ions, metal ions and free radical sources. The reactant catalyst may be at least one of the group of a weak-base-catalysts such as Li₂SO₄, a weak-acid catalyst such as a solid acid such as LiHSO₄, a metal ion source such as TiCl₃ or AlCl₃ which provide Ti³⁺ and Al³⁺ ions, respectively, a free radical source such a CoX₂ wherein X is a halide such as Cl wherein Co²⁺ may react with O₂ to form the O₂⁻ radical, metals such as Ni, Fe, Co preferably at a concentration of about 1 mol %, a source of X⁻ ion (X is halide) such as Cl⁻ or F⁻ from LiX, a source of free radical initiators/propagators such as peroxides, azo-group compounds, and UV light.

In an embodiment, the reactant mixture to form lower-energy hydrogen comprises a source of hydrogen, a source of catalyst, and at least one of a getter for hydrino and a getter for electrons from the catalyst as it is ionized to resonantly accept energy from atomic hydrogen to form hydrinos having energies given by Eq. (1). The hydrino getter may bind to lower-energy hydrogen to prevent the reverse reaction to ordinary hydrogen. In an embodiment, the reaction mixture comprises a getter for hydrino such as LiX or Li₂X (X is halide or other anion such anions from the CRC [41]). The electron getter may perform at least one of accepting electrons from the catalyst and stabilizing the catalyst-ion intermediate such as a Li²⁺ intermediate to allow the catalysis reaction to occur with fast kinetics. The getter may be an inorganic compound comprising at least one cation and one anion. The cation may be Li⁺. The anion may be a halide or other anion given in the CRC [41] such as one of the group comprising F⁻, Cl⁻, Br⁻, I⁻, NO₃⁻, NO₂⁻, SO₄²⁻, HSO₄⁻, CoO₂⁻, IO₃⁻, IO₄⁻, TiO₃⁻, CrO₄⁻, FeO₂⁻, PO₄³⁻, HPO₄²⁻, H₂PO₄⁻, VO₃⁻, ClO₄⁻ and Cr₂O₇²⁻ and other anions of the reactants. The hydride binder and/or stabalizer may be at least one of the group of LiX (X=halide) and the other compounds comprising the reactants.

In an embodiment of the reaction mixture such as Li, LiNH₂, and X wherein X is the hydride binding compound, X is at least one of LiHBr, LiHI, a hydrino hydride compound, and a lower-energy hydrogen compound. In an embodiment, the catalyst reaction mixture is regenerated by addition of hydrogen from a source of hydrogen.

In an embodiment, the hydrino product may bind to form a stable hydrino hydride compound. The hydride binder may be LiX wherein X is a halide or other anion. The hydride binder may react with a hydride that has an NMR upfield shift greater than that of TMS. The binder may be an alkali halide, and the product of hydride binding may be an alkali hydride halide having an NMR upfield shift greater than that of TMS. The hydride may have a binding energy determined by XPS of 11 to 12 eV. In an embodiment, the product of the catalysis reaction is the hydrogen molecule H₂(1/4) having an solid NMR peak at about 1 ppm relative to TMS and a binding energy of about 250 eV that is trapped in a crystalline ionic lattice. In an embodiment, the product H₂(1/4) is trapped in the crystalline lattice of an ionic compound of the reactor such that the selection rules for infrared absorption are such that the molecule becomes IR active and a FTIR peak is observed at about 1990 cm⁻¹.

Additional sources of atomic Li of the present invention comprise additional alloys of Li such as these comprising Li and at least one of alkali, alkaline earth metals, transitions, metals, rare earth metals, noble metals, tin, aluminum, other Group III and Group IV metal, actinides, and lanthanides. Some representative alloys comprise one or more members of the group of LiBi, LiAg, LiIn, LiMg, LiAl, LiMgSi, LiFeSi, LiZr, LiAlCu, LiAlZr, LiAlMg, LiB, LiCa, LiZn, LiBSi, LiNa, LiCu, LiPt, LiCaNa, LiAlCuMgZr, LiPb, LiCaK, LiV, LiSn, and LiNi. In other embodiments, K, Cs, and Na replace Li wherein the catalyst is atomic K, atomic Cs, and molecular NaH,

In another embodiment, an anion can form a hydrogen-type bond with a Li atom of a covalently bound Li—Li molecule. This hydrogen-type bond can weaken the Li—Li bond to the point that a Li atom is at vacuum energy (equivalent to free a atom) such that it can serve as a catalyst atom to form hydrinos. In other embodiments, K, Cs, and Na replace Li wherein the catalyst is atomic K, atomic Cs, and molecular NaH.

In an embodiment, the function of the hydrogen dissociator is provided by a chemical reaction. Atomic H is generated by the reaction of at least two species of the reaction mixture or by the decomposition of at least one species. In an embodiment, Li—Li reacts with LiNH₂ to form atomic Li, atomic H, and Li₂NH. Atomic Li may also form by the decomposition or reaction of LiNO₃. In other embodiments, K, Cs, and Na replace Li wherein the catalyst is atomic K, atomic Cs, and molecular NaH.

In further embodiments, in addition to a catalyst or source of catalyst to form lower-energy hydrogen, the reaction mixture comprises heterogeneous catalysts to dissociate MM and MH such as LiLi and LiH as to provide M and H atoms. The heterogeneous catalyst may comprise at least one element from the group of transition elements, precious metals, rare earth and other metals and elements such as Mo, W, Ta, Ni, Pt, Pd, Ti, Al, Fe, Ag, Cr, Cu, Zn, Co, and Sn.

In an embodiment of the Li carbon alloy, the reaction mixture comprises an excess of Li over the Li-carbon intercalation limit. The excess may be in the range of 1% and 1000% and preferably in the range of 1% to 10%. The carbon may further comprise a hydrogen spillover catalyst having a hydrogen dissociator such as Pd or Pt on activated carbon. In a further embodiment, the cell temperature exceeds that at which Li is completely intercalated into the carbon. The cell temperature may be in the range of about 100 to 2000° C., preferably in the range of about 200 to 800° C., and most preferably in the range of about 300 to 700° C. In other embodiments, K, Cs, and Na replace Li wherein the catalyst is atomic K, atomic Cs, and molecular NaH.

In an embodiment of the Li silicon alloy, the cell temperature is in the range over which the silicon alloy further comprising H releases atomic hydrogen. The range may be about 50-1500° C., preferably about 100 to 800° C., and most preferably in the range of about 100 to 500° C. The hydrogen pressure may be in range of about 0.01 to 10⁵ Torr, preferably in the range of about 10 to 5000 Torr, and most preferably in the range of about 0.1 to 760 Torr. In other embodiments, K, Cs, and Na replace Li wherein the catalyst is atomic K, atomic Cs, and molecular NaH.

The reaction mixture, alloys, and compounds may be formed by mixing the catalyst such as Li or a source of catalyst such as catalyst hydride with the other element(s) or compound(s) or a source of the other element(s) or compound(s) such as a hydride of the other element(s). The catalyst hydride may be LiH, KH, CsH, or NaH. The reagents may be mixed by ball milling. An alloy of the catalyst may also be formed from a source of alloy comprising the catalyst and at least one other element or compound.

In an embodiment, the reaction mechanism for the Li/N system to form hydrino reactants of atomic Li and H is

LiNH₂+Li-Li to Li+H+Li₂NH (32)

In embodiments of the other Li-alloy systems, the reaction mechanism is analogous to that of the Li/N system with the other alloy element(s) replacing N. Exemplary reaction mechanisms to carryout the reaction to form hydrino reactants, atomic Li and H, involving the reaction mixtures comprising Li with at least one of S, Sn, Si, and C are

SH+Li-Li to Li+H+LiS (33)

SnH+Li-Li to Li+H+LiSn (34)

SiH+Li-Li to Li+H+LiSi, and (35)

CH+Li-Li to Li+H+LiC, (36)

Preferred embodiments of the Li/S alloy-catalyst system comprises Li with Li₂S and Li with LiHS. In other embodiments, K, Cs, and Na replace Li wherein the catalyst is atomic K, atomic Cs, and molecular NaH.

### Primary Li/Nitrogen Alloy Reactions

Lithium in the solid and liquid states is a metal, and the gas comprises covalent Li₂ molecules. In order to generate atomic lithium, the reaction mixture of the solid fuel comprises Li/N alloy reactants. The reaction mixture may comprise at least one of the group of Li, LiH, LiNH₂, Li₂NH, Li₃N, NH₃, a dissociator, a hydrogen source such as H₂ gas or a hydride, a support, and a getter such as LiX (X is a halide). The dissociator is preferably Pt or Pd on a high surface area support inert to Li. It may comprise Pt or Pd on carbon or Pd/Al₂O₃. The latter support may comprise a protective surface coating of a material such as LiAlO₂. Preferred dissociators for a reagent mixture comprising a Li/N alloy or Na/N alloy are Pt or Pd on Al₂O₃, Raney nickel (R-Ni), and Pt or Pd on carbon. In the case that the dissociator support is Al₂O₃, the reactor temperature may be maintained below that which results in its substantial reaction with Li. The temperature may be below the range of about 250° C. to 600° C. In another embodiment, Li is in the form of LiH and the reaction mixture comprises one or more of LiNH₂, Li₂NH, Li₃N, NH₃, a dissociator, a hydrogen source such as H₂ gas or a hydride, a support, and a getter such as LiX (X is a halide) wherein the reaction of LiH with Al₂O₃ is substantially endothermic. In other embodiments, the dissociator may be separate from the balance of the reaction mixture wherein the separator passes H atoms.

Two preferred embodiments comprise the first reaction mixture of LiH, LiNH₂, and Pd on Al₂O₃ powder and a second reaction mixture of Li, Li₃N, and hydrided Pd on Al₂O₃ powder that may further comprise H₂ gas. The first reaction mixture can be regenerated by addition of H₂, and the second mixture can be regenerated by removing H₂ and hydriding the dissociator or by reintroducing H₂. The reactions to generate catalyst and H as well as the regeneration reactions are given infra.

In an embodiment, LiNH₂ is added to the reaction mixture. LiNH₂ generates atomic hydrogen as well as atomic Li according to the reversible reactions

Li₂+LiNH₂→Li+Li₂NH+H (37)

and

Li₂+Li₂NH→Li+Li₃N+H (38)

In an embodiment, the reaction mixture comprises about 2:1 Li and LiNH₂. In the hydrino reaction cycle, Li—Li and LiNH₂ react to form atomic Li, atomic H, and Li₂NH, and the cycle continues according to Eq. (38). The reactants may be present in any wt %

The mechanism of the formation of Li₂NH from LiNH₂ involves a first step that forms ammonia [42]:

2LiNH₂ to Li₂NH+NH₃ (39)

With LiH present, the ammonia reacts to release H₂

LiH+NH₃ to LiNH₂+H₂ (40)

and the net reaction is the consumption of LiNH₂ with the formation of H₂:

LiNH₂+LiH to Li₂NH+H₂ (41)

With Li present, the amide is not consumed due to the energetically much more favorable back reaction of Li with ammonia:

Li-Li+NH₃ to LiNH₂+H+Li (42)

Thus, in an embodiment, the reactants comprise a mixture of Li and LiNH₂ to form atomic Li and atomic H according to Eqs. (37-38).

The reaction mixture of Li and LiNH₂ that serves as a source of Li catalyst and atomic hydrogen may be regenerated. During the regeneration cycle, the reaction product mixture comprising species such as Li, Li₂NH, and Li₃N can be reacted with H to form LiH and LiNH₂. LiH has a melting point of 688° C.; whereas, LiNH₂ melts at 380° C., and Li melts at 180° C. LiNH₂ liquid and any Li liquid that forms can be physically removed from the LiH solid at about 380° C., and then LiH solid can be heated separately to form Li and H₂. The Li and LiNH₂ can be recombined to regenerate the reaction mixture. And, the excess H₂ from LiH thermal decomposition can be reused in the next regeneration cycle with some make-up H₂ to replace any H₂ consumed in hydrino formation.

In a preferred embodiment, the competing kinetics of the hydriding or dehydriding of one reactant over another is exploited to achieve a desired reaction mixture comprising hydrided and non-hydrided compounds. For example, hydrogen can be added under appropriate temperature and pressure conditions such that the reverse of reactions of Eqs. (37) and (38) occur over the competing reaction of the formation of LiH such that the hydrogenated products are predominantly Li and LiNH₂. Alternatively, a reaction mixture comprising compounds of the group of Li, Li₂NH, and Li₃N may be hydrogenated to form the hydrides and the LiH can be selectively dehydrided by pumping at the temperature and pressure ranges and duration which achieves the selectivity based on differential kinetics.

In an embodiment, Li is deposited as a thin film over a large area and a mixture of LiH and LiNH₂ is formed by addition of ammonia. The reaction mixture may further comprise excess Li. Atomic Li and H are formed according to Eqs. (37-38) with the subsequent reaction to form states with energies given by Eq. (1). Then, the mixture can be regenerated by H₂ addition followed by heating and pumping with selective pumping and removal of H₂.

A reversible system of the present invention to generate atomic lithium catalyst is the Li₃N+H system which can be regenerated by pumping. The reaction mixture comprises at least one of Li₃N and a source of Li₃N such as Li and N₂, and a source of H such as at least one of H₂ and a hydrogen dissociator, LiNH₂, Li₂NH, LiH, Li, NH₃, and a metal hydride. The reaction of H₂ with Li₃N gives LiH and Li₂NH; whereas, the reaction of Li₃N and H from an atomic hydrogen source such a H₂ and a dissociator or form a hydride undergoing decomposition gives

Li₃N+H to Li₂NH+Li (43)

The atomic Li catalyst can then react with additional atomic H to form hydrinos. The side products such as LiH, Li₂NH, and LiNH₂ can be converted to Li₃N by evacuating the reaction vessel of H₂. Representative Li/N alloy reactions are as follows:

Li₃N+H→Li₂NH+Li (44)

Li₃N+LiH→Li₂NH+2Li (45)

Li₂NH+LiH→Li₃N+H₂ (46)

Li₂NH+H→LiNH₂+Li (47)

Li₂NH+LiH→LiNH₂+2Li (48)

Li₃N, a source of H, and a hydrogen dissociator are in any desired molar ratio. Each are in molar ratios of greater than 0 and less than 100%. Preferably the molar ratios are similar. In an embodiment, the ratios of Li₃N, at least one of LiNH₂, Li₂NH, LiH, Li, and NH₃, and a H source such as a metal hydride are similar. In other embodiments, K, Cs, and Na replace Li wherein the catalyst is atomic K, atomic Cs, and molecular NaH.

In an embodiment, lithium amide and hydrogen is reacted to form ammonia and lithium:

1/2H₂+LiNH₂→NH₃+Li (49)

The reaction can be driven to form Li by increasing the H₂ concentration. Alternatively, the forward reaction can be driven via the formation of atomic H using a dissociator. The reaction with atomic H is given by

H+LiNH₂→NH₃+Li (50)

In an embodiment of the reaction mixture that comprises one or more compounds that react with a source of Li to form Li catalyst, the reaction mix comprises at least one species from the group of LiNH₂, Li₂NH, Li₃N, Li, LiH, NH₃, H₂ and a dissociator. In an embodiment, Li catalyst is generated from a reaction of LiNH₂ and hydrogen, preferably atomic hydrogen as given in reaction Eq. (50). The ratios of reactants may be any desired amount. Preferably the ratios are about stoichiometric to those of Eqs. (49-50). The reactions to form catalyst are reversible with the addition of a source of H such as H₂ gas to replace that reacted to form hydrinos wherein the catalyst reactions are given by Eqs. (3-5), and lithium amide forms by the reaction of ammonia with Li:

NH₃±Li→LiNH₂+H (51)

In other embodiments, K, Cs, and Na replace Li wherein the catalyst is atomic K, atomic Cs, and molecular NaH. In a preferred embodiment, the reaction mixture comprises a hydrogen dissociator, a source of atomic hydrogen, and Na or K and NH₃. In an embodiment, ammonia reacts with Na or K to form NaNH₂ or KNH₂ that serves as a source of catalyst. Another embodiment comprises a source of K catalyst such as K metal, a hydrogen source such as at least one of NH₃, H_{z}, and a hydride such as a metal hydride, and a dissociator. A preferred hydride is one comprising R-Ni that also may serve as a dissociator. Additionally, a hydrino getter such as KX may be present wherein X is preferably a halide such as Cl, Br, or I. The cell may be run continuously with the replacement of the hydrogen source. The NH₃ may act as a source of atomic K by the reversible formation of KN alloy compounds from K—K such as at least one of amide, imide, or nitride or by formation of KH with the release of atomic K.

In a further embodiment, the reactants comprise the catalyst such as Li and an atomic hydrogen source such H₂ and a dissociator or a hydride such as hydrided R-Ni. H can react with Li—Li to form LiH and Li which can further serve as the catalyst to react with additional H to form hydrinos. Then, Li can be regenerated by evacuating H₂ released from LiH. The plateau temperature at 1 Torr for LiH decomposition is about 560° C. LiH can be decomposed at about 0.5 Torr and about 500° C., below the alloy-formation and sintering temperatures of R-Ni. The molted Li can be separated from R-Ni, the R-Ni may be rehydrided, and Li and hydrided R-Ni can be returned to another reaction cycle.

In an embodiment, Li atoms are vapor deposited on a surface. The surface may support or be a source of H atoms. The surface may comprise at least one of a hydride and hydrogen dissociator. The surface may be R-Ni which may be hydrided. The vapor deposition may be from a reservoir containing a source of Li atoms. The Li source may be controlled by heating. One source that provides Li atoms when heated is Li metal. The surface may be maintained at a low temperature such as room temperature during the vapor deposition. The Li-coated surface may be heated to cause the reaction of Li and H to form H states given by Eq. (1). Other thin-film deposition techniques that are well known in the ART comprise further embodiments of the Invention. Such embodiments comprise physical spray, electro-spray, aerosol, electro-arching, Knudsen cell controlled release, dispenser-cathode injection, plasma-deposition, sputtering, and further coating methods and systems such as melting a fine dispersion of Li, electroplating Li, and chemical deposition of Li. In other embodiments, K, Cs, and Na replace Li wherein the catalyst is atomic K, atomic Cs, and molecular NaH.

In the case of vapor-deposited Li on a hydride surface, regeneration can be achieved by heating with pumping to remove LiH and Li, the hydride can be rehydrided by introducing H₂, and Li atoms can be redeposited onto the regenerated hydride after the cell is evacuated in an embodiment. In other embodiments, K, Cs, and Na replace Li wherein the catalyst is atomic K, atomic Cs, and molecular NaH.

Li and R-Ni are in any desired molar ratio. Each of Li and R-Ni are in molar ratios of greater than 0 and less than 100%. Preferably the molar ratio of Li and R—Ni are similar.

In a preferred embodiment, the competing kinetics of the hydriding or dehydriding of one reactant over another is exploited to achieve a reaction mixture comprising hydrided and non-hydrided compounds. For example, the formation of LiH is thermodynamically favored over the formation of R-Ni hydride. However, the rate of LiH formation at low temperature such as the range of about 25° C.-100° C. is very low; whereas, the formation of R-Ni hydride proceeds at a high rate in this temperature range at modest pressures such as the range of about 100 Torr to 3000 Torr. Thus, the reaction mixture of Li and hydrided R-Ni can be regenerated from LiH R-Ni by pumping at about 400-500° C. to dehydride LiH, cooling the vessel to about 25-100° C., adding hydrogen to preferentially hydride R-Ni for a duration that achieves the desired selectivity, and then removing the excess hydrogen by evacuating the cell. While excess Li is present or is added to be in excess, the R-Ni can be used in repeated cycles by selectively hydriding alone. This can be achieved by adding hydrogen in the temperature and pressure ranges that achieve the selective hydriding of R-Ni and then by removing the excess hydrogen before the vessel is heated to initiate the reactions that form atomic H and atomic Li and the subsequent hydrino reaction. Further hydrides and sources of catalysts can be used in place of Li and R-Ni in this procedure. In a further embodiment, the R-N is hydrided to a great extent in a separate preparation step using elevated temperature and high-pressure hydrogen or by using electrolysis. The electrolysis may be in basic aqueous solution. The base may be a hydroxide. The counter electrode may be nickel. In this case, R-Ni can provide atomic H for a long duration with the appropriate temperature, pressure, and temperature ramp rate.

LiH has a high melting point of 688° C. which may be above that which sinters the dissociator or causes the dissociator metal to form an alloy with the catalyst metal. For example, an alloy of LiNi may form at temperatures in excess of about 550° C. in the case that the dissociator is R-Ni and the catalyst is Li. Thus, in another embodiment, LiH is converted to LiNH₂ that can be removed at its lower melting point such that the reaction mixture can be regenerated. The reaction to form lithium amide from lithium hydride and ammonia is given by

LiH+NH₃→LiNH₂+H₂ (52)

Then, molten LiNH₂ can be recovered at the melting point of 380° C. LiNH₂ may be converted to Li by decomposition.

In an embodiment comprising the recovery of molten LiNH₂, gas pressure is applied to the mixture comprising LiNH₂ to increase the rate of its separation from solid components. A screen separator or semi-permeable membrane may retain the solid components. The gas may be an inert gas such as a noble gas or a decomposition product such as nitrogen to limit the decomposition of LiNH₂. Molten Li can be separated using gas pressure as well. To clean any residue from a dissociator, gas flow can be used. An inert gas such as a noble gas is preferable. In the case that residual Li adheres to the dissociator such as R-Ni, the residue can be removed by washing with a basic solution such as a basic aqueous solution which may also regenerate the R-Ni. Alternatively, the Li may be hydrided and the solids of LiH and R-Ni and any additional solid compounds present may be separated mechanically by methods such as sieving. In another embodiment, the dissociator such as R-Ni and the other reactants may be physically separated but maintained in close proximity to permit diffusion of atomic hydrogen to the balance of reactant mixture. The balance of reaction mixture and dissociator may be placed in open juxtaposed boats, for example. In other embodiments, the reactor further comprises multiple compartments independently containing the dissociator and balance of the reaction mixture. The separator of each compartment allows for atomic hydrogen formed in a dissociator compartment to flow to the balance-of-reaction-mixture compartment while maintaining the chemical separation. The separator may be a metallic screen or semipermeable, inert membrane which may be metallic. The contents may be mechanically mixed during the operation of the reactor. The separated balance of the reaction mixture and its products can be removed and reprocessed outside of the reaction vessel and returned independently of the dissociator, or either may be independently reprocessed within the reactor.

Other embodiments of systems to generate atomic catalyst Li and atomic H involve Li, ammonia, and LiH. Atomic Li catalyst and atomic H can be generated by reaction of Li₂ and NH₃:

Li₂+NH₃ to LiNH₂+Li+H (53)

LiNH₂ is a source of NH₃ by the reaction:

2LiNH₂ to Li₂NH+NH₃ (54)

In a preferred embodiment, the Li is dispersed on a support having a large surface area to react with ammonia. Ammonia can also react with LiH to generate LiNH₂:

LiH+NH₃ to LiNH₂+H₂ (55)

And, H₂ can react with Li₂NH to regenerate LiNH₂:

H₂+Li₂NH to LiNH₂+LiH (56)

In another embodiment, the reactants comprise a mixture of LiNH₂ and a dissociator. The reaction to form atomic lithium is:

LiNH₂+H to Li+NH₃ (57)

The Li can then react with additional H to form hydrino.

Other embodiments of systems to generate atomic catalyst Li and atomic H involve Li and LiBH₄ or NH₄X (X is an anion such as halide). Atomic Li catalyst and atomic H can be generated by reaction of Li₂ and LiBH₄:

Li₂+LiBH₄ to LiBH₃+Li+LiH (58)

NH₄X can generate LiNH₂ and H₂

Li₂+NH₄X to LiX+LiNH₂+H₂ (59)

Then, atomic Li can be generated according to the reaction of Eqs. (32) and (37). In another embodiment, the reaction mechanism for the Li/N system to form hydrino reactants of atomic Li and H is

NH₄X+Li-Li to Li+H+NH₃+LiX (60)

where X is a counterion, preferably a halide.

Atomic Li catalyst can be generated by reaction of Li₂NH or Li₃N with atomic H formed by the dissociation of H₂:

Li₂NH+H to LiNH₂+Li (61)

Li₃N+H to Li₂NH+Li (62)

In a further embodiment, the reaction mixture comprises nitrides of metals in addition to Li such as those of Mg Ca Sr Ba Zn and Th. The reaction mixture may comprise metals that exchange with Li or form mixed-metal compounds with Li. The metals may be from the group of alkali, alkaline earth, and transition metals. The compounds may further comprise N such as amides, imides, and nitrides.

In an embodiment, the catalyst Li is generated chemically by an anion exchange reaction such as a halide (X) exchange reaction. For example, at least one of Li metal and Li—Li molecules are reacted with a halide compound to form atomic Li and LiX. Alternatively, LiX is reacted with a metal M to form atomic Li and MX. In an embodiment, lithium metal is reacted with a lanthanide halide to form Li and the LiX where X is halide. An example is the reaction of CeBr₃ with Li₂ to form Li and LiBr. In other embodiments, K, Cs, and Na replace Li wherein the catalyst is atomic K, atomic Cs, and molecular NaH.

In another embodiment, the reaction mixture further comprises the reactants and products of the Haber process [43]. The products may be NHₓ x=0, 1, 2, 3, 4. These products may react with Li or compounds comprising Li to form atomic Li and atomic H. For example, Li—Li may react with NHₓ to form Li and possibly H:

Li-Li+NH₃ to Li+LiNH₂+H (63)

Li-Li+NH₂ to LiNH₂+Li (64)

Li-Li+NH₂ to Li₂NH+H (65)

In other embodiments, K, Cs, and Na replace Li wherein the catalyst is atomic K, atomic Cs, and molecular NaH.

A mixture of compounds may be used which melts at a lower temperature than that of one or more of compounds individually. Preferably, a eutectic mixture may form that is a molten salt that mixes the reactants such as Li and LiNH₂.

The chemistry of the reaction mixture can change very substantially based on the physical state of the reactants and the presence or absence of a solvent or added solute or alloy species. Objectives of the present invention for changing the physical state are to control the rate of reaction and to alter the thermodynamics to achieve a sustainable lower-energy hydrogen reaction with the addition of H from a source of H. For the Li/N alloy system comprising reactants such as Li and LiNH₂, alkali metals, alkaline earth metals, and their mixtures may serve as the solvent. For example, excess Li can serve as a molten solvent for LiNH₂ to comprise solvated Li and LiNH₂ reactants that will have different kinetics and thermodynamics of reaction relative to those of the solid-state mixture. The former effect, control of the kinetics of the lower-energy hydrogen reaction, can be adjusted by controlling the properties of the solute and solvent such as temperature, concentration, and molar ratios. Following the reaction to generate atomic catalyst and atomic hydrogen, the latter effect can be used to regenerate the initial reactants. This is a route when the products cannot be directly regenerated by hydrogenation.

One embodiment where the regeneration of the reactants is facilitated by a solvent or added solute or alloy species involves lithium metal wherein the hydriding of Li is not to completion so that Li remains a solvent and a reactant. In Li solvent, the following regeneration reaction may occur with the addition of H from a source to form LiH:

LiH+Li₂NH to 2Li+LiNH₂ (66)

For the Li/N alloy system comprising reactants such as Li and LiNH₂, alkali metals, alkaline earth metals, and their mixtures may serve as the solvent. In an embodiment, the solvent is selected such that it can reduce LiH to Li and form an unstable solvent hydride with the release of H. Preferably, the solvent may be one or more of the group of Li (excess), Na, K, Rb, Cs, and Ba that have the ability to reduce Li⁺ and a corresponding hydride having a low thermal stability. In a case that the melting point of the solvent is higher than desired such as in the case of Ba with a high melting point of 727° C., the solvent can be mixed with other solvents such as metals to from a solvent with a lower melting point such as one comprising a eutectic mixture. In an embodiment, one or more alkaline earth metals can be mixed with one or more alkali metals to lower the melting point, add the capability to reduce Li⁺, and decrease the stability of the corresponding solvent hydride.

Another embodiment where the regeneration of the reactants is facilitated by a solvent or added solute or alloy species involves potassium metal. Potassium metal in a mixture of LiH and LiNH₂ may reduce LiH to Li and form KH. Since KH is thermally unstable at intermediate temperatures such as 300° C., it may facilitate the further hydrogenation of Li₂NH to Li and LiNH₂.

Thus, K may catalyze the reaction given by Eq. (66). The reaction steps are

LiH K to Li+KH (67)

KH+Li₂NH to K+Li+LiNH₂ (68)

wherein H is added at the rate at which it is consumed by lower-energy hydrogen production. Alternatively, K catalytically generates Li and H from LiH wherein LiNH₂ is formed directly from hydrogenation of Li₂NH. The reactions steps are

Li₂NH+2H to LiH+LiNH₂ (69)

LiH+K to KH+Li (70)

KH to K+H(g) (71)

In addition to the favorable condition of the instability of the hydride (KH), the amide (KNH₂) is also unstable so that the exchange of lithium amide with potassium amide is not thermodynamically favorable. In addition to K, Na is a preferred metal solvent since it can reduce LiH and has a lower vapor pressure. Other examples of suitable metal solvents are Rb, Cs, Mg. Ca, Sr, Ba, and Sn. The solvent may comprise a mixture of metals such as a mixture of two or more alkaline or alkaline earth metals. Preferable solvents are Li (excess) and Na above 380° C. since Li is miscible in Na above this temperature.

In another embodiment, an alkali or alkaline earth metal serves as a regeneration catalyst according to Eqs. (70-71). In an embodiment, LiNH₂ is first removed from the LiH/LiNH₂ mixture by melting the LiNH₂. Then, the metal M may be added to catalyze the LiH to Li conversion. M can be selectively removed by distillation. Na, K, Rb, and Cs form hydrides that decompose at relatively low temperatures and form amides that thermally decompose; thus, in another embodiment, at least one can serve as a reactant for the catalytic conversion of LiH to Li and H according to the corresponding reaction for K given by Eqs. (67-71). In addition, some alkaline earths such as Sr can form very stable hydrides which can serve to convert LiH to Li by reaction of LiH and an alkaline earth metal to form the stable alkaline earth hydride. By operating at an elevated temperature, hydrogen may be supplied from the alkaline earth hydride via decomposition with the lithium inventory being primarily as Li. The reaction mixture may comprise Li, LiNH₂, X, and a dissociator wherein X may be a lithium compound such as LiH, Li₂NH, Li₃N with a small amount of an alkaline earth metal that forms a stable hydride to generate Li from LiH. The source of hydrogen may be H₂ gas. The operating temperature may be sufficient such that H is available.

In an embodiment, LiNO₃ can serve to generate the LiNH₂ source of Li and H in a set of coupled reactions. Consider an embodiment of the catalysis reaction mixture comprising Li, LiNH₂, and LiNO₃. The reaction of Li and LiNH₂ to Li₃N and release H₂ is

LiNH₂+2Li→H₂+Li₃N (72)

The balanced H₂ reduction reaction of the released H₂ (Eq. (72)) with LiNO₃ to form water and lithium amide is

4H₂+LiNO₃→LiNH₂+3H₂O (73)

Then, reaction Eq. (72) can proceed with the generated LiNH₂ and the balance of Li, and the coupled reactions given by Eqs. (72) and (73) can occur until the Li is completely consumed. The overall reaction is given by

LiNO₃+8Li+3LiNH₂→+3H₂O+4Li₃N (74)

The water may be dynamically removed by methods such as condensation or reacted with a getter to prevent its reaction with species such as Li, LiNH₂, Li₂NH, and Li₃N.

### Exemplary Regeneration of Li Catalyst Reactants

The present invention further comprises methods and systems to generate, or regenerate the reaction mixture to form states given by Eq. (1) from any side products that form during said reaction. For example, in an embodiment of the energy reactor, the catalysis reaction mixture such as Li, LiNH₂, and LiNO₃ is regenerated from any side products such as LiOH and Li₂O by methods known to those skilled in the Art such as given in Cotton and Wilkinson [43]. Components of the reaction mixture including side products may be liquid or solids. The mixture is heated or cooled to a desired temperature, and the products are separated physically by means known by those skilled in the Art. In an embodiment, LiOH and Li₂O are solid, Li, LiNH₂, and LiNO₃ are liquid, and the solid components are separated from the liquid ones. The LiOH and Li₂O may be converted to lithium metal by reduction with H₂ at high temperature or by electrolysis of the molten compounds or a mixture containing them. The electrolysis cell may comprise a eutectic molten salt comprising at least one of LiOH, Li₂O, LiCl, KCl, CaCl₂ and NaCl. The electrolysis cell is comprised of a material resistant to attack by Li such as a BeO or BN vessel. The Li product may be purified by distillation. LiNH₂ is formed by means known in the Art such as reaction of Li with nitrogen followed by hydrogen reduction. Alternatively, LiNH₂ can be formed directly by reaction of Li with NH₃.

In the case that the initial reaction mixture comprises at least one of Li, LiNH₂, and LiNO₃, Li metal may be regenerated by methods such as electrolysis, LiNO₃ can be generated from Li metal. One key step that eliminates the difficult nitrogen fixation step is the reaction of Li metal with N₂ to form Li₃N even at room temperature. Li₃N can be reacted with H₂ to form Li₂NH and LiNH₂. Li₃N can be reacted with an oxygen source to form LiNO₃. In an embodiment, Li₃N is used in the synthesis of lithium nitrate (LiNO₃) involving reactants or intermediates of at least one or more of lithium (Li), lithium nitride (Li₃N), oxygen (O₂), an oxygen source, lithium imide (Li₂NH), and lithium amide (LiNH₂).

In an embodiments, the oxidation reactions are

LiNH₂+2O₂→LiNO₃+H₂O (75)

Li₂NH+2O₂→LiNO₃+LiOH (76)

Li₃N+2O₂→LiNO₃+Li₂O (77)

Lithium nitrate can be regenerated from Li₂O and LiOH using at least one of NO₂, NO, and O₂ by the following reactions

3Li₂O+6NO₂+3/2O₂→6LiNO₃ (78)

Li₂O+3NO₂→2LiNO₃+NO (79)

NO+1/2O₂→NO₂ (80)

LiOH+NO₂+NO→2LiNO₂+H₂O (industrial process) (81)

2LiOH+2NO₂→LiNO₃+LiNO₂+H₂O (82)

Lithium oxide can be converted to lithium hydroxide by reaction with steam:

Li₂O+H₂O→2LiOH (83)

In an embodiment, Li₂O is converted to LiOH followed by reaction with NO₂ and NO according to Eq. (81).

Both lithium oxide and lithium hydroxide can be converted to lithium nitrate by treatment with nitric acid followed by drying:

Li₂O+2HNO₃→2LiNO₃+H₂O (84)

LiOH+HNO₃→LiNO₃+H₂O (85)

LiNO₃ can be made by treatment of lithium oxide or lithium hydroxide with nitric acid. Nitric acid, in tern, can be generated by known industrial methods such as by the Haber process followed by the Ostwald process and then by hydration and oxidation of NO as given in Cotton and Wilkinson [43]. In one embodiment, the exemplary sequence of steps are:

$$\begin{matrix}{N}_{2} {}_{\begin{matrix}Haber \\ process\end{matrix}}^{{H}_{2}} {NH}_{3} {}_{\begin{matrix}Ostwald \\ process\end{matrix}}^{{O}_{2}} NO {}^{{O}_{2} + {H}_{2} O} {HNO}_{3} & ( 86 ) \\ LiOH + {HNO}_{3} \to {LINO}_{3} + {H}_{2} O & ( 87 )\end{matrix}$$

Specifically, the Haber process may be used to produce NH₃ from N₂ and H₂ at elevated temperature and pressure using a catalyst such as α-iron containing some oxide. The ammonia may be used to form LiNH₂ from Li. The Ostwald process may be used to oxidize the ammonia to NO at a catalyst such as a hot platinum or platinum-rhodium catalyst. The NO may be further reacted with oxygen and water to form nitric acid which can be reacted with lithium oxide or lithium hydroxide to form lithium nitrate. The crystalline lithium nitrate reactant is then obtained by drying. In another embodiment, NO and NO₂ are reacted directly with the one or more of lithium oxide and lithium hydroxide to form lithium nitrate. The regenerated Li, LiNH₂, and LiNO₃ are then returned to the reactor in desired molar ratios. In further exemplary regeneration reactions, an embodiment of the reactor comprises the reactants of Li, LiNH₂, and LiCoO₂. LiOH, Li₂O, and Co and its lower oxides are the side products. The reactants can be regenerated by electrolysis of LiOH and Li₂O to Li. LiNH₂ can be regenerated by reaction of Li with NH₃ or N₂ and then H₂. The CoO₂ and its lower oxides can be regenerated by reaction with oxygen. The LiCoO₂ can be formed by reaction of Li with CoO₂. Li, LiNH₂, and LiCoO₂ are then returned to the cell in a batch or continuous regeneration process. In the case that LiIO₃ or LiIO₄ is a reagent of the mixture, IO₃⁻ and or IO₄⁻ may be regenerated by reaction of iodine or iodide ion with base and may further undergo electrolysis to the desired anion which may be precipitated out as LiIO₃ or LiIO₄, dried, and dehydrated.

### NaH Molecular Catalyst

In a further embodiment, a compound comprising hydrogen such as MH where H is hydrogen and M is another element serves as a source of hydrogen and a source of catalyst. In an embodiment, a catalytic system is provided by the breakage of the M-H bond plus the ionization of t electrons from an atom M each to a continuum energy level such that the sum of the bond energy and ionization energies of the t electrons is approximately one of m·27.2 eV and

$$m \cdot \frac{27.2}{2} eV$$

where m is an integer.

One such catalytic system involves sodium. The bond energy of NaH is 1.9245 eV [44]. The first and second ionization energies of Na are 5.13908 eV and 47.2864 eV, respectively [1]. Based on these energies NaH molecule can serve as a catalyst and H source since the bond energy of NaH plus the double ionization (t=2) of Na to Na²⁺, is 54.35 eV (2×27.2 eV) which is equivalent to m=2 in Eq. (2). The catalyst reactions are given by

$$\begin{matrix}54.35 eV + NaH \to {Na}^{2 +} + 2 {e}^{-} + H [ \frac{{a}_{H}}{( 3 )} ] + [ {( 3 )}^{2} - {1}^{2} ] \cdot 13.6 eV & ( 88 ) \\ {Na}^{2 +} + 2 {e}^{-} + H \to NaH + 54.35 eV & ( 89 )\end{matrix}$$

And, the overall reaction is

$$H \to H [ \frac{{a}_{H}}{( 3 )} ] + [ {( 3 )}^{2} - {1}^{2} ] \cdot 13.6 eV \qquad ( 90 )$$

As given in Chp. 5 of Ref [30], and Ref. [20], hydrogen atoms H(1/p) p=1, 2, 3, . . . 137 can undergo further transitions to lower-energy states given by Eq. (1) wherein the transition of one atom is catalyzed by a second that resonantly and nonradiatively accepts m·27.2 eV with a concomitant opposite change in its potential energy. The overall general equation for the transition of H(1/p) to H(1/(p+m)) induced by a resonance transfer of m·27.2 eV to H(1/p′) is represented by

H(1/p′)+H(1/p)→H⁺+e⁻+H(1/(p+m))+[2pm+m²−p′²]·13.6 eV (91)

In the case of high hydrogen concentrations, the transition of H(1/3) (p=3) to H(1/4) (p+m=4) with H as the catalyst (p=1; m=1) can be fast:

$$H ( 1 / 3 ) {}^{H} H ( 1 / 4 ) + 81.6 eV \qquad ( 92 )$$

Due to the stable binding of H⁻(1/4) in halides and its stability to ionization relative to other reaction species, it and the corresponding molecule formed by the reactions 2H(1/4)→H₂(1/4) and H⁻(1/4)+H⁺→H(1/4) are favored products of the catalysis of hydrogen.

The NaH catalyst reaction may be concerted since the sum of the bond energy of NaH, the double ionization (t=2) of Na to Na²⁺, and the potential energy of H is 81.56 eV (3·27.2 eV) which is equivalent to m=3 in Eq. (2). The catalyst reactions are given by

$$\begin{matrix}81.56 eV + NaH + H \to {Na}^{2 +} + 2 {e}^{-} + {H}_{fast}^{+} + {e}^{-} + H [ \frac{{a}_{H}}{( 4 )} ] + [ {( 4 )}^{2} - {1}^{2} ] \cdot 13.6 eV & ( 93 ) \\ {Na}^{2 +} + 2 {e}^{-} + H + {H}_{fast}^{+} + {e}^{-} \to NaH + H + 81.56 eV & ( 94 )\end{matrix}$$

And, the overall reaction is

$$H \to H [ \frac{{a}_{H}}{( 4 )} ] + [ {( 4 )}^{2} - {1}^{2} ] \cdot 13.6 eV \qquad ( 95 )$$

where H_{fast}⁺ is a fast hydrogen atom having at least 13.6 eV of kinetic energy

In an embodiment, the reaction mixture comprises at least one of a source of NaH molecules and hydrogen. The NaH molecules may serve as the catalyst to form H states given by Eq. (1). A source of NaH molecules may comprise at least one of Na metal, a source of hydrogen, preferably atomic hydrogen, and NaH(s). The source of hydrogen may be at least one of H₂ gas and a dissociator and a hydride. Preferably, the dissociator and hydride may be R-Ni. Preferably, the dissociator may also be Pt/Ti, Pt/Al₂O₃, and Pd/Al₂O₃ powder. Solid NaH may be a source of at least one of NaH molecules, H atoms, and Na atoms.

In a preferred embodiment, one of atomic sodium and molecular NaH is provided by a reaction between a metallic, ionic, or molecular form of Na and at least one other compound or element. The source of Na or NaH may be at least one of metallic Na, an inorganic compound comprising Na such as NaOH, and other suitable Na compounds such as NaNH₂, Na₂CO₃, and Na₂O which are given in the CRC [41], NaX (X is a halide), and NaH(s). The other element may be H, a displacing agent, or a reducing agent. The reaction mixture may comprise at least one of (1) a source of sodium such as at least one of Na(m), NaH, NaNH₂, Na₂CO₃, Na₂O, NaOH, NaOH doped-R-Ni, NaX (X is a halide), and NaX doped R-Ni, (2) a source of hydrogen such as H₂ gas and a dissociator and a hydride, (3) a displacing agent such as an alkali or alkaline earth metal, preferably Li, and (4) a reducing agent such as at least one of a metal such as an alkaline metal, alkaline earth metal, a lanthanide, a transition metal such as Ti, aluminum, B, a metal alloy such as AlHg, NaPb, NaAl, LiAl, and a source of a metal alone or in combination with reducing agent such as an alkaline earth halide, a transition metal halide, a lanthanide halide, and aluminum halide. Preferably, the alkali metal reductant is Na. Other suitable reductants comprise metal hydrides such as LiBH₄, NaBH₄, LiAlH₄, or NaAlH₄. Preferably, the reducing agent reacts with NaOH to form a NaH molecules and a Na product such as Na, NaH(s), and Na₂O. The source of NaH may be R-Ni comprising NaOH and a reactant such as a reductant to form NaH catalyst such as an alkali or alkaline earth metal or the Al intermetallic of R-Ni. Further exemplary reagents are an alkaline or alkaline earth metal and an oxidant such as AlX₃, MgX₂, LaX₃, CeX₃, and TiXₙ where X is a halide, preferably Br or I. Additionally, the reaction mixture may comprise another compound comprising a getter or a dispersant such as at least one of Na₂CO₃, Na₃SO₄, and Na₃PO₄ that may be doped into the dissociator such as R-Ni. The reaction mixture may further comprise a support wherein the support may be doped with at least one reactant of the mixture. The support may have preferably a large surface area that favors the production of NaH catalyst from the reaction mixture. The support may comprise at least one of the group of R-Ni, Al, Sn, Al₂O₃ such as gamma, beta, or alpha alumina, sodium aluminate (according to Cotton [45] beta-aluminas have other ions present such as Na⁺ and possess the idealized composition Na₂O·11Al₂O₃), lanthanide oxides such as M₂O₃ (preferably M=La, Sm, Dy, Pr, Tb, Gd, and Er), Si, silica, silicates, zeolites, lanthanides, transition metals, metal alloys such as alkali and alkali earth alloys with Na, rare earth metals, SiO₂—Al₂O₃ or SiO₂ supported Ni, and other supported metals such as at least one of alumina supported platinum, palladium, or ruthenium. The support may have a high surface area and comprise a high-surface-area (HSA) materials such as R-Ni, zeolites, silicates, aluminates, aluminas, alumina nanoparticles, porous Al₂O₃, Pt, Ru, or Pd/Al₂O₃, carbon, Pt or Pd/C, inorganic compounds such as Na₂CO₃, silica and zeolite materials, preferably Y zeolite powder. In an embodiment, the support such as Al₂O₃ (and the Al₂O₃ support of the dissociator if present) reacts with the reductant such as a lanthanide to form a surface-modified support. In an embodiment, the surface Al exchanges with the lanthanide to form a lanthanide-substituted support. This support may be doped with a source of NaH molecules such as NaOH and reacted with a reductant such as a lanthanide. The subsequent reaction of the lanthanide-substituted support with the lanthanide will not significantly change it, and the doped NaOH on the surface can be reduced to NaH catalyst by reaction with the reductant lanthanide.

In an embodiment, wherein the reaction mixture comprises a source of NaH catalyst, the source of NaH may be an alloy of Na and a source of hydrogen. The alloy may comprise at least one of those known in the Art such as an alloy of sodium metal and one or more other alkaline or alkaline earth metals, transition metals, Al, Sn, Bi, Ag, In, Pb, Hg, Si, Zr, B, Pt, Pd, or other metals and the H source may be H₂ or a hydride.

The reagents such as the source of NaH molecules, the source of sodium, the source of NaH, the source of hydrogen, the displacing agent, and the reducing agent are in any desired molar ratio. Each is in a molar ratio of greater than 0 and less than 100%. Preferably, the molar ratios are similar.

A preferred embodiment comprises the reaction mixture of NaH and Pd on Al₂O₃ powder wherein the reaction mixture may be regenerated by addition of H₂.

In an embodiment, Na atoms are vapor deposited on a surface. The surface may support or be a source of H atoms to form NaH molecules. The surface may comprise at least one of a hydride and hydrogen dissociator such as Pt, Ru, or Pd/Al₂O₃ which may be hydrided. Preferably, the surface area is large. The vapor deposition may be from a reservoir containing a source of Na atoms. The Na source may be controlled via heating. One source that provides Na atoms when heated is Na metal. The surface may be maintained at a low temperature such as room temperature during the vapor deposition. The Na-coated surface may be heated to cause the reaction of Na and H to form NaH and may further cause the NaH molecules to react to form H states given by Eq. (1). Other thin-film deposition techniques that are well known in the ART comprise further embodiments of the Invention. Such embodiments comprise physical spray, electro-spray, aerosol, electro-arching, Knudsen cell controlled release, dispenser-cathode injection, plasma-deposition, sputtering, and further coating methods and systems such as melting a fine dispersion of Na, electroplating Na, and chemical deposition of Na. Na metal may be dispersed on a high-surface area material, preferably Na₂CO₃, carbon, silica, alumina, R-Ni, and Pt, Ru, or Pd/Al₂O₃, to increase the activity to form NaH when reacted with another reagent such as H or a source of H. Other dispersion materials are known in the Art such as those given in Cotton et al. [46].

In an embodiment, at least one reactant comprising the reductant or source of NaH such as Na and NaOH undergoes aerosolization to create a corresponding reactant vapor to react to form NaH catalyst. Na and NaOH may react in the cell to form NaH catalyst wherein at least one species undergoes aerosolization. The aerosolized species may be transported into the cell to react to form NaH catalyst. The means to carry the aerosolized species may be a carrier gas. The aerosolization of the reactant may be achieved using a mechanical agitator and a carrier gas such as a noble gas to carry the reactant into the cell to form NaH catalyst. In an embodiment, Na which may serve as a source of NaH and a reductant is aerosolized by becoming charged and electrically dispensed. The reactants such as at least one of Na and NaOH may be aerosolized mechanically in a carrier gas or they may undergo ultrasonic aerosolization. The reactant may be forced through an orifice to form a vapor. Alternatively, the reactant may be heated locally to very high temperature to be vaporized or sublimed to form a vapor. The reactants may further comprise a source of hydrogen. The hydrogen may react with Na to form NaH catalyst. The Na may be in the form of a vapor. The cell may comprise a dissociator to from atomic hydrogen from H₂. Other means of achieving aerosolization that are known to those skilled in the Art are part of the Invention.

In an embodiment, the reaction mixture comprises at least one species of the group comprising Na or a source of Na, NaH or a source of NaH, a metal hydride or source of a metal hydride, a reactant or source of a reactant to form a metal hydride, a hydrogen dissociator, and a source of hydrogen. The reaction mixture may further comprise a support. A reactant to form a metal hydride may comprise a lanthanide, preferably La or Gd. In an embodiment, La may reversibly react with NaH to form LaHₙ (n=1, 2, 3). In an embodiment, the hydride exchange reaction forms NaH catalyst. The reversible general reaction may be given by

NaH+M [symbol] Na+MH (96)

The reaction given by Eq. (96) applies to other MH-type catalysts given in TABLE 2. The reaction may proceed with the formation of hydrogen that may be dissociated to form atomic hydrogen that reacts with Na to form NaH catalyst. The dissociator is preferably at least one of Pt, Pd, or Ru/Al₂O₃ powder, Pt/Ti, and R-Ni. Preferentially, the dissociator support such as Al₂O₃ comprises at least surface La substitution for Al or comprises Pt, Pd, or Ru/M₂O₃ powder wherein M is a lanthanide. The dissociator may be separated from the rest of the reaction mixture wherein the separator passes atomic H.

A preferred embodiment comprises the reaction mixture of NaH, La, and Pd on Al₂O₃ powder wherein the reaction mixture may be regenerated in an embodiment, by adding H₂, separating NaH and lanthanum hydride by sieving, heating lanthanum hydride to form La, and mixing La and NaH. Alternatively, the regeneration involves the steps of separating Na and lanthanum hydride by melting Na and removing the liquid, heating lanthanum hydride to form La, hydriding Na to NaH, and mixing La and NaH. The mixing may be by ball milling.

In an embodiment, a high-surface-area material such as R-Ni is doped with NaX (X=F, Cl, Br, I). The doped R-Ni is reacted with a reagent that will displace the halide to form at least one of Na and NaH. In an embodiment, the reactant is at least an alkali or alkaline earth metal, preferably at least one of K, Rb, Cs. In another embodiment, the reactant is an alkaline or alkaline earth hydride, preferably at least one of KH, RbH, CsH, MgH₂ and CaH₂. The reactant may be both an alkali metal and an alkaline earth hydride. The reversible general reaction may be given by

NaX+MH [symbol] NaH+MX (97)

### NaOH Catalyst Reactions to Form NaH Catalyst

The reaction of NaOH and Na to Na₂O and NaH is

NaOH+2Na→Na₂O+NaH (98)

The exothermic reaction can drive the formation of NaH(g). Thus, Na metal can serve as a reductant to form catalyst NaH(g). Other examples of suitable reductants that have a similar highly exothermic reduction reaction with the NaH source are alkali metals, alkaline earth metals such as at least one of Mg and Ca, metal hydrides such as LiBH₄, NaBH₄, LiAlH₄, or NaAlH₄, B, Al, transition metals such as Ti, lanthanides such as at least one of La, Sm, Dy, Pr, Tb, Gd, and Er, preferably La, Tb, and Sm. Preferably, the reaction mixture comprises a high-surface-area material (HSA material) having a dopant such as NaOH comprising a source of NaH catalyst. Preferably, conversion of the dopant on the material with a high surface area to the catalyst is achieved. The conversion may occur by a reduction reaction. The reductant may be provided as a gas stream. Preferably, Na is flowed into the reactor as a gas stream. In addition to the preferred reductant, Na, other preferred reductants are other alkali metals, Ti, a lanthanide, or Al. Preferably, the reaction mixture comprises NaOH doped into a HSA material preferably R-Ni wherein the reductant is Na or the intermetallic Al. The reaction mixture may further comprise a source of H such as a hydride or H₂ gas and a dissociator. Preferably the H source is hydrided R-Ni.

In an embodiment, the reaction temperature is maintained below that at which the reductant such as a lanthanide forms an alloy with the source of catalyst such as R-Ni. In the case of lanthanum, preferably the reaction temperature does not exceed 532° C. which is the alloy temperature of Ni and La as shown by Gasser and Kefif [47]. Additionally, the reaction temperature is maintained below that at which the reaction with the Al₂O₃ of R-Ni occurs to a significant extent such as in the range of 100° C. to 450° C.

In an embodiment, Na₂O formed as a product of a reaction to generate NaH catalyst such as that given by Eq. (98), is reacted with a source of hydrogen to form NaOH that can further serve as a source of NaH catalyst. In an embodiment, a regenerative reaction of NaOH from Eq. (98) in the presence of atomic hydrogen is

Na₂O+H→NaOH+Na ΔH=−11.6 kJ/mole NaOH (99)

NaH→Na+H(1/3) ΔH=−10,500 kJ/mole H (100)

and

NaH→Na+H(1/4) ΔH=−19,700 kJ/mole H (101)

Thus, a small amount of NaOH and Na with a source of atomic hydrogen or atomic hydrogen serves as a catalytic source of the NaH catalyst, that in turn forms a large yield of hydrinos via multiple cycles of regenerative reactions such as those given by Eqs. (98-101). In an embodiment, from the reaction given by Eq. (102), Al(OH), can serve as a source of NaOH and NaH wherein with Na and H, the reactions given by Eqs. (98-101) proceed to form hydrinos.

3Na+Al(OH)₃→NaOH+NaAlO₂+NaH+1/2H₂ (102)

In an embodiment, the Al of the intermetallic serves as the reductant to form NaH catalyst The balanced reaction is given by

3NaOH+2Al→Al₂O₃+3NaH (103)

This exothermic reaction can drive the formation of NaH(g) to drive the very exothermic reaction given by Eqs. (88-92) wherein the regeneration of NaH occurs from Na in the presence of atomic hydrogen.

Two preferred embodiments comprise the first reaction mixture of Na and R—Ni comprising about 0.5 wt % NaOH wherein Na serves as the reductant and a second reaction mixture of R-Ni comprising about 0.5 wt % NaOH wherein intermetallic Al serves as the reductant. The reaction mixture may be regenerated by adding NaOH and NaH that may serve as an H source and a reductant.

In an embodiment, of the energy reactor, the source of NaH such as NaOH is regenerated by addition of a source of hydrogen such as at least one of a hydride and hydrogen gas and a dissociator. The hydride and dissociator may be hydrided R-Ni. In another embodiment, the source of NaH such as NaOH-doped R-Ni is regenerated by at least one of rehydriding, addition of NaH, and addition of NaOH wherein the addition may be by physical mixing. The mixing may be performed mechanically by means such as by ball milling.

In an embodiment, the reaction mixture further comprises oxide-forming reactants that react with NaOH or Na₂O to form a very stable oxide and NaH. Such reactants comprises a cerium, magnesium, lanthanide, titanium, or aluminum or their compounds such as AlX₃, MgX₂, LaX₃, CeX₃, and TiXₙ where X is a halide, preferably Br or I and a reducing compound such as an alkali or alkaline earth metal. In an embodiment, the source of NaH catalyst comprises R-Ni comprising a sodium compound such as NaOH on its surface. Then, the reaction of NaOH with the oxide-forming reactants such as AlX₃, MgX₂, LaX₃, CeX₃, and TiXₙ, and alkali metal M forms NaH, MX, and Al₂O₃, MgO, La₂O₃, Ce₂O₃, and Ti₂O₃, respectively.

In an embodiment, the reaction mixture comprises NaOH doped R-Ni and an alkaline or alkaline earth metal added to form at least one of Na and NaH molecules. The Na may further react with H from a source such as H₂ gas or a hydride such as R-Ni to form NaH catalyst. The subsequent catalysis reaction of NaH forms H states given by Eq. (1). The addition of an alkali or alkaline earth metal M may reduce Na⁺ to Na by the reactions:

NaOH+M to MOH+Na (104)

2NaOH+M to M(OH)₂+2Na (105)

M may also react with NaOH to form H as well as Na

2NaOH+M to Na₂O+H₂+MO (106)

Na₂O+M to M₂O+2Na (107)

Then, the catalyst NaH may be formed by the reaction

Na+H to NaH (108)

by reacting with H from reactions such as that given by Eq. (106) as well as from R—Ni and any added source of H. Na is a preferred reductant since it is a further source of NaH.

Hydrogen may be added to reduce NaOH and form NaH catalyst:

NaOH+H₂ to NaH+H₂O (109)

The H in R-Ni may reduce NaOH to Na metal, and water that may be removed by pumping.
In an embodiment, the reaction mixture comprises one or more compounds that react with a source of NaH to form NaH catalyst. The source may be NaOH. The compounds may comprise at least one of a LiNH₂, Li₂NH, and Li₃N. The reaction mixture may further comprise a source of hydrogen such as H₂. In embodiments, the reaction of sodium hydroxide and lithium amide to form NaH and lithium hydroxide is

NaOH+LiNH₂→LiOH+NaH+1/2N₂+LiH (110)

The reaction of sodium hydroxide and lithium imide to form NaH and lithium hydroxide is

NaOH+Li₂NH→Li₂O+NaH+1/2N₂+1/2H₂ (111)

And, the reaction of sodium hydroxide and lithium nitride to form NaH and lithium oxide is

NaOH+Li₃N→Li₂O+NaH+1/2N₂+Li (112)

### Alkaline Earth Hydroxide Catalyst Reactions to Form NaH Catalyst

In an embodiment, a source of H is provided to a source of Na to form the catalyst NaH. The Na source may be the metal. The source of H may be a hydroxide. The hydroxide may be at least one of alkali, alkaline earth hydroxide, a transition metal hydroxide, and Al(OH)₃. In an embodiment, Na reacts with a hydroxide to form the corresponding oxide and NaH catalyst. In an embodiment wherein the hydroxide is Mg(OH)₂, the product is MgO. In an embodiment wherein the hydroxide is Ca(OH)₂, the product is CaO. Alkaline earth oxides may be reacted with water to regenerate the hydroxide as given in Cotton [48]. The hydroxide can be collected as a precipitate by means such as filtration and centrifugation.

For example, in an embodiment, the reaction to form NaH catalyst and regeneration cycle for Mg(OH)₂, are given by the reactions:

3Na+Mg(OH)₂→2NaH+MgO+Na₂O (113)

MgO+H₂O→Mg(OH)₂ (114)

In an embodiment, the reaction to form NaH catalyst and regeneration cycle for Ca(OH)₂, are given by the reactions:

4Na+Ca(OH)₂→2NaH+CaO+Na₂O (115)

CaO+H₂O→Ca (116)

### Na/N Alloy Reactions to Form NaH Catalyst

Sodium in the solid and liquid states is a metal, and the gas comprises covalent Na₂ molecules. In order to generate NaH catalyst, the reaction mixture of the solid fuel comprises Na/N alloy reactants. In an embodiment, the reaction mixture, solid-fuel reactions, and regeneration reactions comprise those of the Li/N system wherein Na replaces Li and the catalyst is molecular NaH except that the solid fuel reaction generates molecular NaH rather than atomic Li and H. In an embodiment, the reaction mixture comprises one or more compounds that react with a source of NaH to form NaH catalyst. The reaction mixture may comprise at least one of the group of Na, NaH, NaNH₂, Na₂NH, Na₃N, NH₃, a dissociator, a hydrogen source such as H₂ gas or a hydride, a support, and a getter such as NaX (X is a halide). The dissociator is preferably Pt, Ru, or Pd/Al₂O₃ powder. For high-temperature operation, the dissociator may comprise Pt or Pd on a high surface area support suitably inert to Na. The dissociator may be Pt or Pd on carbon or Pd/Al₂O₃. The latter support may comprise a protective surface coating of a material such as NaAlO₂. The reactants may be present in any wt %.

A preferred embodiment comprises the reaction mixture of Na or NaH, NaNH₂, and Pd on Al₂O₃ powder wherein the reaction mixture may be regenerated by addition of H₂.

In an embodiment, NaNH₂ is added to the reaction mixture. NaNH₂ generates NaH according to the reversible reactions

Na₂+NaNH₂→NaH+Na₂NH (117)

and

2NaH+NaNH₂→NaH(g)+Na₂NH+H₂ (118)

In the hydrino reaction cycle, Na—Na and NaNH₂ react to form NaH molecule and Na₂NH, and the NaH forms hydrino and Na. Thus, the reaction is reversible according to the reactions:

Na₂NH+H₂→NaNH₂+NaH (119)

and

Na₂NH+Na+H→NaNH₂+Na₂ (120)

In an embodiment, NaH of Eq. (119) is molecular such that this reaction is another to generate the catalyst.

The reaction of sodium amide and hydrogen to form ammonia and sodium hydride is

H₂+NaNH₂→NH₃+NaH (121)

In an embodiment, this reaction is reversible. The reaction can be driven to form NaH by increasing the H₂ concentration. Alternatively, the forward reaction can be driven via the formation of atomic H using a dissociator. The reaction is given by

2H+NaNH₂→NH₃+NaH (122)

The exothermic reaction can drive the formation of NaH(g).

In an embodiment, NaH catalyst is generated from a reaction of NaNH₂ and hydrogen, preferably atomic hydrogen as given in reaction Eqs. (121-122). The ratios of reactants may be any desired amount. Preferably the ratios are about stoichiometric to those of Eqs. (121-122). The reactions to form catalyst are reversible with the addition of a source of H such as H₂ gas or a hydride to replace that reacted to form hydrinos wherein the catalyst reactions are given by Eqs. (88-95), and sodium amide forms with additional NaH catalyst by the reaction of ammonia with Na:

NH₃+Na₂→NaNH₂+NaH (123)

In an embodiment, a HSA material is doped with NaNH₂. The doped HSA material is reacted with a reagent that will displace the amide group to form at least one of Na and NaH. In an embodiment, the reactant is an alkali or alkaline earth metal, preferably Li. In another embodiment, the reactant is an alkaline or alkaline earth hydride, preferably LiH. The reactant may be both an alkali metal and an alkaline earth hydride. A source of H such as H₂ gas may be further provided in addition to that provided by any other reagent of the reaction mixture such as a hydride, HSA material, and displacing reagent.

In an embodiment, sodium amide undergoes reaction with lithium to form lithium amide, imide, or nitride and Na or NaH catalyst. The reaction of sodium amide and lithium to form lithium imide and NaH is

2Li+NaNH₂→Li₂NH+ (124)

The reaction of sodium amide and lithium hydride to form lithium amide and NaH is

LiH+NaNH₂→LiNH₂+NaH (125)

The reaction of sodium amide, lithium, and hydrogen to form lithium amide and NaH is

Li+1/2H₂+NaNH₂→LiNH₂+NaH (126)

In an embodiment, the reaction of the mixture forms Na, and the reactants further comprise a source of H that reacts with Na to form catalyst NaH by a reaction such as the following:

Li+NaNH₂ to LiNH₂+Na (127)

and

Na+H to NaH (128)

LiH+NaNH₂ to LiNH₂+NaH (129)

In an embodiment, the reactants comprise NaNH₂, a reactant to displace the amide group of NaNH₂ such as an alkali or alkaline earth metal, preferably Li, and may additionally comprise a source of H such as at least one of MH (M=Li, Na, K, Rb, Cs, Mg, Ca, Sr, and Ba), H₂ and a hydrogen dissociator, and a hydride.

The reagents of the reaction mixture such as M, MH, NaH, NaNH₂, HSA material, hydride, and the dissociator are in any desired molar ratio. Each of M, MH, NaNH₂, and the dissociator are in molar ratios of greater than 0 and less than 100%, preferably the molar ratios are similar.

Other embodiments of systems to generate molecular catalyst NaH involve Na and NaBH₄ or NH₄X (X is an anion such as halide). Molecular NaH catalyst can be generated by reaction of Na₂ and NaBH₄:

Na₂+NaBH₄ to NaBH₃+Na+NaH (130)

NH₄X can generate NaNH₂ and H₂

Na₂+NH₄X to NaX+NaNH₂+H₂ (131)

Then, NaH catalyst can be generated according to the reaction of Eqs. (117-129). In another embodiment, the reaction mechanism for the Na/N system to form hydrino catalyst NaH is

NH₄X+Na-Na to NaH+NH₃+NaX (132)

### Preparation and Regeneration of NH Catalyst Reactants

In an embodiment NaH molecules or Na and hydrided R-Ni can be regenerated by systems and methods after those disclosed for the Li-based reactant systems. In an embodiment, Na can be regenerated from solid NaH by evacuating H₂ released from NaH. The plateau temperature at about 1 Torr for NaH decomposition is about 500° C. NaH can be decomposed at about 1 Torr and 500° C., below the alloy-formation and sintering temperatures of R-Ni. The molten Na can be separated from R-Ni, the R-Ni may be rehydrided, and Na and hydrided R-Ni can be returned to another reaction cycle. In the case of vapor-deposited Na on a hydride surface, regeneration can be achieved by heating with pumping to remove Na, the hydride can be rehydrided by introducing H₂, and Na atoms can be redeposited onto the regenerated hydride after the cell is evacuated in an embodiment.

In a preferred embodiment, the competing kinetics of the hydriding or dehydriding of one reactant over another is exploited to achieve a reaction mixture comprising hydrided and non-hydrided compounds. For example, the formation of NaH solid is thermodynamically favored over the formation of R-Ni hydride. However, the rate of NaH formation at low temperature such as the range of about 25° C.-100° C. is low; whereas, the formation of R-Ni hydride proceeds at a high rate in this temperature range at modest pressures such as the range of about 100 Torr to 3000 Torr. Thus, the reaction mixture of Na and hydrided R-Ni can be regenerated from NaH solid and R-Ni by pumping at about 400-500° C. to dehydride NaH, cooling the vessel to about 25-100° C., adding hydrogen to preferentially hydride R-Ni for a duration that achieves the desired selectivity, and then removing the excess hydrogen by evacuating the cell. While excess Na is present or is added to be in excess, the R-Ni can be used in repeated cycles by selectively hydriding alone. This can be achieved by adding hydrogen in the temperature and pressure ranges that achieve the selective hydriding of R-Ni and then by removing the excess hydrogen before the vessel is heated to initiate the reactions that form atomic H and molecular NaH and the subsequent reaction to yield H states given by Eq. (1). Alternatively, a reaction mixture comprising Na and a hydrogen source such as R-Ni may be hydrogenated to form the hydrides, and the NaH solid can be selectively dehydrided by pumping at the temperature and pressure ranges and durations which achieve the selectivity based on differential kinetics.

In an embodiment having powder reactants such as a powder source of catalyst and a reductant, the reductant powder is mixed with the catalyst-source powder. For example, NaOH-doped R-Ni that provides NaH catalyst is mixed with a metal or metal hydride powder such as a lanthanide or NaH, respectively. In an embodiment of the reaction mixture having a solid material such as a dissociator, support, or HSA material that is doped or coated with at least one other species of the reaction mixture, the mixing may be achieved by ball milling or the method of incipient wetness. In an embodiment, the surface may be coated by immersing the surface into a solution of the species such as NaOH or NaX (X is a counter anion such as halide) followed by drying. Alternatively, NaOH may be incorporated into Ni/Al alloy or R-Ni by etching with concentrated NaOH(deoxygenated) using the same procedure as used to etch R-Ni as is well known in the Art [49]. In an embodiment, the HSA material such as R-Ni doped with a species such as NaOH is reacted with a reductant such as Na to form NaH catalyst that reacts to form hydrinos. Then, the excess reductant such as Na may be removed from the products by evaporation, preferably, under vacuum at elevated temperature. The reductant may be condensed to be recycled. In another embodiment, at least one of the reductant and a product species is removed by using a transporting medium such as a gas or liquid such as a solvent, and the removed species is isolated from the transporting medium. The species can be isolated by means well known in the Art such as precipitation, filtration, or centrifugation. The species may be recycled directly or further reacted to a chemical form suitable for recycling. In addition, the NaOH may be regenerated by H reduction or by reaction with a water-vapor gas stream. In the former case, excess Na may be removed by evaporation, preferably, under vacuum at elevated temperature. Alternatively, the reaction products can be removed by rinsing with a suitable solvent such as water, the HSA material may be dried, and the initial reactants may be added. Separately, the products may be regenerated to the original reactants by methods known to those skilled in the Art. Or, a reaction product such as NaOH separated by rinsing R-Ni can be used in the process of etching R-Ni to regenerate it. In an embodiment comprising a reactant that reacts with the HSA material, the product such as an oxide may be treated with a solvent such as dilute acid to remove the product. The HSA material may then be re-doped and reused while the removed product may be regenerated by known methods.

The reductant such as an alkali metal can be regenerated from the product comprising a corresponding compound, preferably NaOH or Na₂O, using methods and systems known to those skilled in the Art as given in Cotton [48]. One method comprises electrolysis in a mixture such as a eutectic mixture. In a further embodiment, the reductant product may comprise at least some oxide such as a lanthanide metal oxide (e.g. La₂O₃). The hydroxide or oxide may be dissolved in a weak acid such as hydrochloric acid to form the corresponding salt such as NaCl or LaCl₃. The treatment with acid may be a gas phase reaction. The gases may be streaming at low pressure. The salt may be treated with a product reductant such as an alkali or alkaline earth metal to form the original reductant. In an embodiment, the second reductant is an alkaline earth metal, preferably Ca wherein NaCl or LaCl₃ is reduced to Na or La metal. Methods known to those skilled in the Art are given in Cotton [48] which is herein incorporated by reference in its entirety. The additional product of CaCl₃ is recovered and recycled as well. In alternative embodiment, the oxide is reduced with H₂ at high temperature.

In an embodiment wherein NaAlH₄ is the reductant, the product comprises Na and Al that need not be separated from the R-Ni product. The R-Ni is regenerated as a source of catalyst without separation. Regeneration may be by the addition of NaOH. The NaOH may partially etch Al of R-Ni [49] which is dried [50] for reuse. Alternatively, Na and Al are reacted insitu or separated from the reaction product mixture and reacted with H₂ to form NaAlH₄ directly as given by Cotton [51] or by reaction of the recovered NaH with Al to form NaAlH₄.

R-Ni is a preferred HSA material having NaOH as a source of NaH catalyst. In an embodiment, the Na content from the manufacturer is in the range of about 0.01 mg to 100 mg per gram of R-Ni, preferably in the range of about 0.1 mg to 10 mg per gram of R-Ni, and most preferably in the range of about 1 mg to 10 mg Na per gram of R-Ni. The R-Ni or an alloy of Ni may further comprise promoters such as at least one of Zn, Mo, Fe, and Cr. The R-Ni or alloy may be at least one of W. R. Grace Davidson Raney 2400, Raney 2800, Raney 2813, Raney 3201, and Raney 4200, preferably 2400, or etched or Na-doped embodiments of these materials. The NaOH content of the R-Ni may be increased by a factor in the range of about 1.01 to 1000 times. Solid NaOH may added by mixing by means such as ball milling, or it may be dissolved in a solution to achieve a desired concentration or pH. The solution may be added to R-Ni and the water evaporated to achieve the doping. The doping may be in the range of about 0.1 μg to 100 mg per gram of R-Ni, preferably in the range of about 1 μg to 100 μg per gram of R-Ni, and most preferably in the range of about 5 μg to 50 μg per gram of R-Ni. In an embodiment, 0.1 g of NaOH is dissolved in 100 ml of distilled water and 10 ml of the NaOH solution is added to 500 g of non-decanted R-Ni from W. R. Grace Chemical Company such lot #2800/05310 having an initial total content of Na of about 0.1 wt %. The mixture is then dried. The drying may be achieved by heating at 50° C. under vacuum for 65 hours. In another embodiment, the doping may be achieved by ball milling NaOH with the R-Ni such as about 1 to 10 mg of NaOH per gram of R-Ni.

The R-Ni may be dried dry according to the standard R-Ni drying procedure [50]. The R-Ni may be decanted and dried in the temperature range of about 10-500° C. under vacuum, preferably, it is dried at 50° C. The duration may be in the range of about 1 hr to 200 hours, preferably, the duration is about 65 hours. In an embodiment, the H content of the dried R-Ni is in the range of about 1 ml-100 ml H/g R-Ni, preferably the H content of the dried R-Ni is in the range of about 10-50 ml H/g R-Ni (where ml gas are at STP). The drying temperature, time, vacuum pressure and flow of gases, if any, such as He, Ar, or H₂ during and after drying is controlled to achieve dryness and the desired H content.

In an embodiment of the R-Ni doped with a source of NaH catalyst such as NaOH, the preparation of R-Ni from Ni/Al alloy comprises the step of etching the alloy with aqueous NaOH solution. The concentration of NaOH, etching times, and rinsing exchanges, may be varied to achieve the desired level of incorporation of NaOH. In an embodiment, the NaOH solution is oxygen free. The molarity is in the range of about 1 to 10 M, preferably in the range of about 5 to 8 M, and most preferably about 7 M. In an embodiment, the alloy is reacted with the NaOH for about 2 hours at about 50° C. The solution is then diluted with water such as deionized water until Al(OH)₃ precipitate forms. In that case, the amphoteric reaction of NaOH with Al(OH)₃ to form water-soluble Na[Al(OH)₄] is at least partially prevented such that NaOH is incorporated into the R-Ni. The incorporation may be achieved by drying the R-Ni without decanting. The pH of the diluted solution may be in the range of 8 to 14, preferably in the range of 9 to 12, and most preferably about 10-11. Argon may be bubbled through the solution for about 12 hours, and then the solution may be dried.

Following the reaction of the reductant and source of catalyst to form hydrino (H with states given by Eq. (1)), the reductant and catalyst source are regenerated. In an embodiment, the reaction products are separated. The reductant product may be separated from the product of the source of catalyst. In an embodiment wherein at least one of the reductant and source of catalyst are powders, the products are separated mechanically based on at least one of particle size, shape, weight, density, magnetism, or dielectric constant. Particles having a significant difference in size and shape can be mechanically separated using sieves. Particles with large differences in density can be separated by buoyancy differences. Particles having large differences in magnetic susceptibility can be separated magnetically. Particles with large differences in dielectric constant can be separated electrostatically. In an embodiment, the products are ground to reverse any sintering. The grinding may be with a ball mill.

Methods known by those skilled in the Art that can be applied to the separations of the present Invention by application of routine experimentation. In general, mechanical separations can be divided into four groups: sedimentation, centrifugal separation, filtration, and sieving as described in Earle [52] which is incorporated herein in its entirety by reference. In a preferred embodiment, the separation of the particles is achieved by at least one of sieving and use of classifiers. The size and shape of the particle may be selected in the starting materials to achieve the desired separation of the products.

In a further embodiment, the reductant is a powder or is converted to a powder and mechanically separated from the other components of the product reaction mixture such as a HSA material. In embodiments, Na, NaH, and a lanthanide comprise at least one of the reductant and a source of the reductant, and a HSA material component is R-Ni. The reductant product may be separated from the product mixture by converting any unreacted non-powder reductant metal to the hydride. The hydride may be formed by the addition of hydrogen. The metal hydride may be ground to form a powder. The powder may then be separated from the other products such as that of the source of the catalyst based on a difference in the size of the particles. The separation may be by agitating the mixture over a series of sieves that are selective for certain size ranges to cause the separation. Alternatively, or in combination with sieving, the R-Ni particles are separated from the metal hydride or metal particles based on the large magnetic susceptibility difference between the particles. The reduced R-Ni product may be magnetic. The unreacted lanthanide metal and hydrided metal and any oxide such as La₂O₃ are weakly paramagnetic and diamagnetic, respectively. The product mixture may be agitated over a series of strong magnets alone or in combination with one or more sieves to cause the separation based on at least one of the stronger adherence or attraction of the R-Ni product particles to the magnet and a size difference of the two classes of particles. In an embodiment of the use of sieves and an applied magnetic field, the latter adds an additional force to that of gravity to draw the smaller R-Ni product particles through the sieve while the weakly paramagnetic or diamagnetic particles of the reductant product are retained on the sieve due to their larger size. The alkali metal may be recovered from the corresponding hydride by heating and optionally by applying vacuum. The evolved hydrogen can be reacted with alkali metal in another batch of a repetitive reaction-regeneration cycle. There may be more than one batch in the cycle at various stages. The hydride and any other compound(s) may be separated, and then reacted to form the metal separately from the formation of the metal from the hydride.

In an embodiment, the reaction mixture is regenerated by vapor deposition techniques, preferably in the case that the reactants are on the surface of a HSA material such as R-Ni. In further embodiments, having other coated desired reactants comprising at least one of a source of NaH catalyst on a surface and a material that supports the formation of NaH catalyst such as a HSA material, the reactants are provided by reacting gas streams with the HSA material such as R-Ni. The deposited reactants may comprise at least one of the group of Na, NaH, Na₂O, NaOH, Al, Ni, NiO, NaAl(OH)₄, β-alumina, Na₂O.nAl₂O₃ (n=integer from 1 to 1000, preferably 11), Al(OH)₃, and Al₂O₃ in alpha, beta, and gamma forms. Vapor-deposited elements, compounds, intermediates, and species that are the desired reactants or are converted into the desired reactants as well as the sequence and composition of the gas streams and the chemistry to form the reactants from the gas streams are well by those skilled in the Art of vapor deposition. For example, alkali metals can be directly vapor deposited and any metals with low vapor pressure such as Al can be vapor deposited from the gaseous halide or hydride. Furthermore, oxide products such as Na₂O may be reacted with a source of hydrogen to form the hydroxide such as NaOH. The source of hydrogen may comprise a water-vapor gas stream to regenerate NaOH. Alternatively, the NaOH can be formed using H₂ or a source of H₂. In addition, the hydriding of the HSA material such as R-Ni can be achieved by supplying hydrogen gas, and removing excess hydrogen by means such as pumping. The NaOH may be regenerated stoichiometrically by precisely controlling the total moles of reacted H from a source such as water vapor or hydrogen gas. Any additional Na or NaH formed at this stage may be removed by evaporation, and decomposition and evaporation, respectively. Alternative, an oxide or hydroxide product such as Na₂O or excess NaOH can be removed. This can be achieved by conversion to a halide such as NaI which may be removed by distillation or vaporization. The vaporization can be achieved with heating and by maintaining a vacuum at elevated temperature. The conversion to a halide may be achieved by reaction with an acid such as HI. The treatment may be by a gas stream comprising the acid gas. In another embodiment, any excess NaOH is removed by sublimation. This occurs under vacuum in the temperature range of 350−400° C. as given by Cotton [53]. Any evaporation, distillation, transport, gas-stream process, or related processes of the reactants may further comprise a carrier gas. The carrier gas may be an inert gas such as a noble gas. Further steps may comprise mechanical mixing or separation. For example, NaOH and NaH can be also be deposited or removed mechanically by methods such as ball milling and sieving, respectively.

In the case that the redundant is an element other than a desired first element such as Na, the other element may be replaced by a second such as Na using methods known in the Art. A step may comprise evaporation of excess reductant. The large surface-area material such as R-Ni may be etched. The etching may be with a base, preferably NaOH. The etched product may be decanted with substantially all of any solvent such as water removed mechanically such as by decanting and possibly centrifugation. The etched R-Ni may be dried under vacuum and recycled.

### Additional MH-Type Catalysts and Reactions

Another catalytic system of the type MH involves aluminum. The bond energy of AlH is 2.98 eV [44]. The first and second ionization energies of Al are 5.985768 eV and 18.82855 eV, respectively [1]. Based on these energies AlH molecule can serve as a catalyst and H source since the bond energy of AlH plus the double ionization (t=2) of Al to Al²⁺, is 27.79 eV (27.2 eV) which is equivalent to in =1 in Eq. (2). The catalyst reactions are given by

$$\begin{matrix}27.79 eV + AlH \to {Al}^{2 +} + 2 {e}^{-} + H [ \frac{{a}_{H}}{( 2 )} ] + [ {( 2 )}^{2} - {1}^{2} ] \cdot 13.6 eV & ( 133 ) \\ {Al}^{2 +} + 2 {e}^{-} + H \to AlH + 27.79 eV & ( 134 )\end{matrix}$$

And, the overall reaction is

$$H \to H [ \frac{{a}_{H}}{( 2 )} ] + [ {( 2 )}^{2} - {1}^{2} ] \cdot 13.6 eV \qquad ( 135 )$$

In an embodiment, the reaction mixture comprises at least one of AlH molecules and a source of AlH molecules. A source of AlH molecules may comprise Al metal and a source of hydrogen, preferably atomic hydrogen. The source of hydrogen may be a hydride, preferably R-Ni. In another embodiment, the catalyst AlH is generated by the reaction of an oxide or hydroxide of Al with a reductant. The reductant comprises at least one of the NaOH reductants given previously. In an embodiment, a source of H is provided to a source of Al to form the catalyst AlH. The Al source may be the metal. The source of H may be a hydroxide. The hydroxide may be at least one of alkali, alkaline earth hydroxide, a transition metal hydroxide, and Al(OH)₃.

Raney nickel can be prepared by the following two reaction steps:

$$\begin{matrix} Ni + 3 Al \to {NiAl}_{3} ( or {Ni}_{2} {Al}_{3} ) & ( 136 ) \\ {NiAl}_{3} + 2 NaOH + 6 {H}_{2} O \to ( \begin{matrix}{NiAl}_{x} ( skeleton , porous Ni ) + \\ 2 Na [ {Al ( OH )}_{4} ] + 3 {H}_{2}\end{matrix} ) & ( 137 )\end{matrix}$$

Na[Al(OH)₄] is readily dissolved in concentrated NaOH. It can be washed in de-oxygenated water. The prepared Ni contains Al (˜10 wt %, that may vary), is porous, and has a large surface area. It contains large amounts of H, both in the Ni lattice and in the form of Ni—AlHₓ (x=1, 2, 3).

R-Ni may be reacted with another element to cause the chemical release of AlH molecules which then undergo catalysis according to reactions given by Eqs. (133-135). In an embodiment, the AlH release is caused by a reduction reaction, etching, or alloy formation. One such other element M is an alkali or alkaline earth metal which reacts with the Ni portion of R-Ni to cause the AlHₓ component to release AlH molecules that subsequently under go catalysis. In an embodiment, M may react with Al hydroxides or oxides to form Al metal that may further react with H to form AlH. The reaction can be initiated by heating, and the rate may be controlled by controlling the temperature. M (alkali or alkaline earth metal) and R-Ni are in any desired molar ratio. Each of M and R-Ni are in molar ratios of greater than 0 and less than 100%. Preferably the molar ratio of M and R-Ni are similar.

In an embodiment, Al atoms are vapor deposited on a surface. The surface may support or be a source of H atoms to form AlH molecules. The surface may comprise at least one of a hydride and hydrogen dissociator. The surface may be R-Ni which may be hydrided. The vapor deposition may be from a reservoir containing a source of Al atoms. The Al source may be controlled by heating. One source that provides Al atoms when heated is Al metal. The surface may be maintained at a low temperature such as room temperature during the vapor deposition. The Al-coated surface may be heated to cause the reaction of Al and H to form AlH and may further cause the AlH molecules to react to form H states given by Eq. (1). Other thin-film deposition techniques that are well known in the ART to form layers of at least one of Al and other elements such as metals comprise further embodiments of the Invention. Such embodiments comprise physical spray, electro-spray, aerosol, electro-arching, Knudsen cell controlled release, dispenser-cathode injection, plasma-deposition, sputtering, and further coating methods and systems such as melting a fine dispersion of Al, electroplating Al, and chemical deposition of Al.

In an embodiment, the source of AlH comprises R-Ni and other Raney metals or alloys of Al known in the Art such as R-Ni or an alloy comprising at least one of Ni, Cu, Si, Fe, Ru, Co, Pd, Pt, and other elements and compounds. The R-Ni or alloy may further comprise promoters such as at least one of Zn, Mo, Fe, and Cr. The R-Ni may be at least one of W. R. Grace Raney 2400, Raney 2800, Raney 2813, Raney 3201, Raney 4200, or an etched or Na doped embodiment of these materials. In another embodiment of the AlH catalyst system, the source of catalyst comprises a Ni/Al alloy wherein the Al to Ni ratio is in the range of about 10-90%, preferably about 10-50%, and more preferably about 10-30%. The source of catalyst may comprise palladium or platinum and further comprise Al as a Raney metal.

The source of AlH may further comprise AlH₃. The AlH₃ may be deposited on or with Ni to form a NiAlHₓ alloy. The alloy may be activated by the addition of a metal such as an alkali or alkaline earth metal. In an embodiment the reaction mixture comprises AlH₃, R-Ni, and a metal such as an alkali metal. The metal may be supplied by vaporization from a reservoir or by gravity feed from a source that flows down on the R-Ni at an elevated temperature. In an embodiments, AlH molecules or Al and hydrided R-Ni can be regenerated by systems and methods after those disclosed for the other reactant systems.

Another catalytic system of the type MH involves chlorine. The bond energy of HCl is 4.4703 eV [44]. The first, second, and third ionization energies of Cl are 12.96764 eV, 23.814 eV, and 39.61 eV, respectively [1]. Based on these energies HCl can serve as a catalyst and H source since the bond energy of HCl plus the triple ionization (t=3) of Cl to Cl³⁺, is 80.86 eV (3·27.2 eV) which is equivalent to m=3 in Eq. (2). The catalyst reactions are given by

$$\begin{matrix}80.86 eV + HCl -> {Cl}^{3 +} + 3 {e}^{-} + H [ \frac{{a}_{H}}{( 4 )} ] + [ {( 4 )}^{2} - {1}^{2} ] \cdot 13.6 eV & ( 138 ) \\ {Cl}^{3 +} + 3 {e}^{-} + H -> HCl + 80.86 eV & ( 139 )\end{matrix}$$

And, the overall reaction is

$$H -> H [ \frac{{a}_{H}}{( 4 )} ] + [ {( 4 )}^{2} - {1}^{2} ] \cdot 13.6 eV \qquad ( 140 )$$

In an embodiment, the reaction mixture comprises HCl or a source of HCl. A source may be NH₄Cl or a solid acid and a chloride such as an alkali or alkaline earth chloride. The solid acid may be at least one of MHSO₄, MHCO₃, MH₂PO₄, and MHPO₄ wherein M is a cation such as an alkali or alkaline earth cation. Other such solid acids are known to those skilled in the Art. In an embodiment, the reactants comprise HCl catalyst in an ionic lattice such as HCl in an alkali or alkaline earth halide, preferably a chloride. In an embodiment, the reaction mixture comprises a strong acid such as H₂SO₄ and an ionic compound such as NaCl. The reaction of the acid with the ionic compound such as NaCl generates HCl in the crystalline lattice to serve as a hydrino catalyst and H source.

In general, MH type hydrogen catalysts to produce hydrinos provided by the breakage of the M-H bond plus the ionization of t electrons from the atom M each to a continuum energy level such that the sum of the bond energy and ionization energies of the t electrons is approximately m·27.2 eV where m is an integer are given in TABLE 2. Each MH catalyst is given in the first column and the corresponding M-H bond energy is given in column two. The atom M of the MH species given in the first column is ionized to provide the net enthalpy of reaction of m·27.2 eV with the addition of the bond energy in column two. The enthalpy of the catalyst is given in the eighth column where m is given in the ninth column. The electrons, that participate in ionization are given with the ionization potential (also called ionization energy or binding energy). For example, the bond energy of NaH, 1.9245 eV [44], is given in column two. The ionization potential of the nth electron of the atom or ion is designated by IPₙ and is given by the CRC [1]. That is for example, Na+5.13908 eV→Na⁺+e⁻ and Na⁺+47.2864 eV→Na²⁺+e⁻. The first ionization potential, IP₁=5.13908 eV, and the second ionization potential, IP₂=47.2864 eV, are given in the second and third columns, respectively. The net enthalpy of reaction for the breakage of the NaH bond and the double ionization of Na is 54.35 eV as given in the eighth column, and m=2 in Eq. (2) as given in the ninth column. Additionally, H can react with each of the MH molecules given in TABLE 2 to form a hydrino having a quantum number p increased by one (Eq. (1)) relative to the catalyst reaction product of MH alone as given by exemplary Eq. (92).

TABLE 2
MH type hydrogen catalysts capable of providing a net enthalpy of
reaction of approximately m · 27.2 eV.

| | M-H | | | | | | | |
|---|---|---|---|---|---|---|---|---|
| | Bond | | | | | | | |
| Catalyst | Energy | IP₁ | IP₂ | IP₃ | IP₄ | IP₅ | Enthalpy | m |
| AlH | 2.98 | 5.985768 | 18.82855 | | | | 27.79 | 1 |
| BiH | 2.936 | 7.2855 | 16.703 | | | | 26.92 | 1 |
| ClH | 4.4703 | 12.96763 | 23.8136 | 39.61 | | | 80.86 | 3 |
| CoH | 2.538 | 7.88101 | 17.084 | | | | 27.50 | 1 |
| GeH | 2.728 | 7.89943 | 15.93461 | | | | 26.56 | 1 |
| InH | 2.520 | 5.78636 | 18.8703 | | | | 27.18 | 1 |
| NaH | 1.925 | 5.139076 | 47.2864 | | | | 54.35 | 2 |
| RuH | 2.311 | 7.36050 | 16.76 | | | | 26.43 | 1 |
| SbH | 2.484 | 8.60839 | 16.63 | | | | 27.72 | 1 |
| SeH | 3.239 | 9.75239 | 21.19 | 30.8204 | 42.9450 | | 107.95 | 4 |
| SiH | 3.040 | 8.15168 | 16.34584 | | | | 27.54 | 1 |
| SnH | 2.736 | 7.34392 | 14.6322 | 30.50260 | | | 55.21 | 2 |

In other embodiments of the MH type catalyst, the reactants comprise sources of SbH, SiH, SnH, and InH. In embodiments providing the catalyst MH, the sources comprise at least one of M and a source of H₂ and MHₓ such as at least one of Sb, Si, Sn, and In and a source of H₂, and SbH₃, SiH₄, SnH₄, and InH₃.

The reaction mixture may further comprise a source of H and a source of catalyst wherein the source of at least one of H and catalyst may be a solid acid or NH₄X where X is a halide, preferably Cl to form HCl catalyst. Preferably, the reaction mixture may comprise at least one of NH₄X, a solid acid, NaX, LiX, KX, NaH, LiH, KH, Na, Li, K, a support, a hydrogen dissociator and H₂ where X is a halide, preferably Cl. The solid acid may be NaHSO₄, KHSO₄, LiHSO₄, NaHCO₃, KHCO₃, LiHCO₃, Na₂HPO₄, K₂HPO₄, Li₂HPO₄, NaH₂PO₄, KH₂PO₄, and LiH₂PO₄. The catalyst may be at least one of NaH, Li, K, and HCl. The reaction mixture may further comprise at least one of a dissociator and a support.

Other thin-film deposition techniques that are well known in the ART comprise further embodiments of the Invention. Such embodiments comprise physical spray, electro-spray, aerosol, electro-arching, Knudsen cell controlled release, dispenser-cathode injection, plasma-deposition, sputtering, and further coating methods and systems such as melting a fine dispersion of M, electroplating M, and chemical deposition of M where MH comprises a catalyst.

In each case of a source of MH comprising an M alloy such as AlH and Al, respectively, the alloy may be hydrided with a source of H₂ such as H₂ gas. H₂ can be supplied to the alloy during the reaction, or H₂ may be supplied to form the alloy of a desired H content with the H pressure changed during the reaction. In this case, the initial H₂ pressure may be about zero. The alloy may be activated by the addition of a metal such as an alkali or alkaline earth metal. For MH catalysts and sources of MH, the hydrogen gas may be maintained in the range of about 1 Torr to 100 atm, preferably about 100 Torr to 10 atm, more preferably about 500 Torr to 2 atm. In other embodiments, the source of hydrogen is from a hydride such as an alkali or alkaline earth metal hydride or a transition metal hydride.

Atomic hydrogen in high density can undergo three-body-collision reactions to form hydrinos wherein one H atom undergoes the transition to form states given by Eq. (1) when two additional H atoms ionize. The reaction are given by

$$\begin{matrix}27.21 eV + 2 H [ {a}_{H} ] + H [ {a}_{H} ] -> 2 {H}^{+} + 2 {e}^{-} + H [ \frac{{a}_{H}}{( 2 )} ] + [ {( 2 )}^{2} - {1}^{2} ] \cdot 13.6 eV & ( 141 ) \\ 2 {H}^{+} + 2 {e}^{-} -> 2 H [ {a}_{H} ] + 27.21 eV & ( 142 )\end{matrix}$$

And, the overall reaction is

$$H [ {a}_{H} ] -> H [ \frac{{a}_{H}}{( 2 )} ] + [ {( 2 )}^{2} - {1}^{2} ] \cdot 13.6 eV \qquad ( 143 )$$

In another embodiment, the reaction are given by

$$\begin{matrix}54.4 eV + 2 H [ {a}_{H} ] + H [ {a}_{H} ] -> 2 {H}_{fast}^{+} + 2 {e}^{-} + H [ \frac{{a}_{H}}{( 3 )} ] + [ {( 3 )}^{2} - {1}^{2} ] \cdot 13.6 eV & ( 144 ) \\ 2 {H}_{fast}^{+} + 2 {e}^{-} -> 2 H [ {a}_{H} ] + 54.4 eV & ( 145 )\end{matrix}$$

And, the overall reaction is

$$H [ {a}_{H} ] -> H [ \frac{{a}_{H}}{( 3 )} ] + [ {( 3 )}^{2} - {1}^{2} ] \cdot 13.6 eV \qquad ( 146 )$$

In an embodiment, the material that provides H atoms in high density is R-Ni. The atomic H may be from at least one of the decomposition of H within R-Ni and the dissociation of H₂ from an H₂ source such as H₂ gas supplied to the cell. R-Ni may be reacted with an alkali or alkaline earth metal M to enhance the production of layers of atomic H to cause the catalysis. R-Ni can be regenerated by evaporating the metal M followed by addition of hydrogen to rehydride the R-Ni.

### REFERENCES

1. D. R. Lide, CRC Handbook of Chemistry and Physics, 78 th Edition, CRC Press, Boca Raton, Fla., (1997), p. 10-214 to 10-216; hereafter referred to as “CRC”.
2. R. L. Mills, “The Nature of the Chemical Bond Revisited and an Alternative Maxwellian Approach”, Physics Essays, Vol. 17, No. 3, (2004), pp. 342-389. Posted at http://www.blacklightpower.com/pdf/technical/H2PaperTableFiguresCaptions111303.pdf which is incorporated by reference.
3. R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts”, European Physical Journal-Applied Physics, Vol. 28, (2004), pp. 83-104.
4. R. Mills and M. Nansteel, P. Ray, “Argon-Hydrogen-Strontium Discharge Light Source”, IEEE Transactions on Plasma Science, Vol. 30, No. 2, (2002), pp. 639-653.
5. R. Mills and M. Nansteel, P. Ray, “Bright Hydrogen-Light Source due to a Resonant Energy Transfer with Strontium and Argon Ions”, New Journal of Physics, Vol. 4, (2002), pp. 70.1-70.28.
6. R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943.
7. R. Mills, M. Nansteel, and P. Ray, “Excessively Bright Hydrogen-Strontium Plasma Light Source Due to Energy Resonance of Strontium with Hydrogen”, J. of Plasma Physics, Vol. 69, (2003), pp. 131-158.
8. H. Conrads, R. Mills, Th. Wrubel, “Emission in the Deep Vacuum Ultraviolet from a Plasma Formed by Incandescently Heating Hydrogen Gas with Trace Amounts of Potassium Carbonate”, Plasma Sources Science and Technology, Vol. 12, (3003), pp. 389-395.
9. R. L. Mills, J. He, M. Nansteel, B. Dhandapani, “Catalysis of Atomic Hydrogen to New Hydrides as a New Power Source”, submitted.
10. R. L. Mills, M. Nansteel, J. He, B. Dhandapani, “Low-Voltage EUV and Visible Light Source Due to Catalysis of Atomic Hydrogen”, submitted.
11. J. Phillips, R. L. Mills, X. Chen, “Water Bath calorimetric Study of Excess Heat in ‘Resonance Transfer’ Plasmas”, Journal of Applied Physics, Vol. 96, No. 6, pp. 3095-3102.
12. R. L. Mills, X. Chen, P. Ray, J. He, B. Dhandapani, “Plasma Power Source Based on a Catalytic Reaction of Atomic Hydrogen Measured by Water Bath calorimetry”, Thermochimica Acta, Vol. 406/1-2, (2003), pp. 35-53.
13. R. L. Mills, Y. Lu, M. Nansteel, J. He, A. Voigt, B. Dhandapani, “Energetic Catalyst-Hydrogen Plasma Reaction as a Potential New Energy Source”, Division of Fuel Chemistry, Session: Chemistry of Solid, Liquid, and Gaseous Fuels, 227th American Chemical Society National Meeting, Mar. 28-Apr. 1, 2004, Anaheim, Calif.
14. R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367.
15. R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979.
16. R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203.
17. R. L. Mills, Y. Lu, J. He, M. Nansteel, P. Ray, X. Chen, A. Voigt, B. Dhandapani, “Spectral Identification of New States of Hydrogen”, submitted.
18. R. L. Mills, P. Ray, “Extreme Ultraviolet Spectroscopy of Helium-Hydrogen Plasma”, J. Phys. D, Applied Physics, Vol. 36, (2003), pp. 1535-1542.
19. R. L. Mills, P. Ray, B. Dhandapani, M. Nansteel, X. Chen, J. He, “New Power Source from Fractional Quantum Energy Levels of Atomic Hydrogen that Surpasses Internal Combustion”, J Mol. Struct., Vol. 643, No. 1-3, (2002), pp. 43-54.
20. R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, Vol. 27, No. 3, (2002), pp. 301-322.
21. R. L. Mills, P. Ray, “A Comprehensive Study of Spectra of the Bound-Free Hyperfine Levels of Novel Hydride Ion H⁻(1/2), Hydrogen, Nitrogen, and Air”, Int. J. Hydrogen Energy, Vol. 28, No. 8, (2003), pp. 825-871.
22. R. Mills, “Spectroscopic Identification of a Novel Catalytic Reaction of Atomic Hydrogen and the Hydride Ion Product”, Int. J. Hydrogen Energy, Vol 26, No. 10, (2001), pp. 1041-1058.
23. R. L. Mills, P. Ray, B. Dhandapani, R. M. Mayo, J. He, “Comparison of Excessive Balmer α Line Broadening of Glow Discharge and Microwave Hydrogen Plasmas with Certain Catalysts”, J. of Applied Physics, Vol. 92, No. 12, (2002), pp. 7008-7022.
24. R. L. Mills, P. Ray, B. Dhandapani, J. He, “Comparison of Excessive Balmer a Line Broadening of Inductively and Capacitively Coupled RF, Microwave, and Glow Discharge Hydrogen Plasmas with Certain Catalysts”, IEEE Transactions on Plasma Science, Vol. 31, No. (2003), pp. 338-355.
25. R. L. Mills, P. Ray, “Substantial Changes in the Characteristics of a Microwave Plasma Due to Combining Argon and Hydrogen”, New Journal of Physics, www.njp.org, Vol. 4, (2002), pp. 22.1-22.17.
26. J. Phillips, C. Chen, “Evidence of Energetic Reaction Between Helium and Hydrogen Species in RF Generated Plasmas”, submitted.
27. R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, Vol. 31, No. 2, (2003), pp. 236-247.
28. R. L. Mills, P. Ray, “Stationary Inverted Lyman Population Formed from Incandescently Heated Hydrogen Gas with Certain Catalysts”, J. Phys. D, Applied Physics, Vol. 36, (2003), pp. 1504-1509.
29. R. Mills, P. Ray, R. M. Mayo, “The Potential for a Hydrogen Water-Plasma Laser”, Applied Physics Letters, Vol. 82, No. 11, (2003), pp. 1679-1681.
30. R. Mills, The Grand Unified Theory of Classical Quantum Mechanics; October 2007 Edition, posted at http://www.blacklightpower.com/theory/bookdownload.shtml.
31. N. V. Sidgwick, The Chemical Elements and Their Compounds, Volume I, Oxford, Clarendon Press, (1950), p. 17.
32. M. D. Lamb, Luminescence Spectroscopy, Academic Press, London, (1978), p. 68.
33. R. L. Mills, “The Nature of the Chemical Bond Revisited and an Alternative Maxwellian Approach”, submitted; posted at http://www.blacklightpowercom/pdf/technical/H2PaperTableFiguresCaptions111303.pdf.
34. H. Beutler, Z. Physical Chem., “Die dissoziationswarme des wasserstoffmolekuls H₂, aus einem neuen ultravioletten resonanzbandenzug bestimmt”, Vol. 27B, (1934), pp. 287-302.
35. G. Herzberg, L. L. Howe, “The Lyman bands of molecular hydrogen”, Can. J. Phys., Vol. 37, (1959), pp. 636-659.
36. P. W. Atkins, Physical Chemistry, Second Edition, W. H. Freeman, San Francisco, (1982), p. 589.
37. M. Karplus, R. N. Porter, Atoms and Molecules an Introduction for Students of Physical Chemistry, The Benjamin/Cummings Publishing Company, Menlo Park, Calif., (1970), pp. 447-484.
38. K. R. Lykke, K. K. Murray, W. C. Lineberger, “Threshold photodetachment of H⁻”, Phys. Rev. A, Vol. 43, No. 11, (1991), pp. 6104-6107.
39. R. Mills, J. He, Z. Chang, W. Good, Y. Lu, B. Dhandapani, “Catalysis of Atomic Hydrogen to Novel Hydrogen Species H⁻(1/4) and H₂(1/4) as a New Power Source”, Int. J. Hydrogen Energy, Vol. 32, No. 12, (2007), pp. 2573-2584.
40. W. M. Mueller, J. P. Blackledge, and G. G. Libowitz. Metal Hydrides, Academic Press, New York, (1968), Hydrogen in Intermetallic Compounds I, Edited by L. Schlapbach, Springer-Verlag, Berlin, and Hydrogen in Intermetallic Compounds II, Edited by L. Schlapbach, Springer-Verlag, Berlin which is incorporate herein by reference.
41. D. R. Lide, CRC Handbook of Chemistry and Physics, 86th Edition, CRC Press, Taylor & Francis, Boca Raton, (2005 Jun.), pp. 4-45 to 4-97 which is herein incorporated by reference.
42. W. I. F. David, M. O. Jones, D. H. Gregory, C. M. Jewell, S. R. Johnson, A. Walton, P. Edwards, “A Mechanism for Non-stoichiometry in the Lithium Amide/Lithium Imide Hydrogen Storage Reaction,” J. Am. Chem. Soc., 129, (2007), 1594-1601.
43. F. A. Cotton, G. Wilkinson, Advanced Inorganic Chemistry, Interscience Publishers, New York, (1972).
44. D. R. Lide, CRC Handbook of Chemistry and Physics, 86th Edition, CRC Press, Taylor & Francis, Boca Raton, (2005 Jun.), pp. 9-54 to 9-59.
45. F. A. Cotton, G. Wilkinson, C. A. Murillo, M. Bochmann, Advanced Inorganic Chemistry, Sixth Edition, John Wiley & Sons, Inc., New York, (1999), Chp 6.
46. F. A. Cotton, G. Wilkinson, C. A. Murillo, M. Bochmann, Advanced Inorganic Chemistry, Sixth Edition, John Wiley & Sons, Inc., New York, (1999), p. 95.
47. J-G. Gasser, B. Kefif, “Electrical resistivity of liquid nickel-lanthanum and nickel-cerium alloys”, Physical Review B, Vol. 41, No. 5, (1990), pp. 2776-2783.
48. F. A. Cotton, G. Wilkinson, C. A. Murillo, M. Bochmann, Advanced Inorganic Chemistry, Sixth Edition, John Wiley & Sons, Inc., New York, (1999).
49. V. R. Choudhary, S. K. Chaudhari, “Leaching of Raney Ni—Al alloy with alkali; kinetics of hydrogen evolution”, J. Chem. Tech. Biotech, Vol. 33a, (1983), pp. 339-349.
50. R. R. Cavanagh, R. D. Kelley, J. J. Rush, “Neutron vibrational spectroscopy of hydrogen and deuterium on Raney nickel”, J. Chem. Phys., Vol. 77(3), (1982), pp. 1540-1547.
51. F. A. Cotton, G. Wilkinson, C. A. Murillo, M. Bochmann, Advanced Inorganic Chemistry, Sixth Edition, John Wiley & Sons, Inc., New York, (1999), pp. 190-191.
52. R. L. Earle, M. D. Earle, Unit Operations in Food Processing, The New Zealand Institute of Food Science & Technology (Inc.), Web Edition 2004, available at http://www.nzifst.org.nz/unitoperations/.
53. F. A. Cotton, G. Wilkinson, C. A. Murillo, M. Bochmann, Advanced Inorganic Chemistry, Sixth Edition, John Wiley & Sons, Inc., New York, (1999), p. 98.

### EXPERIMENTAL

Equation numbers, section numbers, and reference numbers given hereafter in this Experimental section refer to those given in this Experimental section of the Disclosure.

### Abstract

The data from a broad spectrum of investigational techniques strongly and consistently indicates that hydrogen can exist in lower-energy states than previously thought possible. The predicted reaction involves a resonant, nonradiative energy transfer from otherwise stable atomic hydrogen to a catalyst capable of accepting the energy. The product is H(1/p), fractional Rydberg states of atomic hydrogen called “hydrino atoms” wherein

$$n = \frac{1}{2} , \frac{1}{3} , \frac{1}{4} , … , \frac{1}{p}$$

(p≤137 is an integer) replaces the well-known parameter n=integer in the Rydberg equation for hydrogen excited states. Atomic lithium and molecular NaH served as catalysts since they meet the catalyst criterion—a chemical or physical process with an enthalpy change equal to an integer multiple m of the potential energy of atomic hydrogen, 27.2 eV (e.g. m=3 for Li and m=2 for NaH). Specific predictions based on closed-form equations for energy levels of the corresponding hydrino hydride ions H⁻(1/4) of novel alkali halido hydrino hydride compounds (MH*X; M=Li or Na, X=halide) and dihydrino molecules H₂(1/4) were tested using chemically generated catalysis reactants.

First, Li catalyst was tested. Li and LiNH₂ were used as a source of atomic lithium and hydrogen atoms. Using water-flow, batch calorimetry, the measured power from 1 g Li, 0.5 g LiNH₂, 10 g LiBr, and 15 g Pd/Al₂O₃ was about 160 W with an energy balance of ΔH=−19.1 kJ. The observed energy balance was 4.4 times the maximum theoretical based on known chemistry. Next, Raney nickel (R-Ni) served as a dissociator when the power reaction mixture was used in chemical synthesis wherein LiBr acted as a getter of the catalysis product H(1/4) to form LiH*X as well as to trap H₂(1/4) in the crystal. The ToF-SIMs showed LiH*X peaks. The ¹H MAS NMR LiH*Br and LiH*I showed a large distinct upfield resonance at about −2.5 ppm that matched H⁻(1/4) in a LiX matrix. An NMR peak at 1.13 ppm matched interstitial H₂(1/4), and the rotation frequency of H₂(1/4) of 4² times that of ordinary H₂ was observed at 1989 cm⁻¹ in the FTIR spectrum. The XPS spectrum recorded on the LiH*Br crystals showed peaks at about 9.5 eV and 12.3 eV that could not be assigned to any known elements based on the absence of any other primary element peaks, but matched the binding energy of H⁻(1/4) in two chemical environments. A further signature of the energetic process was the observation of the formation of a plasma called a resonant transfer- or rt-plasma at low temperatures (e.g. ≈10³ K) and very low field strengths of about 1-2 V/cm when atomic Li was present with atomic hydrogen. Time-dependent line broadening of the H Balmer α line was observed corresponding to extraordinarily fast H (>40 eV).

NaH uniquely achieves high kinetics since the catalyst reaction relies on the release of the intrinsic H, which concomitantly undergoes the transition to form H(1/3) that further reacts to form H(1/4). High-temperature differential scanning calorimetry (DSC) was performed on ionic NaH under a helium atmosphere at an extremely slow temperature ramp rate (0.1° C./min) to increase the amount of molecular NaH formation. A novel exothermic effect of −177 kJ/mole NaH was observed in the temperature range of 640° C. to 825° C. To achieve high power, R-Ni having a surface area of about 100 m²/g was surface-coated with NaOH and reacted with Na metal to form NaH. Using water-flow, batch calorimetry, the measured power from 15 g of R-Ni was about 0.5 kW with an energy balance of ΔH=−36 kJ compared to ΔH≈0 kJ from the R-Ni starting material, R-NiAl alloy, when reacted with Na metal. The observed energy balance of the NaH reaction was −1.6×10⁴ kJ/mole H₂, over 66 times the −241.8 kJ/mole H₂ enthalpy of combustion.

The ToF-SIMs showed sodium hydrino hydride, NaHₓ, peaks. The ¹H MAS NMR spectra of NaH*Br and NaH*Cl showed large distinct upfield resonance at −3.6 ppm and −4 ppm, respectively, that matched H⁻(1/4), and an NMR peak at 1.1 ppm matched H₂(1/4). NaH*Cl from reaction of NaCl and the solid acid KHSO₄ as the only source of hydrogen comprised two fractional hydrogen states. The H⁻(1/4) NMR peak was observed at −3.97 ppm, and the H⁻(1/3) peak was also present at −3.15 ppm. The corresponding H₂(1/4) and H₂(1/3) peaks were observed at 1.15 ppm and 1.7 ppm, respectively. The XPS spectrum recorded on NaH*Br showed the H⁻(1/4) peaks at about 9.5 eV and 12.3 eV that matched the results from LiH*Br and KH*I; whereas, sodium hydrino hydride showed two fractional hydrogen states additionally having the H⁻(1/3) XPS peak at 6 eV in the absence of a halide peak. The predicted rotational transitions having energies of 4² times those of ordinary H₂ were also observed from H₂(1/4) which was excited using a 12.5 keV electron beam.

### I. Introduction

Mills [1-12] solved the structure of the bound electron using classical laws and subsequently developed a unification theory based on those laws called the Grand Unified Theory of Classical Physics (GUTCP) with results that match observations for the basic phenomena of physics and chemistry from the scale of the quarks to cosmos. This paper is the first in a series of two that covers two specific predictions of GUTCP involving the existence of lower-energy states of the hydrogen atom, which represents a powerful new energy source and the transitions of atomic hydrogen to lower-energy states [2].

GUTCP predicts a reaction involving a resonant, nonradiative energy transfer from otherwise stable atomic hydrogen to a catalyst capable of accepting the energy to form hydrogen in lower-energy states than previously thought possible. Specifically, the product is H(1/p), fractional Rydberg states of atomic hydrogen wherein

$$n = \frac{1}{2} , \frac{1}{3} , \frac{1}{4} , … , \frac{1}{p}$$

(p≤137 is an integer) replaces the well known parameter n=integer in the Rydberg equation for hydrogen excited states. He⁺, Ar⁺, Sr⁺, Li, K, and NaH are predicted to serve as catalysts since they meet the catalyst criterion—a chemical or physical process with an enthalpy change equal to an integer multiple of the potential energy of atomic hydrogen, 27.2 eV. The data from a broad spectrum of investigational techniques strongly and consistently support the existence of these states called hydrino, for “small hydrogen”, and the corresponding diatomic molecules called dihydrino molecules. Some of these prior related studies supporting the possibility of a novel reaction of atomic hydrogen, which produces hydrogen in fractional quantum states that are at lower energies than the traditional “ground” (n=1) state, include extreme ultraviolet (EUV) spectroscopy, characteristic emission from catalysts and the hydride ion products, lower-energy hydrogen emission, chemically-formed plasmas, Balmer α line broadening, population inversion of H lines, elevated electron temperature, anomalous plasma afterglow duration, power generation, and analysis of novel chemical compounds [13-40].

Recently, there has been the announcement of some unexpected astrophysical results that support the existence of hydrinos. In 1995, Mills published the GUTCP prediction [41] that the expansion of the universe was accelerating from the same equations that correctly predicted the mass of the top quark before it was measured. To the astonishment of cosmologists, this was confirmed by 2000. Mills made another prediction about the nature of dark matter based on GUTCP that may be close to being confirmed. Based on recent evidence, Bournaud et al. [42-43] suggest that dark matter is hydrogen in dense molecular form that somehow behaves differently in terms of being unobservable except by its gravitational effects. Theoretical models predict that dwarfs formed from collisional debris of massive galaxies should be free of nonbaryonic dark matter. So, their gravity should tally with the stars and gas within them. By analyzing the observed gas kinematics of such recycled galaxies, Bournaud et al. [42-43] have measured the gravitational masses of a series of dwarf galaxies lying in a ring around a massive galaxy that has recently experienced a collision. Contrary to the predictions of Cold-Dark-Matter (CDM) theories, their results demonstrate that they contain a massive dark component amounting to about twice the visible matter. This baryonic dark matter is argued to be cold molecular hydrogen, but it is distinguished from ordinary molecular hydrogen in that it is not traced at all by traditional methods, such as emission of CO lines. These results match the predictions of the dark matter being dihydrino molecules.

Emission lines recorded on cold interstellar regions containing dark matter matched H(1/p), fractional Rydberg states of atomic hydrogen given by Eqs. (2a) and (2c) [29]. Such emission lines with energies of q·13.6 eV, where q=1, 2, 3, 4, 6, 7, 8, 9, or 11 were also observed by extreme ultraviolet (EUV) spectroscopy recorded on microwave discharges of helium with 2% hydrogen [27-29]. These He⁺ fulfills the catalyst criterion—a chemical or physical process with an enthalpy change equal to an integer multiple of 27.2 eV since it ionizes at 54.417 eV, which is 2·27.2 eV. The product of the catalysis reaction of He⁺, H(1/3), may further serve as a catalyst to lead to transitions to other states H(1/p)

J. R. Rydberg showed that all of the spectral lines of atomic hydrogen were given by a completely empirical relationship:

$$\overline{v} = R ( \frac{1}{{n}_{f}^{2}} - \frac{1}{{n}_{i}^{2}} ) \qquad ( 1 )$$

where R=109,677 cm⁻¹, n_{f}=1, 2, 3, . . . nᵢ=2, 3, 4, . . . and nᵢ>n_{f} Bohr, Schrödinger, and Heisenberg, each developed a theory for atomic hydrogen that gave the energy levels in agreement with Rydberg's equation.

$$\begin{matrix}{E}_{n} = - \frac{{e}^{2}}{{n}^{2} 8 {πɛ}_{o} {a}_{H}} = - \frac{13.598 eV}{{n}^{2}} & ( 2 a ) \\ n = 1 , 2 , 3 , … & ( 2 b )\end{matrix}$$

where e is the elementary charge, εₒ is the permittivity of vacuum, and a_{H} is the radius of the hydrogen atom. The excited energy states of atomic hydrogen are given by Eq. (2a) for n>1 in Eq. (2b). The n=1 state is the “ground” state for “pure” photon transitions (i.e. the n=1 state can absorb a photon and go to an excited electronic state, but it cannot release a photon and go to a lower-energy electronic state). However, an electron transition from the ground state to a lower-energy state may be possible by a resonant nonradiative energy transfer such as multipole coupling or a resonant collision mechanism. Processes such as hydrogen molecular bond formation that occur without photons and that require collisions are common [44]. Also, some commercial phosphors are based on resonant nonradiative energy transfer involving multipole coupling [45].

The theory reported previously [1, 13-40] predicts that atomic hydrogen may undergo a catalytic reaction with certain atoms, excimers, ions, and diatomic hydrides which provide a reaction with a net enthalpy of an integer multiple of the potential energy of atomic hydrogen, Eₕ=27.2 eV where Eₕ is one Hartree. Specific species (e.g. He⁺, Ar⁺, Sr⁺, K, Li, HCl, and NaH) identifiable on the basis of their known electron energy levels are required to be present with atomic hydrogen to catalyze the process. The reaction involves a nonradiative energy transfer followed by q·13.6 eV emission or q·13.6 eV transfer to H to form extraordinarily hot, excited-state H [13-17, 19-20, 32-39] and a hydrogen atom that is lower in energy than unreacted atomic hydrogen that corresponds to a fractional principal quantum number. That is

$$n = 1 , \frac{1}{2} , \frac{1}{3} , \frac{1}{4} , … , \frac{1}{p} ; p \leq 137 is an integer \qquad ( 2 c )$$

replaces the well known parameter n=integer in the Rydberg equation for hydrogen excited states. The n=1 state of hydrogen and the

$$n = \frac{1}{integer}$$

states of hydrogen are nonradiative, but a transition between two nonradiative states, say n=1 to n=1/2, is possible via a nonradiative energy transfer. Thus, a catalyst provides a net positive enthalpy of reaction of m·27.2 eV (i.e. it resonantly accepts the nonradiative energy transfer from hydrogen atoms and releases the energy to the surroundings to affect electronic transitions to fractional quantum energy levels). As a consequence of the nonradiative energy transfer, the hydrogen atom becomes unstable and emits further energy until it achieves a lower-energy nonradiative state having a principal energy level given by Eqs. (2a) and (2c).

The catalyst product, H(1/p), may also react with an electron to form a novel hydride ion H⁻(1/p) with a binding energy E_{B} [1, 13-14, 18, 30]:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 3 )$$

where p=integer >1, s=1/2, ℏ is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, aₒ is the Bohr radius, and the ionic radius is

$${r}_{1} = \frac{{a}_{0}}{p} ( 1 + \sqrt{s ( s + 1 )} ) .$$

From Eq. (3), the calculated ionization energy of the hydride ion is 0.75418 eV, and the experimental value given by Lykke [46] is 6082.99±0.15 cm⁻¹ (0.75418 eV).

Upfield-shifted NMR peaks are a direct evidence of the existence of lower-energy state hydrogen with a reduced radius relative to ordinary hydride ion and having an increase in diamagnetic shielding of the proton. The shift is given by the sum of that of ordinary hydride ion H⁻ and a component due to the lower-energy state [1, 15]:

$$\frac{Δ {B}_{T}}{B} = - {μ}_{0} \frac{{e}^{2}}{12 {m}_{e} {a}_{0} ( 1 + \sqrt{s ( s + 1 )} )} ( 1 + α 2 π p ) = - ( 29.9 + 13.7 p ) ppm \qquad ( 4 )$$

where for H⁻ p=0 and p=integer >1 for H⁻(1/p) and α is the fine structure constant.

H(1/p) may react with a proton and two H(1/p) may react to form H₂(1/p) and H₂(1/p), respectively. The hydrogen molecular ion and molecular charge and current density functions, bond distances, and energies were solved previously [1, 6] from the Laplacian in ellipsoidal coordinates with the constraint of nonradiation.

$$( η - ζ ) {R}_{ξ} \frac{\partial }{\partial ξ} ( {R}_{ξ} \frac{\partial φ}{\partial ξ} ) + ( ζ - ξ ) {R}_{η} \frac{\partial }{\partial η} ( {R}_{η} \frac{\partial φ}{\partial η} ) + ( ξ - η ) {R}_{ζ} \frac{\partial }{\partial ζ} ( {R}_{ζ} \frac{\partial φ}{\partial ζ} ) = 0 \qquad ( 5 )$$

The total energy E_{T} of the hydrogen molecular ion having a central field of +pe at each focus of the prolate spheroid molecular orbital is

$$\begin{matrix}{E}_{T} = - {p}^{2} \{ \begin{matrix}\frac{{e}^{2}}{8 {πɛ}_{o} {a}_{H}} ( \begin{matrix}4 ln 3 - \\ 1 - 2 ln 3\end{matrix} ) [ 1 + p \sqrt{\frac{2 ℏ \sqrt{\frac{\frac{2 {e}^{2}}{4 {{πɛ}_{0} ( 2 {a}_{H} )}^{3}}}{{m}_{e}}}}{{m}_{e} {c}^{2}}} ] - \\ \frac{1}{2} ℏ \sqrt{\frac{k}{μ}}\end{matrix} \} \\ = - {p}^{2} 16.13392 eV - {p}^{3} 0.118755 eV\end{matrix} \qquad ( 6 )$$

where p is an integer, c is the speed of light in vacuum, μ is the reduced nuclear mass, and k is the harmonic force constant solved previously in a closed-form equation with fundamental constants only [1, 6]. The total energy of the hydrogen molecule having a central field of +pe at each focus of the prolate spheroid molecular orbital is

$$\begin{matrix}{E}_{T} = - {p}^{2} \{ \begin{matrix}\frac{{e}^{2}}{8 {πɛ}_{o} {a}_{H}} [ ( \begin{matrix}2 \sqrt{2} - \\ \begin{matrix}\sqrt{2} + \\ \frac{\sqrt{2}}{2}\end{matrix}\end{matrix} ) ln \frac{\sqrt{2} + 1}{\sqrt{2 - 1}} - \sqrt{2} ] [ 1 + p \sqrt{\frac{2 ℏ \sqrt{\frac{\frac{{e}^{2}}{4 {πɛ}_{0} {a}_{0}^{3}}}{{m}_{e}}}}{{m}_{e} {c}^{2}}} ] - \\ \frac{1}{2} ℏ \sqrt{\frac{k}{μ}}\end{matrix} \} \\ = - {p}^{2} 31.351 eV - {p}^{3} 0.326469 eV\end{matrix} \qquad ( 7 )$$

The bond dissociation energy, E_{D}, of hydrogen molecule H₂(1/p) is the difference between the total energy of the corresponding hydrogen atoms and E_{T}

E_{D}=E(2H(1/p))−E_{T} (8)

where [47]

E(2H(1/p))=−p²27.20 eV (9)

E_{D} is given by Eqs. (8-9) and (7):

$$\begin{matrix}{E}_{D} = - {p}^{2} 27.20 eV - {E}_{T} \\ = - {p}^{2} 27.20 eV - ( - {p}^{2} 31.351 eV - {p}^{3} 0.326469 eV ) \\ = {p}^{2} 4.151 eV + {p}^{3} 0.326469 eV\end{matrix} \qquad ( 10 )$$

The calculated and experimental parameters of H₂, D₂, H₂⁺, and D₂⁺ from Ref. [1, 6] are given in TABLE 3.

TABLE 3
The Maxwellian closed-form calculated and experimental
parameters of H₂, D₂, H₂⁺ and D₂⁺.

| Parameter | Calculated | | Experimental | |
|---|---|---|---|---|
| H₂ Bond Energy | 4.478 | eV | 4.478 | eV |
| D₂ Bond Energy | 4.556 | eV | 4.556 | eV |
| H₂⁺ Bond Energy | 2.654 | eV | 2.651 | eV |
| D₂⁺ Bond Energy | 2.696 | eV | 2.691 | eV |
| H₂ Total Energy | 31.677 | eV | 31.675 | eV |
| D₂ Total Energy | 31.760 | eV | 31.760 | eV |
| H₂ Ionization Energy | 15.425 | eV | 15.426 | eV |
| D₂ Ionization Energy | 15.463 | eV | 15.466 | eV |
| H₂⁺ Ionization Energy | 16.253 | eV | 16.250 | eV |
| D₂⁺ Ionization Energy | 16.299 | eV | 16.294 | eV |
| H₂⁺ Magnetic Moment | 9.274 × 10⁻²⁴ | JT⁻¹ | 9.274 × 10⁻²⁴ | JT⁻¹ |
| | | (μ_{B}) | | (μ_{B}) |
| Absolute H₂ Gas-Phase | −28.0 | ppm | −28.0 | ppm |
| NMR Shift | | | | |
| H₂ Internuclear Distance^{a} | 0.748 | Å | 0.741 | Å |
| | \sqrt{2}a₀ | | | |
| D₂ Internuclear Distance^{a} | 0.748 | Å | 0.741 | Å |
| | \sqrt{2}a₀ | | | |
| H₂⁺ Internuclear | 1.058 | Å | 1.06 | Å |
| Distance | 2a₀ | | | |
| D₂⁺ Internuclear | 1.058 | Å | 1.0559 | Å |
| Distance^{a} | 2a₀ | | | |
| H₂ Vibrational Energy | 0.517 | eV | 0.516 | eV |
| D₂ Vibrational Energy | 0.371 | eV | 0.371 | eV |
| H₂ ωₑxₑ | 120.4 | cm⁻¹ | 121.33 | cm⁻¹ |
| D₂ ωₑxₑ | 60.93 | cm⁻¹ | 61.82 | cm⁻¹ |
| H₂⁺ Vibrational Energy | 0.270 | eV | 0.271 | eV |
| D₂⁺ Vibrational Energy | 0.193 | eV | 0.196 | eV |
| H₂ J = 1 to J = 0 | 0.0148 | eV | 0.01509 | eV |
| Rotational Energy^{a} | | | | |
| D₂ J = 1 to J = 0 | 0.00741 | eV | 0.00755 | eV |
| Rotational Energy^{a} | | | | |
| H₂⁺ J = 1 to J = 0 | 0.00740 | eV | 0.00739 | eV |
| Rotational Energy | | | | |
| D₂⁺ J = 1 to J = 0 | 0.00370 | eV | 0.003723 | eV |
| Rotational Energy^{a} | | | | |

^{a}Not corrected for the slight reduction in internuclear distance due to Ē_{osc}.

The ¹H NMR resonance of H₂(1/p) is predicted to be upfield from that of H₂ due to the fractional radius in elliptic coordinates [1, 6] wherein the electrons are significantly closer to the nuclei. The predicted shift,

$$\frac{Δ {B}_{T}}{B} ,$$

for H₂(1/p) derived previously [1, 6] is given by the sum of that of H₂ and a term that depends on p=integer >1 for H₂(1/p):

$$\begin{matrix}\frac{Δ {B}_{T}}{B} = - {μ}_{0} ( 4 - \sqrt{2} ln \frac{\sqrt{2} + 1}{\sqrt{2 - 1}} ) \frac{{e}^{2}}{36 {a}_{0} {m}_{e}} ( 1 + π α p ) & ( 11 ) \\ \frac{Δ {B}_{T}}{B} = - ( 28.01 + 0.64 p ) ppm & ( 12 )\end{matrix}$$

where for H₂ p=0.

The vibrational energies, E_{vib}, for the υ=0 to υ=1 transition of hydrogen-type molecules H₂(1/p) are [1, 6]

E_{vib}=p²0.515902 eV (13)

where p is an integer and the experimental vibrational energy for the υ=0 to υ=1 transition of H₂, E_{H}_{₂}_{(υ=0→υ1)}, is given by Beutler [48] and Herzberg [49].

The rotational energies, Eᵣₒₜ, for the J to J+1 transition of hydrogen-type molecules H₂(1/p) are [1, 6]

$${E}_{rot} = {E}_{J + 1} - {E}_{J} = \frac{{ℏ}^{2}}{I} [ J + 1 ] = {p}^{2} ( J + 1 ) 0.01509 eV \qquad ( 14 )$$

where p is an integer, I is the moment of inertia, and the experimental rotational energy for the J=0 to J=1 transition of H₂ is given by Atkins [50].

The p² dependence of the rotational energies results from an inverse p dependence of the internuclear distance and the corresponding impact on the moment of inertia I. The predicted internuclear distance 2c′ for H₂ (1/p) is

$$2 {c}^{′} = \frac{{a}_{o} \sqrt{2}}{p} \qquad ( 15 )$$

The formation of new states of hydrogen is very energetic. A new chemically generated or assisted plasma source based on the resonant energy transfer mechanism (rt-plasma) has been developed that may be a new power source. One such source operates by incandescently heating a hydrogen dissociator and a catalyst to provide atomic hydrogen and gaseous catalyst, respectively, such that the catalyst reacts with the atomic hydrogen to produce a plasma. It was extraordinary that intense EUV emission was observed by Mills et al. [13-21, 38-39] at low temperatures (e.g. ≈10³ K), as well as an extraordinary low field strength of about 1-2 V/cm from atomic hydrogen and certain atomized elements or certain gaseous ions, which singly or multiply ionize at integer multiples of the potential energy of atomic hydrogen, 27.2 eV.

K to K³⁺ provides a reaction with a net enthalpy equal to three times the potential energy of atomic hydrogen. It was reported previously [13-21, 38-39] that the presence of these gaseous atoms with thermally dissociated hydrogen formed an rt-plasma having strong EUV emission with a stationary inverted Lyman population. Other noncatalyst metals such as Mg produced no plasma. Significant line broadening of the Balmer α, β, and γ lines of 18 eV was observed. Emission from rt-plasmas occurred even when the electric field applied to the plasma was zero. Since a conventional discharge power source was not present, the formation of a plasma would require an energetic reaction. The origin of Doppler broadening is the relative thermal motion of the emitter with respect to the observer. Line broadening is a measure of the atom temperature, and a significant increase was expected and observed for catalysts, K as well as Sr⁺ or Ar⁺[ 13-21, 38-39], with hydrogen. The observation of a high hydrogen temperature with no conventional explanation would indicate that an rt-plasma must have a source of free energy. An energetic chemical reaction was further implicated since it was found that the broadening is time dependent [13-14, 20]. Therefore, the thermal power balance was measured calorimetrically. The reaction was exothermic since excess power of 20 mW·cm⁻³ was measured by Calvet calorimetry [20]. In further experiments, KNO₃ and Raney nickel were used as a source of K catalyst and atomic hydrogen, respectively, to produce the corresponding exothermic reaction. The energy balance was ΔH=−17, 925 kcal/mole KNO₃, about 300 times that expected for the most energetic known chemistry of KNO₃, and −3585 kcal/mole H₂, over 60 times the hypothetical maximum enthalpy of −57.8 kcal/mole H₂ due to combustion of hydrogen with atmospheric oxygen, assuming the maximum possible H₂ inventory [14]. Additional substantial evidence of an energetic catalytic reaction was previously reported [13-15, 24-26, 30-31] involving a resonant energy transfer between hydrogen atoms and K to form very stable novel hydride ions and molecules H⁻(1/4) and H₂(1/4), respectively. Characteristic emission was observed from K³⁺ that confirmed the resonant nonradiative energy transfer of 3·27.2 eV from atomic hydrogen to K that served as a predicted catalyst. From Eq. (3), the binding energy E_{B} of H⁻(1/4) is

E_{B}=11.232 eV (λ_{vac}=110.38 nm) (16)

The product hydride ion H⁻(1/4) was observed by EUV spectroscopy at 110 nm corresponding to its predicted binding energy of 11.2 eV [13-15, 24-26, 30-31]. The identification of H⁻(1/4) was confirmed previously by the XPS measurement of its binding energy. The XPS spectrum of KH*I differed from that of KI by having additional features at 8.9 eV and 10.8 eV that did not correspond to any other primary element peaks but did match the H⁻(1/4) E_{b}=11.2 eV hydride ion (Eq. (3)) in two different chemical environments. The ¹H MAS NMR spectrum of novel compound KH*Cl relative to external tetramethylsilane (TMS) showed a large distinct upfield resonance at −4.4 ppm corresponding to an absolute resonance shift of −35.9 ppm that matched the theoretical prediction of p=4 [13-15, 25-26, 30-31]. Elemental analysis identified [13-15, 25-26, 30-31] these compounds as only containing the alkaline metal, halogen, and hydrogen, and no known hydride compound of this composition could be found in the literature that had an upfield-shifted hydride NMR peak. Ordinary alkali hydrides alone or mixed with alkali halides show down-field shifted peaks [13-15, 25-26, 30-31]. From the literature, the list of alternatives to H⁻(1/p) as a possible source of the upfield NMR peaks was limited to U centered H. This was eliminated by the absence of the intense and characteristic infrared vibration band at 503 cm⁻¹ due to the substitution of H⁻ for Cl⁻ in KCl [51].

As a further characterization, FTIR analysis of KH*I crystals with H⁻(1/4) was performed and interstitial H₂(1/4) having a predicted rotational energy given by Eq. (14) was observed. Rotational lines were observed previously [13-14] in the 145-300 nm region from atmospheric pressure electron beam-excited argon-hydrogen plasmas. The unprecedented energy spacing of 4² times that of hydrogen established the internuclear distance as 1/4 that of H₂ and identified H₂(1/4) (Eqs. (13-15)). The spectrum was asymmetric with the P branch dominant corresponding to the absence of populated rotational states in the exited υ=1 vibrational state. This was due to the high rotational energy (10 times the thermal energy), the short lifetime of the rotational excited states, and the low cross section for electron-beam rotational excitation; whereas, the vibrational dipole excitation was allowed. Thus, only the υ=1, J=0 state was populated significantly from e-beam excitation, and transitions occurred with ΔJ>0 during the υ=1 to υ=0 transition. KH*Cl having H⁻(1/4) by NMR was incident to the 12.5 keV electron beam, which excited similar emission of interstitial H₂ (1/4) as observed in the argon-hydrogen plasma [13-14]. Specifically, H₂(1/4) trapped in the lattice of KH*Cl was investigated by windowless EUV spectroscopy on electron-beam excitation of the crystals using the 12.5 keV electron gun at pressures below which any gas could produce detectable emission (<10⁻⁵ Torr). The rotational energy of H₂(1/4) was confirmed by this technique as well. These results confirmed the previous observations from the plasmas formed by the energetic hydrino-forming reaction having intense hydrogen Lyman emission, a stationary inverted Lyman population, excessive afterglow duration, highly energetic hydrogen atoms, characteristic alkali-ion emission due to catalysis, predicted novel spectral lines, and the measurement of a power beyond any conventional chemistry [13-40] that matched predictions for a catalytic reaction of atomic hydrogen to form more stable hydride ions designated H⁻(1/p). Since the comparison of theory and experimental energies is direct evidence of lower-energy hydrogen with an implicit large exotherm during its formation, we report in this paper the results when these experiments were repeated with additionally predicted catalysts Li and NaH.

A catalytic system used to make and analyzed predicted hydride compounds involves lithium atoms. The first and second ionization energies of lithium are 5.39172 eV and 75.64018 eV, respectively [52]. The double ionization (t=2) reaction of Li to Li²⁺ then, has a net enthalpy of reaction of 81.0319 eV, which is equivalent to 3·27.2 eV.

$$\begin{matrix}81.0319 eV + Li ( m ) + H [ \frac{{a}_{H}}{p} ] \to {Li}^{2 +} + 2 {e}^{-} + H [ \frac{{a}_{H}}{( p + 3 )} ] + [ {( p + 3 )}^{2} - {p}^{2} ] \cdot 13.6 eV & ( 17 ) \\ {Li}^{2 +} + 2 {e}^{-} \to Li ( m ) + 81.0319 eV & ( 18 )\end{matrix}$$

And, the overall reaction is

$$H [ \frac{{a}_{H}}{p} ] \to H [ \frac{{a}_{H}}{( p + 3 )} ] + [ {( p + 3 )}^{2} - {p}^{2} ] \cdot 13.6 eV \qquad ( 19 )$$

Lithium is a metal in the solid and liquid states, and the gas comprises covalent Li₂ molecules [53], each having a bond energy of 110.4 kJ/mole [54]. In order to generate atomic lithium, LiNH₂ was added to the reaction mixture. LiNH₂ generates atomic hydrogen as well, according to the reversible reactions [55-64]:

Li₂+LiNH₂→Li+Li₂NH+H (20)

and

Li_{z}+Li₂NH→Li+Li₃N+H (21)

The energy for the reaction of lithium amide to lithium nitride and lithium hydride is exothermic [65-66]:

4Li+KiNH₂→Li₃N+2LiH ΔH=−198.5 kJ/mole LiNH₂ (22)

Thus, it should occur to a significant extent. The specific predictions of the energetic reaction given by Eqs. (17-19) were tested by rt-plasma formation and H line broadening. The power developed was measured using water-flow, batch calorimetry. Then, the predicted products of H⁻(1/4) and H₂ (1/4) having the energies given by Eqs. (3) and (5-15), respectively, were tested by magic angle solid proton nuclear magnetic resonance spectroscopy (MAS ¹H NMR), X-ray photoelectron spectroscopy (XPS), time of flight secondary ion mass spectroscopy (ToF-SIMs), and Fourier transform infrared spectroscopy (FTIR).

A compound comprising hydrogen such as MH, where M is element other than hydrogen, serves as a source of hydrogen and a source of catalyst. A catalytic reaction is provided by the breakage of the M—H bond plus the ionization of t electrons from the atom M each to a continuum energy level such that the sum of the bond energy and ionization energies of the t electrons is approximately 27.2 eV where m is an integer. One such catalytic system involves sodium. The bond energy of NaH is 1.9245 eV [54], and the first and second ionization energies of Na are 5.13908 eV and 47.2864 eV, respectively [52]. Based on these energies NaH molecule can serve as a catalyst and H source, since the bond energy of NaH plus the double ionization (t=2) of Na to Na²⁺ is 54.35 eV (2·27.2 eV). The catalyst reactions are given by

$$\begin{matrix}54.35 eV + NaH \to {Na}^{2 +} + 2 {e}^{-} + H [ \frac{{a}_{H}}{3} ] + [ {3}^{2} - {1}^{2} ] \cdot 13.6 eV & ( 23 ) \\ {Na}^{2 +} + 2 {e}^{-} + H \to NaH + 54.35 eV & ( 24 )\end{matrix}$$

And, the overall reaction is

$$H \to H [ \frac{{a}_{H}}{3} ] + [ {3}^{2} - {1}^{2} ] \cdot 13.6 eV \qquad ( 25 )$$

As given in Chp. 5 of Ref [1], and Ref. [29], hydrogen atoms H(1/p) p=1, 2, 3, . . . 137 can undergo further transitions to lower-energy states given by Eqs. (2a) and (2c) wherein the transition of one atom is catalyzed by a second that resonantly and nonradiatively accepts m·27.2 eV with a concomitant opposite change in its potential energy. The overall general equation for the transition of H(1/p) to H(1/(p+m)) induced by a resonance transfer of m·27.2 eV to H(1/p′) is represented by

H(1/p′)+H(1/p)→H⁺+e⁻+H(1/(p+m))+[2pm+m²−p′²]·13.6 eV (26)

In the case of a high hydrogen atom concentration, the transition of H(1/3) (p=3) to H(1/4) (p+m=4) with H as the catalyst (p=1; m=1) can be fast:

$$H ( 1 / 3 ) {\to }^{H} H ( 1 / 4 ) + 81.6 eV \qquad ( 27 )$$

The NaH catalyst reactions may be concerted since the sum of the bond energy of NaH, the double ionization (t=2) of Na to Na²⁺, and the potential energy of H is 81.56 eV (3·27.2 eV). The catalyst reactions are given by

$$\begin{matrix}81.56 eV + NaH + H \to {Na}^{2 +} + 2 {e}^{-} + {H}_{fast}^{+} + {e}^{-} + H [ \frac{{a}_{H}}{4} ] + [ {4}^{2} - {1}^{2} ] \cdot 13.6 eV & ( 28 ) \\ {Na}^{2 +} + 2 {e}^{-} + H + {H}_{fast}^{+} + {e}^{-} \to NaH + H + 81.56 eV & ( 30 )\end{matrix}$$

And, the overall reaction is

$$H \to H [ \frac{{a}_{H}}{4} ] + [ {4}^{2} - {1}^{2} ] \cdot 13.6 eV \qquad ( 30 )$$

where H_{fast}⁺ is a fast hydrogen atom having at least 13.6 eV of kinetic energy. H(1/4) forms stable halidohydrides and is a favored product together with the corresponding molecule formed by the reactions 2H(1/4)→H₂(1/4) and H⁻(1/4)+H⁺→H₂(1/4) [13-15, 24-26, 30-31]. The corresponding hydrino atom H(1/4) is a preferred final product consistent with observation since the p=4 quantum state has a multipolarity greater than that of a quadrupole giving it a long theoretical lifetime. H(1/4) may be formed directly from H(e.g. Eqs. (36-38)) or via multiple transitions (e.g. Eqs. (23-27)). In the latter case, the higher-energy H(1/p) states with quantum numbers p=2; l=0, 1 and p=3; e=0, 1, 2 corresponding to dipole and quadrupole transitions, respectively, have theoretically allowed, fast transitions.

Sodium hydride is typically in the form of an ionic crystalline compound formed by the reaction of gaseous hydrogen with metallic sodium. And, in the gaseous state, sodium comprises covalent Na₂ molecules [53] with a bond energy of 74.8048 kJ/mole [54]. It was found that when NaH(s) was heated at a very slow temperature ramp rate (0.1° C./min) under a helium atmosphere to form NaH(g), the predicted exothermic reaction given by Eqs. (23-25) was observed at high temperature by differential scanning calorimetry (DSC). To achieve high power, a chemical system was designed to greatly increase the amount and rate of formation of NaH(g). The reaction of NaOH and Na to Na₂O and NaH(s) calculated from the heats of formation [54, 65] releases ΔH=−44.7 kJ/mole NaOH:

NaOH+2Na→Na₂O+NaH(s) ΔH=−44.7/mole NaOH (31)

This exothermic reaction can drive the formation of NaH(g) and was exploited to drive the very exothermic reaction given by Eqs. (23-25). The regenerative reaction in the presence of atomic hydrogen is

Na₂O+H→NaOH+Na ΔH=−11.6 kJ/mole NaOH (32)

NaH→Na+H(1/3) ΔH=−10,500 kJ/mole H (33)

and

NaH→Na+H(1/4) ΔH=−19,700 kJ/mole H (34)

Thus, a small amount of NaOH, Na, and atomic hydrogen serves as a catalytic source of the NaH catalyst that in turn forms a large yield of hydrinos via multiple cycles of regenerative reactions such as those given by Eqs. (31-34). R-Ni having a high surface area of about 100 m²/g and containing H was surface coated with NaOH and reacted with Na metal to form NaH(g). Since the energy balance in the formation of NaH(g) was negligible due to the small amounts involved, the energy and power due to the hydrino reactions given by Eqs. (23-25) were specifically measured using water-flow, batch calorimetry. Next, R-Ni 2400 was prepared such that it comprised about 0.5 wt % NaOH, and the Al of the intermetallic served as the reductant to form NaH catalyst during calorimetry measurement. The reaction of NaOH+Al to Al₂O₃+NaH calculated from the heats of formation [65] is exothermic by ΔH=−189.1 kJ I mole NaOH. The balanced reaction is given by

3NaOH+2Al→Al₂O₃+3NaH Δ=−189.1 kJ/mole NaOH (35)

This exothermic reaction can drive the formation of NaH(g) and was exploited to drive the very exothermic reaction given by Eqs. (23-25) wherein the regeneration of NaH occurred from Na in the presence of atomic hydrogen. For 0.5 wt % NaOH, the exothermic reaction given by Eq. (35) gave a negligible ΔH=−0.024 kJ background heat during measurement.

It was reported previously [28-29] that the reaction products H(1/p) may undergo further reaction to lower-energy states. For example, the catalyst reaction of Ar⁺ to Ar²⁺ forms H(1/2), which may further serve as both a catalyst and a reactant to form H(1/4) [1, 13-14, 28-29] and the corresponding favored molecule H₂(1/4), observed using different catalysts [13-14]. Thus, predicted products of NaH catalyst from Eqs. (23-25) and Table 1 of Ref. [29] are H⁻(1/3) and H₂(1/4) having the energies given by Eqs. (3) and (5-15), respectively. They were tested by MAS ¹H NMR and ToF-SIMs.

Another catalytic system of the type MH involves chlorine. The bond energy of HCl is 4.4703 eV [54]. The first, second, and third ionization energies of Cl are 12.96764 eV, 23.814 eV, and 39.61 eV, respectively [52]. Based on these energies, HCl can serve as a catalyst and H source, since the bond energy of HCl plus the triple ionization (t=3) of Cl to Cl³⁺ is 80.86 eV (3·27.2 eV). The catalyst reactions are given by

$$\begin{matrix}80.86 eV + HCl \to {Cl}^{3 +} + 3 {e}^{-} + H [ \frac{{a}_{H}}{4} ] + [ {4}^{2} - {1}^{2} ] \cdot 13.6 eV & ( 36 ) \\ {Cl}^{3 +} + 3 {e}^{-} + H \to HCl + 80.86 eV & ( 37 )\end{matrix}$$

And, the overall reaction is

$$H \to H [ \frac{{a}_{H}}{4} ] + [ {4}^{2} - {1}^{2} ] \cdot 13.6 eV \qquad ( 38 )$$

The anticipated product then is H₂(1/4).

Alkali chlorides contain both Cl and H, typically from H₂O contamination. Thus, some HCl can form interstitially in the crystalline matrix. Since H+ can most easily substitute for Lr, and the substitution is least likely in the case of c s+, it was anticipated that alkali chlorides may form HCl that undergoes catalysis to form H₂(1/4) with the trend of the rate of formation increasing in the order of the Group I elements. Due to the difference in lattice structure, MgCl₂ may not form HCl catalyst; thus, it serves as a chlorine control. This condition applies to other alkaline earth halides and transition metal halides such as those of copper that can serve as controls for the formation of H₂(1/4). One exception from this set is Mg²⁺ in a suitable lattice, since the ionization of Mg²⁺ to Mg³⁺ is 80. 1437 eV [52] which is close to 3·27.2 eV These hypotheses were tested by electron beam-excitation emission spectroscopy on alkali halides, MgX₂ (X=F, Cl, Br, I}, and CuX₂ (X=F, Cl, Br) with the goal of determining whether the predicted emission of H₂(1/4) is selectively observed when a catalyst reaction is possible and not otherwise. NMR was recorded on these compounds to search for the corresponding predicted H₂ (1/4) peak to be compared with the emission results.

### II. Experimental Methods

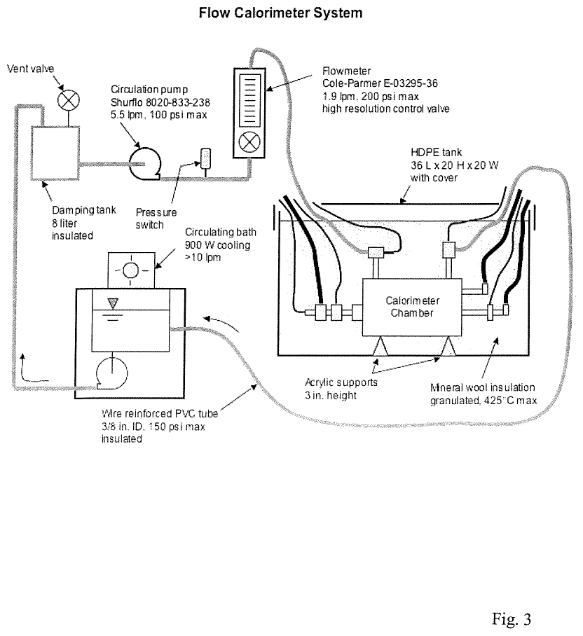

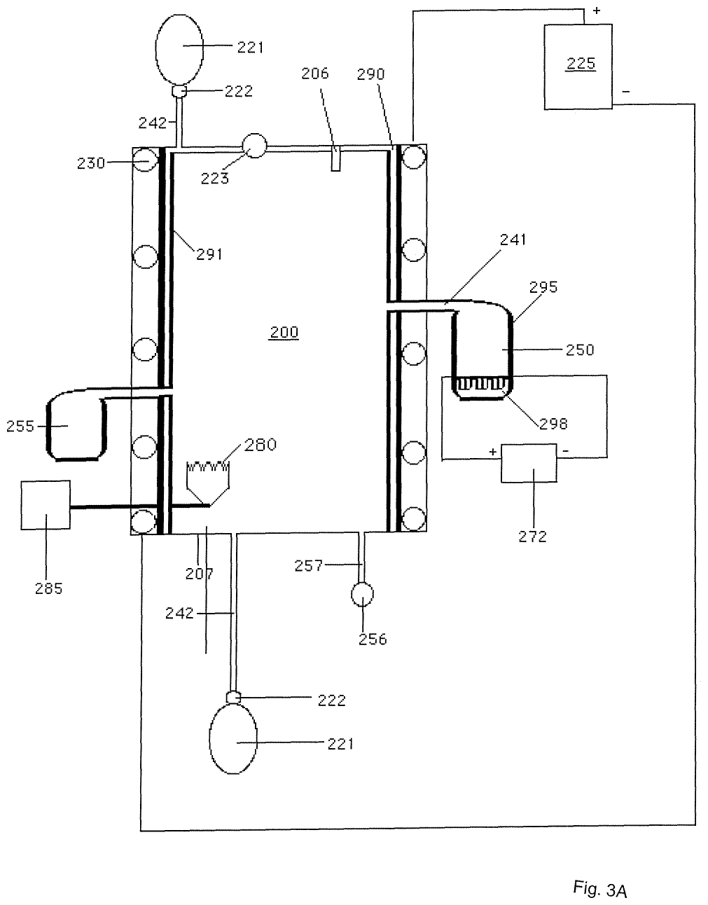

Rt-plasma and Line Broadening Measurements. LiNH₂ argon-hydrogen (95/5%) and LiNH₂ hydrogen rt-plasmas was generated in the experimental set up described previously [15-21] (FIG. 2A) comprising a thermally insulated stainless steel cell with a cap that incorporated ports for gas inlet, and outlet. A titanium filament (55 cm long, 0.5 mm diameter} that served as a heater and hydrogen dissociator was in the cell. 1 g of LiNH₂ (Alfa Aesar 99.95%) was placed in the center of the cell under 1 atm of dry argon in a glove box. The cell was sealed and removed from the glove box. The cell was maintained at 50° C. for 4 hours with helium flowing at 30 sccm at a pressure of 1 Torr. The filament power was increased to 200 W in 20 W increments every 20 minutes. At 120 W, the filament temperature was estimated to be in the range 800 to 1000° C. The external cell wall temperature was about 700° C. The cell was then operated with and without an argon-hydrogen (95/5%) flow rate of 5.5 sccm maintained at 1 Torr. Additionally, the cell was operated with hydrogen gas flow replacing argon-hydrogen (95/5%). The LiNH₂ was vaporized by the filament heater as evidence the presence of Li lines. The presence of an argon-hydrogen or hydrogen plasma was determined by recording the visible spectrum over the Balmer region with a Jobin Yvon Horiba 1250 M spectrometer with a CCD detector described previously [15-21] using entrance/exits slits of 80/80 μm and a 3 second integration time. The width of the 656.3 nm Balmer α line emitted from the argon-hydrogen (95/5%)-LiNH₂ or hydrogen-LiNH₂ rt-plasma having a titanium filament was measured initially and periodically during operation. As further controls, the experiment was run with each of the flowing gases in the absence of LiNH₂.

Differential Scanning calorimetry (DSC) Measurements. Differential scanning calorimeter (DSC) measurements were performed using the DSC mode of a Setaram HT-1000 calorimeter (Setaram, France). Two matched alumina glove fingers were used as the sample compartment and the reference compartment. The fingers permitted the control of the reaction atmosphere. 0.067 g NaH was placed in a flat-base Al-23 crucible (Alfa-Aesar, 15 mm high×10 mm OD×8 mm ID). The crucible was then placed in the bottom of the sample alumina glove finger cell. As a reference, an aluminum oxide sample (Alfa-Aesar, −400 Mesh powder, 99.9%) with matching weight of the sample was placed in a matched Al-23 crucible. All samples were handled in a glove box. Each alumina glove finger cell was sealed in the glove box, removed from the glove box, and then quickly attached to the Setaram calorimeter. The system was immediately evacuated to pressure of 1 mTorr or less. The cell was back filled with 1 atm of helium, evacuated again, and then refilled with helium to 760 Torr. The cells were then inserted into the oven, and secured to their positions in the DSC instrument. The oven temperature was brought to the desired starting temperature of 100° C. The oven temperature was scanned from 100° C. to 750° C. at a ramp rate of 0.1 degree/minute. As a control, MgH₂ replaced NaH. A 0.050 g MgH₂ sample (Alfa-Aesar, 90%, reminder Mg) was added to the sample cell, while a similar weight of aluminum oxide (Alfa-Aesar) was added to the reference cell. Both samples were also handled in a glove box.

Water-Flow, Batch calorimetry. The cylindrical stainless steel reactor of approximately 60 cm³ volume (1.0″ outside diameter (OD), 5.0″ length, and 0.065″ wall thickness) is shown in FIG. 2B. The cell further comprised a welded-in 2.5″ long, cylindrical thermocouple well with a wall thickness of 0.035″ along the centerline that held a Type K thermocouple (Omega) read by a meter (DAS). For the cell sealed with a high temperature valve, a ⅜″ OD, 0.065″ thick SS tube welded at the end of the cell ¼″ off-center served as a port to introduce combinations of the reagents comprising the group of (i) 1 g Li, 0.5 g LiNH₂, 10 g LiBr, and 15 g PdIAl₂O₃, (ii) 3.28 g Na, 15 g Raney (R-) NiIAl alloy, (iii) 15 g R-Ni doped with NaOH, and (iv) 3 wt % Al(OH)₃ doped NiIAl alloy. In the case that this port was spot-weld sealed, the SS tube had a ¼″ OD and a 0.02″ wall-thickness. The reactants were loaded in a glove box, and a valve was attached to the port tube to seal the cell before it was removed from the glove box and connected to a vacuum pump. The cell was evacuated to a pressure of 10 mTorr and crimped. The cell was then sealed with the valve or hermetically sealed by spot-welding ½″ from the cell with the remaining tube cut off.

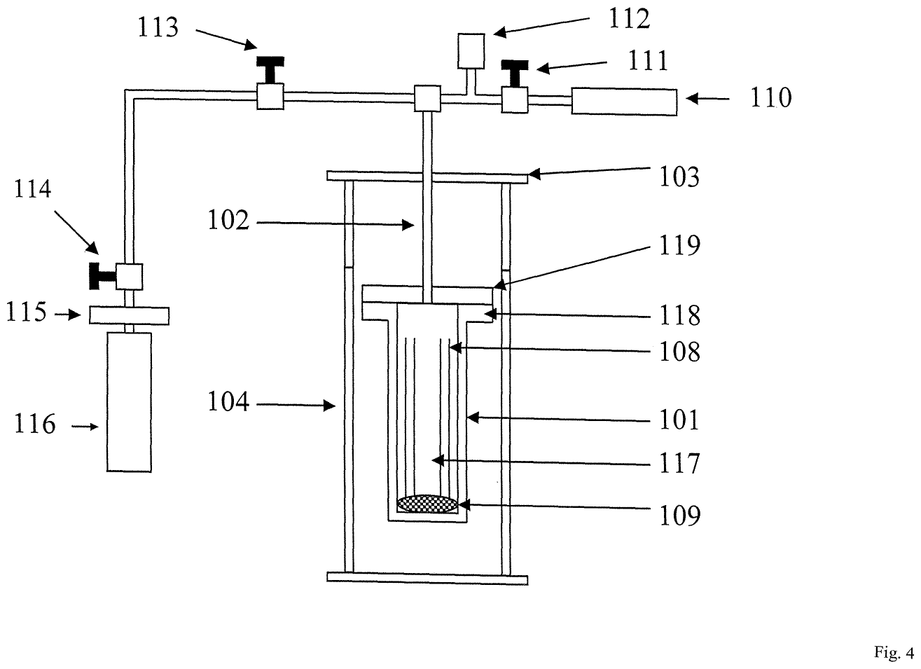

The reactor was installed inside a cylindrical calorimeter chamber shown in FIG. 3. The stainless steel chamber had 15.2 cm ID, 0.305 cm wall thickness, and 40.4 cm length. The chamber was sealed at both ends by removable stainless steel plates and Viton o-rings. The space between the reactor and the inside surface of the cylindrical chamber was filled with high temperature insulation. The gas composition and pressure in the chamber was controlled to modulate the thermal conductance between the reactor and the chamber. The interior of the chamber was first filled with 1000 Torr helium to allow the cell to reach ambient temperature, the chamber was then evacuated during the calorimetric run to increase the cell temperature. Afterwards, 1000 Torr helium was added to increase the heat transfer rate from the hot cell to the coolant and balance any heat associated with P-V work. The relative dimensions of the reactor and the chamber were such that heat flow from the reactor to the chamber was primarily radial. Heat was removed from the chamber by cooling water which flowed turbulently through 6.35 mm OD copper tubing, which was wound tightly (63 turns) onto the outer cylindrical surface of the chamber. The reactor and chamber system were designed to safely absorb a thermal power pulse of 50 kW with one a minute duration. The absorbed energy was subsequently released to the cooling water stream in a controlled manner for calorimetric measurement. The temperature rise of the cooling water was measured by precision thermistor probes (Omega, OL-703-PP, 0.01° C.) at the cooling coil inlet and exit. The inlet water temperature was controlled by a Cole Parmer (digital Polystat, model 12101-41) circulating bath with 0.01° C. temperature stability and 900 W cooling capacity at 20° C. A well insulated eight-liter damping tank was installed just downstream of the bath in order to reduce temperature fluctuations caused by cycling of the bath. Coolant flow through the system was maintained by an FMI model QD variable flow rate positive displacement lab pump. Cooling water flow rate was set by a variable area flow meter with a high-resolution control valve. The flow meter was calibrated directly by water collection in situ. A secondary flow rate measurement was performed by a turbine flow meter (McMillan Co., G111 Flometer, ±1%) which continuously output the flow rate to the data acquisition system. The calorimeter chamber was installed in a covered HDPE tank which was filled with melamine foam insulation to minimize heat loss from the system. Careful measurement of the thermal power release to the coolant and comparison with the measured input power indicated that thermal losses were less than 2-3%.

The calorimeter was calibrated with a precision heater applied for a set time period to determine the percentage recovery of the total energy applied by the heater. The energy recovery was determined by integrating the total output power P_{T} over time. The power was given by

P_{T}=\dot{m}CₚΔT (39)

where \dot{m} was the mass flow rate, Cₚ was the specific heat of water, and ΔT was the absolute change in temperature between the inlet and outlet where the two thermistors were matched to correct any offset using a constant flow with no input power. In first step of the calibration test, an empty reaction cell, that was identical to the latter tested power cell containing the reactants, was evacuated to below 1 Torr and inserted into the calorimeter vacuum chamber. The chamber was evacuated and then filled with helium to 1000 Torr. The unpowered assembly reached equilibrium over an approximately two-hour period at which time the temperature difference between the thermistors became constant. The system was run another hour to confirm the value of the difference due to absolute calibrations of the two sensors. The magnitude of the correction was 0.036° C., and it was confirmed to be consistent over all of the tests performed over the reported data set.

To increase the temperature of the cell per input power, ten minutes before the end of the ten-hour equilibration period, helium was evacuated from the chamber by the vacuum pump, and the chamber was maintained under dynamic pumping at a pressure below 1 Torr. 100.00 W of power was supplied to the heater (50.23 V and 1.991 A) for a period of 50 minutes. During this period, the cell temperature increased to approximately 650° C., and the maximum change in water temperature (outlet minus inlet) was approximately 1.2° C. After 50 minutes, the program directed the power to zero. To increase the rate of heat transfer to the coolant, the chamber was re-pressurized with 1000 Torr of helium and the assembly was allowed to fully reach equilibrium over a 24-hour period as confirmed by the observation of full equilibrium in the flow thermistors.

The hydrino-reaction procedure followed that of the calibration run, but the cell contained the reagents. The equilibration period with 1000 Torr helium in the chamber was 90 minutes. 100.00 W of power was applied to the heater, and after 10 minutes, the helium was evacuated from the chamber. The cell heated at a faster rate post evacuation, and the reagents reached a hydrino reaction threshold temperature of 190° C. at 57 minutes. The onset of reaction was confirmed by a rapid rise in cell temperature that reached 378° C. at about 58 minutes. After ten minutes, the power was terminated, and helium was reintroduced into the cell slowly over a period of 1 hour at a rate of 150 sccm.

The reactants 0.1 wt % NaOH-doped R-Ni 2800 or 0.5 wt % NaOH-doped R-Ni 2400 (elemental analysis was provided by the manufacturer, W. R. Grace Davidson, and the wt % NaOH was confirmed by elemental analysis (Galbraith) performed on samples handled in an inert atmosphere) and the products following the reaction of these reactants as well as those of the reaction mixture comprising Li (1 g) and LiNH₂ (0.5 g) (Alfa Aesar 99%), LiBr (10 g) (Alfa Aesar ACS grade 99+%), and Pd/Al₂O₃ (15 g) (1% Pd, Alfa Aesar) were analyzed by quantitative X-ray diffraction (XRD) using hermetically sealed sample holders (Bruker Model #A100B37) loaded in a glove box under argon and analyzed with a Siemens D5000 diffractometer using Cu radiation at 40 kV/30 mA over the range 10°-70° with a step size of 0.02° and a counting time of eight hours. In addition, a weighed sample of R-Ni in a 16.5 cc stainless steel cell connected to a vacuum system having a total volume of 291 cc was heated with a temperature ramp from 25° C. to 550° C. to decompose any physically absorbed or chemisorbed gasses and to identify and quantify the released gasses. The hydrogen content was determined by mass spectroscopy, quantitative gas chromatography (HP 5890 Series II with a ShinCarbon ST 100/120 micropacked column (2 m long, 1/16″ OD), N₂ carrier gas with a flow rate of 14 ml/min, an oven temperature of 80° C., an injector temperature of 100° C., and thermal-conductivity detector temperature of 100° C.), and by using the ideal gas law and the measured pressure, volume, and temperature. Hydrogen dominated each analysis with trace water only detected by mass spectroscopy, and <2% methane was also quantified by gas chromatography. The trace water of the R-Ni and controls was quantified independently of the hydrogen by liquefying the H₂O in a liquid nitrogen trap, pumping off the hydrogen, and allowing all the water to vaporize by using a sample size of 0.5 g which is less than that which gives rise to a saturated water-vapor pressure at room temperature.

Synthesis and Solid ¹H MAS NMR of LiH*Br, LiH*I, NaH*Cl and NaH*Br. Lithium bromo and iodohydrinohydride (LiH*Br and LiH*I) were synthesized by reaction of hydrogen with Li (1 g) and LiNH₂ (0.5 g) (Alfa Aesar 99%) as a source of atomic catalyst and additional atomic H with the corresponding alkali halide (10 g), LiBr (Alfa Aesar ACS grade 99+%) or Li/(Alfa Aesar 99.9%), as an additional reactant. The compounds were prepared in a stainless steel gas cell (FIG. 4) further containing Raney Ni (15 g) (W. R. Grace Davidson) as the hydrogen dissociator according to the methods described previously [13-14]. The reactor was run at 500° C. in a kiln for 72 hours with make-up hydrogen addition such that the pressure ranged cyclically between 1 Torr to 760 Torr. Then, the reactor was cooled under helium atmosphere. The sealed reactor was then opened in a glove box under an argon atmosphere. NMR samples were placed in glass ampules, sealed with rubber septa, and transferred out of the glove box to be flame sealed. ¹H MAS NMR was performed on solid samples of LiH*X (X is a halide) at Spectral Data Services, Inc., Champaign, Ill. as described previously [13-14]. Chemical shifts were referenced to external TMS. XPS was also performed on crystalline samples that were handled as air-sensitive materials.

Since the synthesis reaction comprised LiNH₂, and Li₂NH was a reaction product, both were run as controls alone and in a LiBr or LiI matrix. The LiNH₇ was the commercial starting material, and Li₂NH was synthesized by the reaction of LiNH₂ and LiH [67] and by decomposition of LiNH₂ [68] with the Li, NH product confirmed by X-ray diffraction (XRD). To eliminate the possibility that the alkali halide influenced the local environment of the protons or that any given known species produced an NMR resonance that was shifted upfield relative to the ordinary peak, controls comprising LiH (Aldrich Chemical Company 99%), LiNH₂, and Li₂NH with an equimolar mixture of LiX were run. The controls were prepared by mixing equimolar amounts of compounds in a glove box under argon. To further eliminate F centers as a possible contributor to the local environment of the protons of any given known species to produce an upfield-shifted NMR resonance, electron spin resonance spectroscopy (ESR) was performed on the LiH*Br and LiH*I samples. For the ESR studies, the samples were loaded into 4 mm OD Suprasil quartz tubes and evacuated to a final pressure of 10⁻⁴ Torr. ESR spectra were recorded with a Bruker ESP 300 X-band spectrometer at room temperature and 77 K. The magnetic field was calibrated with a Varian E-500 gauss meter. The microwave frequency was measured by a HP 5342A frequency counter.

Elemental analysis was performed at Galbraith Laboratories to confirm the product composition and to eliminate the possibility of NMR-detectable amounts of any transition metal hydrides or other exotic hydrides that may give rise to upfield-shifted peaks. Specifically, the abundance of all elements present in the product (Li,H,X) and the stainless steel reaction vessel and R-Ni (Ni,Fe,Cr,Mo,Mn,Al) were determined.

NaH*Cl and NaH*Br were synthesized by reaction of hydrogen with Na (3.28 g) and NaH(1 g) (Aldrich Chemical Company 99%) as a source of NaH catalyst and intrinsic atomic H with the corresponding alkali halide (15 g), NaCl or NaBr (Alfa Aesar ACS grade 99+%), as an additional reactant. The compounds were prepared in a stainless steel gas cell (FIG. 4) further containing Pt/Ti (Pt coated Ti (15 g); Titan Metal Fabricators, platinum plated titanium mini-expanded anode, 0.089 cm×0.5 cm×2.5 cm with 2.54 μm of platinum) as the hydrogen dissociator. Each synthesis was run according to the methods described for Li except that the kiln was maintained at 500° C., and, the NaH*Cl synthesis was repeated without the addition of hydrogen gas to determine the effect of using NaH(s) as the sole hydrogen source. XPS was performed on NaH*Cl since no primary element peaks were possible in the region for H⁻(1/4), and NMR investigations of both products were preformed.

NaH*Cl was also synthesized from NaCl (10 g) and the solid acid KHSO₄ (1.6 g) as the only source of hydrogen with the kiln maintained at 580° C. NMR was performed to test whether H⁻(1/3) formed by the reactions of Eqs. (23-25) could be observed when the rapid reaction to H⁻(1/4) according to Eq. (27) was partially inhibited due to the absence of a high concentration of H from a dissociator with H₂ or a hydride.

A silicon wafer (2 g, 0.5×0.5×0.05 cm, Silicon Quest International, silicon (100), boron-doped, cleaned by heating to 700° C. under vacuum) was coated by the product NaH*Cl and NaH* by placing it in reactants comprising Na (1.7 g), NaH (0.5 g), NaCl (10 g), and Pr/Ti (15 g) wherein the NaCl that was initially heated to 400° C. under vacuum to remove any H₂(1/4). The reaction was run at 550° C. in the kiln for 19 hours with an initial hydrogen pressure of 760 Torr. XPS was performed on a spot comprising only sodium hydrino hydride coated silicon wafer (NaH*-coated Si). The NaH*Cl-coated silicon wafer (NaH*Cl-coated Si) was investigated by electron-beam excitation spectroscopy. An emission spectrum of a pressed pellet of the NaH*Cl crystals was also recorded.

ToF-SIMS Spectra. The crystalline samples of LiH*Br, LiH*I, NaH*Cl, NaH*Br, and the corresponding alkali halide controls were sprinkled onto the surface of a double-sided adhesive tape and characterized using a Physical Electronics TFS-2000 ToF-SIMS instrument. The primary ion gun utilized a ⁶⁹Ga⁺ liquid metal source. A region on each sample of (60 pm)² was analyzed. In order to remove surface contaminants and expose a fresh surface, the samples were sputter-cleaned for 60 seconds using a 180 μm×100 μm raster, The aperture setting was 3, and the ion current was 600 pA resulting in a total ion dose of 10¹⁵ ions/cm².

During acquisition, the ion gun was operated using a bunched (pulse width 4 ns bunched to 1 ns) 15 kV beam [69-70]. The total ion dose was 10¹² ions/cm². Charge neutralization was active, and the post accelerating voltage was 8000 V. The positive and negative SIMS spectra were acquired. Representative post sputtering data is reported.

In addition, 0.1 g Na, 0.5 g NaH, and 15 g PtITi were loaded into the water flow calorimetry cell, and water flow calorimetry was performed under the same conditions as described for Na and R-Ni. The cell generated 15 kJ of excess energy; whereas, the theoretical energy balance from the decomposition of NaH is endothermic by +1.2 kJ. Thus, to confirm the presence of hydrino hydrides corresponding to the reactions given by Eqs. (23-25) as the source of the excess heat, a sample of the PtITi coated with sodium hydrino hydride (NaH*-coated Pt/Ti) was analyzed directly by the same procedure as for the crystalline samples except that the sputtering was for 100 s. Unreacted Pt/Ti coated with the starting materials served as a control. XPS was also performed.

ToF-SIMS of R-Ni 2400 reacted over a 48 hour period at 50° C. was also performed by the same procedure as for the crystalline samples. The reactions to form hydrinos are given by Eqs. (32-35). Since the surface was coated with NaOH, sodium hydrino hydride compounds with NaOH were predicted.

FTIR Spectroscopy. FTIR analysis was performed on solid-sample-KBr pellets of LiH*Br using the transmittance mode at the Department of Chemistry, Princeton University, New Jersey using a Nicolet 730 FTIR spectrometer with DTGS detector at resolution of 4 cm⁻¹ as described previously [13-14]. The samples were handled under an inert atmosphere. The resolution was 0.5 cm⁻¹. Controls comprised LiNH₂, Li₂NH, and Li₃N that were commercially available except Li₂NH that was synthesized by the reaction of LiNH₂ and LiH [67] and by decomposition of LiNH₂ [68] with the Li₂NH product confirmed by X-ray diffraction (XRD).

XPS Spectra. A series of XPS analyses were made on the crystalline samples using a Scienta 300 XPS Spectrometer. The fixed analyzer transmission mode and the sweep acquisition mode were used. The step energy in the survey scan was 0.5 eV, and the step energy in the high-resolution scan was 0.15 eV. In the survey scan, the time per step was 0.4 seconds, and the number of sweeps was 4. In the high-resolution scan, the time per step was 0.3 seconds, and the number of sweeps was 30. C is at 284.5 eV was used as the internal standard.

UV Spectroscopy of Electron-Beam Excited Interstitial H₂(1/4). Vibration-rotational emission of H₂(1/4) trapped in the lattice of alkali halides, MgCl₂, and in a silicon wafer was investigated via electron bombardment of the crystals. Windowless UV spectroscopy of the emission from electron-beam excitation of the crystals was recorded using a 12.5 keV electron gun at a beam current of 10-20 pA in the pressure range of <10⁻⁵ Torr. The UV spectrum was recorded with a photomultiplier tube (PMT). The wavelength resolution was about 2 nm (FWHM) with an entrance and exit slit width of 300 μm. The increment was 0.5 nm and the dwell time was 1 second.

### III. Results and Discussion

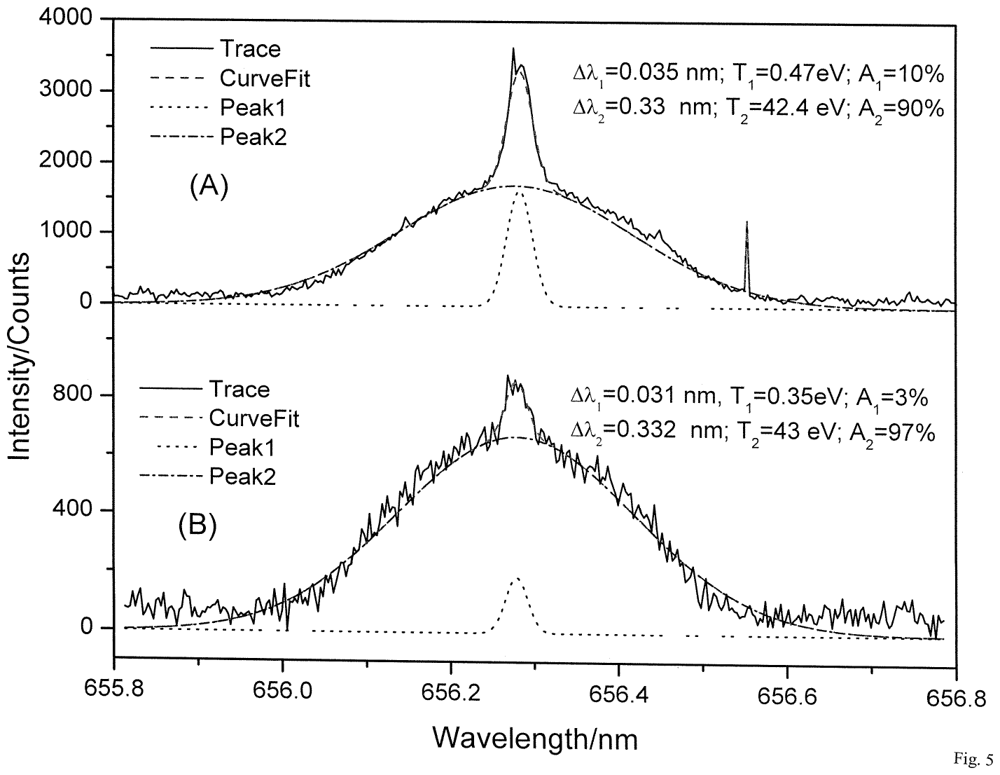

A. RT-plasma Emission and Balmer α Line Widths. An argon-hydrogen (95/5%)-lithium rt-plasma formed with a low field (1V/cm), at low temperatures (e.g. ≈10³ K), from atomic hydrogen generated at a titanium filament and LiNH₂ that was vaporized by heating. Lithium and H emission were observed that confirmed LiNH₂ and its decomposition product Li served as a source of atomic Li and H. Argon of the argon-hydrogen mixture increased the amount of atomic H as evidenced by the significantly decreased H emission in the absence of argon. H Balmer emission corresponding to population of a level with energy >12 eV was observed, as shown in FIGS. 5 and 6, which also requires that Lyman emission was present.

No plasma formed with argon/hydrogen alone. No possible chemical reaction of the titanium filament, the vaporized LiNH₂, and 0.6 Torr argon-hydrogen mixture at a cell temperature of 700° C. could be found to account for the Balmer emission. In fact, no known chemical reaction releases enough energy to excite Balmer and Lyman emission from hydrogen. In addition to known chemical reactions, electron collisional excitation, resonant photon transfer, and the lowering of the ionization and excitation energies by the state of “non ideality” in dense plasmas were also rejected as the source of ionization or excitation to form the hydrogen plasma [21]. The formation of an energetic reaction of atomic hydrogen was consistent with a source of free energy from the catalysis of atomic hydrogen by Li.

The energetic hydrogen atom energies were calculated from the width of the 656.3 nm Balmer α line emitted from RF rt-plasmas. The full half-width Δλ_{G} of each Gaussian results from the Doppler (Δλ_{D}) and instrumental (Δλ_{I}) half-widths:

Δλ_{G}=\sqrt{Δλ_{D}²+Δλ_{I}²} (40)

Δλ_{I} in our experiments was ±0.006 nm. The temperature was calculated from the Doppler half-width using the formula:

$$Δ {λ}_{D} = 7.16 \times {10}^{- 7} {{λ}_{0} ( \frac{T}{μ} )}^{1 / 2} \qquad ( 41 )$$

where λ₀ is the line wavelength, T is the temperature in K (1 eV=11,605 K), and μ is the molecular weight (=1 for atomic hydrogen). In each case, the average Doppler half-width that was not appreciably changed with pressure, varied by ±5% corresponding to an error in the energy of ±10%.

The 656.3 nm Balmer α line widths recorded on the argon-hydrogen (95/5%)-lithium rt-plasma, initially and after 70 hours of operation, are shown in FIGS. 5A and 5B, respectively. The Balmer α line profile of the plasma emission at both time points comprised two distinct Gaussian peaks, an inner, narrower peak corresponding to a slow component of less than 0.5 eV and an outer, significantly broadened peak corresponding to a fast component of >40 eV. The fast component accounted for 90% of the n=3 excited-state H population initially and increased to 97% at 70 hours. Only the hydrogen lines were broadened. As shown previously, the source of energy of the fast H cannot be attributed to any applied electric field, but is predicted by the mechanism of the catalysis of hydrogen to lower-states [32-37].

A lithium rt-plasma also formed in the case of pure H₂ gas at a pressure of 1 Torr, except that the line broadening and populations were less, about 6 eV with only a 27% population, at the initial and 70-hour time points as shown in FIGS. 6A and 6B, respectively. This result was expected, since the excess H₂ can react with Li to form LiH that catalyzes the destruction of LiNH₂ by the reaction:

LiH+LiNH₂→Li₂NH+H₂ (42)

Thus, the reactions to produce atomic Li and H are diminished. In addition, argon of the argon-hydrogen mixture can increase the amount of atomic H by preventing its recombination, and Ar generated by the plasma can participate as a catalyst as well as Li.

We have assumed that Doppler broadening due to thermal motion was the dominant source to the extent that other sources may be neglected. This assumption was confirmed when each source was considered. In general, the experimental profile is a convolution of two Doppler profiles, an instrumental profile, the natural (lifetime) profile, Stark profiles, van der Waals profiles, a resonance profile, and fine structure. The contribution from each source was determined to be below the limit of detection [13-21, 38-39].

The formation of fast H can be explained by a resonant energy transfer from hydrogen atoms to Li atoms, of three times the potential energy of atomic hydrogen, to form a short-lived intermediate H*(1/4) having a central field equivalent to four times that of a proton and a radius of the hydrogen atom. The intermediate spontaneously decays by a collisional or through-space energy transfer as the radius decreases to a₀/4 yielding fast H(n=1), as well as the emission of q·13.6 eV photons reported previously [27-29]. Collisional energy transfer including through-space coupling is common. For example, the exothermic chemical reaction of H+H to form H₂ does not occur with the emission of a photon. Rather, the reaction requires a collision with a third body, M, to remove the bond energy-H+H+M→H₂+M* [44]. The third body distributes the energy from the exothermic reaction, and the end result is the H₂ molecule and an increase in the temperature of the system. In the case of the catalytic reaction with the formation of states given by Eqs. (2a) and (2c), the temperature of H becomes very high.

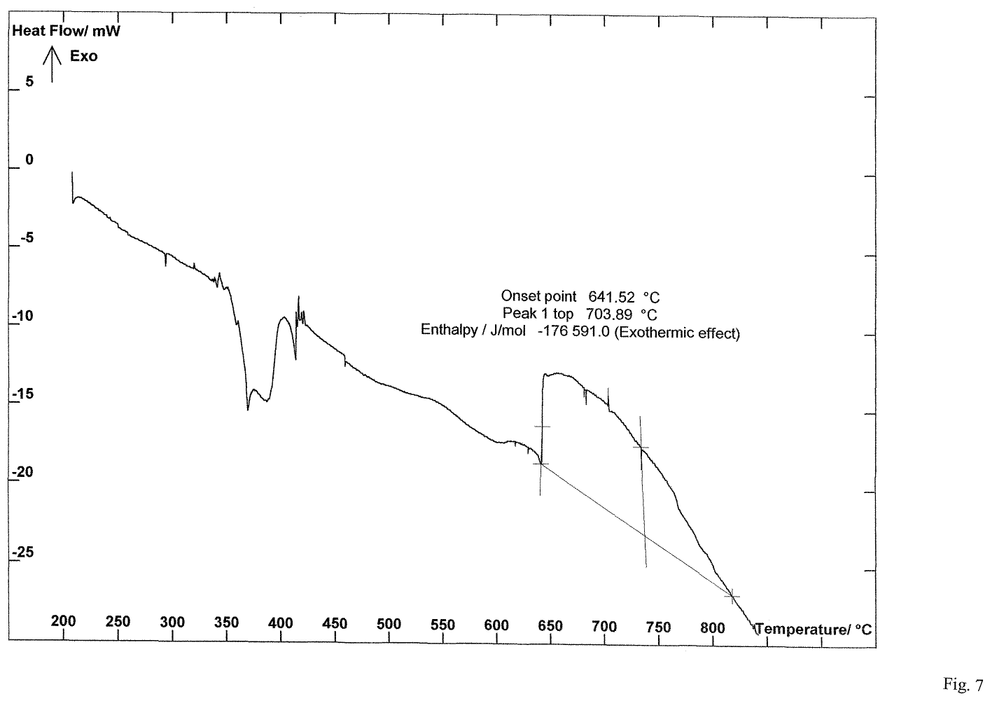

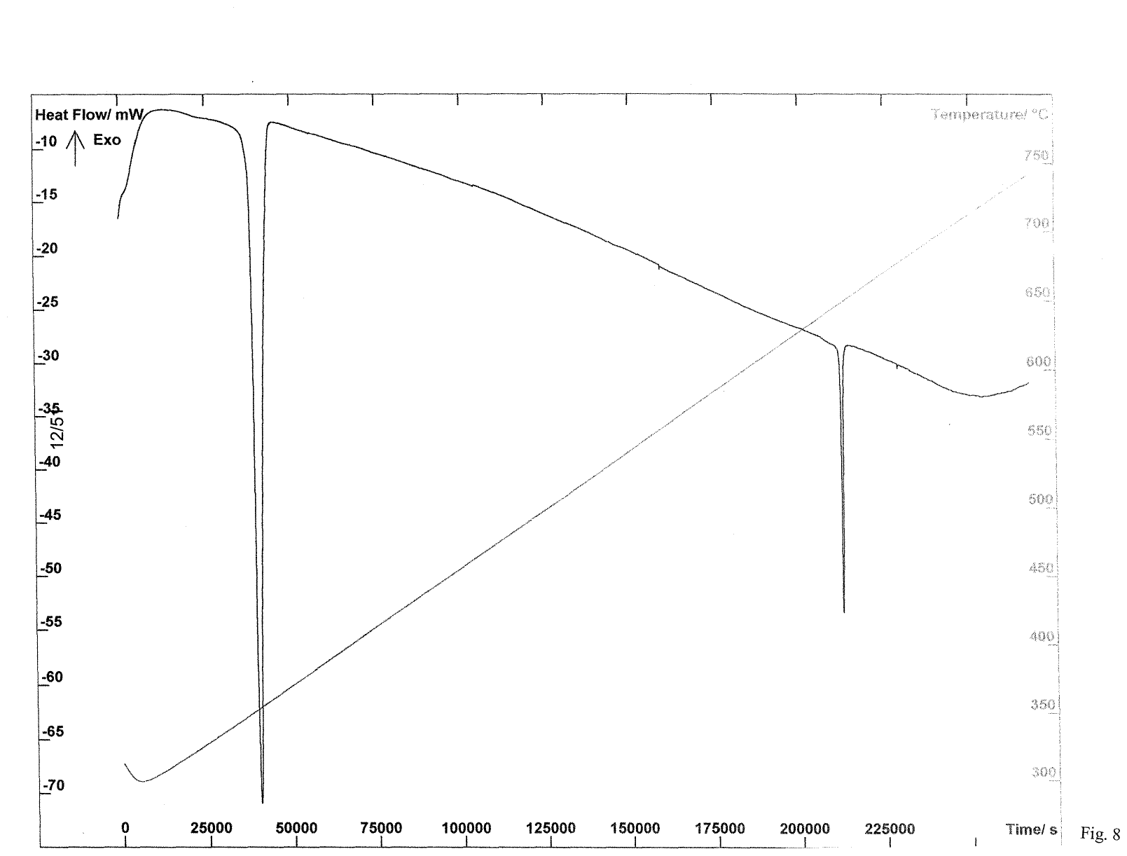

B. Differential Scanning calorimetry (DSC) Measurements. The DSC (100-750° C.) of NaH is shown in FIG. 7. A broad endothermic peak was observed at 350° C. to 420° C. which corresponded to 47 kJ/mole. Sodium hydride decomposes in this temperature range with a corresponding enthalpy of 57 kJ I mole [71]. A large exotherm was observed in the region 640° C. to 825° C. which corresponded to −177 kJ I mole. The DSC (100-750° C.) of MgH₂ is shown in FIG. 8. Two sharp endothermic peaks were observed. A first peak was observed centered at 351.75° C. corresponding to 68.61 kJ/mole MgH₂. The decomposition of MgH₂ is observed at 440° C. to 560° C. corresponding to 74.4 kJ/mole MgH₂ [71]. In FIG. 8, a second peak was observed centered at 647.66° C. corresponding to 6.65 kJ/mole MgH₂. The known melting point of Mg(m) is 650° C. corresponding to an enthalpy of fusion of 8.48 kJ/mole Mg(m) [72]. Thus, the expected behavior was observed for the decomposition of a control, noncatalyst hydride. In contrast, a novel exothermic effect of −177 kJ/mole NaH or at least −354 kJ/mole H₂ was observed under conditions that form NaH catalyst with some portion of the H undergoing the catalysis reactions given by Eqs. (23-25). The observed enthalpy was greater than that of the most exothermic reaction possible for H₂ the −241.8 kJ/mole H₂ enthalpy of combustion of hydrogen.
C. Water-Flow calorimetry Power Measurements. In each test, the energy input and energy output were calculated by integration of the corresponding power. For the input power, the voltage and current measured at the end of each time interval were multiplied by the time interval (typically 10 seconds) to obtain the energy increment in Joules. All energy increments were summed over the entire experiment after the equilibration period to obtain total energy. For output energy, the thermistor offset was calculated after each test assuming that the final readings of inlet and outlet temperature were identical. This offset was calculated to be 0.036° C. The thermal energy in the coolant flow in each time increment was calculated using Eq. (39) by multiplying volume flow rate of water by the water density at 19° C. (0.998 kg/liter), the specific heat of water (4.181 kJ/kg-° C.), the corrected temperature difference, and the time interval. Values were summed over the entire experiment to obtain the total energy output. The total energy from cell E_{T} must equal the energy input Eᵢₙ and any excess energy Eₑₓ:

E_{T}=Eᵢₙ+Eₑₓ (43)

From the energy balance, any excess heat was determined.

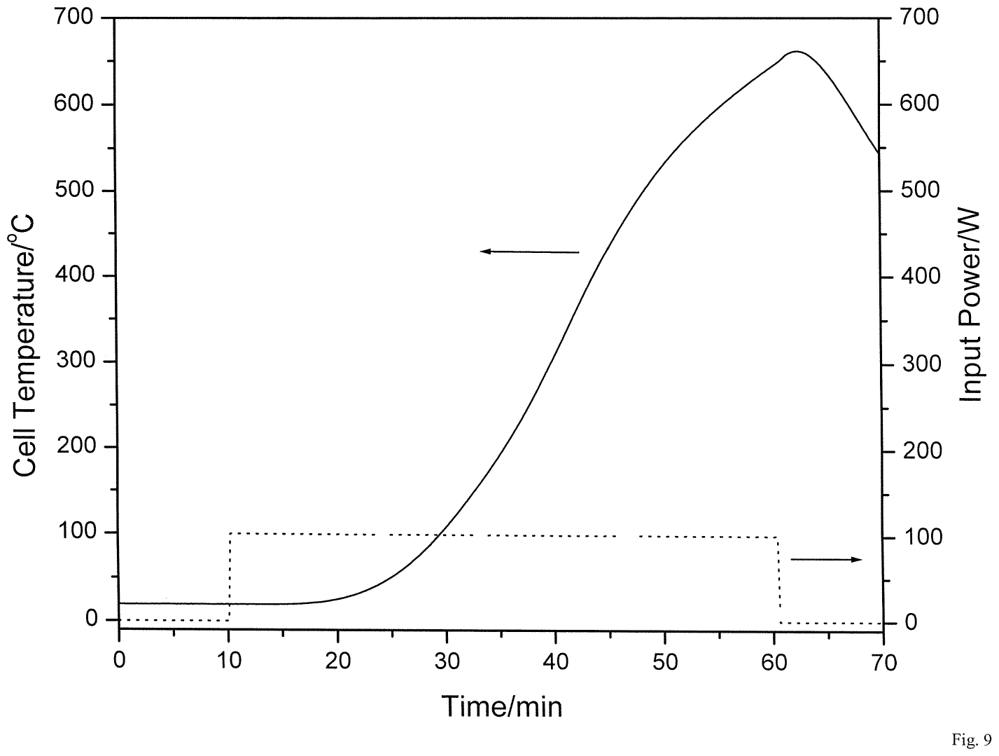

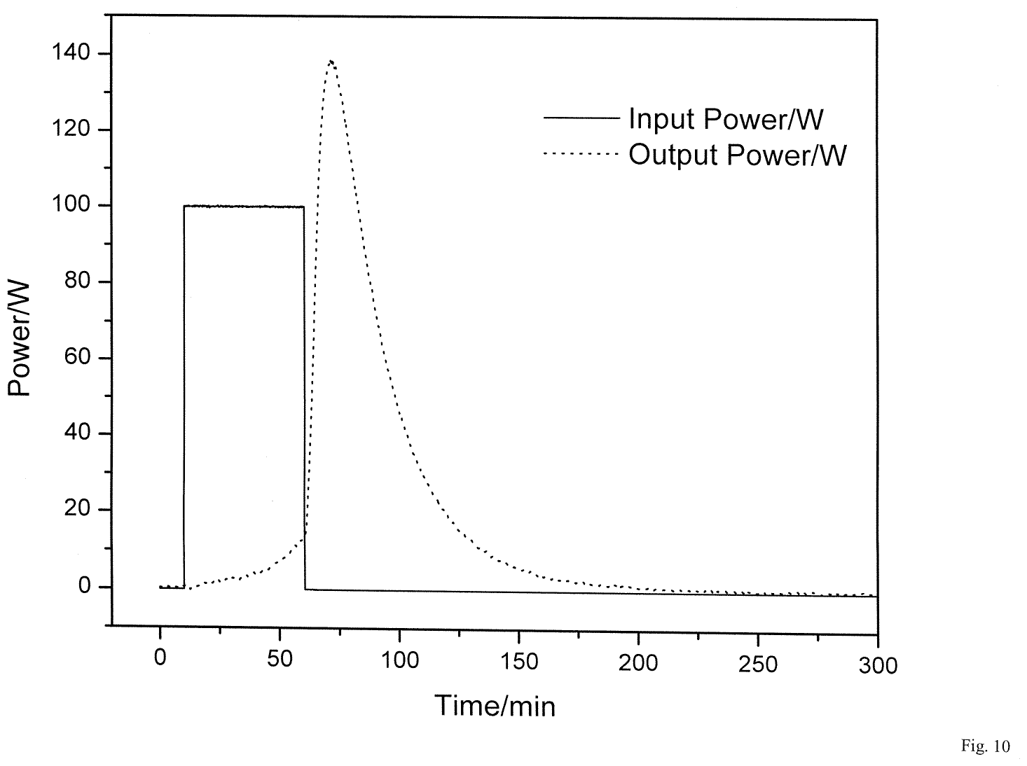

The calibration test results are shown in FIGS. 9 and 10. In the plot of FIG. 10, there is a time point at which the slope of the coolant power changes almost discontinuously. This point at about one hour corresponds to the helium addition enhancing heat transfer from the cell to the chamber wall. The numerical integration of the input and output power curves yielded an output energy of 292.2 kJ and an input energy of 303.1 kJ corresponding to a coupling of flow of 96.4% of the resistive input to the output coolant.

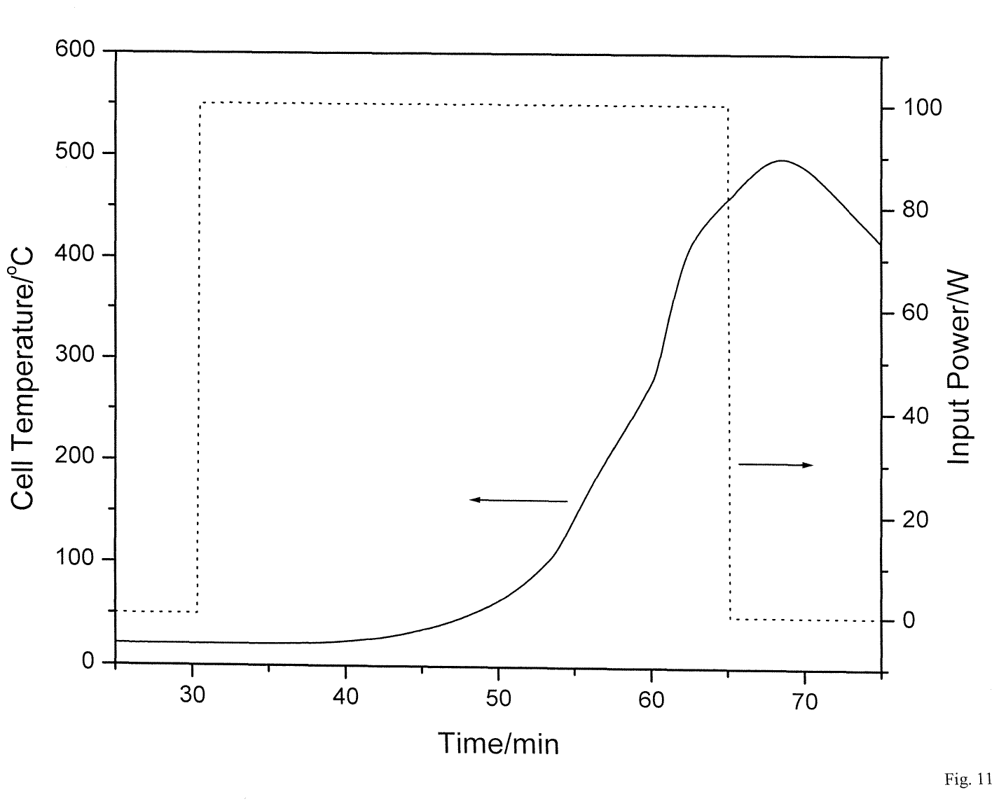

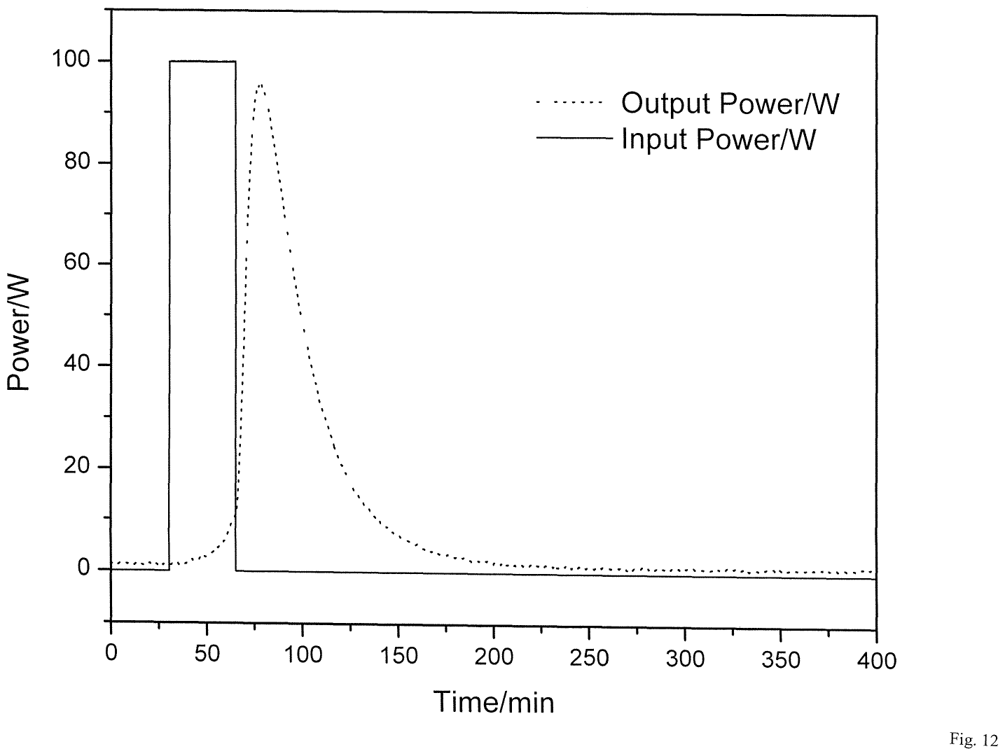

The cell temperature with time and the coolant power with time for the hydrino reaction with the cell containing the reagents comprising the catalyst material, 1 g Li, 0.5 g LiNH₂, 10 g LiBr, and 15 g Pd/Al₂O₃ are shown in FIGS. 11 and 12, respectively. The numerical integration of the input and output power curves with the calibration correction applied yielded an output energy of 227.2 kJ and an input energy of 208.1 kJ. Thus, from Eq. (43), the excess energy was 19.1 kJ. In the plot of FIG. 12, there is a point at which the slope of the temperature changes almost discontinuously. The slope change occurs just slightly after 1 hour, and this corresponds to the cell temperature rising rapidly with the onset of reaction. Based on the system response to a power pulse, the excess energy of 19.1 kJ occurred in less than 2 minutes which places the power for the reaction at over 160 W.

The quantitative XRD of the composition of the products following the reaction showed that the LiBr and Pd/Al₂O₃ were unchanged. Thus, assuming a 100% yield, the maximum theoretical energy released by known chemistry is 4.3 kJ from the formation lithium nitride and hydride according to Eq. (22); whereas, the observed energy balance was 4.4 times this maximum. The only exothermic reaction possible to account for the energy balance is that given by Eqs. (17-19). The hydrogen content of the 0.5 g LiNH₂ was 22 mmoles H₂. Thus, the observed energy balance is −870 kJ/mole H₂, over 3.5 times the −241.8 kJ/mole H₂ enthalpy of combustion, the most energetic reaction of hydrogen assuming the maximum possible H₂ inventory.

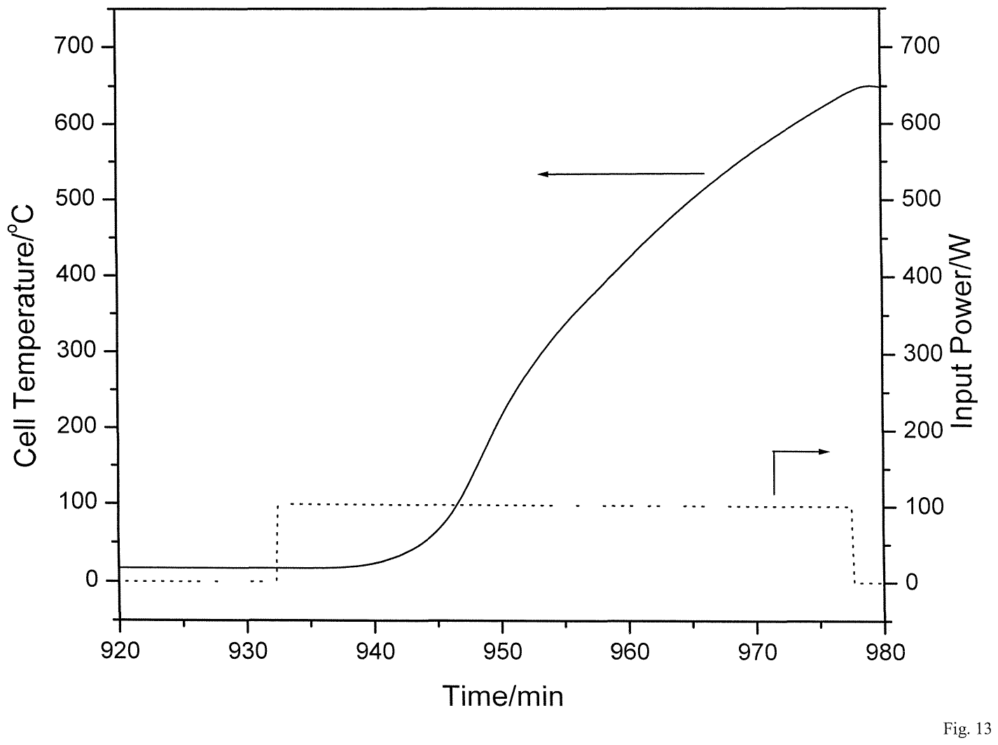

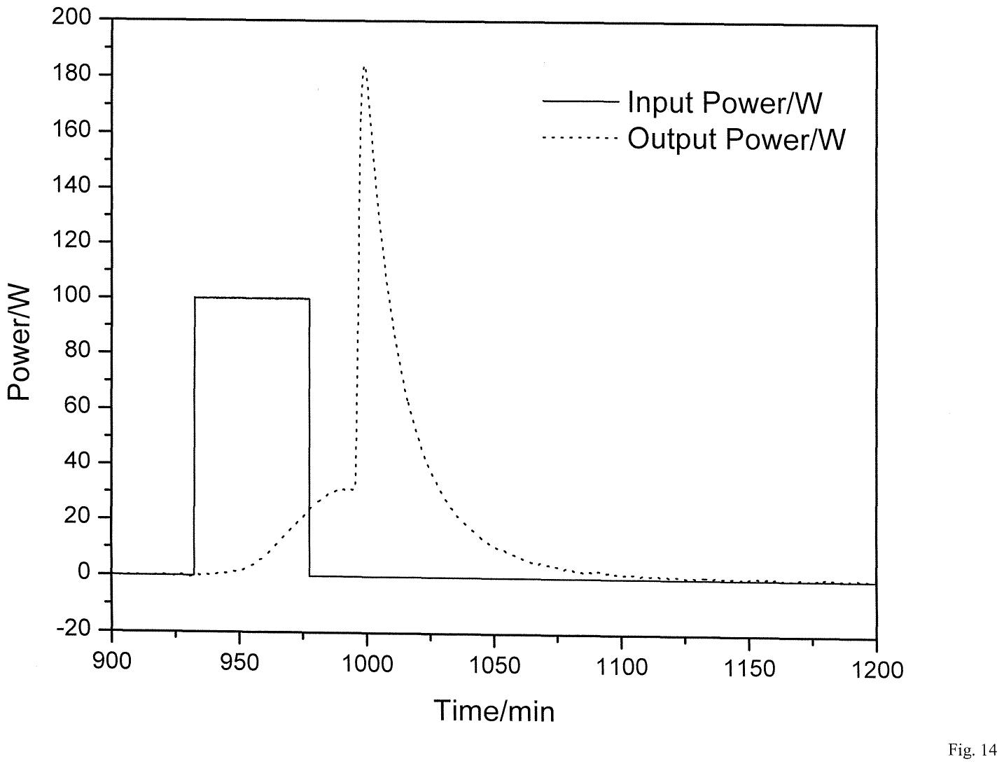

The cell temperature with time and the coolant power with time for the R-Ni control power test with the cell containing the reagents comprising the starting material for R-Ni, 15 g R-Ni/Al alloy powder, and 3.28 g of Na are shown in FIGS. 13 and 14, respectively. The temperature and coolant power time profiles curves were very similar to the calibration. The numerical integration of the input and output power curves with the calibration correction applied yielded an output energy of 384 kJ and an input energy of 385 kJ. Energy balance was obtained.

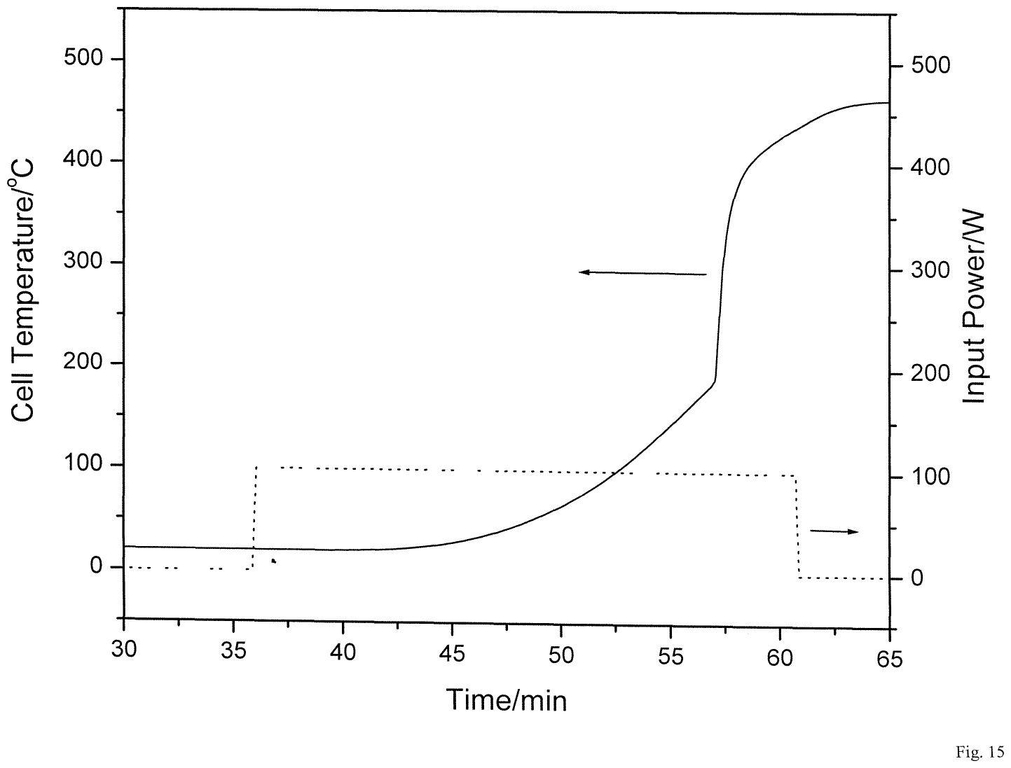

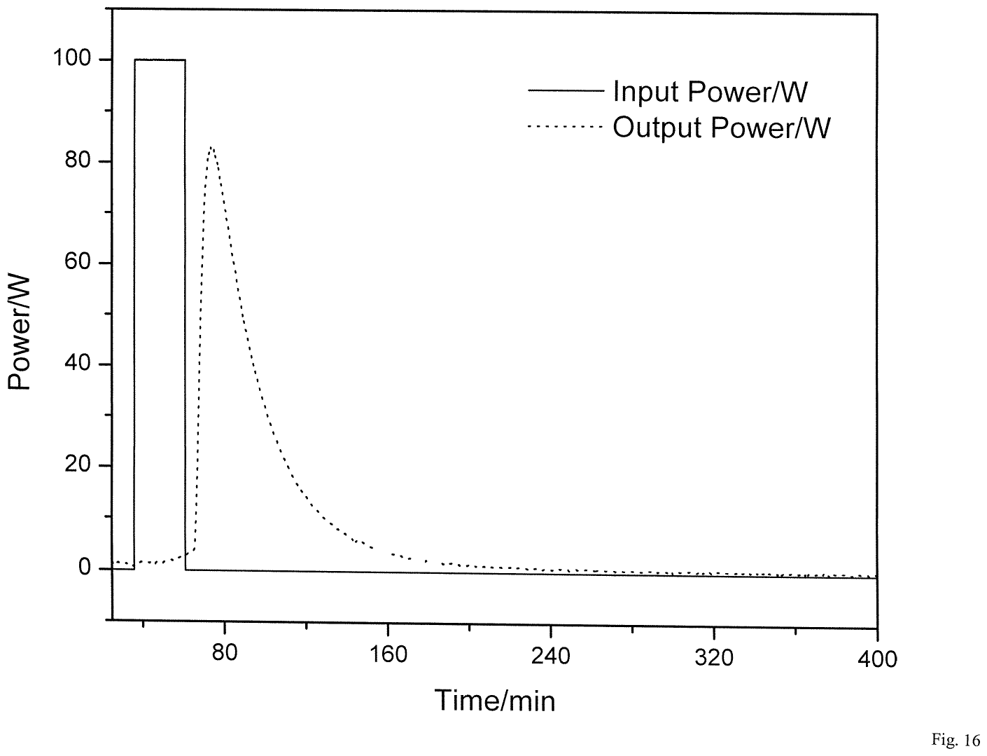

The cell temperature with time and the coolant power with time for the hydrino reaction with the cell containing the reagents comprising the catalyst material, 15 g NaOH-doped R-Ni, and 3.28 g of Na are shown in FIGS. 15 and 16, respectively. The numerical integration of the input and output power curves with the calibration correction applied yielded an output energy of 185.1 kJ and an input energy of 149.1 kJ. Thus, from Eq. (43), the excess energy was 36 kJ. In the plot of FIG. 15, there is a point at which the slope of the temperature changes almost discontinuously. The slope change occurs just slightly before 1 hour, and this corresponds to the cell temperature rising rapidly with the onset of reaction. Based on the system response to a power pulse, the excess energy of 36 kJ occurred in less than 1.5 minutes which places the power for the reaction at over 0.5 kW.

The composition of the reactant NaOH-doped R-Ni and the product following the reaction with the alkali metal determined by quantitative XRD was Ni with trace Bayerite and Ni with trace alkali hydroxide, respectively. The formation of a sodium-Ni alloy or the reaction of sodium with Al₂O₃ of R-Ni [73-74] is significantly endothermic (ΔH=+138 kJ/mole Na [75] and ΔH=+72.18 kJ/mole Na [65], respectively). Using the heat of formations, the reaction of Bayerite with sodium to form NaOH (ΔH=−15.6 kJ/mole Al(OH)₃ [65, 76]) contributes negligibly to the energy balance based on the XRD analysis showing trace Bayerite initially and the corresponding NaOH product from reaction with Na. Consistent with the literature [74], the H₂O content from Bayerite decomposition was 47.7 μmoles H₂O/g R-Ni corresponding to a negligible contribution due to the formation of NaOH (ΔH=−184.0 mole H₂O [65]) from the decomposition of Al(OH)₃ (2Al(OH)₃→Al₂O₃+3H₂O ΔH=+92.45 kJ/mole Al). The overall reaction is the reaction of Bayerite with sodium to form NaOH (ΔH=−15.6 kJ/mole Al(OH)₃).

The only exothermic reaction possible to account for the energy balance is that given by Eqs. (23-25). The hydrogen content of the R-Ni determined using quantitative GC and by using the ideal gas law on the measured P, V, and T was 150 μmoles H₂/g R-Ni. Thus, the observed energy balance is −1.6×10⁴ kJ/mole H₂, over 66 times the −241.8 kJ/mole H₂ enthalpy of combustion, the most energetic reaction of hydrogen assuming the maximum possible H₂ inventory. The conservative theoretical energy yield for the reaction of Eq. (44) is 259 eV/H₂ or 25 MJ/moleH₂(Eq. (7)).

H₂→H₂(1/3) (44)

Among the most energetic known oxidation reactions involving a solid fuel is the reaction Be+1/2O₂→BeO, which has a heat of combustion of 24 kJ/g, and there are very few known fuel/oxidizer systems producing greater than 10 kJ/g [65]. As a comparison, even without possibly going to completion, the H content of the recyclable catalyst NaH produced energy of over 300 times that of the best known solid fuel per weight.

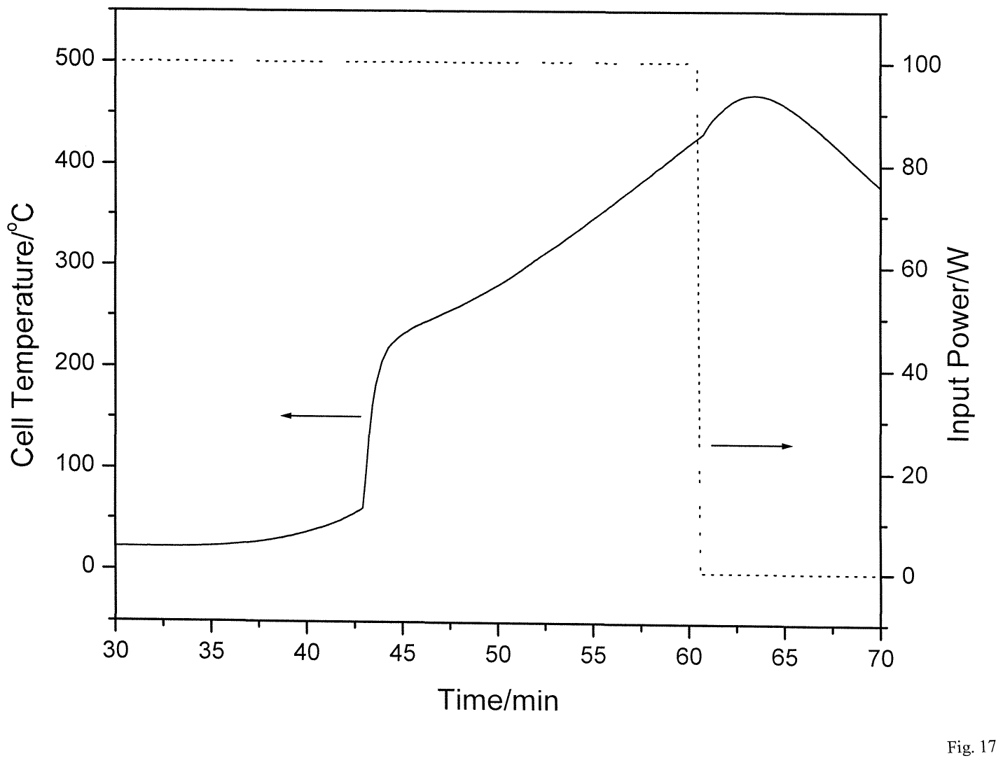

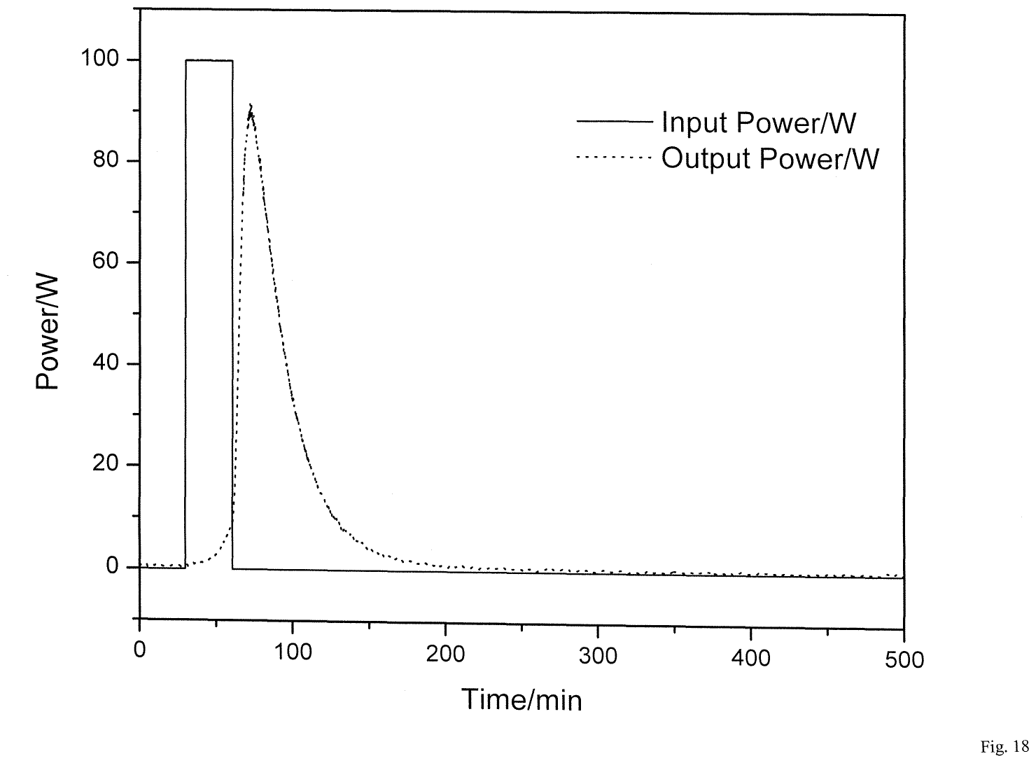

With increased NaOH doping and a switch to R-Ni 2400, the catalytic material generated high power and energy without requiring the addition of Na. The cell temperature with time and the coolant power with time for the hydrino reaction with the cell containing the catalyst material, 15 g NaOH-doped R-Ni 2400, are shown in FIGS. 17 and 18, respectively. The numerical integration of the input and output power curves with the calibration correction applied yielded an output energy of 195.7 kJ and an input energy of 184.0 kJ corresponding to an excess energy of 11.7 kJ, and the power was over 0.25 kW.

The composition of the reactant NaOH-doped R-Ni and the product following the reaction determined by quantitative XRD was R-Ni with 3.7 wt % Bayerite and R-Ni, respectively. The measured H₂O content from Bayerite decomposition of the initial R-Ni was 32.8 μmoles H₂O/g R-Ni compared to the measured H₂O content from Bayerite decomposition of 34.0 μmoles H₂O/g for 3 wt % Al(OH)₃ doped Ni/Al alloy. The most exothermic reaction possible was the reaction of Al(OH)₃ to Al₂O₃. The balanced reaction is given by [65, 75, 77]:

2Al(OH)₃+2Ni₅Al→2Al₂O₃+Ni₁₀H₆ ΔH=−263.9 kJ/mole Al(OH)₃ (45)

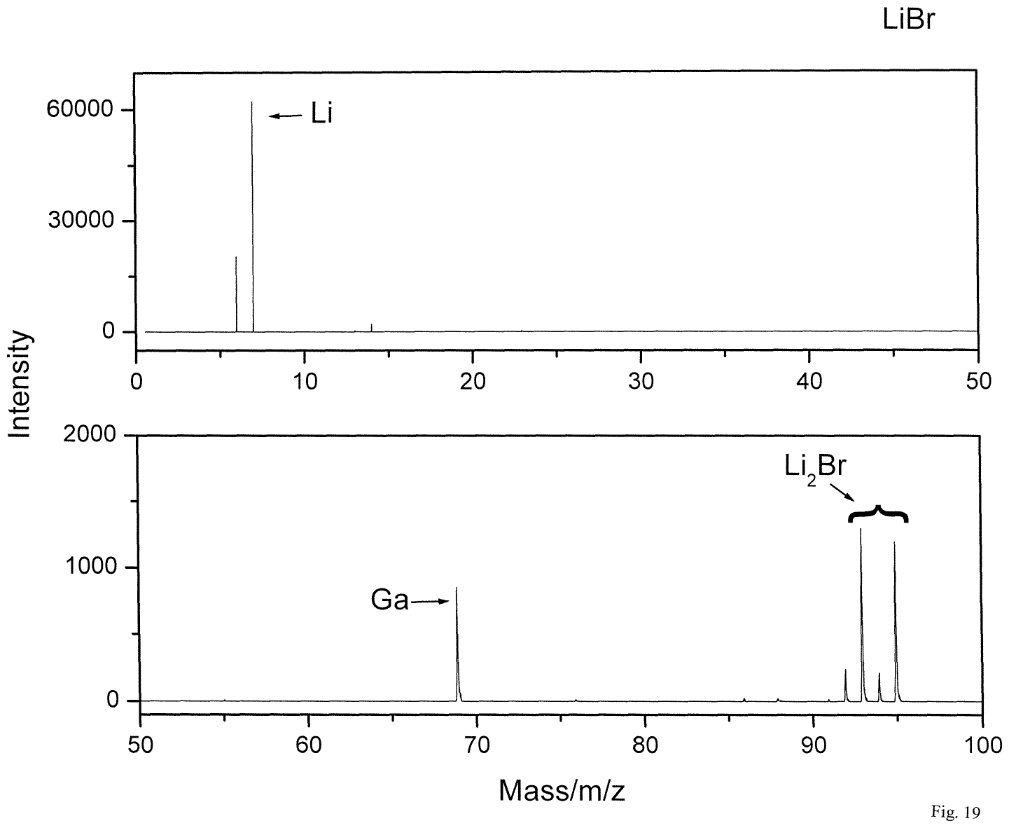

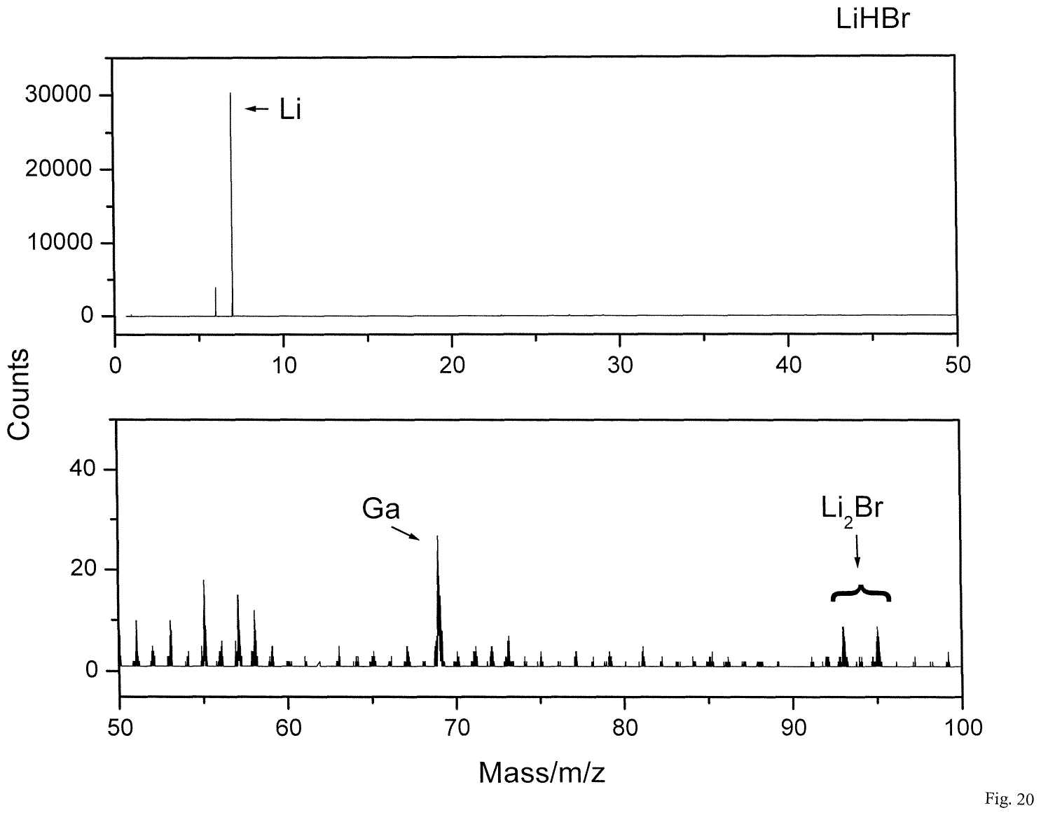

For 3.7 wt % Al(OH)₃, the maximum theoretical energy from the reaction given by Eq. (45) is ΔH=−1.88 kJ. This was confirmed by the heat measurement of 15 g of 3 wt % Al(OH)₃ doped Ni/Al alloy that showed and average energy of ΔH=−1.1 kJ compared to the theoretical energy of ΔH=−1.7 kJ (ΔH=−300 kJ/mole Al(OH)₃ using Eq. (45) with ΔH_{f}(NiAlcrystal)=−96 kJ/mole [75]). Thus, the observed energy from the NaOH-doped R-Ni was 4.4 times the theoretical; thus, it was predominantly attributable to the catalysis reaction given by Eqs. (23-25).
D. ToF-SIMS Spectra. The positive ToF-SIMS spectrum obtained from LiBr and the LiH*Br crystals are shown in FIGS. 19 and 20, respectively. The positive ion spectrum of the LiH*Br crystals and that of the LiBr control were dominated by the Li⁺ ion. Li₂⁺, Na⁺, Ga⁺, and Li(LiBr)⁺ were also observed.

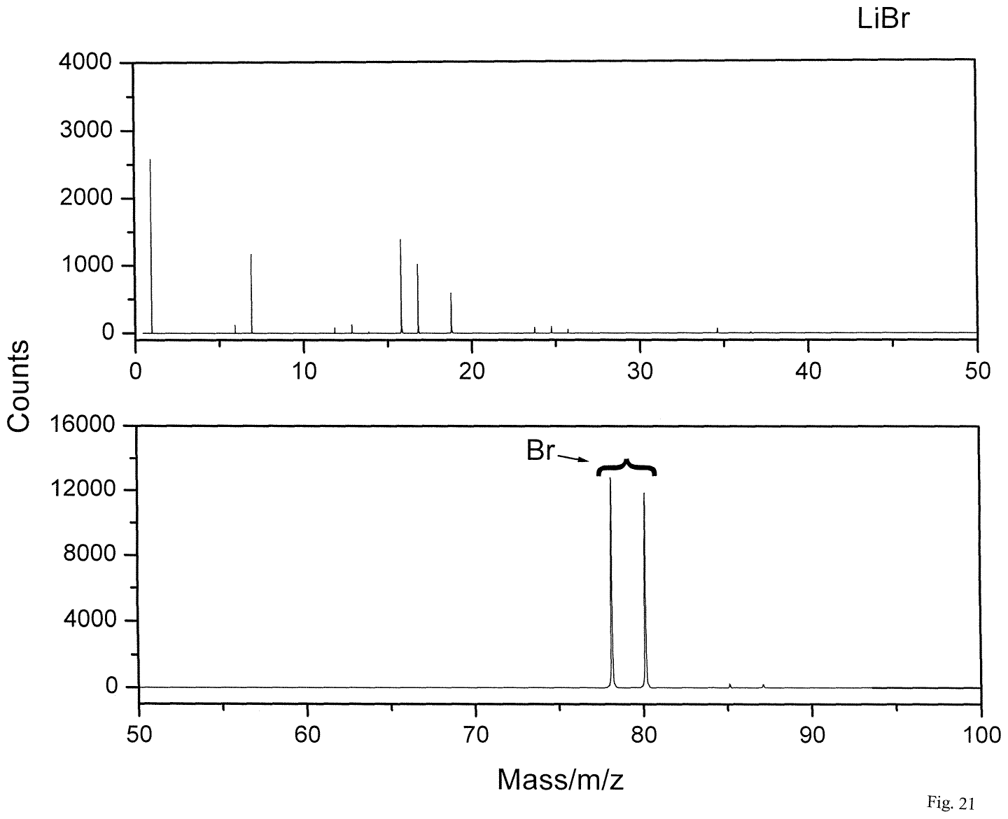

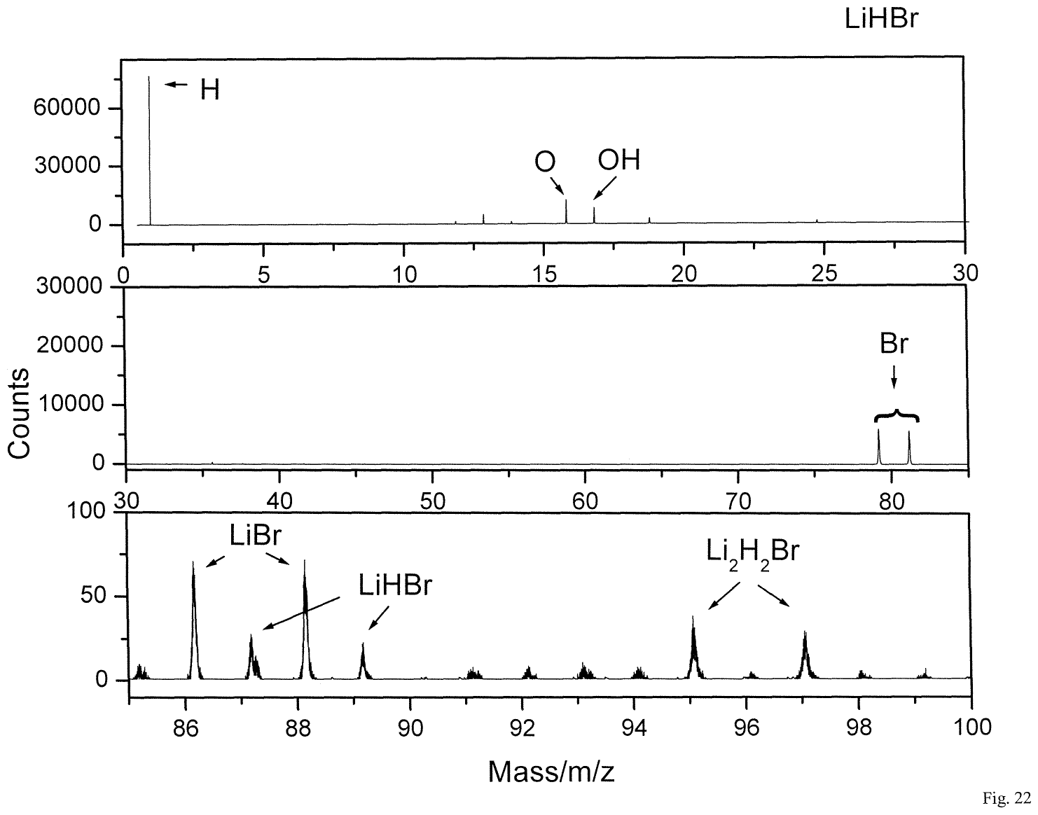

The negative ion ToF-SIMS of LiBr and the LiH*Br crystals are shown in FIGS. 21 and 22, respectively. The LiH*Br spectrum was dominated by H⁻ and Br⁻ peaks with the intensity of H⁻>Br⁻. Bromide alone dominated the negative ion ToF-SIMS of the LiBr control. For both, O⁻, OH⁻, Cl⁻, and LiBr⁻ were also observed. In addition to the increased hydride, other unique peaks of the LiH*Br sample were LiHBr⁻ and Li₂H₂Br⁻ consistent with the formation of novel lithium bromohydride.

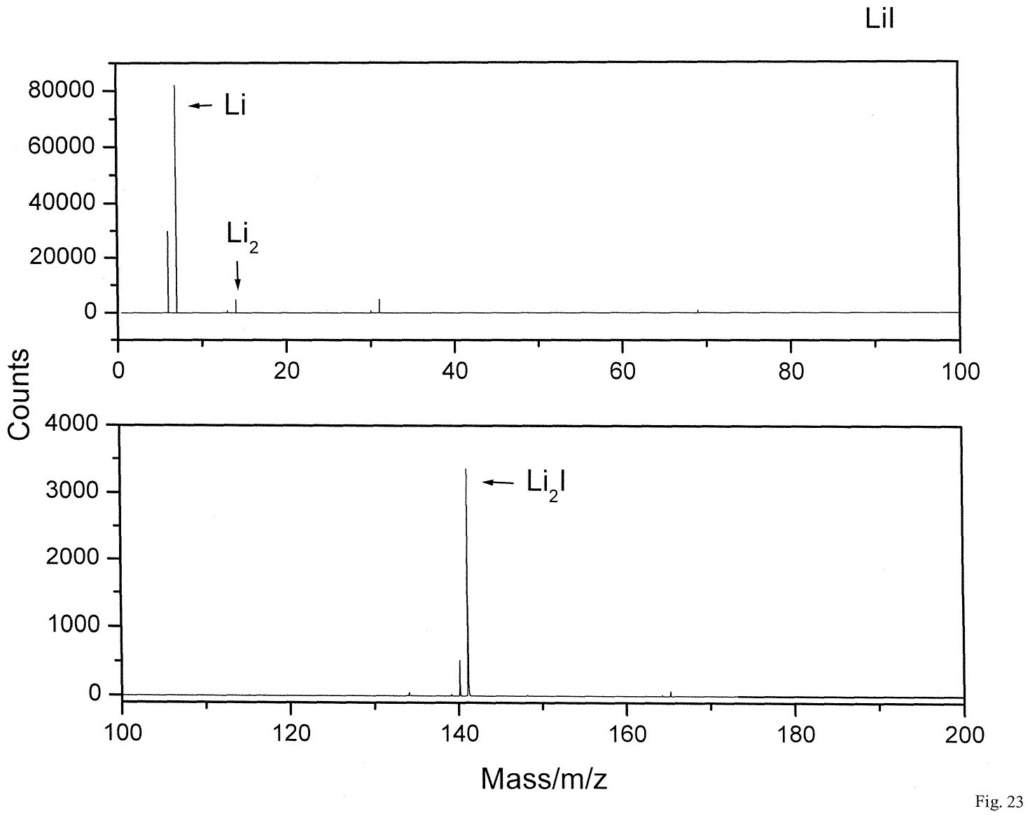

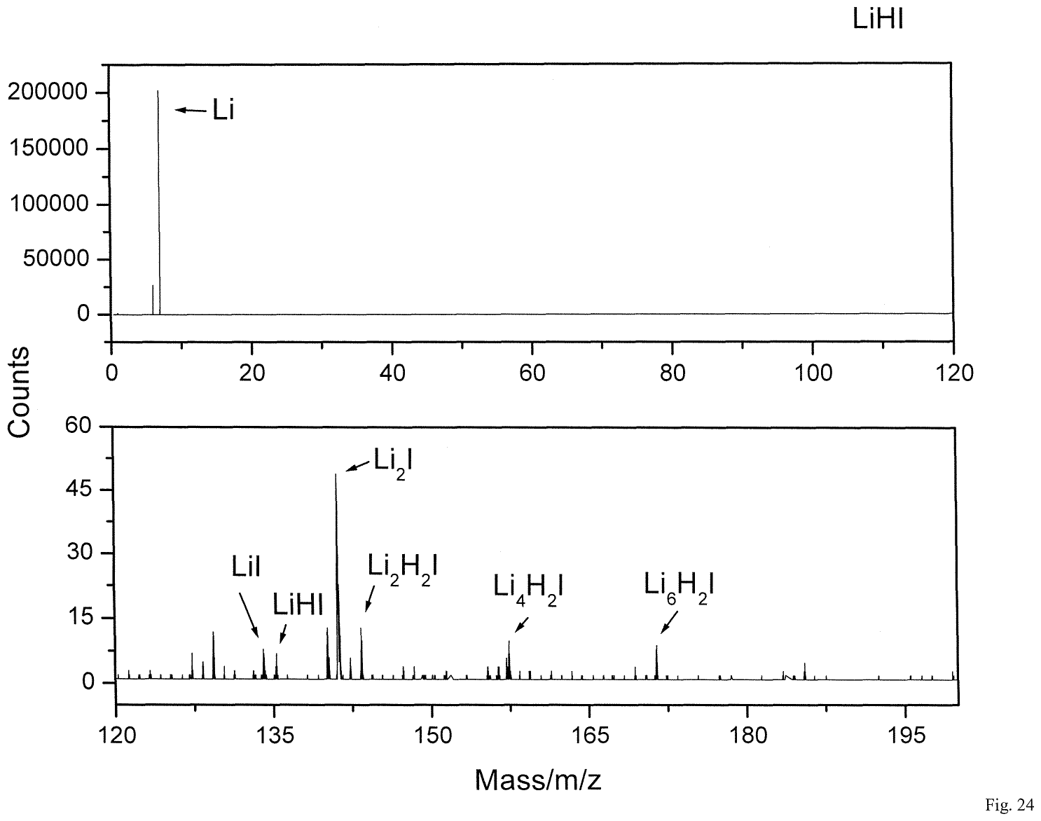

The positive ToF-SIMS spectrum obtained from LiI and the LiH*I crystals are shown in FIGS. 23 and 24, respectively. The positive ion spectrum of the LiH*I crystals and that of the LiI control were dominated by the Li⁺ ion. Li₂⁺, Na⁺, Ga⁺, and a series of positive ions Li[LiI]ₙ⁺ were also observed. Unique peaks of the LiH*I sample were LiHI⁺, Li₂H₂I⁺, Li₄H₂I⁺, and Li₆H₂I⁺.

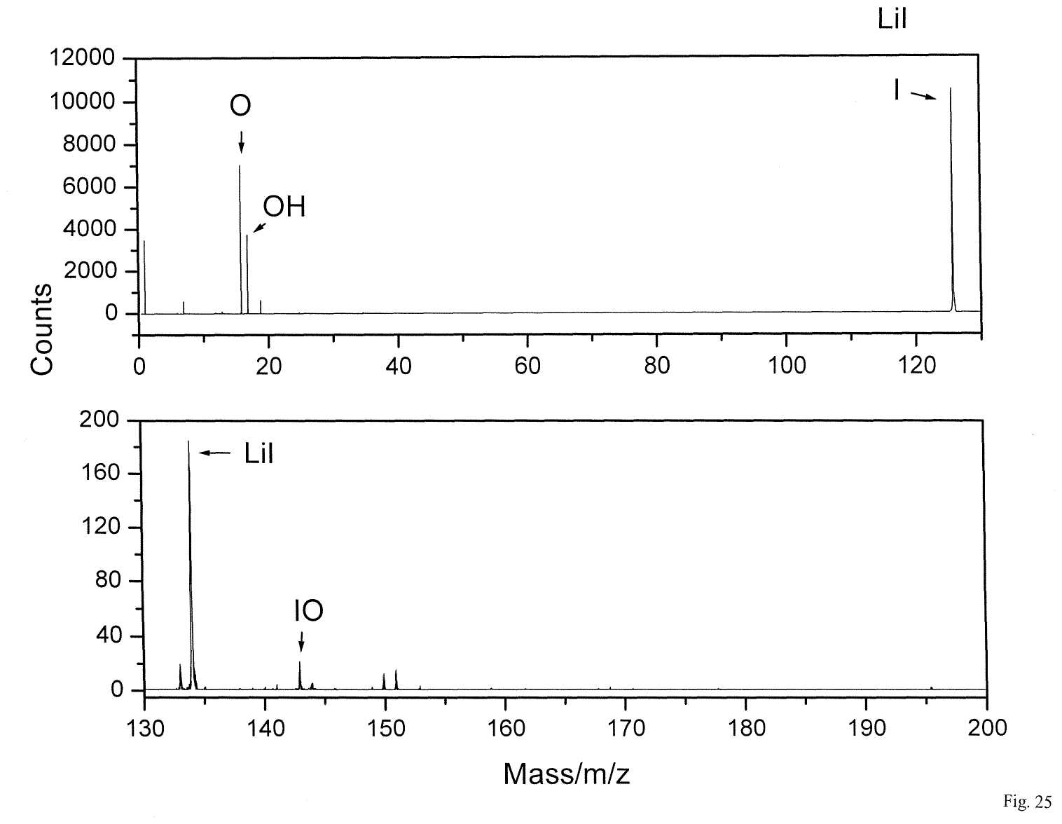

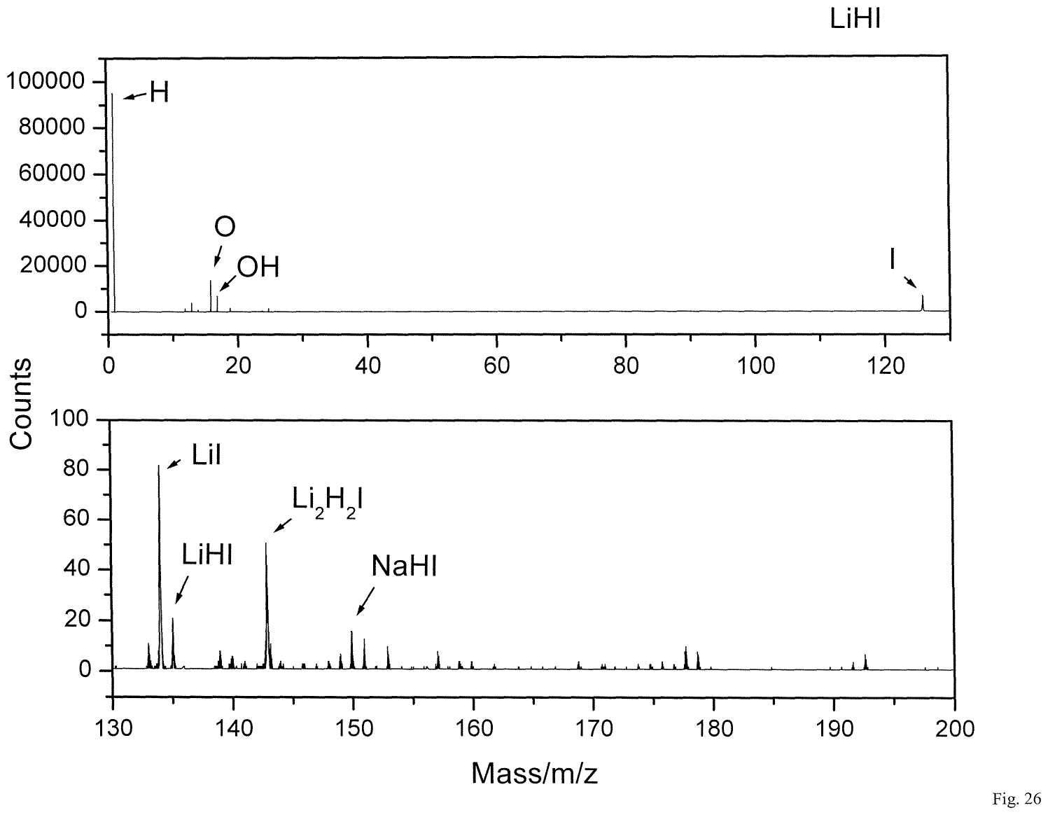

The negative ion ToF-SIMS of LiI and the LiH*I crystals are shown in FIGS. 25 and 26, respectively. The LiH*I spectrum was dominated by H⁻ and I⁻ peaks with the intensity of H⁻>I⁻. Iodide alone dominated the negative ion ToF-SIMS of the LiI control. For both, O⁻, OH⁻, Cl⁻, and a series of negative ions I[LiI]ₙ⁻ were also observed. In addition to the increased hydride, other unique peaks of LiH*I sample were LiHI⁻, Li₂H₂I⁻, and NaHI⁻ consistent with the formation of novel lithium iodohydride.

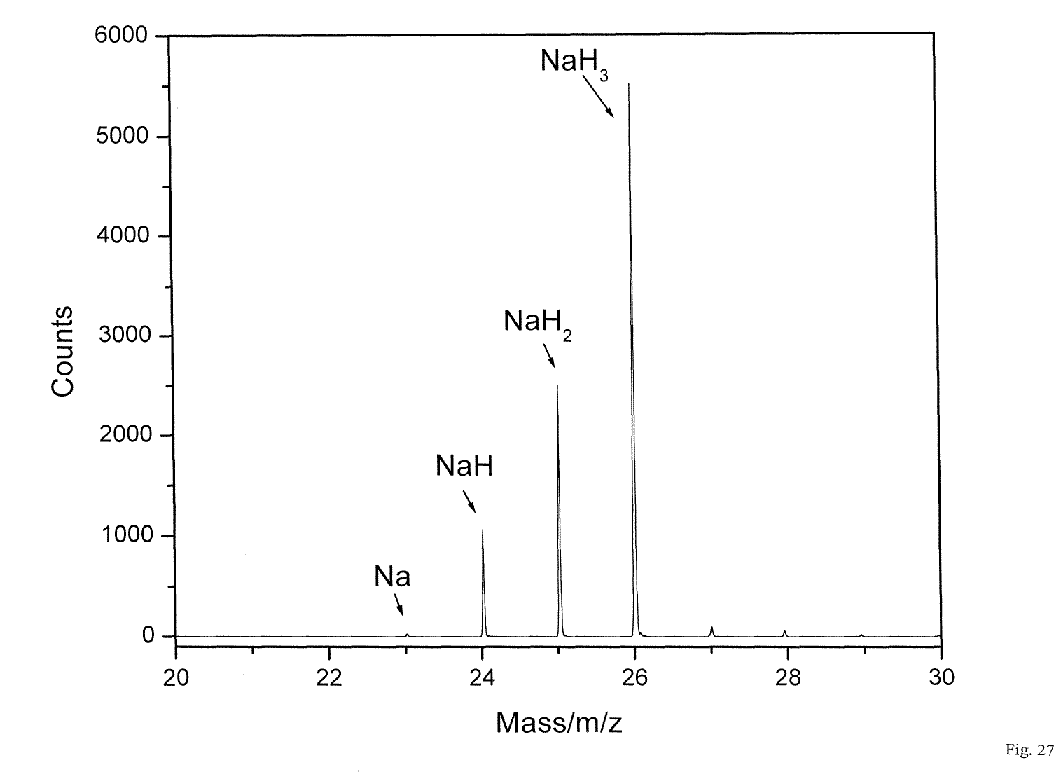

The negative ToF-SIMS spectrum (m/e=20-30) of NaH*-coated PtITi following the production of 15 kJ of excess heat is shown in FIG. 27. Hydrino-hydride-compound series NaHₓ⁻ was observed wherein the mass deficit from the high resolution (10,000) mass determination definitively distinguished this assignment over the C₂Hₓ⁻ series observed in controls. The XPS spectrum showed that NaH*-coated Pt/Ti comprised two fractional hydrogen states, H⁻(1/3) and H⁻(1/4) (Sec. IIIF).

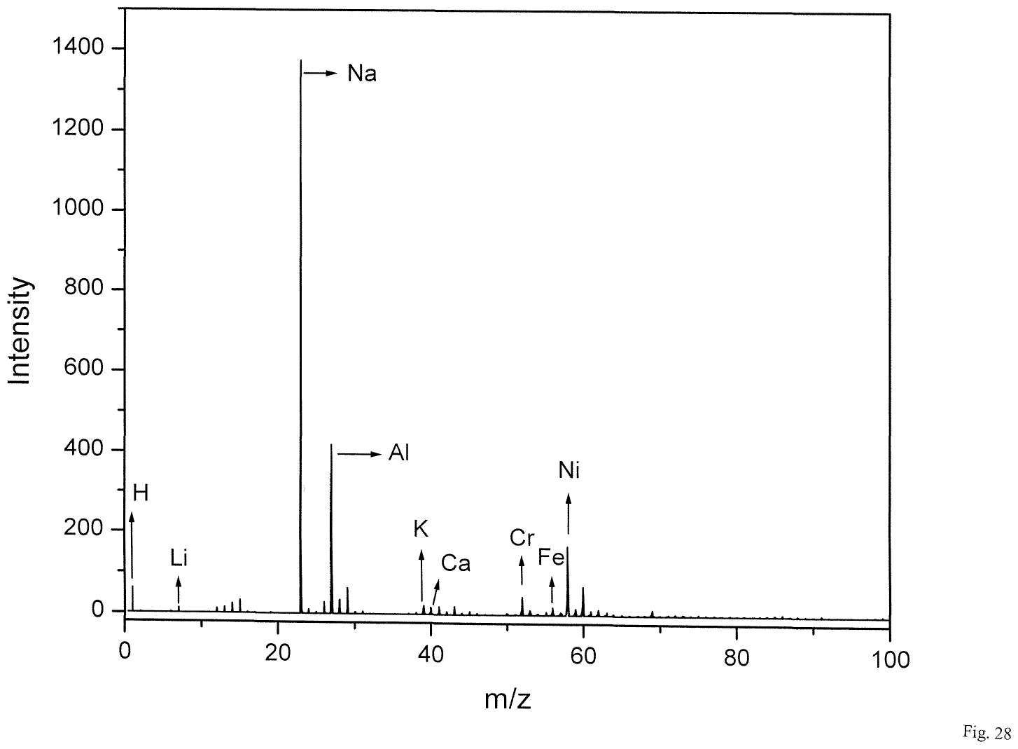

NaHₓ⁻ having the mass-deficit series was also observed in the spectrum of R-Ni from the Na/R-Ni water-flow calorimetric run that produced 36 kJ of excess heat. The positive ToF-SIMS spectrum obtained from R-Ni reacted over a 48 hour period at 50° C. is shown in FIG. 28. The dominant ion on the surface was Na⁺ consistent with NaOH doping of the surface. The ions of the other major elements of R-Ni 2400 such as Al⁺, Ni⁺, Cr⁺, and Fe⁺ were also observed.

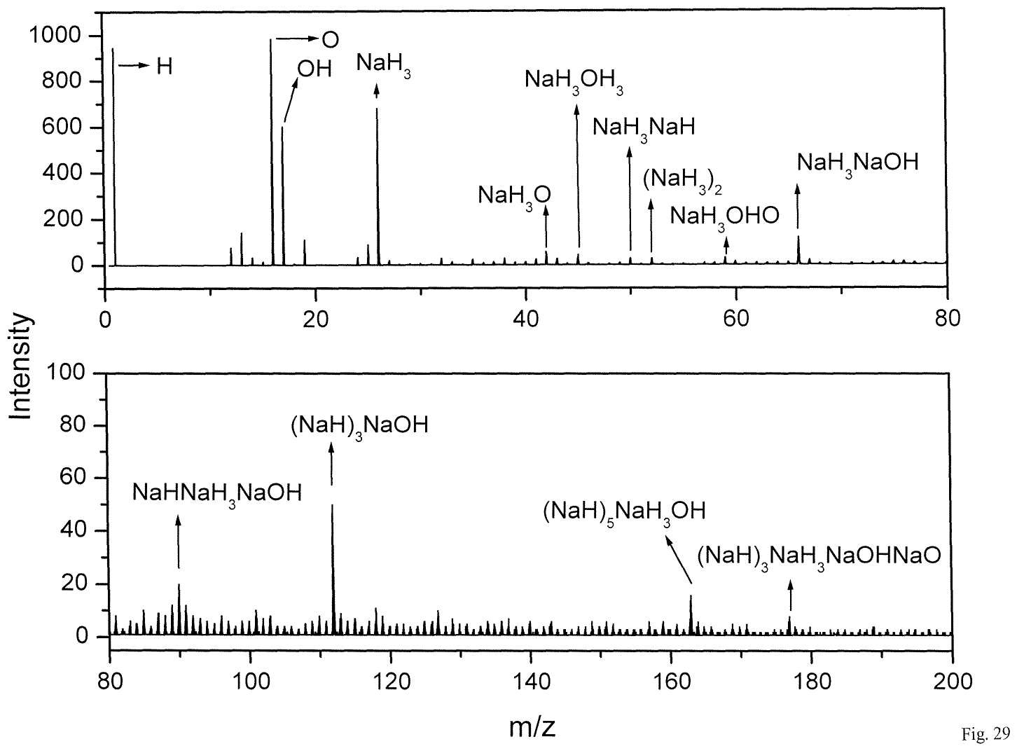

The negative ion ToF-SIMS of R-Ni reacted over a 48 hour period at 50° C. is shown in FIG. 29. The spectrum showed a very large H⁻ peak as well as hydroxide fragments OH⁻ and O⁻. Two other dominant peaks matched the high resolution mass of NaH₃⁻ and NaH₃NaOH⁻ to 10,000 and were assigned to sodium hydrino hydride and this ion in combination with NaOH. Other unique ions assignable to sodium hydrino hydrides NaHₓ⁻ in combinations with NaOH, NaO, OH⁻ and O⁻ were observed.

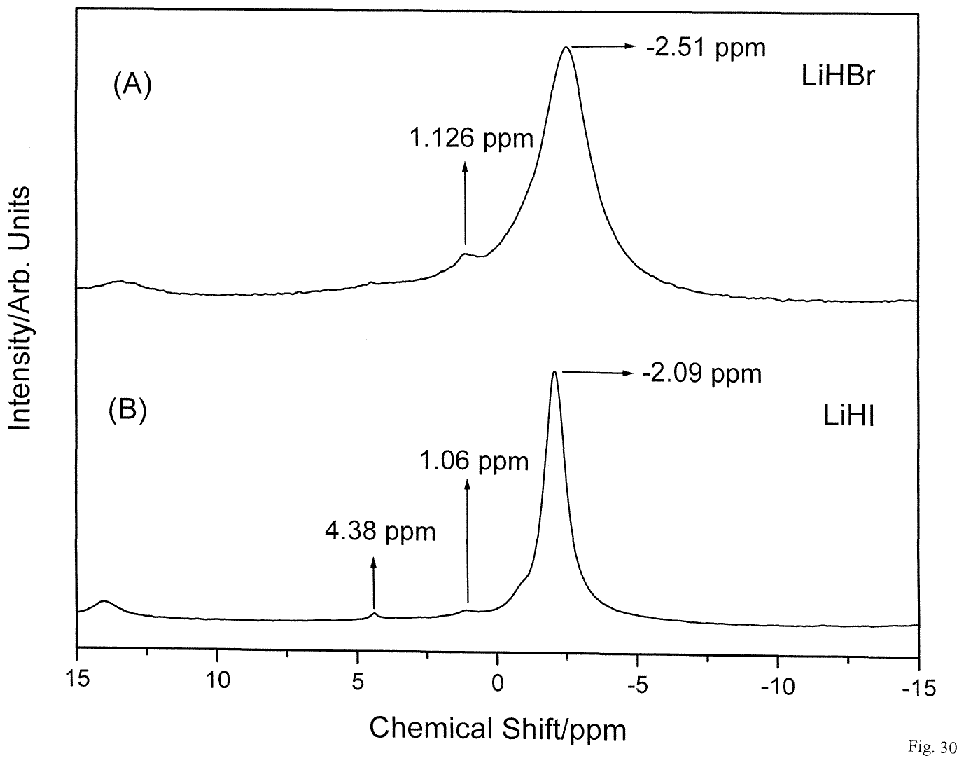

E. NMR Identification of H⁻(1/3), H⁻(1/4), H₂(1/3) and H₂(1/4). The ¹H MAS NMR spectra of LiH*Br and LiH*I relative to external TMS are shown in FIGS. 30A and 30B, respectively. LiH*X samples showed a large distinct upfield resonance at −2.51 ppm and −2.09 ppm for X=Br and X=I, respectively. None of the controls comprising LiH, equal molar mixtures of LiH and LiBr or Li LiNH₂, Li₂NH, and equal molar mixtures of LiNH₂ or Li₂NH and LiBr or LiI showed an upfield-shifted peak. Since the upfield peak of LiH*X at about −2.2 ppm was very broad, it is useful to compare these results to those of the prior identification of H⁻(1/4) of KH*Cl and KH*I.

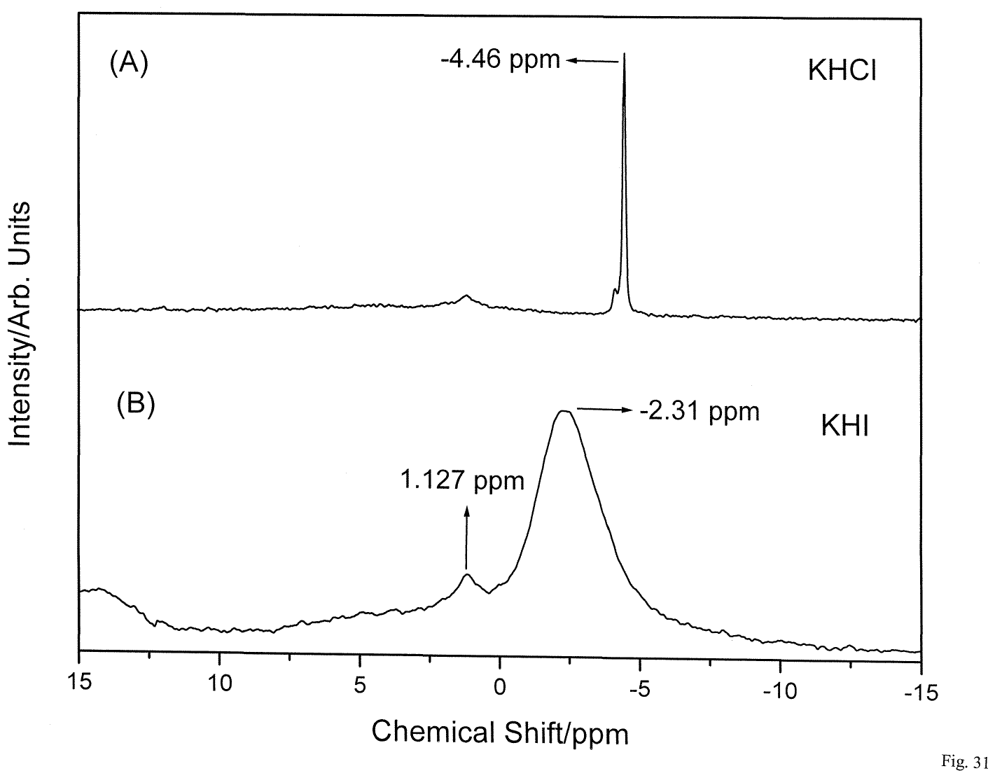

The ¹H MAS NMR spectra relative to TMS of KH*Cl samples (FIG. 31A) from independent syntheses and controls were given previously [13-15, 24-26]. The experimental absolute resonance shift of TMS is −31.5 ppm relative to the proton's gyromagnetic frequency [78-79]. The KH experimental shift of +1.1 ppm relative to TMS corresponding to absolute resonance shift of −30.4 ppm matches very well the predicted shift of H⁻(1/1) of −30 ppm given by Eq. (4) wherein p=0. The novel peak at −4.46 ppm relative to TMS corresponding to an absolute resonance shift of −35.96 ppm indicates that p=4 in Eq. (4). H⁻(1/4) is the hydride ion predicted by using K as the catalyst [1, 15, 30]. Furthermore, the extraordinarily narrow peak-width is indicative of a small hydride ion that is a free rotator. In contrast, KH*I (FIG. 31B) shows a very broad peak at −2.31 ppm. The predicted product hydride ion H⁻(1/4) of the reaction with K catalyst to form KH*I was observed by XPS [13-15, 26, 30] at its predicted binding energy of 11.2 eV. Thus, the diamagnetic shift due to the larger halide is +2.15 ppm. The corrected upfield NMR peaks for LiH*X are each about −4.46 ppm which matches the predicted shift of the free ion given by Eq. (4).

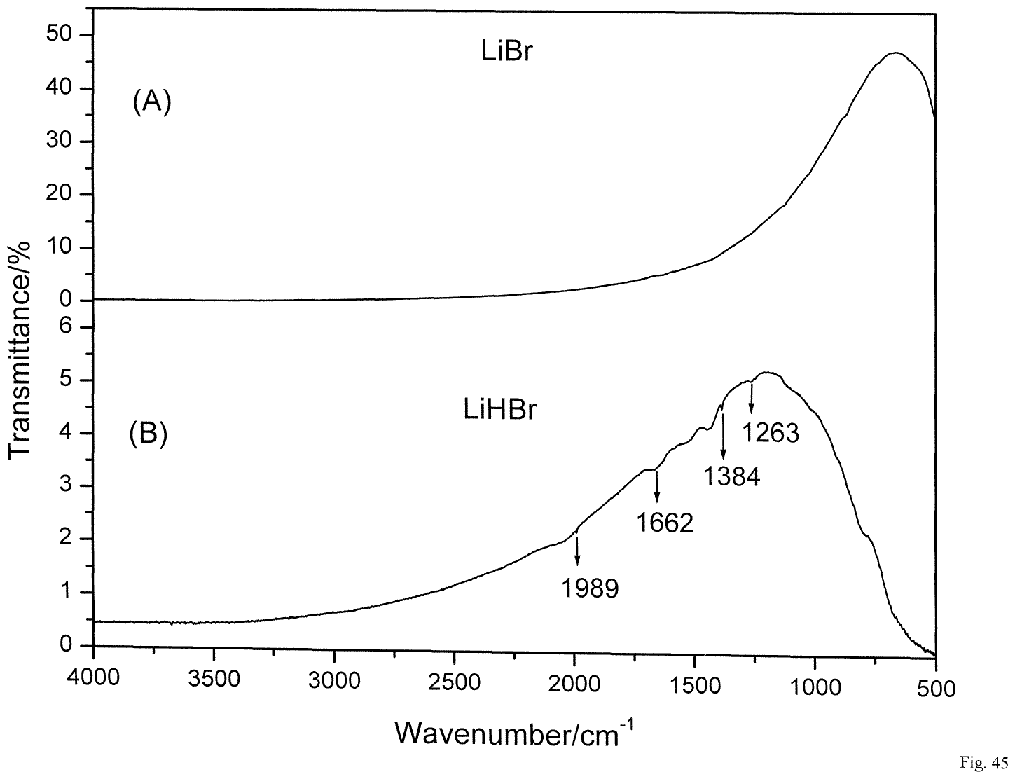

The elemental analysis of LiH*Br by wt % was Li (8%), H(1.1%), I (90.9%) corresponding stoichiometrically to LiHBr with the stainless steel and R-Ni components at less than detectable levels. The elemental analysis of LiH*I by wt % was Li (5.2%), H(0.8%), I (94%) corresponding stoichiometrically to LiHI with the stainless steel and R-Ni components at less than detectable levels. Thus, no hydrides other than those of Li are possible assignments. U H does not have an upfield-shifted NMR peak as determined previously [13-14]. F centers could not have been the source since no ESR signal was detectable in LiH*Br or LiH I at room temperature or 77 K. ¹H MAS NMR spectra obtained on LiNH₂, Li₂NH, and these compounds in a LiBr or LiI matrix also showed that neither of these compounds have an upfield-shifted NMR peak. To further eliminate LiNH₂ and Li₂NH as the source of the −2.5 ppm peak, LiH*Br samples with the −2.5 ppm peak were heated to >600° C. under dynamic vacuum to decompose LiNH₂ and Li₂NH. The heat-treated samples were analyzed by FTIR spectroscopy to confirm that the amide and imide were eliminated as indicated by the absence of the amide peaks at 3314, 3259, 2079(broad), 1567, and 1541 cm⁻¹ and the imide peaks at 3172 (broad), 1953, and 1578 cm while the −2.5 ppm peak remained upon reanalysis by NMR. The FTIR spectrum shown in FIG. 45B shows the elimination of these species while the corresponding NMR showed the −2.5 ppm peak. Since the past and present NMR and FTIR analysis leads to the conclusion that the −2.5 ppm peak in NMR spectrum is not associated with the U H, LiNH₂, LiNH₂, or any other known species, the −2.5 ppm peak in ¹H NMR spectrum is assigned to the H⁻(1/4) ion which matches theoretical prediction and is direct evidence of a lower-energy state hydride ion.

In addition to the −2.5 ppm and −2.09 ppm peaks assigned to H⁻(1/4), a 1.3 ppm peak was observed in the ¹H MAS NMR spectra of LiH*Br and LiH*I shown in FIGS. 30A. and 30B, respectively. None of the controls showed this peak which eliminated any of the starting compounds or their possible known products. However, the peak may be due to the H₂(1/4) molecule corresponding to H⁻(1/4).

H₂ has been characterized by gas-phase ¹H NMR. The experimental absolute resonance shift of gas-phase TMS relative to the proton's gyromagnetic frequency is −28.5 ppm [80]. H₂ was observed at 0.48 ppm compared to gas phase TMS set at 0.00 ppm [81]. Thus, the corresponding absolute H₂ gas-phase resonance shift of −28.0 ppm (−28.5+0.48) ppm was in excellent agreement with the predicted absolute gas-phase shift of −28.01 ppm given by Eq. (12).

The absolute H₂ gas-phase shift can be used to determine the matrix shift for H₂ in a lithium-compound matrix. The correction for the matrix shift can then be applied to the 1.3 ppm peak to determine the gas-phase absolute shift to compare to Eq. (12). The shifts of all of the peaks were relative to liquid-phase TMS which has an experimental absolute resonance shift of −31.5 ppm relative to the proton's gyromagnetic frequency [78-79]. The experimental shift of H₂ in a lithium-compound matrix of 4.06 ppm relative to liquid-phase TMS is shown in FIG. 7 of Lu et al. [82] and corresponds to an absolute resonance shift of −27.44 ppm (−31.5 ppm+4.06 ppm). Using the absolute H₂ gas-phase resonance shift of −28.0 ppm corresponding to 3.5 ppm (−28.0 ppm−31.5 ppm) relative to liquid TMS, the lithium-compound matrix effect is +0.56 ppm (4.06 ppm−3.5 ppm) requiring a correction of the measured shift of −0.56 ppm. Then, the peak upfield of H₂ at 1.26 ppm peak relative to TMS corresponds to a matrix-corrected absolute resonance shift of −30.8 ppm (−31.5 ppm+1.26 ppm−0.56 ppm). Using Eq. (12), the data indicates p=4 and matches H₂(1/4):

$$\frac{Δ {B}_{T}}{B} = - ( 28.01 + 0.64 p ) ppm = - ( 28.01 + 0.64 ( 4 ) ) ppm = - 30.6 ppm \qquad ( 46 )$$

Lu et al. [82] also observed a peak at this position that increased in intensity relative to H₂ with the duration of in situ heating of LiH+LiNH₂ (1.1/1). They were unable to assign the peak labeled unknown in their FIGS. 6 and 7. The assignment of the peak that matched the theoretical shift of H₂(1/4) extremely well, was confirmed by FTIR (Sec. IIIG) and electron beam-excitation emission spectroscopy (Sec. IIIH).

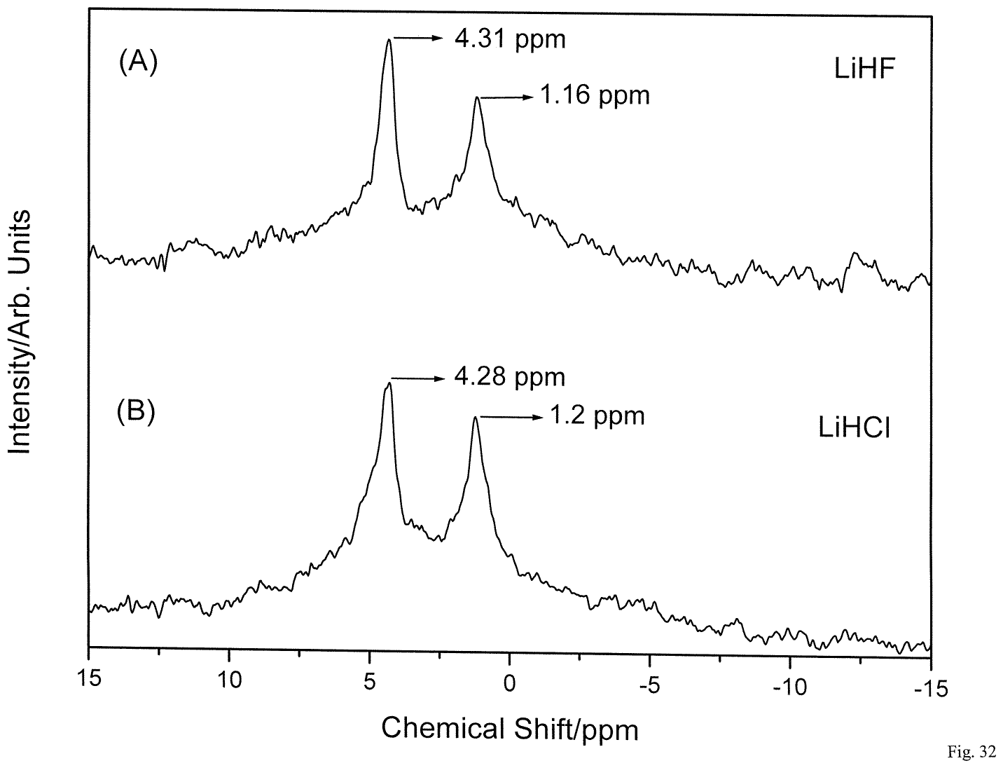

The presence of the H⁻(1/4) ion in LiH*X was found to depend on the polarizability of the halide ion. The ¹H MAS NMR spectra of LiH*F and LiH*Cl are shown in FIGS. 32A and 32B, respectively. Peaks at 4.3 ppm and 1.2 ppm matched theoretical predictions of molecular hydrogen in two different quantum states [1, 6]. The 4.3 ppm peak matched the assignment of Lu et al. [82] for H₂, and the 1.2 ppm peak labeled unknown by Lu et al. [82] matched H₂(1/4). The H₂(1/4) assignment was confirmed by the observation of the predicted rotational transition in the FTIR spectrum (Sec. IIIG) and the predicted rotational spacing by electron beam-excitation emission spectroscopy (Sec. IIIH). The H⁻(1/4) ion peak was absent in LiH*F comprising a nonpolarizable fluorine as well as in LiH*Cl comprising a nonpolarizable chlorine; whereas, it was the dominant peak in both LiH*Br and LiH*I as shown in FIGS. 30A and 30B, respectively. These results indicate that a polarizable halide is required for LiX to react with the H⁻(1/4) ion to form the corresponding lithium halidohydride. Since molecular species are nonspecifically trapped in the crystalline lattice, the H-content selectivity of LiH*X for molecular species alone or in combination with H⁻(1/4) ions is based on the polarizability of the halide and the corresponding reactivity towards H⁻(1/4). Potassium catalyst formed H₂(1/4) as well, but in KCl and KI matrices with H⁻(1/4), as shown in FIGS. 31A and 31B.

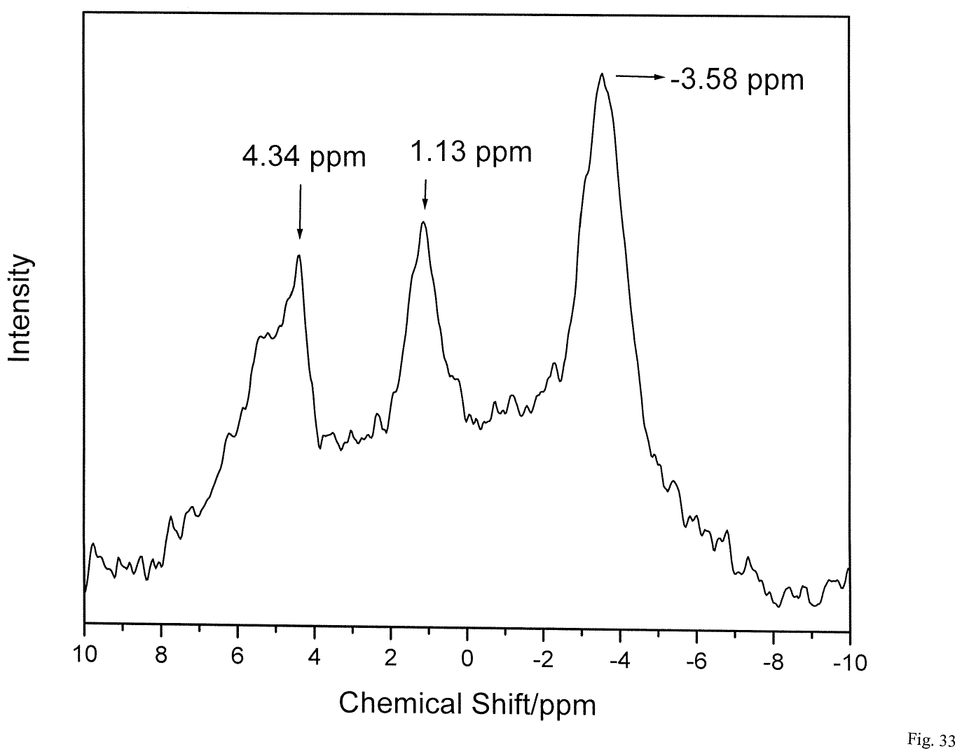

The ¹H MAS NMR spectra of NaH*Br relative to external TMS is shown in FIG. 32. NaH*Br showed a large distinct upfield resonance at −3.58 ppm. None of the controls comprising NaH or equal molar mixtures of NaH and NaBr showed an upfield-shifted peak. The −3.58 ppm upfield peak of NaH*Br was broadened, but not significantly as in the case of KH*I; thus, the matrix may not have as large an effect as in the prior case of the identification of H⁻(1/4) in KH*I. Thus, the measured shift is directly compared to theory with the expectation of that it is the peak shifted downfield due to the matrix effect. The experimental absolute resonance shift of TMS is −31.5 ppm relative to the proton's gyromagnetic frequency [78-79]. The novel peak at −3.58 ppm relative to TMS corresponding to an absolute resonance shift of −35.08 ppm indicates that p=4 in Eq. (4). H⁻(1/4) is the favored hydride ion predicted by using NaH as the catalyst (Eqs. (3-4) and (23-27)). Similar to the case of LiH*X, the 4.3 ppm peak shown in FIG. 33 is assigned to H₂, and the 1.13 ppm peak is assigned to H₂(1/4). The latter is commonly observed as a favored catalysis molecular product [29].

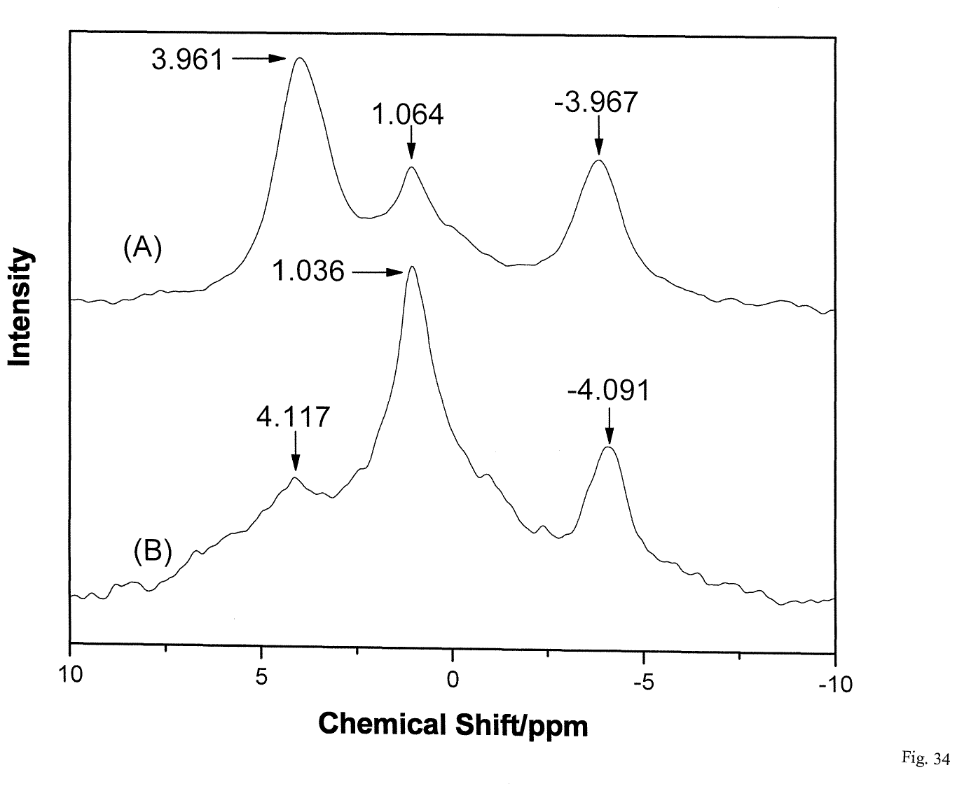

NaH*Cl ¹H MAS NMR spectra relative to external TMS showing the effect of hydrogen addition on the relative intensities of H₂, H₂(1/4), and H⁻(1/4) is shown in FIGS. 34A-B. The addition of hydrogen increased the H⁻(1/4) peak and decreased the H₂(1/4) while the H₂ increased. (A) NaH*Cl synthesized with hydrogen addition showing a −4 ppm upfield-shifted peak assigned to H⁻(1/4), a 1.1 ppm peak assigned to H₂(1/4), and a dominant 4 ppm peak assigned to H₂. (B) NaH*Cl synthesized without hydrogen addition showing a −4 ppm upfield-shifted peak assigned to H⁻(1/4), a dominant 1.0 ppm peak assigned to H₂(1/4), and a small 4.1 ppm assigned to H₂.

The effect of hydrogen addition on the relative ¹H MAS NMR intensities of H₂, H₂(1/4), and H⁻(1/4) in NaH*Cl is shown in FIGS. 34A-B. The dominant peak switched from being H₂ to H₂(1/4) with the addition of external hydrogen indicating that H₂ may occupy sites in the lattice that are filled by H₂(1/4) when H₂ is less abundant. However, the addition of hydrogen increased the relative intensity of the H⁻(1/4) peak, mostly likely by increasing the hydrino reactant concentration.

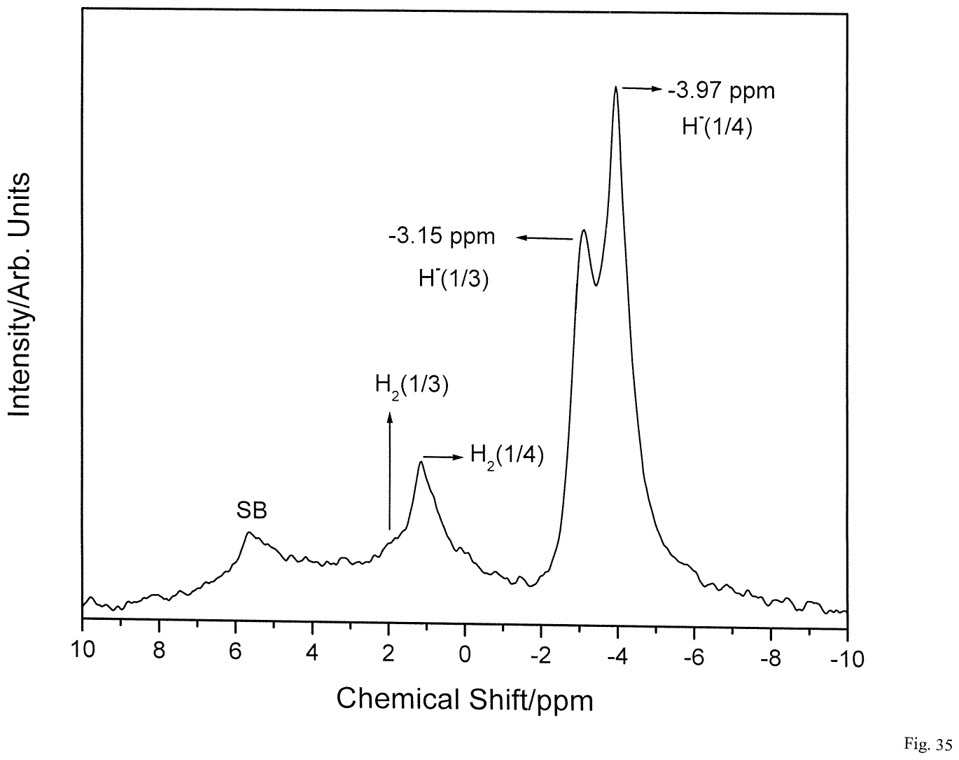

NMR was performed on NaH*Cl synthesized from NaCl and the solid acid KHSO₄ as the only source of hydrogen to test whether H⁻(1/3) formed by the reactions of Eqs. (23-25) could be observed when the rapid reaction to H⁻(1/4) according to Eq. (27) was partially inhibited due to the absence of a high concentration of H from a dissociator with H₂ or a hydride. The ¹H MAS NMR spectrum of NaH*Cl formed using the solid acid relative to external TMS is shown in FIG. 35. Peaks at −3.97 ppm and 1.15 ppm matched the −4 ppm and 1.1 ppm peaks of FIGS. 34A-B that were assigned to H⁻(1/4) and H₂ (1/4), respectively, of NaH*Cl synthesized using H from a dissociator with H₂ or a hydride. The close match was expected since the KHSO₄ was only 6.5 mole % of the mixture with NaCl such that the matrix effect was essentially constant between samples. Uniquely, another set of peaks at −3.15 ppm and 1.7 ppm was observed for the solid-acid product. Using Eqs. (4) and (12) with the matrix shift given previously for NaH*Cl these peaks matched and were assigned to H⁻(1/3) and H₂(1/3), respectively. Curve fitting of two peaks put the peaks at about −3 ppm and −4 ppm, the theoretical values with experimental error. Thus, both fractional hydrogen states were present, and the H₂ peak was absent at 4.3 ppm due to the synthesis of NaH*Cl using a solid acid as the only H source which confirms the reactions given by Eqs. (23-30). The presence of H⁻(1/4) and H₂(1/4) in NaH*Cl from reaction of NaCl and the solid acid KHSO₄ was confirmed by XPS and electron beam-excitation emission spectroscopy.

Helium is another catalyst that can cause a transition reaction to

$$[ \frac{{a}_{H}}{3} ]$$

because the second ionization energy is 54.4 eV, (2 27.2 eV). The catalyst reactions are given by

$$\begin{matrix}54.4 eV + {He}^{+} + H [ \frac{{a}_{H}}{p} ] \to {He}^{2 +} + {e}^{-} + H [ \frac{{a}_{H}}{( p + 2 )} ] + [ {( p + 2 )}^{2} - {p}^{2} ] \cdot 13.6 eV & ( 47 ) \\ {He}^{2 +} + {e}^{-} \to {He}^{2 +} + 54.4 eV & ( 48 )\end{matrix}$$

And, the overall reaction is

$$H [ \frac{{a}_{H}}{p} ] \to H [ \frac{{a}_{H}}{( p + 2 )} ] + [ {( p + 2 )}^{2} - {p}^{2} ] \cdot 13.6 eV \qquad ( 49 )$$

As in the case of the NaH catalyst reaction, the subsequently rapid transition of the He⁺ catalysis product

$$[ \frac{{a}_{H}}{3} ] to [ \frac{{a}_{H}}{4} ]$$

may occur via further catalysis by atomic hydrogen that first accepts 27.2 eV from

$$[ \frac{{a}_{H}}{3} ]$$

as given by Eq. (27). Characteristic broad emission starting at 46.5 nm and continuing to shorter wavelengths is predicted for this transition reaction as the energetic H catalyst decays. The emission has been observed by EUV spectroscopy recorded on microwave discharges of helium with 2% hydrogen [27-29]. The spectroscopic and NMR data provide strong support for the catalyst mechanism of the formation of

$$[ \frac{{a}_{H}}{3} ]$$

with the subsequent transition to

$$[ \frac{{a}_{H}}{4} ] .$$

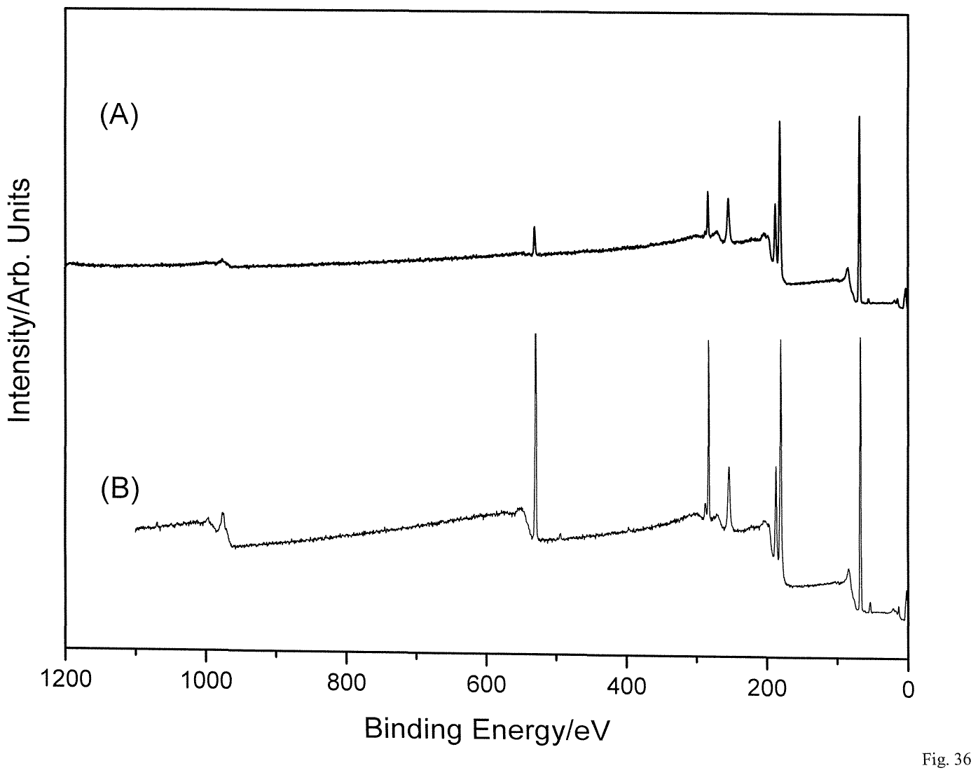

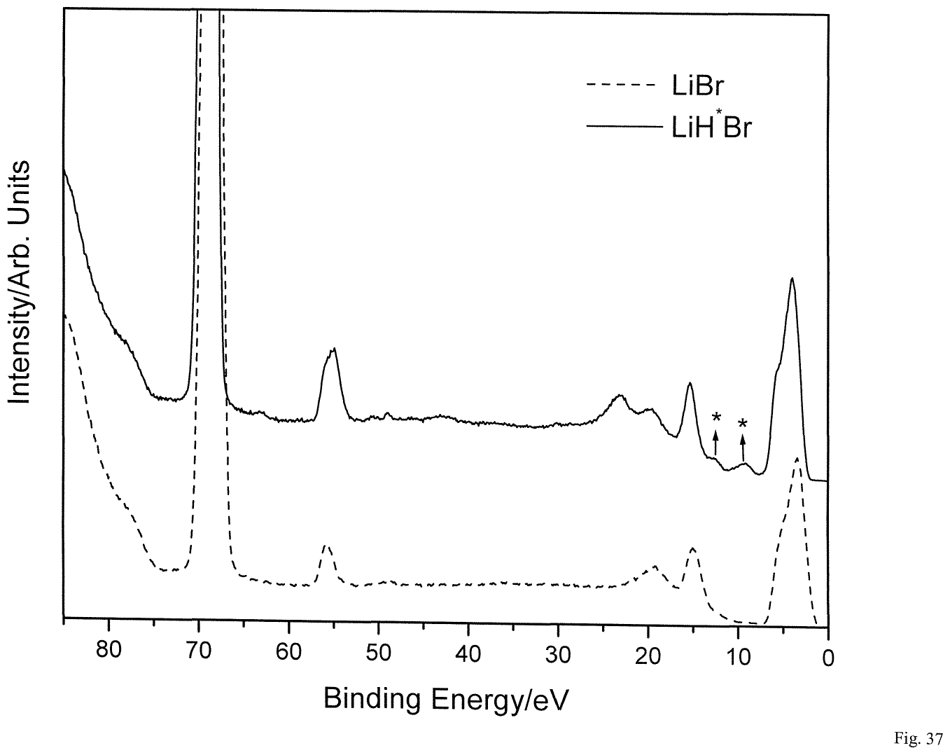

Additional evidence is the observation of both H⁻(1/3) and H⁻(1/4) in NaH*Cl as given in Sec. IIIF.
F. XPS Identification of H⁻(1/4) and H⁻(1/3). A survey spectrum was obtained on each of LiBr and LiH*Br over the region E_{b}=0 eV to 1200 eV (FIGS. 36A-B). The primary element peaks allowed for the determination of all of the elements present in the LiH*Br crystals and the control LiBr. No elements were present in the survey scan which could be assigned to peaks in the low binding energy region (FIG. 37) with the exception of the Li is peak at 55 eV (shifted 1 eV lower compared to LiBr), the O 2s at 23 eV, the Br 3d_{5/2} and Br 3d_{3/2} peaks at 69 eV and 70 eV, respectively, the Br 4s at 15 eV, and the Br 4d at 5 eV. Accordingly, any other peaks in this region must be due to novel species. As shown in FIG. 37, the XPS spectrum of LiH*Br differs from that of LiBr by having additional peaks at 9.5 eV and 12.3 eV that do not correspond to any other primary element peaks but do match the H⁻(1/4) E_{b}=11.2 eV hydride ion (Eqs. (4) and (16)). The literature was searched for elements having a peak in the valance-band region that could be assigned to these peaks. Given the primary element peaks present, there was no known alternative assignment. Thus, the 9.5 eV and 12.3 eV peaks that could not be assigned to known elements and do not correspond to any other primary element peak were assigned to the H⁻(1/4) in two different chemical environments. These features closely matched those for H⁻(1/4) of KH*I reported previously [13-15, 26, 30].

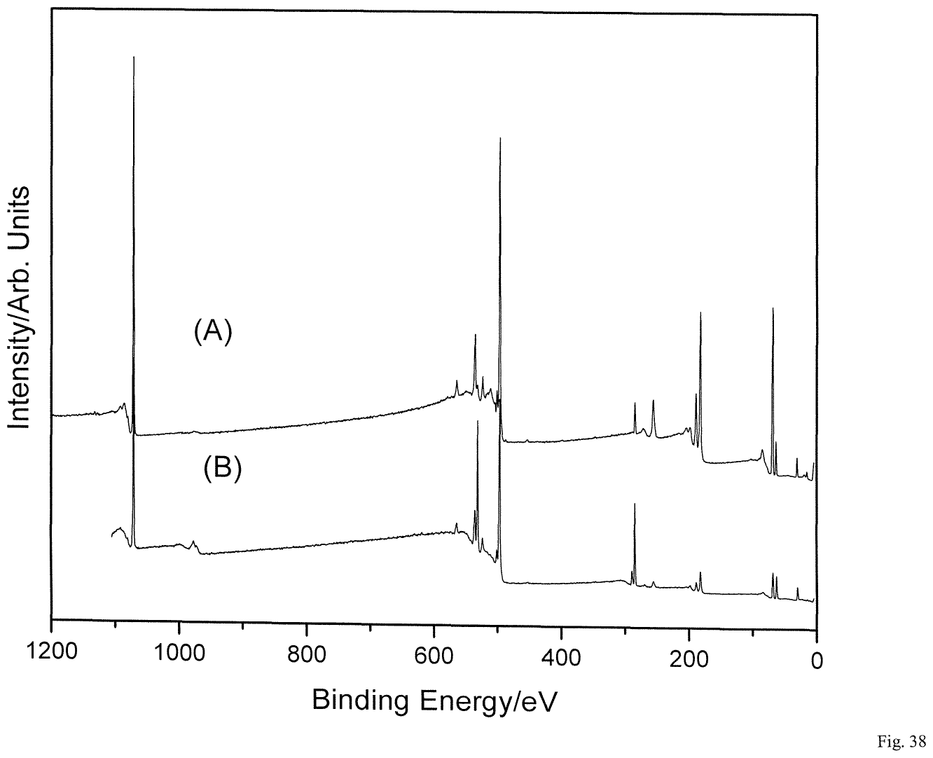

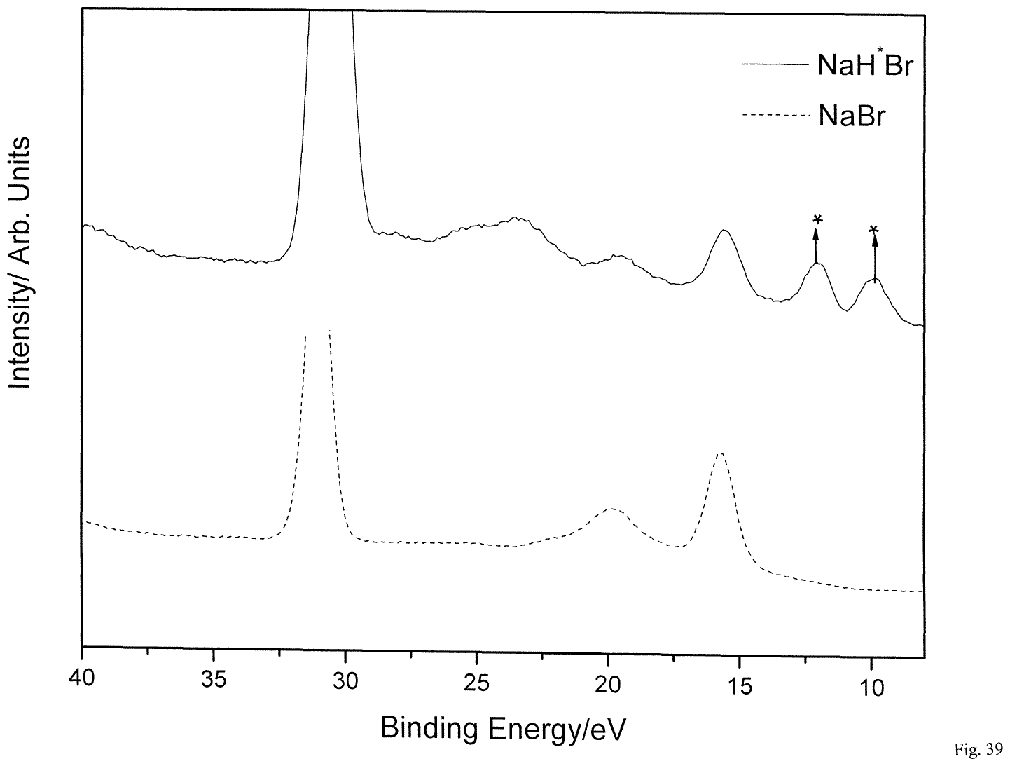

A survey spectrum was obtained on each of NaBr and NaH*Br over the region E_{b}=0 eV to 1200 eV (FIGS. 38A-B). The primary element peaks allowed for the determination of all of the elements present in the NaH*Br crystals and the control NaBr. No elements were present in the survey scan which could be assigned to peaks in the low binding energy region (FIG. 39) with the exception of the Na 2p and Na 2s peaks at 30 eV and 63 eV (shifted 1 eV lower compared to NaBr), the O 2s at 23 eV, the Br 3d_{5/2} and Br 3d_{3/2} peaks at 69 eV and 70 eV, respectively, the Br 4s at 15.2 eV, and the Br 4d at 5 eV. Accordingly, any other peaks in this region must be due to novel species. As shown in FIG. 39, the XPS spectrum of NaH*Br differs from that of NaBr by having additional peaks at 9.5 eV and 12.3 eV that do not correspond to any other primary element peaks but do match the H⁻(1/4) E_{b}=11.2 eV hydride ion (Eqs. (4) and (16)). The literature was searched for elements having a peak in the valance-band region that could be assigned to these peaks. Given the primary element peaks present, there was no known alternative assignment. Thus, the 9.5 eV and 12.3 eV peaks that could not be assigned to known elements and do not correspond to any other primary element peak were assigned to the H⁻(1/4) two different chemical environments.

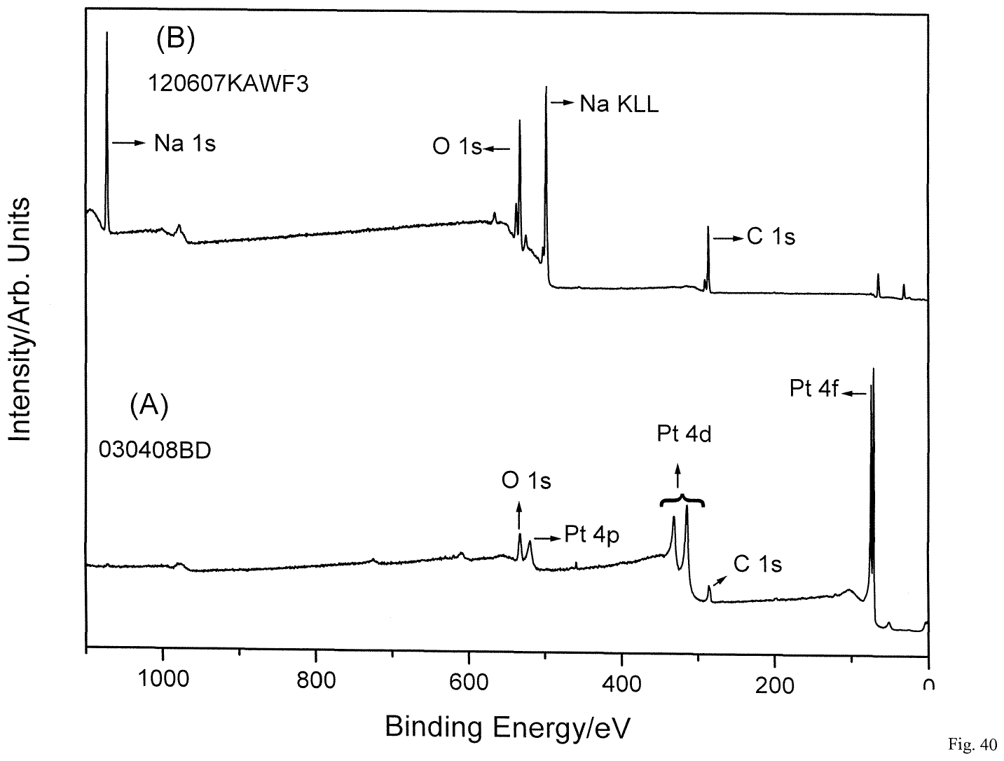

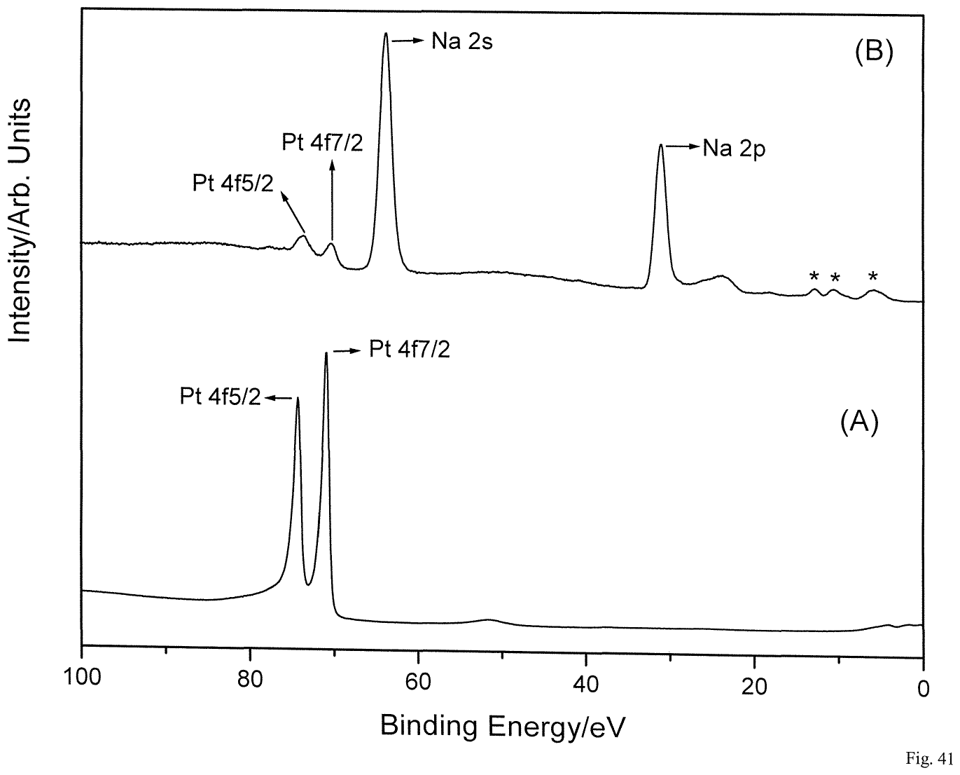

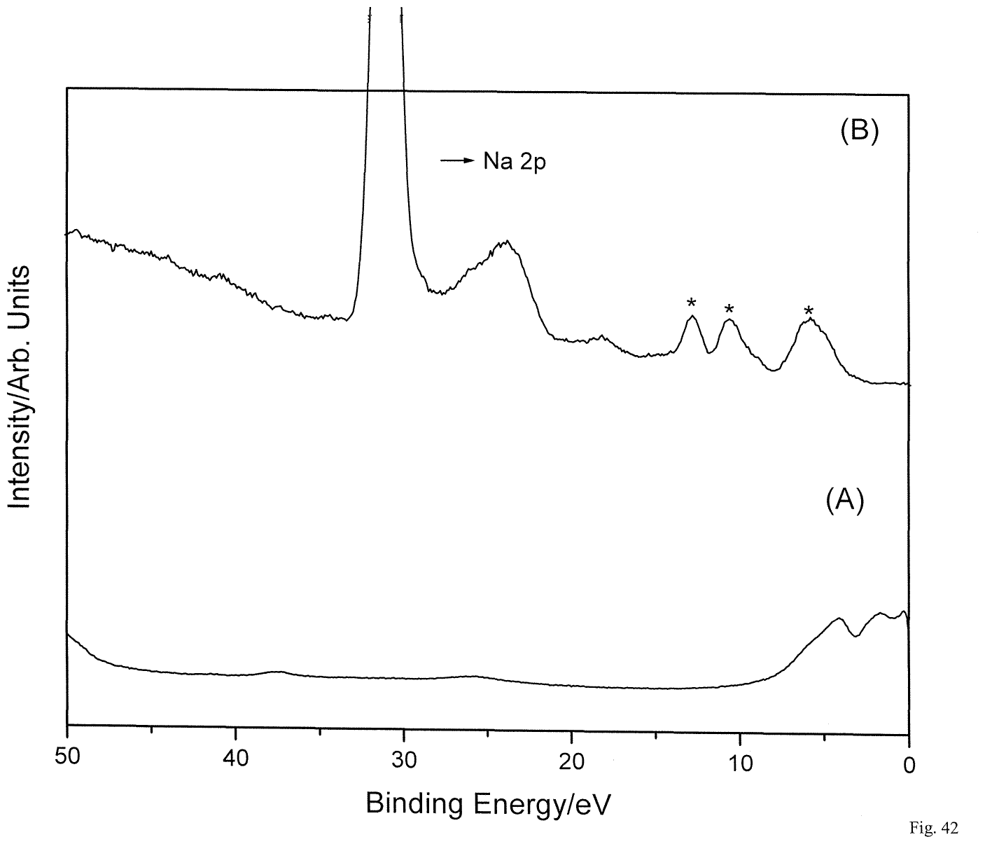

Survey spectra over the region E_{b}=0 eV to 1200 eV were obtained on each of Pt/Ti and NaH*-coated Pt 1 Ti following the production of 15 kJ of excess heat (FIGS. 40A-B). The primary element peaks allowed for the determination of all of the elements present in the NaH*-coated PtITi and the control Pt/Ti. No elements were present in the survey scan which could be assigned to peaks in the low binding energy region (FIGS. 41A-B) with the exception of the Pt 4f_{7/2} and Pt 4f_{5/2} peaks at 70.7 eV and 74 eV, respectively, and the O 2s at 23 eV. The Na 2p and Na 2s peaks were observed at 31 eV and 64 eV on NaH*-coated Pt/Ti, and a valance band was only observed for Pt/Ti. Accordingly, any other peaks in this region must be due to novel species. As shown in FIGS. 42A-B, the XPS spectrum of NaH*-coated Pt/Ti differs from that of PtITi by having additional peaks at 6 eV, 10.8 eV, and 12.8 eV that do not correspond to any other primary element peaks but do match the H⁻(1/3) E_{b}=6.6 eV and H⁻(1/4) E_{b}=11.2 eV hydride ions (Eqs. (4) and (16)). The literature was searched for elements having a peak in the valance-band region that could be assigned to these peaks. Given the primary element peaks present, there was no known alternative assignment. Thus, the 10.8 eV, and 12.8 eV peaks that could not be assigned to known elements and do not correspond to any other primary element peak were assigned to the H⁻(1/4) in two different chemical environments. The 6 eV peak matched and was assigned to H⁻(1/3). Thus, in the absence of a halide peak in this region, both fractional hydrogen states, 1/3 and 114, were observed as predicted by Eq. (27). The absence of a valance band due to the high-binding energies was also consistent with the hydrino hydride assignments of NaH*-coated Pt/Ti.

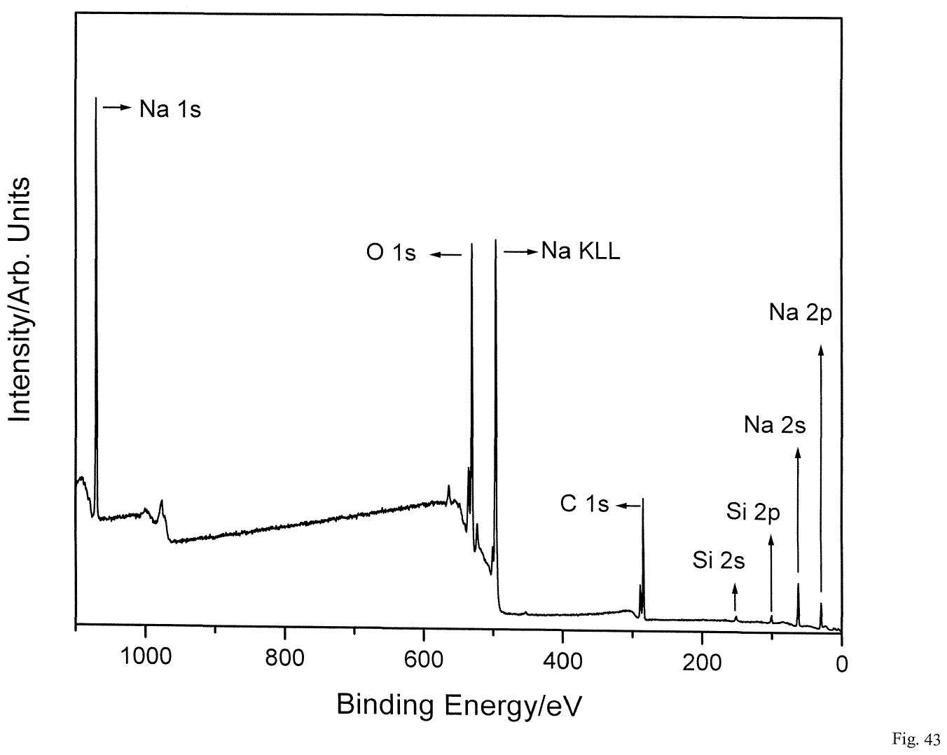

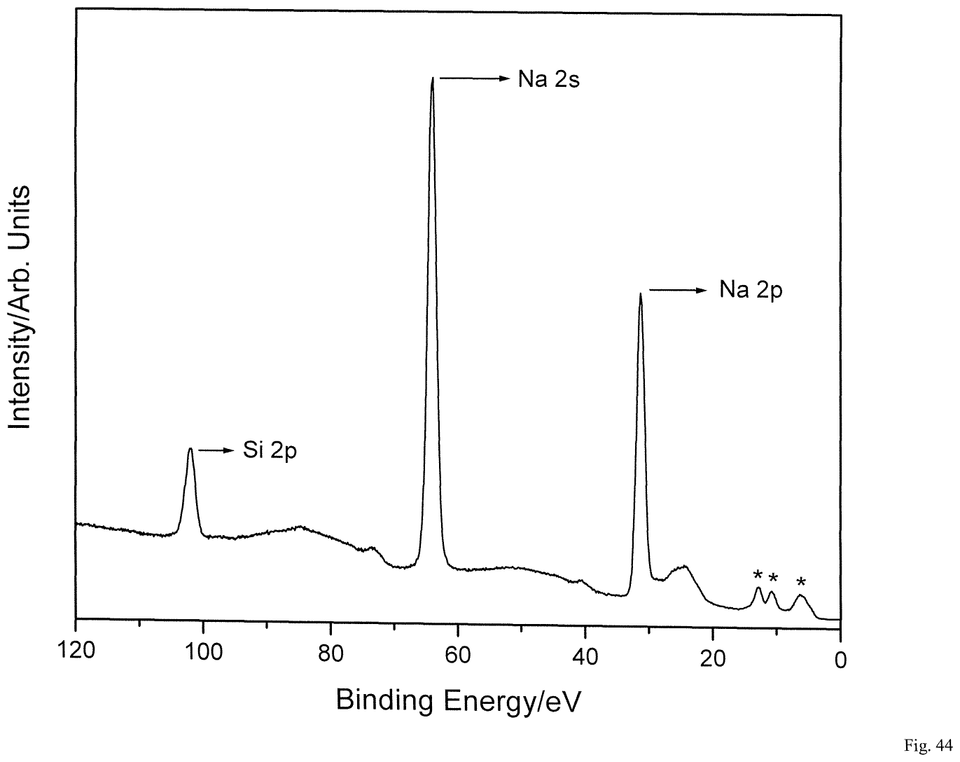

The results of the NaH*-coated Pt/Ti shown in FIG. 42B were replicated with NaH*-coated Si. As shown in FIGS. 43 and 44, the XPS spectra of NaH*-coated Si showed peaks at 6 eV, 10.8 eV, and 12.8 eV that could not be assigned to known elements and do not correspond to any other primary element peak, but matched H⁻(1/3) and H⁻(1/4). Thus, both fractional hydrogen states, 1/3 as H⁻(1/3) at the 6 eV and 1/4 as H⁻(1/4) at 10.8 eV and 12.8 eV, were present as predicted by Eq. (27).

G. FTIR Identification of H₂(1/4). Samples of LiH*Br having an upfield-shifted ¹H NMR peak at −2.5 ppm assigned to H⁻(1/4) and an NMR peak at 1.3 ppm assigned to the corresponding molecule H₂(1/4) were analyzed by high resolution FTIR spectroscopy. As shown in FIG. 45B, a single narrow peak was observed at 1989 cm⁻¹. The compounds, LiNH₂, Li₂NH, and Li₃N are possible, based on the staring materials and predicted reactions, but none of these compounds showed peaks in the region of 1989 cm⁻¹. No additional peaks other than those easily assignable to LiBr were observed (FIG. 45A). An exhaustive list of species that have features in this region were considered, including exotic species such as azide, metal carbonyls, and metaborate ion. The former were eliminated based on their known spectra, which have very broad bands. Metaborate ion was eliminated by ToF-SIMs analysis, which showed a total boron content that was not detectable at the ppb level which is orders of magnitude below its FTIR detection limit and the absence of two peaks corresponding to the boron isotopes ¹⁰B (20% NA.) and ¹¹B (80% NA).

Considering a possible matrix effect, the peak at 1989 cm⁻¹ (0.24 eV) matched the theoretical prediction of 1947 cm⁻¹ for H₂(1/4). 1 From Eqs. (14-15), the unprecedented rotational energy of 4² times that of ordinary hydrogen establishes the internuclear distance of H₂(1/4) as 1/4 that of H₂. Interstitial H₂ in silicon and GaAs is a nearly free rotator showing single rovibrational transitions [83-87]. H₂ is FTIR active as well as Raman active due to the induced dipole from interactions with the crystalline lattice [83]. The crystalline lattice may also influence the selection rules to permit an otherwise forbidden transition in H₂(1/4). Considering a matrix effect, the match to the predicted 1943 cm⁻¹ peak and the relatively narrow peak width, indicates that H₂(1/4) can rotate essentially freely inside of the crystal and confirms its small size corresponding to 1/4 the dimensions of ordinary hydrogen. Ordinary hydrogen shows a 3:1 ortho-para ratio at non-cryogenic temperatures; whereas, a single peak of H₂(1/4) formed under the synthesis conditions is assigned to the para form only due to the 64 times increase in stability due to the 1/4 relative internuclear separation. Given the frequency match of the 1989 cm⁻¹ peak and the absence of any known alternative, wherein hydrogen is the only known species that exhibits single rovibrational transitions in a solid matrix, the 1989 cm⁻¹ peak is assigned to the J=0 to J=1 rotational transitions of para H₂(1/4).

H. H₂(1/4) Rotational UV Spectrum by Electron Beam Excitation. H₂(1/4) trapped in the lattice of alkali halides, MgX₇ (X=F, Cl, Br, I), and CuX₂ (X=F, Cl, Br) was investigated by windowless UV spectroscopy on electron beam excitation of the crystals using the 12.5 keV electron gun at a beam current of 10-20 μA in the pressure range of <10⁻⁵ Torr. Of the alkali metals, it was found that only alkali chlorides showed the peaks predicted by Eq. (14), and the intensity roughly matched the order predicted, increasing intensity down the column of the Group I elements. In all cases, the peaks could be eliminated by heating with the loss of the Lyman α peak, and no other peaks were observed in the UV. The on-line mass spectrometer recorded hydrogen only. Of the compounds of the series MgX₂ (X=F, Cl, Br, I) and CuX₂ (X=F, Cl, Br), the predicted band was just detectable only for MgI₂ which, in this case, can be attributed to Mg²⁺ as the catalyst. NMR on these crystals showed the H₂(1/4) peak at 1.13 ppm only in MgX₂ with relative intensities F, Cl, Br, <<I that matched the detection of the band by electron beam-excitation emission for MgI₂ only.

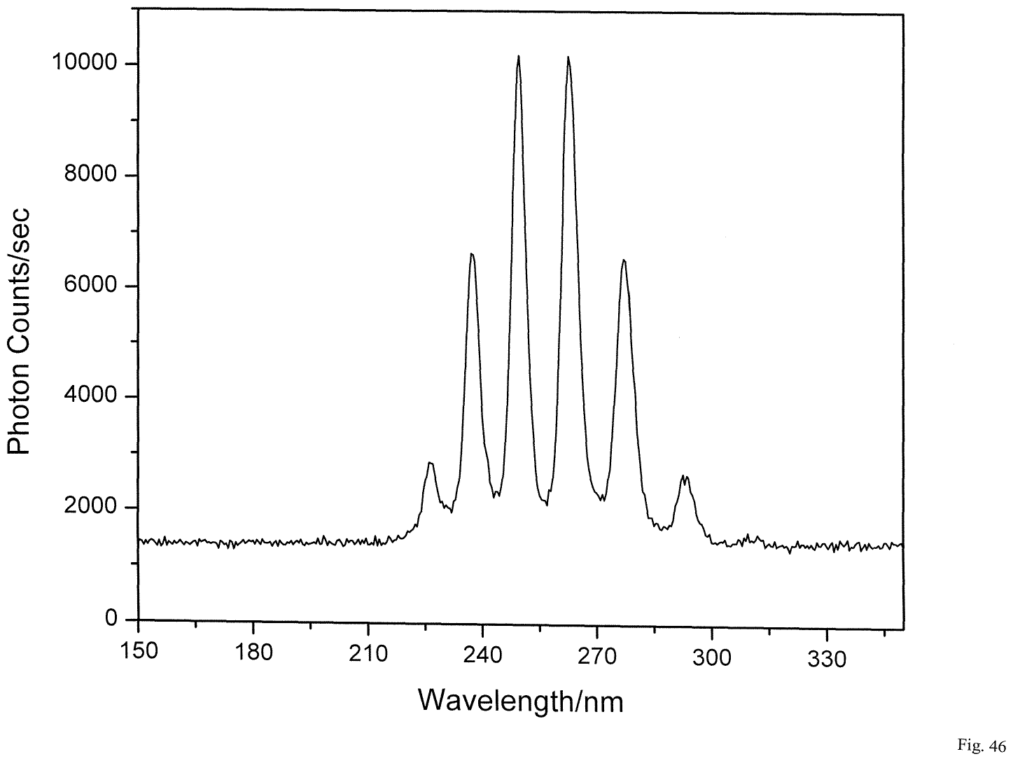

The 100-350 nm spectrum of electron beam-excited CsCl crystals having trapped H₂(1/4) is shown in FIG. 46. A series of evenly spaced lines was observed in the 220-300 nm region as shown in FIG. 46. The series matched the spacing and intensity profile of the P branch of H₂(1/4) given by Eq. (14). P(1), P(2), P(3), P(4), P(5), and P(6) were observed at 226.0 nm, 237.0 nm, 249.5 nm, 262.5 nm, 277.0 nm, and 292.5 nm, respectively. The slope of the linear curve-fit of the energies of the peaks shown in FIG. 46 is 0.25 eV with an intercept of 5.73 eV and a sum of residual errors r²<0.0000. The slope matches the predicted rotational energy spacing of 0.241 eV (Eq. (14); p=4) with ΔJ=+1; J=1, 2, 3, 4, 5, 6 where J is the rotational quantum number of the final state. H₂(1/4) is a free rotator, but is not a free vibrator which is similar to the case of interstitial hydrogen in silicon discussed previously [83-87]. The observed intercept of 5.73 eV is shifted from the predicted υ=1→υ=0 vibrational energy of H₂(1/4) of 8.25 eV (Eq. (13)) by about twice the percentage as that of interstitial H₂ in silicon [83-87]. In the latter case, vibrational energy of free H₂ is 4161 cm⁻¹, whereas the vibrational peaks in silicon are observed at 3618 and 3627 cm⁻¹ corresponding to ortho and para-H₂, respectively [83]. In the former case the shift is about 30% lower, possibly due to an increase in the effective mass from coupling of the molecular vibrational mode with the crystal lattice.

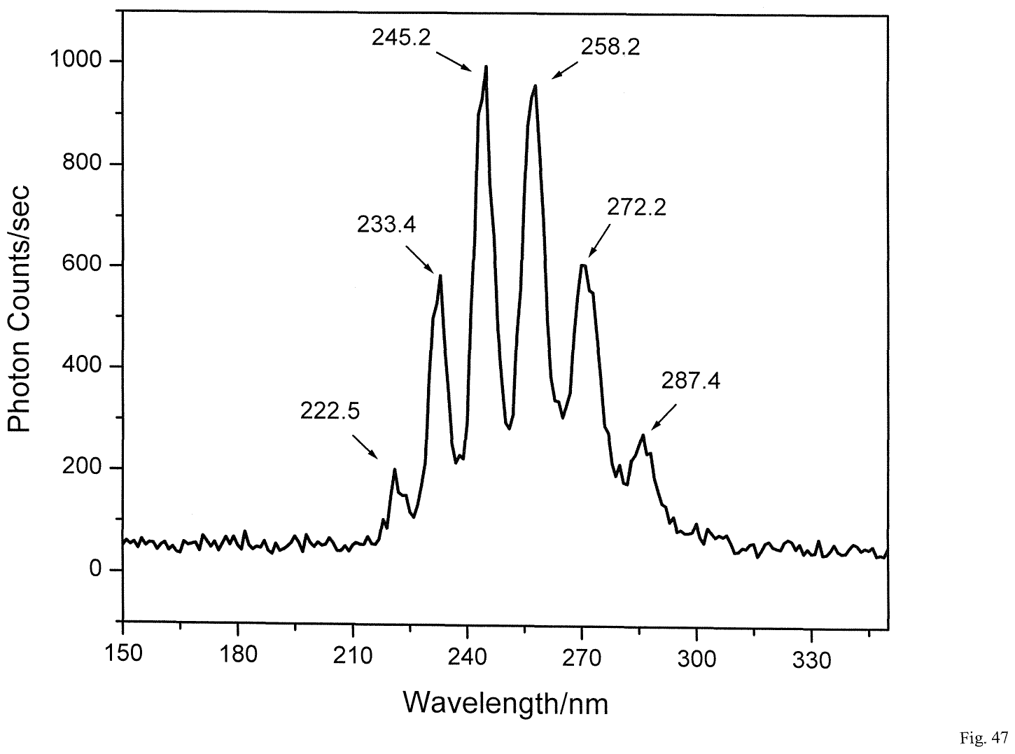

Using Eqs. (14) and (15) with the measured rotational energy spacing of 0.25 eV establishes an internuclear distance of 1/4 that of the ordinary H₂ for H₂(1/4). A corresponding weak band was observed from NaH*Br, and a more intense band was observed from NaH*Cl. Regarding the latter case, the intensity of the emission was significantly increased by trapping H₂(1/4) in a silicon matrix. The 100-550 nm spectrum of an electron beam-excited silicon wafer coated with NaH*Cl having trapped H₂(1/4) is shown in FIG. 47. The series matching the spacing and intensity profile of the P branch of H₂(1/4) given by Eq. (14) was observed. P(1), P(2), P(3), P(4), P(5), and P(6) were observed at 222.5 nm, 233.4 nm, 245.2 nm, 258.2 nm, 272.2 nm, and 287.4 nm, respectively. The slope of the linear curve-fit of the energies of the peaks shown in FIG. 47 is 0.25 eV with an intercept of 5.82 eV and a sum of residual errors r²<0.0000. The linearity is characteristic of rotation, and the results again match H₂(1/4). This technique confirms the solid NMR and FTIR results given in Secs. IIIE and IIIG, respectively. It was reported previously [13-14] that when KH*Cl having H⁻(1/4) by NMR was incident to the 12.5 keV electron beam, similar excited emission of interstitial H₂(1/4) was observed as that from electron-beam excited alkali chlorides, NaH*Cl-coated Si, and argon-hydrogen plasmas [13-14]. It was further observed that the band assigned to H₂(1/4) was eliminated from the KCl stating material by heating to high temperature. KH*Cl was then synthesized from the heat-treated KCl, and H₂(1/4) trapped in the lattice of KH*Cl was then observed in addition to H⁻(1/4) demonstrating that multiple catalysts, HCl, NaH, K, and Ar⁺, can give rise to H₂(1/4).

### EXPERIMENTAL REFERENCES

1. R. Mills, The Grand Unified Theory of Classical Quantum Mechanics; October 2007 Edition, posted at http://www.blacklightpower.com/theory/bookdownload.shtml.
2. R. Mills, K. Akhar, Y. Lu, “Spectroscopic Observation of Helium- and Hydrogen-Catalyzed Hydrino Transitions”, to be submitted.
3. R. L. Mills, “Classical Quantum Mechanics”, Physics Essays, Vol. 16, No. 4, December, (2003), pp. 433-498.
4. R. Mills, “Physical Solutions of the Nature of the Atom, Photon, and Their Interactions to Form Excited and Predicted Hydrino States”, in press.
5. R. L. Mills, “Exact Classical Quantum Mechanical Solutions for One-Through Twenty-Electron Atoms”, Physics Essays, Vol. 18, (2005), pp. 321-361.
6. R. L. Mills, “The Nature of the Chemical Bond Revisited and an Alternative Maxwellian Approach”, Physics Essays, Vol. 17, (2004), pp. 342-389.
7. R. L. Mills, “Maxwell's Equations and QED: Which is Fact and Which is Fiction”, in press.
8. R. L. Mills, “Exact Classical Quantum Mechanical Solution for Atomic Helium Which Predicts Conjugate Parameters from a Unique Solution for the First Time”, submitted.
9. R. L. Mills, “The Fallacy of Feynman's Argument on the Stability of the Hydrogen Atom According to Quantum Mechanics,” Annales de la Fondation Louis de Broglie, Vol. 30, No. 2, (2005), pp. 129-151.
10. R. Mills, “The Grand Unified Theory of Classical Quantum Mechanics”, Int. J. Hydrogen Energy, Vol. 27, No. 5, (2002), pp. 565-590.
11. R. Mills, The Nature of Free Electrons in Superfluid Helium—a Test of Quantum Mechanics and a Basis to Review its Foundations and Make a Comparison to Classical Theory, Int. J. Hydrogen Energy, Vol. 26, No. 10, (2001), pp. 1059-1096.
12. R. Mills, “The Hydrogen Atom Revisited”, Int. J. of Hydrogen Energy, Vol. 25, Issue 12, December, (2000), pp. 1171-1183.
13. R. L. Mills, J. He, Y. Lu, M. Nansteel, Z. Chang, B. Dhandapani, “Comprehensive Identification and Potential Applications of New States of Hydrogen”, Int. J. Hydrogen Energy, Vol. 32(14), (2007), pp. 2988-3009.
14. R. Mills, J. He, Z. Chang, W. Good, Y. Lu, B. Dhandapani, “Catalysis of Atomic Hydrogen to Novel Hydrogen Species H⁻(1/4) and H₂(1/4) as a New Power Source”, Int. J. Hydrogen Energy, Vol. 32, No. 12, (2007), pp. 2573-2584.
15. R. Mills, P. Ray, B. Dhandapani, W. Good, P. Jansson, M. Nansteel, J. He, A. Voigt, “Spectroscopic and NMR Identification of Novel Hydride Ions in Fractional Quantum Energy States Formed by an Exothermic Reaction of Atomic Hydrogen with Certain Catalysts”, European Physical Journal-Applied Physics, Vol. 28, (2004), pp. 83-104.
16. R. Mills and M. Nansteel, P. Ray, “Argon-Hydrogen-Strontium Discharge Light Source”, IEEE Transactions on Plasma Science, Vol. 30, No. 2, (2002), pp. 639-653.
17. R. Mills and M. Nansteel, P. Ray, “Bright Hydrogen-Light Source due to a Resonant Energy Transfer with Strontium and Argon Ions”, New Journal of Physics, Vol. 4, (2002), pp. 70.1-70.28.
18. R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943.
19. R. Mills, M. Nansteel, and P. Ray, “Excessively Bright Hydrogen-Strontium Plasma Light Source Due to Energy Resonance of Strontium with Hydrogen”, J. of Plasma Physics, Vol. 69, (2003), pp. 131-158.
20. R. L. Mills, J. He, M. Nansteel, B. Dhandapani, “Catalysis of Atomic Hydrogen to New Hydrides as a New Power Source”, International Journal of Global Energy Issues (IJGEI), Special Edition in Energy Systems, Vol. 28, Nos. 2/3 (2007), pp. 304-324.
21. H. Conrads, R. Mills, Th. Wrubel, “Emission in the Deep Vacuum Ultraviolet from a Plasma Formed by Incandescently Heating Hydrogen Gas with Trace Amounts of Potassium Carbonate”, Plasma Sources Science and Technology, Vol. 12, (3003), pp. 389-395.
22. J. Phillips, R. L. Mills, X. Chen, “Water Bath calorimetric Study of Excess Heat in ‘Resonance Transfer’ Plasmas”, Journal of Applied Physics, Vol. 96, No. 6, pp. 3095-3102.
23. R. L. Mills, X. Chen, P. Ray, J. He, B. Dhandapani, “Plasma Power Source Based on a Catalytic Reaction of Atomic Hydrogen Measured by Water Bath calorimetry”, Thermochimica Acta, Vol. 406/1-2, (2003), pp. 35-53.
24. R. Mills, B. Dhandapani, M. Nansteel, J. He, T. Shannon, A. Echezuria, “Synthesis and Characterization of Novel Hydride Compounds”, Int. J. of Hydrogen Energy, Vol. 26, No. 4, (2001), pp. 339-367.
25. R. Mills, B. Dhandapani, M. Nansteel, J. He, A. Voigt, “Identification of Compounds Containing Novel Hydride Ions by Nuclear Magnetic Resonance Spectroscopy”, Int. J. Hydrogen Energy, Vol. 26, No. 9, (2001), pp. 965-979.
26. R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203.
27. R. L. Mills, P. Ray, “Extreme Ultraviolet Spectroscopy of Helium-Hydrogen Plasma”, J. Phys. D, Applied Physics, Vol. 36, (2003), pp. 1535-1542.
28. R. L. Mills, P. Ray, B. Dhandapani, M. Nansteel, X. Chen, J. He, “New Power Source from Fractional Quantum Energy Levels of Atomic Hydrogen that Surpasses Internal Combustion”, J Mol. Struct., Vol. 643, No. 1-3, (2002), pp. 43-54.
29. R. Mills, P. Ray, “Spectral Emission of Fractional Quantum Energy Levels of Atomic Hydrogen from a Helium-Hydrogen Plasma and the Implications for Dark Matter”, Int. J. Hydrogen Energy, Vol. 27, No. 3, (2002), pp. 301-322.
30. R. L. Mills, P. Ray, “A Comprehensive Study of Spectra of the Bound-Free Hyperfine Levels of Novel Hydride Ion H⁻(1/2), Hydrogen, Nitrogen, and Air”, Int. J. Hydrogen Energy, Vol. 28, No. 8, (2003), pp. 825-871.
31. R. Mills, “Spectroscopic Identification of a Novel Catalytic Reaction of Atomic Hydrogen and the Hydride Ion Product”, Int. J. Hydrogen Energy, Vol. 26, No. 10, (2001), pp. 1041-1058.
32. R. L. Mills, P. Ray, B. Dhandapani, R. M. Mayo, J. He, “Comparison of Excessive Balmer α Line Broadening of Glow Discharge and Microwave Hydrogen Plasmas with Certain Catalysts”, J. of Applied Physics, Vol. 92, No. 12, (2002), pp. 7008-7022.
33. R. L. Mills, P. Ray, B. Dhandapani, J. He, “Comparison of Excessive Balmer a Line Broadening of Inductively and Capacitively Coupled RF, Microwave, and Glow Discharge Hydrogen Plasmas with Certain Catalysts”, IEEE Transactions on Plasma Science, Vol. 31, No. (2003), pp. 338-355.
34. R. L. Mills, P. Ray, “Substantial Changes in the Characteristics of a Microwave Plasma Due to Combining Argon and Hydrogen”, New Journal of Physics, www.njp.org, Vol. 4, (2002), pp. 22.1-22.17.
35. R. L. Mills, P. Ray, B. Dhandapani, “Excessive Balmer α Line Broadening of Water-Vapor Capacitively-Coupled RF Discharge Plasmas” Int. J. Hydrogen Energy, in press.
36. R. Mills, P. Ray, B. Dhandapani, “Evidence of an Energy Transfer Reaction Between Atomic Hydrogen and Argon II or Helium II as the Source of Excessively Hot H Atoms in RF Plasmas”, Journal of Plasma Physics, (2006), Vol. 72, Issue 4, pp. 469-484.24.
37. J. Phillips, C-K Chen, K. Akhtar, B. Dhandapani, R. Mills, “Evidence of Catalytic Production of Hot Hydrogen in RF Generated Hydrogen/Argon Plasmas”, International Journal of Hydrogen Energy, Vol. 32(14), (2007), 3010-3025.
38. R. Mills, P. Ray, R. M. Mayo, “CW HI Laser Based on a Stationary Inverted Lyman Population Formed from Incandescently Heated Hydrogen Gas with Certain Group I Catalysts”, IEEE Transactions on Plasma Science, Vol. 31, No. 2, (2003), pp. 236-247.
39. R. L. Mills, P. Ray, “Stationary Inverted Lyman Population Formed from Incandescently Heated Hydrogen Gas with Certain Catalysts”, J. Phys. D, Applied Physics, Vol. 36, (2003), pp. 1504-1509.
40. R. Mills, P. Ray, R. M. Mayo, “The Potential for a Hydrogen Water-Plasma Laser”, Applied Physics Letters, Vol. 82, No. 11, (2003), pp. 1679-1681.
41. R. L. Mills, The Grand Unified Theory of Classical Quantum Mechanics, November 1995 Edition, HydroCatalysis Power Corp., Malvern, Pa., Library of Congress Catalog Number 94-077780, ISBN number ISBN 0-9635171-1-2, Chp. 22.
42. F. Bournaud, P. A. Duc, E. Brinks, M. Boquien, P. Amram, U. Lisenfeld, B. Koribalski, F. Walter, V. Charmandaris, “Missing mass in collisional debris from galaxies”, Science, Vol. 316, (2007), pp. 1166-1169.
43. B. G. Elmegreen, “Dark matter in galactic collisional debris”, Science, Vol. 316, (2007), pp. 32-33.
44. N. V. Sidgwick, The Chemical Elements and Their Compounds, Volume I, Oxford, Clarendon Press, (1950), p. 17.
45. M. D. Lamb, Luminescence Spectroscopy, Academic Press, London, (1978), p. 68.
46. K. R. Lykke, K. K. Murray, W. C. Lineberger, “Threshold photodetachment of H⁻”, Phys. Rev. A, Vol. 43, No. 11, (1991), pp. 6104-6107.
47. D. R. Lide, CRC Handbook of Chemistry and Physics, 79 th Edition, CRC Press, Boca Raton, Fla., (1998 Sep.), p. 10-175.
48. H. Beutler, Z. Physical Chem., “Die dissoziationswarme des wasserstoffmolekuls H₂, aus einem neuen ultravioletten resonanzbandenzug bestimmt”, Vol. 27B, (1934), pp. 287-302.
49. G. Herzberg, L. L. Howe, “The Lyman bands of molecular hydrogen”, Can. J. Phys., Vol. 37, (1959), pp. 636-659.
50. P. W. Atkins, Physical Chemistry, Second Edition, W. H. Freeman, San Francisco, (1982), p. 589.
51. F. Abeles (Ed.), Optical Properties of Solids, (1972), p. 725.
52. D. R. Lide, CRC Handbook of Chemistry and Physics, 86th Edition, CRC Press, Taylor & Francis, Boca Raton, (2005 Jun.), pp. 10-202 to 10-204.
53. F. A. Cotton, G. Wilkinson, C. A. Murillo, M. Bochmann, Advanced Inorganic Chemistry, Sixth Edition, John Wiley & Sons, Inc., New York, (1999), p. 92.
54. D. R. Lide, CRC Handbook of Chemistry and Physics, 86th Edition, CRC Press, Taylor & Francis, Boca Raton, (2005 Jun.), pp. 9-54 to 9-59.
55. P. Chen, Z. Xiong, J. Luo, J. Lin, K. L. Tan, “Interaction of Hydrogen with Metal Nitrides and Amides,” Nature, 420, (2002), 302-304.
56. P. Chen, Z. Xiong, J. Luo, J. Lin, K. L. Tan, “Interaction between Lithium Amide and Lithium Hydride,” J. Phys. Chem. B, 107, (2003), 10967-10970.
57. W. I. F. David, M. O. Jones, D. H. Gregory, C. M. Jewell, S. R. Johnson, A. Walton, P. Edwards, “A Mechanism for Non-stoichiometry in the Lithium Amide/Lithium Imide Hydrogen Storage Reaction,” J. Am. Chem. Soc., 129, (2007), 1594-1601.
58. D. B. Grotjahn, P. M. Sheridan, I. Al Jihad, L. M. Ziurys, “First Synthesis and Structural Determination of a Monomeric, Unsolvated Lithium Amide, LiNH₂,” J. Am. Chem. Soc., 123, (2001), 5489-5494.
59. F. E. Pinkerton, “Decomposition Kinetics of Lithium Amide for Hydrogen Storage Materials,” J. Alloys Compd., 400, (2005), 76-82.
60. Y. Kojima, Y. Kawai, “IR Characterizations of Lithium Imide and Amide,” J. Alloys Compd., 395, (2005), 236-239.
61. T. Ichikawa, S. Isobe, N. Hanada, H. Fujii, “Lithium Nitride for Reversible Hydrogen Storage,” J. Alloys Compd., 365, (2004), 271-276.
62. Y. H. Hu, E. Ruckenstein, “Ultrafast Reaction between Li₃N and LiNH₂ to Prepare the Effective Hydrogen Storage Material Li₂NH,” Ind. Eng. Chem. Res., 45, (2006), 4993-4998.
63. Y. H. Hu, E. Ruckenstein, “Hydrogen Storage of LiNH₂ Prepared by Reacting Li with NH₃,” Ind. Eng. Chem. Res., 45, (2006), 182-186.
64. Y. H. Hu, E. Ruckenstein, “High Reversible Hydrogen Capacity of LiNH₂/Li₃N Mixtures,” Ind. Eng. Chem. Res., 44, (2005), 1510-1513.
65. D. R. Lide, CRC Handbook of Chemistry and Physics, 86th Edition, CRC Press, Taylor & Francis, Boca Raton, (2005 Jun.), pp. 5-4 to 5-18; 9-63.
66. P. Chen, Z. Xiong, J. Luo, J. Lin, K. L. Tan, “Interaction of hydrogen with metal nitrides and imides”, Nature, Vol. 420, (2002), pp. 302-304.
67. Yun Hang Hu, Eli Ruckenstein, “Hydrogen Storage of Li₂NH Prepared by Reacting Li with NH₃,” Ind. Eng. Chem. Res., Vol. 45, (2006), pp. 182-186.
68. K. Ohoyama, Y. Nakamori, S. Orimo, “Characteristic Hydrogen Structure in Li—N—H Complex Hydrides,” Proceedings of the International Symposium on Research Reactor and Neutron Science—In Commemoration of the 10^{th} Anniversary of HANARO—Daejeon, Korea, April 2005, pp. 655-657.
69. Microsc. Microanal. Microstruct., Vol. 3, 1, (1992).
70. For specifications see PHI Trift II, ToF-SIMS Technical Brochure, (1999), Eden Prairie, Minn. 55344.
71. W. M. Muller, J. P. Blackledge, G. G. Libowitz, Metal Hydrides, Academic Press, New York, (1968), p 201.
72. David R. Lide, CRC Handbook of Chemistry and Physics, 79 th Edition, CRC Press, Boca Raton, Fla., (1998 Sep.), p. 12-191.
73. R. R. Cavanagh, R. D. Kelley, J. J. Rush, “Neutron vibrational spectroscopy of hydrogen and deuterium on Raney nickel,” J. Chem. Phys., 77(3). (1982), 1540-1547.
74. I. Nicolau, R. B. Andersen, “Hydrogen in a commercial Raney nickel,” J. Catalysis, Vol. 68, (1981), 339-348.
75. K. Niessen, A. R. Miedema, F. R. de Boer, R. Boom, “Enthalpies of formation of liquid and solid binary alloys based on 3d metals,” Physica B, Vol. 152, (1988), 303-346.
76. B. S. Hemingway, R. A. Robie, “Enthalpies of formation of low albite (NaAlSi₃O₈), gibbsite (Al(OH)₃), and NaAlO₂; revised values for ΔH_{f298}_{⁰} and ΔG_{f298}_{⁰} of some aluminosilicate minerals”, J. Res. U.S. Geol. Surv., Vol. 5(4), (1977), pp. 413-429.
77. B. Baranowski, S. M. Filipek, “45 years of nickel hydride—history and perspectives”, Journal of Alloys and Compounds, 404-406, (2005), pp. 2-6.
78. K. K. Baldridge, J. S. Siegel, “Correlation of empirical δ(TMS) and absolute NMR chemical shifts predicted by ab initio computations”, J. Phys. Chem. A, Vol. 103, (1999), pp. 4038-4042.
79. J. Mason, Editor, Multinuclear NMR, Plenum Press, New York, (1987), Chp. 3.
80. C. Suarez, E. J. Nicholas, M. R. Bowman, “Gas-phase dynamic NMR study of the internal rotation in N-trifluoroacetlypyrrolidine”, J. Phys. Chem. A, Vol. 107, (2003), pp. 3024-3029.
81. C. Suarez, “Gas-phase NMR spectroscopy”, The Chemical Educator, Vol. 3, No. 2, (1998).
82. C. Lu, J. Hu, J. H. Kwak, Z. Yang, R. Ren, T. Markmaitree, L. Shaw, “Study the Effects of Mechanical Activation on Li—N—H Systems with ¹H and ⁶Li Solid-State NMR,” J. Power Sources, Vol. 170, (2007), 419-424.
83. M. Stavola, E. E. Chen, W. B. Fowler, G. A. Shi, “Interstitial H₂ in Si: are All Problems Solved?” Physica B, 340-342, (2003), pp. 58-66.
84. E. V. Lavrov, J. Weber, “Ortho and Para Interstitial H₂ in Silicon,” Phys. Rev. Letts., 89(21), (2002), pp. 215501 to 1-215501-4.
85. E. E. Chen, M. Stavola, W. B. Fowler, J. A. Zhou, “Rotation of Molecular Hydrogen in Si: Unambiguous Identification of Ortho-H₂ and Para-D₂,” Phys. Rev. Letts., 88(24), (2002), pp. 245503-1 to 245503-4.
86. E. E. Chen, M. Stavola, W. B. Fowler, P. Walters, “Key to Understanding Interstitial H₂ in Si,” Phys. Rev. Letts., 88(10), (2002), pp. 105507-1 to 105507-4.
87. A. W. R. Leitch, V. Alex, J. Weber, “Raman Spectroscopy of Hydrogen Molecules in Crystalline Silicon,” Phys. Rev. Letts., 81(2), (1998), pp. 421-424.

1-119. (canceled)

120. A solid fuel reaction mixture comprising:
(a) one or more metals selected from Li, K, Cs, and Na and/or a nitrogen or carbon alloy of one of said one or more metals;
(b) one or more inorganic compounds comprising said metal; wherein said inorganic compound is a hydroxide, oxide, carbonate, sulfate, phosphate, borate, halide, or silicate of said metal; and
(c) a metal hydride and/or metal amide of one of said one or more metals.

121. The reaction mixture according to claim 120, wherein one of said one or more metals is Na.

122. The reaction mixture according to claim 121, wherein component (b) is a halide of Na.

123. The reaction mixture according to claim 122, wherein said halide is NaBr or Nat

124. The reaction mixture according to claim 124 further comprising one or more of NaNO₃, NaNO, NaNO₂, Na₃N, Na₂NH, NH₃, NaBH₄, NaAlH₄, Na₃AlH6, Na₂S, NaHS, NaFeSi, Na₂SO₄, Na₂MoO₄, NaNBO₃, Na₂W8+O₄, NaAlCl₄, NaGaCl₄, Na₂CrO₄, Na₂Cr₂O7, Na₂TiO₃, NaZrO₃, NaAlO₂, NaCoO₂, NaGaO₂, Na₂GeO₃, NaMn₂O₄, NaSiO₄, Na₂SiO₃, NaTaO₃, NaCuCl₄, NaPdCl₄, NaPdCl₄, NaVO₃, NaIO₃, NaFeO₂, NaIO₄, NaClO₄, NaSCOn, NaTiOₙ, NaVOn, NaCrOₙ, NaCr₂Oₙ, NaMn₂Oₙ, NaFeOₙ, NaCoOₙ, NaNiOₙ, NaNi₂Oₙ, and NaCuOₙ, wherein n is 1, 2, 3, or 4.

125. The reaction mixture according to claim 120, wherein one of said one or more metals is Li.

126. The reaction mixture according to claim 124, wherein component (b) is a halide of Li.

127. The reaction mixture according to claim 125, wherein said halide is LiBr or LiI.

128. The reaction mixture according to claim 124 further comprising one or more of LiNO₃, LiNO, LiNO₂, Li₃N, Li₂NH, NH₃, LiBH₄, LiAlH₄, Li₃AlH6, Li₂S, LiHS, LiFeSi, Li₂SO₄, Li₂MoO₄, LiNBO₃, Li₂WO₄, LiAlCl₄, LiGaCl₄, Li₂CrO₄, Li₂Cr₂O7, Li₂TiO₃, LiZrO₃, LiAlO₂, LiCoO₂, LiGaO₂, Li₂GeO₃, LiMn₂O₄, LiSiO₄, Li₂SiO₃, LiTaO₃, LiCuCl₄, LiPdCl₄, LiPdCl₄, LiVO₃, LiIO₃, LiFeO₂, LiIO₄, LiClO₄, LiSCOn, LiTiOₙ, LiVOn, LiCrOₙ, LiCr₂Oₙ, LiMn₂Oₙ, LiFeOₙ, LiCoOₙ, LiNiOₙ, LiNi₂Oₙ, and LiCuOₙ, wherein n is 1, 2, 3, or 4.

129. The reaction mixture according to claim 120 further comprising a nitrogen or carbon alloy of said metal and a dissociator selected from Pt, Pd, or Raney Nickel.

130. The reaction mixture according to claim 128 wherein said dissociator is coated on a high surface area support composed of a support material inert to said metal.

130. The reaction mixture according to claim 129 wherein said support is Al₂O₃ or carbon.

131. A system for generating power comprising:
(a) the solid fuel reaction mixture according to claim 120; and
(b) a heater coupled to said solid fuel reaction mixture;
wherein said heater is capable of initiating a reaction in said solid fuel to generate a plasma.
